(19) United States
(12) Patent Application Publication
(10) Pub. No.: US 2007/0194225 A1
(43) Pub. Date: Aug. 23, 2007

(54) Coherent electron junction scanning probe interference microscope, nanomanipulator and spectrometer with assembler and DNA sequencing applications

(76) Inventor: Miguel Delmar Zorn, Portland, OR (US)

Correspondence Address: Miguel D. Zorn, 4820 SW Barbur Blvd. Apt # 31, Portland, OR, 97239, US

(21) Appl. No.: 11/246,665

(22) Filed: Oct. 7, 2005

(51) Int. Cl. G01N 23/00; G21K 7/00

(52) U.S. Cl. 250/306

(57) ABSTRACT

The present invention is directed toward the fabrication and operation of a coherent electron quantum interferometer for scanning probe microscopy. The device may also be operated in a mode where single electrons are used in the sample probe. The device may operate in modes where scanning probe behavior, Kondo effect and/or Aharanov-Bohm interferometer behavior can be observed. The use of nucleic acid molecules attached to the probe structures allows for interrogation of RNA and DNA molecules absorbed on the sample substrate and potentially the sequencing of genetic material using coherent spectroscopic electron imaging in conjunction with prior art probe methods. An embodiment with genetic algorithm generated molecular arrays and circuit prototyping areas is provided in a preferred embodiment for an evolvable hardware embodiment of a coherent electron interferometer nanomanipulator platform. Nanotweezers with Raman optical and mass spectroscopic means are provided in a preferred embodiment for assembly, characterization and nanomanipulation.

### CROSS-REFERENCE TO RELATED APPLICATIONS

Not Applicable

### FEDERALLY SPONSORED RESEARCH

Not Applicable

### SEQUENCE LIST OR PROGRAM

Not Applicable

### BACKGROUND OF THE INVENTION

1. Field of Invention

This invention relates to a device useful in the fields of scanning probe microscopy, coherent mesoscopic circuits, Josephson junction devices, superconducting quantum interferometer devices (SQUID), nanoelectromechanical systems (NEMS) and microelectromechanical systems (MEMS). In addition artificial intelligence algorithms are used for evolvable software, hardware, sample and combinatorial library design in conjunction with the novel scanner and nanomanipulator.

2. Discussion of Prior Art

The use of tunneling junction devices to measure forces and fields associated with materials has evolved into a diverse field of designs and operational modalities. Generally a tunneling junction consists of two electrodes separated by a vacuum, liquid or gas gap of variable dimension. The separation of the electrodes is usually on the order of 1 nm during scanning or spectroscopy. Various transduction mechanisms are employed to drive the modulation of the tunneling gap electrode separation such as piezoelectric, electromagnetic and capacitive drive mechanisms. The use of a servo loop or proportional-integral-derivative controller (PID controller) method for feedback of the gap junction distance is a standard method for gap control. The exponential dependence of the tunneling current on the junction gap distance allows for extremely sensitive measurement of the distance separating the electrodes or the physical properties of the material through which the tunneling electrons pass. The use of multiple axis motion transducers attached to the tunneling electrode or electrodes of the junction has led to the creation of the Scanning Tunneling Microscope by Binnig et al, Appl. Phys. Lett., 40, 178 (1982). The STM device allows for the raster or vector scanning of the tunneling junction electrodes and imaging of the electrode surfaces and absorbed molecules on the sample electrode surface. The scanning electrode in the STM is referred to as the tip as it is typically a sharp etched wire needle or microelectronic cantilever with a metal tip. Prior work relating to SPM (scanning probe microscopes) and STM research is found in the following “Scanned-Probe Microscopes” by H. Kumar Wickramasinghe, Scientific American, October 1989, pages 98 to 105; in “Vacuum Tunneling: A New Technique for Microscopy” by Calvin F. Quate, Physics Today, August 1986, pages 26 through 33; and in U.S. Pat. No. 4,912,822 to Zdeblick et al, issued Apr. 3, 1990. Additionally work on integrated microelectromechanical systems (MEMS) based STM and SPM can be found in U.S. Pat. No 5,449,903. In this patent integrated circuit fabrication methods are used to form the scanning actuators, tip structures and associated electrical and mechanical system on a silicon substrate. This cited device does not allow for coherent electron interferometry or spectroscopy during the tunneling process. Additionally the device does not allow for associated electron spectroscopic methods produced by the novel properties of the instant invention. The methods related to the microelectromechanical integrated circuit and micromachine foundry processing used in U.S. Pat. No. 5,449,903 may be used or modified to build the instant invention microstructures. High aspect ratio electromechanical comb drives may require deep reactive ion etching steps though.

Pump probe optical methods used in conjunction with STM are described in U.S. Pat. No. 4,918,309. This patent describes use of optical excitation of electrical potentials between the STM tip and sample surface by optically gated excitation of charge carriers which are detected by the tunneling junction of a STM. By timing pumping pulses of a laser it is possible to measure very short duration events occurring at the tunneling junction using this and related methods. The citation in the prior art does not provide means for coherent electron quantum interference or resultant spectroscopy provided by the instant invention. By combining the use of optical excitation by optical pulses of femtosecond to picosecond duration with the coherent measurement circuitry of the instant invention novel spectroscopic information and data manipulation methods are possible.

The prior art U.S. Pat. No. 4,918,309 describes an optical pulse sampled scanning tunneling microscope which uses laser excitation of the tunneling gap resulting in photon-assisted tunneling spectroscopy of samples. The tunneling electrons in this prior art invention are not in a phase coherent quantum state as they are in the instant invention. The superconducting quantum interferometer structure of the instant invention may be excited using laser irradiation as in the U.S. Pat. No. 4,918,309 allowing for time gated transient optical excitation and spectroscopic sampling of the flexible gap junction of the instant invention. Photons above the superconducting gap energy will cause Cooper pair destruction but resumption of coherent electron tunneling is indicative of the sample material and can be used as a sample measuring parameter in the present invention.

The U.S. Pat. No. 4,918,309 uses a single tip junction with incoherent electrons to sample when optical pump and probe pulses excite the STM while the instant invention uses a pair of tip structures to form junctions with coherent interferometric tunneling capability. The instant invention may further be operated as a three or more terminal quantum junction device and nanomanipulator which is an additional novel feature compared with the device in U.S. Pat. No. 4,918,309. Asymmetrical excitation of the tip pair is possible using the instant invention device by placing photoconductor materials such as nanoparticles at or near the tips of the flexible junction gap. The use of nanoparticles with different discrete excitation bandgap energies allows for the optical pulse pumping and probing photons to be selectively chosen to measure or excite one of the tips in the pair selectively in conjunction with coherent Cooper pair quantum interferometry.

Prior art references “Circuit Analysis of an ultra fast junction mixing scanning tunneling microscope”, G. M. Steeves, A. Y. Elezzabi, R. Teshima, R. A. Said, and M. R. Freeman, IEEE JOURNAL OF QUANTUM ELECTRONICS, VOL. 34, NO. 8, AUGUST 1998 and “Laser-frequency mixing in a scanning tunneling microscope at 1.3 um”, Th. Gutjahr-Loser, A. Hornsteiner, W. Krieger, and H. Walther JOURNAL OF APPLIED PHYSICS VOLUME 85, NUMBER 9 1 MAY 1999 are incorporated here by reference in their entirety. A citation for reference to feedback methods of use in this area is by A. Pavlov, Y. Pavlova and R. Laiho in Rev.Adv.Mater.Sci. 5(2003) 324-328. This article describes a MEMS scanner which is useful for SPM though it does not offer coherent electron spectroscopy and imaging as the instant invention does. The feedback methods are applicable to the instant invention. Reference to the articles D. Ruger, H. J. Mamin and P. Guethner, Applied Physics Letters 55, 2588 (1989), H. J. Mamin and D. Ruger Applied Physics Letters 79, 3358 (2001) and D. Pelekhov, J. Becker and J. G. Nunes, Rev. Sci. Instrum. 70, 114 (1999) should be made as these citations describe cantilever detection methods useful in the instant invention. These citations do not provide coherent scanning probe microscopy, spectroscopy or nanomanipulation as the instant invention does.

The prior art references on mechanically static Aharonov-Bhom interferometers have relevance to the instant invention can be found in A. Yacoby, M. Heiblum, D. Mahalu and H. Shtrikman, Phys. Rev. Lett. 74, 4047 (1995), R. Schuster, E. Buks, M. Heiblum, D. Mahalu, V. Umansky and H. Shtrikman, Nature (London) 385, 417 (1997) Y. Ji, M. Heiblum, D. Sprinzak, D. Mahalu and H. Shtrikman, Science 290, 779 (2000), Y. Ji, D. Mahalu and H. Shtrikman, Phys. Rev. Lett. 88, 076601 (2002), T. W. Odom, J-L. Huang, C. L. Cheung, C. M. Lieber, Science 290, 1549 (2000) and Tae-Suk Kim and S. Hershfield Physical Review B 67, 165313 (2003). These citation articles describe Aharonov-Bhom electron interferometers and the theory of their use but differ greatly from the instant invention electron coherent probe microscope and nanomanipulator as they do not have a flexible gap and deconvolution means to decouple sample probe motion during scanning from interferometer output as the instant invention does. Additionally these citations can not scan a sample through the Aharonov-Bohm interferometer that they use in their work.

The present inventions coherent flexible gap scanner circuit can be used in conjunction with scanning near field optical spectroscopy, near field aperaturless interferometry probe microscopy and evanescent wave microscopy and sub-wavelength interferometry and thus a prior art citation of relevance is U.S. Pat. No. 5,602,820. This prior art describes measurement and data recording using nanometer scale probes excited by optical means. This prior art citation does not combine coherent electron interferometry with optical near field interferometry via flexible gap coherent electron or SQUID circuit integrated with the probe tips as the instant invention does.

The work by J. Byers and M. Flatte (Phys Rev Lett, vol 74, number 2, Jan. 9, 1995) relates to nanoscale two contact tunneling spectroscopy and is an important prior art reference with respect to the instant invention. The device fabricated by these researchers makes contact with the sample substrate using a first nanometer scale fixed contact and a second contact is made via a movable scanning tunneling microscope contact. The tunneling microscope contact is used to spatially map the electron standing wave amplitude and distribution on the sample surface. The device was used to detect surface gap anisotropy of a superconducting sample. Though the device uses two contacts to the substrate as the instant invention does there are significant differences and advantages to the instant design and method for other applications. First, the instant invention has two or more contacts which can conduct tunneling orthogonal or parallel to the opposing surface of a thin sample substrate. The flexible gap variable junction of the instant invention can scan an ultra thin sample substrate into the junction gap and flux which can be transmitted through the junction.

The reference work uses two contacts which are formed laterally on the sample substrate which are used to map the surface local electronic correlations of the surface-state electrons. The surface-state electron current is conducted between the nanoscale contact and the STM tip, both residing on the same surface. The differential current detection scheme produces electrical contact between the STM tip and nanoscale contact in the referenced work is not performed by a quantum interferometer device as in the instant invention.

Additionally the instant invention has embodiments with the ability to move two or more contacts, where the referenced work uses a fixed nanoscale contact and a movable STM tip. The instant invention also has envisioned embodiments where a fixed nanometer scale contact related to the cited reference is incorporated and used on the sample substrate surface but is used in conjunction with the novel coherent electron flexible gap junction interferometer providing three terminal lateral surface conductance measurements with the novel orthogonal conductance through the thin sample substrate. This three terminal arrangement allows for both lateral surface-state mapping such as angularly resolved dispersion relations, mean free path and mapping of density of states as a function of energy and momentum. This allows for coherent quantum interference effects to be probed. Also the instant device can analyze the sample by evaporation.

The transition between ballistic and diffusive transport, and lifetimes of normal and quasiparticles in normal, superconductive and sample substrate and proximal samples is possible using a three terminal approach of the instant invention. In a three terminal embodiment the substrate sample carrier 127 can be biased separately from the tips 1,2,3 and 4 generally used to scan the samples.

The article Scanning Probe Microscopy with inherent disturbance suppression Applied Physics Letters Vol 85, #17, Oct. 25, 2004 by A. W. Sparks and S. R. Manalis concerns use of interferometric detection of z axis noise and active suppression feedback implemented to limit noise in the tunneling signal. The probe cantilever has a interferometer integrated into the tip sensor structure and achieves noise limited interferometer resolution of 0.02 Angstrom in the bandwidth range of 10 Hz −1 kHz.

This reference is useful for the decoupling of the quantum interference signal of the instant electron interferometer from the spatial modulation of the flexible junction gap. The cited reference provides no deconvolution of the relative motion of the tunneling tips attached to the quantum interferometer loop from the spatial separation drive signal used to produce closed loop active scanning signals can be done with an interferometer as in the reference article. By having quantum coherent energy transport in the quantum interferometer formed by the multiple probes the instant invention can generate data from a scanned sample comprising topographic and coherent electron derived spectroscopic information.

The instant inventions flexible gap variable junction may employ closed loop or open loop actuation feedback. MEMS based accelerometers and gyroscopes using tunneling, electrostatic and piezo resistive actuation and sensing can achieve a spatial displacement resolution of 0.01 Angstroms. The exponential dependence of the tunneling current on the junction gap distance requires sub angstrom resolution in maintaining junction gap separation. When the sample being scanned is scanned by electrodes on opposite sides of the substrate as in FIG. 4 the following scanning method can be used.

The sample substrate surface inserted into the gap or substrate scanned by lateral conduction between tips is integrated into the data acquisition and scanner feedback modulation process so as to couple motion of the gap right electrode, sample substrate surface and left electrode. The basic detection process required is the deconvolution of the sample signal resulting from electron flux between the electrode interacting with the sample from the topography derived movement of the flexible junction gap spacing during sample scanning. This signal must be differentiated from the signal resulting from contact of the clean left surface of the sample substrate with the flexible gap right electrode. The flexible junction gap mechanical spacing couples to the tunneling signal with an exponential dependence of tunnel current on the gap distance. Actuator driven gap tunneling distance of the flexible junction and random thermal noise in the tunneling gap and cantilever produce variation in the signal. The sample can be scanned by tips on the same side of the substrate also.

Cooling systems comprising closed-cycle cryogenic refrigeration, adiabatic demagnetization or dilution refrigeration unit may be commercially purchased and used for cooling. The adiabatic demagnetization refrigerator may cause problems with the magnetically sensitive SQUID quantum interferometer circuit of the instant invention.

The possibility of using thermotunneling solid state cooling methods such as that being developed by Borealis Research via their cool chips technology or magnetoresistive cooling are prime candidate technologies for making the instant invention system compact, low power consuming and self contained.

High aspect ratio electromechanical comb drives may require deep reactive ion etching steps though. A good reference for methods of MEMS fabrication which is CMOS compatible is Nim H. Tea, Veljko Milanovi'c, Christian A. Zincke, John S. Suehle, Michael Gaitan, Mona E. Zaghloul, and Jon Geist in Journal of Microelectromechanical Systems, Vol. 6, No. 4, December 1997

The formation of the superconductive layers required for the SQUID version of the quantum interferometer can be formed using standard trilayer Nb/AlOx/Nb integrated process such as the commercial Hypres process for superconductive quantum interferometer (SQUID) fabrication. The Nb/AlOx/Nb trilayer process is temperature sensitive and thus low temperature etching of mechanical actuator and spring assemblies will be required. Alternately the Nb/AlOx/Nb trilayer can be deposited and etched after the substrate is micromachined. Other superconductive materials for conduit and junction structures can be used for the instant invention. In particular materials such as high temperature YBCO may be used. In addition alternate junctions comprising superconductor-insulator-normal, normal-insulator-superconductor-normal-insulator-superconductor (N-I-SN-I-S), superconductive and superconductor-normal-superconductor multilayer junctions and devices may be used on the scanner of the instant invention. Quantum well structures can be connected to the flexible gap junction to provide electronic and optical measurement and modulation.

The prior art work at IPHT Jena Department of Cryoelectronics on low temperature superconductor circuit fabrication in Stolz, Fritzsch and Meyer, Supercond. Sci. Technol. 12 (1999) 806-808, describes formation of a Niobium based SQUID josephson junction sensor using Nb/AlOx/Nb junction. The citation differs from the present invention in that it does not provide a means for scanning probe microscopy and only acts as a magnetometer. Additional work at IPHT provides standardized fabrication methods for fabricating sub-micron SIS and SNS junctions on the same substrate. Using the described SQUID circuit fabrication sequence with the MEMS fabrication methods cited here the instant invention can be fabricated. Superconducting Josephson junction (JJ) is of high nonlinearity, wide band, low power consumption and high sensitivity device. The formation of a mixer using superconducting Josephson junction as active devices can form a means for signal frequency operation well into the submillimeter and Terahertz (THz) region, which is very difficult for semiconductor devices to achieve.

High temperature superconductor (HTS) Josephson devices have greater potentials in submillimeter and THz applications than low-Tc JJs because of the large energy gaps of HTS materials. The operating frequency range for a JJ is set by the characteristic frequency fc corresponding to the IcRn product (fc=2e/h IcRn), where e is electron charge, Ic is the junction critical current density and Rn is normal-state resistance. The IcRn product or characteristic frequency is fundamentally limited by the superconducting energy gap. Many estimates for the energy gap values for YBCO ranged from 10 to 60 meV, corresponding to a gap frequency of from 5 THz to 30 THz, which is ten times higher than that of low-Tc materials.

One of the important applications of a frequency mixer is to measure frequency of the far-infrared laser and molecular vibrational states. As we know a signal at frequency fs can mix with the harmonics of a local oscillator at frequency fL to get output at intermediate frequency flF=Nfs-fL, where N is an integer (harmonic number). This is called harmonic mixing. If we can measure accurately fL,fIF and N we can also know fs accurately. As long as N is large enough the measurement accuracy of EL and f]F can be transferred to much higher frequencies, which results in fewer conversions in the frequency metrology process. The flexible gap junction interferometer and nanomanipulator of the present invention can be used as or with a frequency mixing means provided by Josephson junctions.

Ring shaped nanostructures such as those found in “Electrical Transport in Rings of Single-Wall Nanotubes: One-Dimensional Localization”H. R. Shea, R. Martel, and Ph. Avouris, VOLUME 84, NUMBER 19 PHYSICAL REVIEW LETTERS 8 MAY 2000 is a prior art reference of note as the present invention has embodiments which use ring shaped nanotubes as circuit elements attached to the flexible gap scanner coherent electron device.

A preferred embodiment uses GaAs or another group III-V semiconductor as the substrate. The advantage of using GaAs or other group III-V semiconductors is that they may be used to form low temperature operable HEMT transistors and amplifiers as well as other analog circuits which may be integrated with the flexible gap junction scanner. The group III-V semiconductors may be used to integrate laser diodes and photodetectors into the MEMS structure forming a microelectro-optical-mechanical systems (MOEMS). Piezo actuators may also be used with or as an alternate to electrostatic actuation. The III-V semiconductors can also be used to form two dimensional electron gas quantum devices which the present invention can make use of in the prototyping areas of the device for novel research and customer derived circuits integrated with the coherent flexible gap scanning electron probe interferometer.

MESFET, PHEMT and HBT transistor technologies are possible circuit technologies which may be integrated with the instant inventions flexible gap coherent electron interferometer. Northrop Grumman has developed a family of GaAs MMIC products focused on power generation. Future upgrades will reduce the gate length of the PHEMT process to 0.1 μm to extend frequency coverage to W-band microwave region. Similarly, critical dimensions in the HBT process will be reduced to extend the applicability of this process to 35 GHz. The process will also be migrated to the GaAs/InGaP materials system for improved reliability. Back end MEMS fabrication steps performed on these commercially processed wafers offers a standard route to fabrication of the instant invention.

Nanotube Deposition;

Xidex U.S. Pat. No. 6,146,227 describes a method of fabricating nanotubes on MEMS devices with controlled deposition of nanoparticle catalysts in channel and pore structures of a MEMS. The channel and pore structures provide a template limiting the direction of growth of the nanoparticle catalyzed nanotube. This patent does not describe or provide any means of performing electron interferometry with the nanotube structures synthesized. Nanowire electronics and logic gates have been fabricated and tested in small numbers recently and a prior art reference by Yu Huang, Xiangfeng Duan, Yi Cui, Lincoln J. Lauhon, Kyoung-Ha Kim and Charles M. Lieber in Science, Vol. 294. 9 Nov. 2001 describes methods useful in conjunction with the instant invention. The nanowire devices in this article do not perform coherent quantum spectroscopy as the instant invention does and can not form images of a substrate. The circuits of this reference can be probed and characterized by the instant invention scanner device and also the circuits described can be incorporated into the circuit of the instant MEMS scanning device.

The prior art reference “Quantum interference device made by DNA templating of superconductive nanowires” David S. Hopkins, David Pekker, Paul M. Goldbart, Alexey Bezryadin in Science 17 June 2005 vol 308 p 1762-1765 describes the formation of nanowire pairs across static etched trench structures on a silicon wafer. The superconductive nanowire pairs are attached to conductive pads which can be operated to form a superconducting phase gradiometer. The device does not provide a means of performing scanning tunneling microscopy or scanning probe microscopy of a sample scanned by the superconducting nanotubes. In addition the reference article device provides no means to from images or gain spectroscopic information of scanned samples as the instant invention does using patterned template superconductive nanotubes.

Prior art references on Raman spectroscopy for molecular and electronic vibrational spectroscopy useful in the present invention for single molecule and mesoscale characterization can be found in:
Shuming Nie and Steven R. Emory, Probing Single Molecules and Single Nanoparticles by Surface-Enhanced Raman Scattering, Feb. 21, 1997, Science vol. 275.
Katrin Kneipp, Yang Wang, Harold Kneipp, Lev T. Perelman, Irving Itzkan, Ramachandra R. Dasari, and Michael S. Feld, Single Molecule Detection Using Surface-Enhanced Raman Scattering (SERS), Mar. 3, 1997, The American Physical Society, Physical Review Letters vol. 78 No. 9.
F. Zenhausem, Y. Martin, H. K. Wickramasinghe, Scanning Interferometric Apertureless Microscopy: Optical Imaging at 10 Angstrom Resolution, Aug. 25, 1995, Science vol. 269. Ayaras et al, Surface enhancement in near-filed Raman spectroscopy, Appl. Physics Letters, June 2000, v. 76, pp 3911-3913.
A. Kosterin and D. Frisbie, SPIE Proceedings 3791, 49-56 (1999).
Harootunian, E. Betzig, M. Isaacson and A. Lewis, Appl. Phys. Lett. 49, 674 (1986).
A. Smith, S. Webster, M. Ayad, S. D. Evans, D. Fogherty and D. Batchelder, Ultramicroscopy 61, 247 (1995).
S. Webster, D. N. Batchelder and D. A. Smith, Appl. Phys. Lett. 72, 1478 (1998).
S. Webster, D. A. Smith and D. N. Batchelder, Spectrosc. Eur. 10, 22 (1998).
Surface Enhanced Raman Scattering, eds. R. K. Chang, T. E. Furtak, Plenum Press, New York, (1982).
J. Wessel, J. Opt. Soc. Am. B2, 1538 (1985)
Lewis and K. Lieberman, Nature 354, 214 (1991).
O. Bouvitch, A. Lewis and L. Loew, Bioimaging, 4, 215 (1996).
S. Nie and S. R. Emory, Science 275, 1102 (1997).
S. R. Emory and S. Nie, Anal. Chem. 69, 2631 (1997).
K. Kneipp, Y. Wang, It Kneipp, L. T. Perelman, I. Itzkan, R. R. Dasari and M. S. Feld, Phys. Rev. Left. 78, 1667 (1997).
D. Zeisel, V. Deckert, R. Zenobi and T. Vo-Dinh, Chem. Phys. Lett. 283, 381 (1998).
V. Deckert, D. Zeisel and R. Zenobi, Anal. Chem. 70, 2646 (1998).
H. Xu, E. Bjerneld, M. Käll and L. Böjesson, Phys. Review Lett. 83, 4357 (1999).
R. M. Stockle, Y. D. Suh, V. Deckert and R. Zenobi, Chem. Phys. Lett. 318, 131 (2000).

The above are incorporated in the entirety as prior art references.

The work by J. Byers and M. Flatte (Phys Rev Lett, vol 74, number 2, Jan. 9, 1995) relates to nanoscale two contact tunneling spectroscopy and is an important prior art reference with respect to the instant invention. The device fabricated by these researchers makes contact with the sample substrate using a first nanometer scale fixed contact and a second contact is made via a movable scanning tunneling microscope contact. The tunneling microscope contact is used to spatially map the electron standing wave amplitude and distribution on the sample surface. The device was used to detect surface gap anisotropy of a superconducting sample. Though the device uses two contacts to the substrate as the instant invention does there are significant differences and advantages to the instant design and method for other applications. First, the instant invention has two or more contacts which can conduct tunneling orthogonal through the opposing surface of a thin sample substrate. The flexible gap variable junction of the instant invention scans an ultra thin sample substrate into the junction gap and flux is transmitted through the junction.

The reference work uses two contacts which are formed laterally on the sample substrate which are used to map the surface local electronic correlations of the surface-state electrons. The surface-state electron current is conducted between the nanoscale contact and the STM tip, both residing on the same surface. The differential current detection scheme producing electrical contact between the STM tip and nanoscale contact in the referenced work is not performed by a quantum interferometer device as in the instant invention.

Additionally the instant invention has embodiments with the ability to move both of the two contacts, where the referenced work uses a fixed nanoscale contact and a movable STM tip. The instant invention also has envisioned embodiments where a fixed nanometer scale contact related to the cited reference is incorporated and used on the sample substrate surface and is used in conjunction with the novel flexible gap junction providing three terminal lateral surface conductance measurements with the additionally novel orthogonal conductance through the thin sample substrate.

This three terminal arrangement allows for both lateral surface-state mapping such as angularly resolved dispersion relations, mean free path and mapping of density of states as a function of energy and momentum. This allows for coherent quantum interference effects to be probed. The transition between ballistic and diffusive transport, and lifetimes of normal and quasiparticles in normal and superconductive samples is possible using the three terminal approach of the instant inventions possible embodiments with the flexible gap coherent interferometer device. The modulation of the second surface sample substrate bias potential allows for the density of states at various energy levels to be probed both above the superconductor binding energy and below. Use of coherent electrons in a flexible normal metal interferometer allows for scanning the energies above the superconductor cooper pair binding energies.

Selection of ranges of bias potentials scanned by the flexible tunnel gap of the instant invention while scanning the sample absorbed polynucleic acid molecules is chosen so as not to exceed the critical current of the Josephson junction using the SQUID embodiments of coherent quantum interferometer mode operation. The bias potential may be DC, AC or electromagnetically modulated. Additionally the bias may be modulated so as to transiently exceed the critical current of a SQUID junction. The tunneling current transiting the gap will revert to non-phase coherent electrons when the critical current is exceeded in a SQUID. The bias potentials which produce currents above the critical current may be used to excite chemical bond specific lowest occupied molecular orbitals or highest occupied molecular orbitals in the sample or substrate. Additionally the instant inventions junction gap may be excited using electromagnetic energy at frequencies below at or above the Josephson voltage-frequency to probe the sample states and provide a means for coherent quasiparticle spectroscopic scanning of samples. The flexible junction gap may itself be used to generate AC Josephson oscillations in the junction by biasing the junction or associated proximal circuitry and generating electromagnetic radiation. This may be combined with mechanical modulation of the flexible gap junction tips, probes or sample substrates.

The prior art work using mechanically controllable break junctions MCBJ method has allowed for individual atom and molecule spectroscopy to be performed. The integration of a quantum interferometer with a flexible break junction is a novel development or possible embodiment of the instant invention as the prior art has not used coherent quantum interferometer conductive structures to probe molecules in the junction gap.

The prior art article “Vacuum Tunneling of Superconductive Quasiparticles from Atomically Sharp Scanning Tunneling Microscope Tips” in Applied Physics Letters, Vol 73, #20, Nov. 16, 1998, describes use of superconductive Niobium STM tips for scanning and spectroscopic work. The article mentions the advantages in tunneling signal detection of the Cooper pairs and proposals for use of the tunneling tip sample junction as a Josephson junction is made. The article does not propose use of the tunneling tip in a quantum interferometer circuit as in the instant invention. Combination of multiple tunneling tips or interferometer signals to deconvolve a pair of moving flexible gap tips and a sample substrate topography is not provided by the prior art citation which is required to operate the instant invention, making novel the combination of quantum interferometer coherent conduction circuit and scanning probe of the instant patent.

The prior art reference article “A variable-temperature scanning tunneling microscope capable of single-molecule vibrational spectroscopy”, B. C. Stipe, M. A. Rezaei, and W. Ho, REVIEW OF SCIENTIFIC INSTRUMENTS VOLUME 70, NUMBER 1 JANUARY 1999 is incorporated here by reference in its entirety. The online prior art research proposal “Single Molecule DNA Sequencing with Inelastic Tunneling Spectroscopy STM” by Jian-Xin Zhu, K. O. Rasmussen, S. A. Trugman, A. R. Bishop, and A. V. Balatsky describes using inelastic electron scattering from a STM tip to differentiate and sequence nucleotide monomers of a DNA molecule. The use of inelastic tunneling spectroscopy according to the prior art does not provide coherent electron spectroscopy or provide a means of deconvolving topographic sample data from coherent electron spectroscopy data during DNA scanning as the instant invention does.

Prior art U.S. Pat. No. 5,824,470 describes functionalization of scanning probe tips and is applicable to the instant invention in terms of methods for adding chemical functional groups to a SPM tip and in particular to nanotube probe tips. The cited patent does not provide quantum interferometer capabilities of the instant invention.

U.S. Pat. No. 5,440,124 describes a rapid repetition rate atom probe device which uses a local extraction electrode to field ionize material atom by atom from a sample surface and inject the ions into a mass spectrometer. This device does not use scanning probe microscopy to image atoms or surface and the sample analyzed must be etched to form a sharp tip geometry for field evaporation. The instant invention has embodiments where a field ionization extraction electrode aperture and mass spectrometer as in the cited reference operated in conjunction with a coherent electron probe spectroscopy, microscopy and nanomanipulation. In addition the citation does not provide means for Raman spectroscopy of samples or surfaces being SPM imaged and evaporation ionized for analysis.

The U.S. Pat. No. 5,621,211 describes use of the STM tip as an extractor electrode for a scanning atom probe microscope integrated with a scanning tunneling microscope (STM) for atomic resolution imaging of surfaces and extraction of ionized species, atom by atom from the region being scanned by the STM. This device transfers atoms or materials from the STM scanned surface to the STM tip then injects the ionized species into a time of flight mass spectroscopy device. The device does not provide a means for performing coherent electron interferometery with the scanning probe or providing nanomanipulation nanotweezers with multiple tips or Raman spectroscopy of samples or surfaces being imaged and ionized.

The U.S. Pat. No. 6,875,981 describes a scanning atom probe microscope (SAP) with a scanning probe for AFM and STM which uses a field ionization probe to remove atoms from a surface and subsequently performs mass analysis on the atomic species released from the extraction electrode probe and sample interaction field. The cited invention does not describe or provide a means to produce coherent electron interferometric images or spectroscopy, nanotweezers and nanomanipulation as the instant invention does. The instant invention has embodiments where probe tip field ionization and mass spectroscopy is performed in conjunction with the coherent electron probe spectroscopy, microscopy and nanomanipulation. In addition the citation does not provide means for Raman spectroscopy of samples or surfaces being imaged and ionized.

The U.S. Pat. No. 6,797,952 describes fabrication of an extractor electrode for a scanning atom probe microscope integrated with a scanning tunneling microscope (STM) for atomic resolution imaging of surfaces and extraction of ionized species, atom by atom from the region after being scanned by the STM using mass spectroscopy. The device does not provide a means for performing coherent electron interferometery with the scanning probe or providing nanomanipulation with multiple tips or Raman spectroscopy of samples or surfaces being imaged and ionized. Thus optical vibrational and low energy coherent interferometry can not be performed by the cited device. In addition the prior art device has limited nanomanipulation capabilities as only one probe is provided and no nanotweezers are described.

The U.S. Pat. No. 6,583,411 describes a multiple probe SPM device and method. The instant invention differs from the cited patent as the cited patent describes a device with multiple probes with a plurality of detection means, each being associated to a particular one of the local probes to independently detect measurement data from local measurements. The instant invention has embodiments which use multiple probes where two or more probes or leads effect a means for a quantum interference measuring device. The cited invention detection means are compartmentalized with one particular local probe associated with one particular detector where the instant invention-generates detection data by measuring quantum interference by generating coherent electron transport between probes. By having quantum coherent energy transport in the quantum interferometer formed by the multiple probes the instant invention can generate data from a scanned sample comprising topographic and coherent electron derived spectroscopic information. The separate compartmentalized detection arrangement of the cited patent precludes interference patterns being formed as an overlap of the energy generated by the transport between or reflection from the probes is required.

The U.S. Pat. No. 6,583,412 describes a scanning tunneling charge transfer microscope (STCTM) which is used for measuring low current and dielectric interactions between a probe tip and a sample. The instant invention differs from this prior art in that it provides modes for coherent electron interferometer measurement of probe sample interactions. In addition the present invention provides means for probe microscope nanotweezers to nanomanipulate and perform mass spectroscopy with the sample material. By combining one or more of the present invention quantum interferometer probes with one or more STCTM probe structures, modes of synergistic and composite operation are possible. The Raman spectroscopy operation modes of the present invention also provide improvements over the prior art cited in that the present invention can perform coherent electron spectroscopy in combination with STCTM and optical spectroscopy using far field and SERS spectroscopy. The conductive tip or sample material can be formed of SERS active particles an advanced operation improvement over the prior art.

The U.S. Pat. No. 6,669,256 U.S. Pat. No. 6,802,549 and U.S. Pat. No. 6,805,390 describe nanotube nanotweezers devices. The instant invention differs from the cited patent in that the multiple probes of the instant invention provide both mechanical nanotweezers and quantum interferometric sample measurement. The cited patents do not provide or anticipate any means of providing novel coherent electron transport measurement or deconvolving displacement related tunneling signal from sample coherent electron data from scanned or manipulated sample material. By having quantum coherent energy transport in the quantum interferometer formed by the multiple probes the instant invention can generate data from a scanned sample comprising topographic and coherent electron derived spectroscopic information. Furthermore the present invention integrates the nanotweezers with mass spectroscopy embodiments for compositional determination of atoms, molecules and complexes of the manipulated or imaged surface material which the prior art invention does not have the capability to do. The present invention also has embodiments where a Raman spectroscopy measurement capability is combined with the nanomanipulator and mass spectrometer means which the cited patents lack.

The U.S. Pat. No. 6,800,865 describes the attachment of nanotubes to surfaces to form a probe microscope. The cited invention does not describe or provide a means to produce coherent electron interferometric images or spectroscopy as the instant invention does.

U.S. Pat. No. 6,528,785 describes a nanotube fusion welding probe and method for forming a local probe device for scanning probe microscopy. The cited invention does not describe or provide a means to produce coherent electron interferometric images or spectroscopy as the instant invention does.

The U.S. Pat. No. 6,743,408 describes a nanotweezers device. The instant invention differs from the cited patent in that the multiple probes of the instant invention provide both mechanical nanotweezers and quantum interferometric sample measurement. The cited patent does not provide or anticipate any means of providing novel coherent electron transport measurement of sample material. By having quantum coherent energy transport in the quantum interferometer formed by the multiple probes the instant invention can generate data from a scanned sample comprising topographic and coherent electron derived spectroscopic information. . Furthermore the present invention integrates the nanotweezers with mass spectroscopy embodiments for compositional determination of atoms, molecules and complexes of the manipulated or imaged surface material which the prior art invention does not have the capability to do. The present invention also has embodiments where a Raman spectroscopy measurement capability is combined with the nanomanipulator and mass spectrometer means which the cited patent lacks.

The U.S. Pat. No. 6,862,921 describes a prior art device and method for scanning probe microscopy where a probe pair is used for scanning and manipulating a surface and materials. The instant invention differs from the cited patent in that the multiple probes of the instant invention provide both mechanical nanotweezers and quantum interferometric sample measurement. The cited patent does not provide or anticipate any means of providing novel coherent electron transport measurement or deconvolving displacement related tunneling signal from sample coherent electron data from scanned sample material. By having quantum coherent energy transport in the quantum interferometer formed by the multiple probes the instant invention can generate data from a scanned sample comprising topographic and coherent electron derived spectroscopic information.

The patent application U.S. patent application 20030134273 describes a scanning probe microscope attached to a mass spectroscopy device for identification of reaction products. The methods and device describe use of a scanning probe tip such as a tunneling microscope or atomic force microscope tip being used to detect molecules and subsequently deliver them to a mass spectroscopy device. The instant invention provides nanotweezers capabilities and novel coherent electron interferometry in conjunction with mass spectroscopy. Nanotweezers have many novel capabilities in comparison to standard scanning probe microscope tips including the ability to pick up high aspect ratio objects and the ability to transfer objects from one functional group to another on the end of the arms of the tweezers pincer tips. Disparate Raman spectroscopy nanoparticles can be used with the present inventions nanotweezers embodiment. The nanotweezers can be asymmetrically functionalized and in conjunction can be used to provide physical capabilities not possible with the cited device or method with a simple scanning probe microscope. Thus many advantages are offered by the use of nanotweezers embodiments of the present invention. In addition the present invention has embodiments where an extractor electrode is used which allows for pulsed field evaporation of the substrate and rapid tomography of the substrate material when field evaporation tips on the substrate are formed. The cited invention lacks an extractor electrode for rapid surface tomography and focused surface sample extraction.

The prior art U.S. Pat. No. 6,365,912 describes a superconductor and normal metal multilayer device useful for multilayer superconductive junction sensors. The devices described has several superconductive device embodiments. In one embodiment a superconductive region and a normal metal trap share an interface which allows for quasiparticles traversing the junction to release potential energy causing amplification. In other embodiments multiple junction devices are formed such as those comprised of a normal-insulator-superconductor-normal-insulator-superconductor (N-I-SN-I-S) multilayer. The instant invention device differs from the cited device in that it provides the junctions formed are static structures and no flexible gap junctions or means for scanning a sample substrate through any of the multilayer interfaces of the junctions is provided or possible using the cited reference. Thus there is no way of forming a scanning probe image or spectroscopic microscopy using the cited device junctions.

The cited patent does not provide or anticipate any means of providing novel coherent electron transport measurement or deconvolving displacement related tunneling signal from sample coherent electron data from scanned sample material. By having quantum coherent energy transport in the quantum interferometer formed by the multiple probes the instant invention can generate data from a scanned sample comprising topographic and coherent electron derived spectroscopic information.

The instant invention scanning probe can be used to form atomic and molecular force curves and surface maps and to form images as an AFM in conjunction with coherent electron interferometry. The prior art reference U.S. Pat. No. 6,666,075 describes a multi-dimensional force detection mode for measuring multiple components of a surface-probe interaction during scanning. This cited patent does not provide a means for coherent electron interferometry as the novel instant invention does.

The instant invention uses spanning nanometer scale nanotube or nanotip structures to create local probe structures to scan sample substrate materials. If the flexible gap coherent electron junctions are spanned by such structures or bisected tips a deviation in the phase or amplitude of the coherent electron wave state is perturbed by chemical, dimensional or physical changes or in the nanoscale structure of the probe producing differential modification of the electron wave function. Detection of chemical or physical forces by means the flexible gap interferometers electron wave states of the instant invention produces a means to detect such perturbation. Use of bisected nanoscale structured tip or spanning beam structures associated with the flexible gap junctions and coherent electron circuits of the instant invention is used for sample characterization. Chemical functionalization of said structures and arrangements of material scanned by said structure can produce data derived by the interferometer structure during scanning of a sample.

The prior art reference U.S. Pat. No. 6,756,795 describes a nanobimorph actuator and sensor made from self-assembled nanobimorph components. The cited reference provides no means for coherent electron interferometer scanning probe microscopy. The instant invention has preferred embodiments where one or more nanobimorph devices are used as actuators for integration of one or more of the probes of the coherent electron nanomanipulator and scanning probe operations of the device.

The prior art citation U.S. Pat. No. 6,360,191 describes a genetic algorithm (GA) design method for generating novel circuits. The method generates a diversity of circuit structures and tests them for task specific functionality. The present invention has regions on preferred embodiments of a MEMS/NEMS device where flexible gap tip probe scanner connected, user specified circuits are evolved by genetic algorithm GA to user specific imaging, nanomanipulation and spectroscopy tasks. The instant invention has preferred embodiments where the use of GA algorithms is made for optimization of a novel coherent electron nucleotide sequencing scanning probe microscope. By providing a prototyping circuit area connected to the instant invention MEMS coherent flexible gap scanning probe microscope and using a GA to fabricate a large diversity of circuit structures a search and optimization of mesoscopic and molecular electronic circuits are tested for nucleotide spectroscopic differentiation. Other nanoscale target interaction specific circuits and structures can be designed by GA for use with the present invention coherent interferometer MEMS/NEMS device. Rich quantum behavioral interactions with scanned materials scan be mapped and target specific circuits evolved using genetic algorithm and simulation of circuits. Artificial intelligence algorithms can be used to generate molecular combinatorial libraries of compounds and nanostructures for circuits, machines and tip structures which can be tested and assembled using the scanning probe microscope (SPM), Raman spectrometer, nanomanipulator and mass spectrometer capabilities of the present invention. The cited prior art means and devices lack the combined capabilities of the present invention to generate, interact and test devices on the atomic, molecular and mesoscopic scales simultaneously.

Prior art references for genetic algorithm driven evolution of hardware can be found in Int. J. Circuit Theory and Applications, 2000 John Wiley & Sons, Inc. “Design of Single Electron Systems through Artificial Evolution” by Adrian Thompson and Christoph Wasshubery which is incorporated by reference it's their entirety. The customer derived prototype areas with evolved hardware on the MEMS/NEMS device can be used to find novel quantum interferometer structures for user specific imaging and nanomanipulation problems. Genetic algorithms in conjunction with a polymorphic prototyping area (mesoscopic-FPGA) attached to the coherent electron scanning probe microscope can provide novel physical capabilities.

Any artificial intelligence means for generating designs and software can be used in conjunction with the present invention but the prior art U.S. Pat. Nos. (5.659,666), (6,018,727) and (6,356,884) perform design algorithms which can be used with the present inventions novel nanomanipulation, characterization and analysis features for a novel synergistic system.

The prior art references concerning molecular electronic field programmable gate arrays (FPGA) and molecular computer can be found in the prior art U.S. Pat. No. 6,215,327. Molecular electronics circuits can be formed by means comprising those above and from any prior art means including U.S. Pat. No. 6,430,511. These patents do not provide a scanning probe microscope method or structure.

Embodiments of the instant invention use amplitude and phase modulation of a electron quantum interferometer in conjunction with the flexible gap scanner junction. Prior art reference work on phase modulation in quantum devices can be found in M. H. S. Amin, T. Duty, A. Omelyanchouk, G. Rose and A. Zagoskin, U.S. Provisional Application Ser. No. 60/257624, “Intrinsic Phase Shifter as an Element of a Superconducting Phase Quantum Bit”, filed Dec. 22, 2000, herein incorporated by reference in its entirety. A phase shifting structure with 0 and .pi.-phase shifts in a two-terminal DC SQUID is described in R. R. Schulz, B. Chesca, B. Goetz, C. W. Schneider, A. Schmehl, H. Bielefeldt, H. Hilgenkamp, J. Mannhart and C. C. Tsuei, “Design and Realization of an all d-Wave dc .pi.-Superconducting Quantum Interference Device”, Appl. Phys. Lett. 76, 7 p. 912-14 (2000) is hereby incorporated by reference in its entirety.

Embodiments of the instant invention use multijunction SQUID device modulation of a electron quantum interferometer in conjunction with the flexible gap scanner junction. Prior art reference work on SQUID modulation in quantum devices can be found in A. N. Omelyanchouk and Malek Zareyan, “Ballistic Four-Terminal Josephson Junction: Bistable States and Magnetic Flux Transfer”, Los Alamos preprint cond-mat/9905139, and B. J. Vleeming, “The Four-Terminal SQUID”, Ph.D. Dissertation, Leiden University, The Netherlands, 1998, both of which are herein incorporated by reference in their entirety. Four terminal SQUID devices are further discussed in R. de Bruyn Ouboter and A. N. Omelyanchouk, “Macroscopic Quantum Interference Effects in Superconducting Multiterminal Structures”, Superlattices and Microstructures, Vol. 25 No 5/6 (1999) is hereby incorporated by reference in its entirety.

The U.S. Pat. No. 6,486,756 describes a SQUID amplifier circuit which is useful in embodiments of the present invention but does not provide a flexible gap scanning structure for scanning probe microscopy as the present invention does.

The instant invention has embodiments where the coherent electron flexible gap junction is used as a Superconductor-Insulator-Normal metal (SIN) junction used in the Bloch Oscillation Transistor (BOT) operation mode.

Bloch Oscillation Configuration:

The instant inventions flexible gap tunneling junction with phase coherent quantum interference detection can be attached to or configured as a Bloch oscillation transistor.

The prior art article by J. Delahaye, J. Hassel, R. Lindell, M. Sillanpaa, M. Paalanen, H. Seppa and P. Hakonen, Science 299, p 1045 (2003) describes the operation and design of the Bloch oscillation transistor (BOT).

Citing Briefly:

“A Bloch oscillating transistor (BOT) is a new type of a mesoscopic transistor (three terminal device, see figure) that combines single particle tunneling and Cooper pair tunneling. When a BOT resides on an upper band (superconducting junction is in a finite-voltage zero-current state), just single tunneling event (either clocked or spontaneous) in the normal-state junction triggers the device momentarily into Bloch-oscillating state (until Zener tunneling returns it to the upper band) so that a finite current pulse is obtained. According to the semiclassical simulations, a BOT provides high current gain (beta˜10), large input impedance (Zin˜500 kOhms), and a band width of 100 MHz. On the basis of thermal voltage noise of the base tunnel junction and the shot noise of the bias current, one can estimate <100 mK for the noise temperature of a BOT.

We have succeeded in making the first working BOTs. In our experimental realization of the BOT, the base electrode is connected via an SIN junction, the collector has a Cr-resistance of 50 kOhms, and on the emitter there is a Josephson junction with EJ/EC˜1. In our experiments we find a significantly asymmetric IV-curve, the analysis of which indicates that the principle works. We obtain current gains of beta˜35 under the best biasing conditions.”

The device of the instant invention may also be operated in a mode where the flexible gap superconductive junction circuit is exposed to a magnetic field whose flux lines are enclosed by the superconducting or non-superconducting coherent ring of the quantum interference device. The magnetic flux induces a supercurrent in the ring structure which exactly opposes the applied flux in the case of a superconductor. The induced supercurrent persists as long as the is applied flux is present. If the device is cooled below the superconducting transition temperature in the presence of the magnetic field the persistent current will remain in the absence of the field. The ring structure will have a current fixed in a quantum state indefinitely. The circulating supercurrent will remain and maintain the flux at its initial value. By integrating a sample scanning means with a persistent current in the flexible gap superconducting loop of the present invention a scanning probe microscopy platform with diverse capabilities is possible.

Each raster scanned site of a sample can have a persistent current generated and the physical properties which can effect the persistent current can be tested as a function of position on or proximal to the sample substrate and sample.

Orthogonal transport through the thin sample substrate provides for short range transport through the sample substrate. Ballistic, diffusive and equilibrated coherent transport are possible using this instant inventions configuration. The sample substrate thickness or transport distance is chosen to be of a dimension equal to or less than the coherence length of the electrons or Cooper pair conduction particle to produce phase coherent interferometry. In other cases, sample scanning distances greater than the coherence length can be chosen during or before a scan. In what is known as the proximity effect, the deposition of thin normal metal layers over a superconductor leads to superconductive states in the normal metal at temperatures below the transition temperature. This process can be used in the instant invention for metallization of the device layers and sample substrate, particularly for forming and attaching chemical functional groups on the MEMS/NEMS device and coherent electron scanner junction.

The field of MEMS microactuator development has advanced rapidly in the past decade. A useful reference for electrostatic comb-drive actuators with two degrees of freedom (2 DOF) is by T. Harness, R. Syms (J. Micromech. Microeng. 9 (1999) 1-8) this article describes finite element analysis simulation, fabrication and testing of a precision MEMS stage. A further prior art reference of use is “AFM imaging with an xy-micropositioner with integrated tip P.-F. Indermuhle, V. P. Jaecklin, J. Brugger, C. Linder, N. F. De Rooij, M. Binggeli Sensors and Actuators A: Physical, 47 (1995), 1-3, 562-565”. A good reference on drive circuits for capacitive MEMS comb drive oscillators can be found in R. E. Best, Phase-locked loops: design, simulation, and applications, 3 ed. New York: McGraw Hill, 1997.

The work on MEMS based SPM devices by A. Pavlov, Y. Pavlova and R. Laiho Rev. Adv. Mater. Sci. 5 (2003) 324-328 is a relevant prior art citation as the device uses feedback and tunneling structures and methods applicable to the instant invention. This MEMS device provides a three terminal field effect tunneling means of detection of tunneling gap displacement with sub angstrom resolution in the Z axis. The device does not provide a coherent quantum interference electron source or a means of providing a single electron spectroscopy probe of samples. Further the method does not provide a means of scanning a sample with quasiparticle electron Cooper pairs.

The instant inventions flexible gap variable junction may employ closed loop or open loop actuation feedback. MEMS based accelerometers and gyroscopes using electrostatic and piezo resistive actuation and sensing can achieve spatial resolutions of 0.01 Angstroms. The exponential dependence of the tunneling current on the junction gap distance requires sub angstrom resolution in maintaining junction gap separation. In embodiments of the present invention the sample substrate surface inserted into the gap is integrated into the feedback modulation process so as to couple motion of the gap top electrode, sample substrate surface and bottom electrode and produce substrate and sample tracking while performing spectroscopy of the sample.

The basic detection process required is the deconvolution of the sample signal resulting from electron flux through the top electrode interacting with the sample from the movement of the flexible junction gap spacing. This signal must be differentiated from the signal resulting from contact of the other probe with the opposing surface of the sample substrate ie the flexible gap opposing electrode. The flexible junction gap spacing couples to the tunneling signal with an exponential dependence of tunnel current on the gap distance. Actuator driven gap tunneling distance of the flexible junction and random thermal noise in the tunneling gap and sample substrate cantilever produce variation in the detected electron interferometer signal. The optical interferometer of the device responds to tip to tip movement. I have found no prior art reference which uniquely combines a local scanning probe tip coherent electron source or acceptor in a quantum interferometer circuit which is measured by a feedback loop of an optical interferometer displacement or tunneling displacement detector.

In preferred embodiments the sample being scanned is located on the interferometer electrode being scanned and thus the deconvolution is simplified.

The actuator elements may be operated in a linear mode or a vibrational mode where any of the aforementioned elements is driven by an input signal and oscillates at a resonant or non-resonant mode. Multiple detection modes may be used to detect interaction of the flexible gap top electrode with the sample substrate surface and flexible gap bottom electrode with the sample substrate surface. The periodic interaction of the surfaces is then detected using differential tunneling signals from the top electrode-sample substrate and bottom electrode-sample substrate. Alternatively the actuator elements may be operated in a mixed mode where one of either the top electrode-sample substrate or bottom electrode-sample substrate is mechanically resonated and the other linearly actuated. A further possible mode of operation is where one of either the top electrode-sample substrate or bottom electrode-sample substrate is actuated and the other is held static. Atomic force, optical, electron or ion beam detection of the interaction of the above said process is possible in addition to tunneling detection.

An alternate method of operation of the variable gap junction is possible where one or more point contacts is made between the bottom electrode of the sample substrate and the bottom tip of the flexible gap junction. This point contact junction is used to maintain a fixed reference by performing actuator feedback with current and voltage measurement of the point contact. This fixed reference established by modulation of the point contact on the bottom side of the sample electrode allows for the measurement of the sample deposited upon the top face of the sample substrate. The top tip electrode of the flexible gap junction is spatially modulated so as to make tunneling measurements of the sample. Alternately the point contacts can be on any surface of the interferometer circuit or scanned sample substrate.

Superconductive circuit fabrication methods developed for radar applications in the following citations can be used to fabricate the instant inventions novel flexible gap junction and sampling and control circuits for the MEMS/NEMS device 128. The citations J. X. Przybysz and D. L. Miller, IEEE Trans. on Appl. Supercond., vol. 5, pp. 2248-2251, June 1995, S. V. Rylov, L. A. Bunz, D. V. Gaidarenko, M. A. Fisher, R. P. Robertazzi and O. A. Mukhanov, “High resolution ADC system” IEEE Trans. on Appl. Supercond., vol. 7. pp. 2649-2652, June 1997, J. H. Kang, D. L. Miller, J. X. Przybysz and M. A. Janocko. IEEE Trans. Magn., vol. 27, pp. 3117-3120, March 1991, D. L. Meier, J. X. Przybysz and J. H. Kang. IEEE Trans. Magn., vol. 27, pp. 3121-3122, March 1991 and C. Lin, S. V. Polonsky, D. F. Schneider, V. K. Sememov, P. N. Shevchenko and K. K. Likharev, Extended Abstracts of 4th ISEC, pp. 304-306, September 1995 are prior art citations which describe circuit designs and fabrication methods for superconducting A to D sampling circuits.

The novel flexible junction scanning tunneling device of the instant invention is related to the nanomechanical resonator circuit of A. Erbe, C. Weiss, W. Zwerger, and R. H. Blick ( Phys, Rev, Lett. vol 87, number 9). Though both the instant invention and this device share a moving tunneling gap the cited nanomechanical resonator shuttle is very different from the instant invention in that there is no sample surface scanned by the tunneling junction. Furthermore the electrons flowing through the nanomechanical resonator device which tunnel during the cycles of mechanical oscillation are not performing measurable quantum interference. The prior art device does not provide a means for performing phase coherent measurements of the conduction electrons transiting the shuttle. The instant invention may be operated in the resonating mode as the nanomechanical resonator is or unlike the resonator it can be operated in a mode where the variable gap junction is linearly displaced and not oscillated as is required of the nanomechanical resonator circuit. Advantages of oscillation of the junction gap are that when a shuttle is used only one tunneling barrier is open at a certain time. This leads to reduction of cotunneling and leads to increased accuracy of current transport through the sample.

The authors postulate using superconductive and magnetic islands of materials on the oscillating shuttle but this still provides no means of imaging samples or performing quantum interference mapping with the circuit forming the leads connecting to the oscillating shuttle. The instant invention uses a quantum interferometer circuit integrated with a flexible gap junction which is operated in several vibrational and spectroscopic modes. The instant device is preferably operated in a mode where the flexible gap junction is modulated as the nanomechanical resonator in the above reference is but the associated quantum interferometer circuit provides coherent transport through the sample. In addition the instant invention provides means for inserting a sample material into the flexible gap junction during scanning of vibrational modes of the mechanical resonance of the flexible gap junction providing novel information of the sample material on the substrate.

In addition to the above improvements the instant invention has embodiments where the quantum interferometer is attached to a network of josephson junctions providing various circuit options. Integration of one or more flexible gap junction devices into a josephson junction discrete breather circuit and or quantum ratchet circuits provide additional operational advantages over the nanomechanical resonator device cited. Prior art references on discrete breathers can be found in the following articles P. J. Martinez, L. M. Floria, J. L. Marin, S. Aubry and J. J. Mazo, “Floquet stability of discrete breathers in anisotropic Josephson junction ladders,” Physica D 119, 175-183 (1998), P. J. Martinez, L. M. Floria, F. Falo and J. J. Mazo, “Intrinsically localized chaos in discrete nonlinear extended systems,” Europhys. Lett. 45, 444-449 (1999), S. Flach and M. Spicci, “Rotobreather dynamics in underdamped Josephson junction ladders,” J. Phys. Cond. Matter 11, 321-334 (1999), J. J. Mazo, E. Trias and T. P. Orlando,

“Discrete breathers in dc-biased Josephson-junction arrays,” Phys. Rev. B 59, 13604-13607 (1999), P. Binder, D. Abraimov and A. V. Ustinov, “Diversity of discrete breathers observed in a Josephson ladder,” Phys. Rev. E 62, 2858-2862 (2000), E. Trias, J. J. Mazo, A. Brinkman and T. P. Orlando, “Discrete breathers in Josephson ladders,” Physica D 156, 98-138 (2001), R. T. Giles and F. V. Kusmartsev, “Chaos transients in the switching of roto-breathers,” Phys. Lett. A 287, 289-294 (2001),

A. E. Miroshnichenko, S. Flach, M. V. Fistul, Y. Zolotaryuk and J. B. Page, “Breathers in Josephson junction ladders: Resonances and electromagnetic wave spectroscopy,” Phys. Rev. E 64, 066601-1(14) (2001), M. Schuster, P. Binder and A V. Ustinov, “Observation of breather resonances in Josephson ladders,” Phys. Rev. E 65, 016606-1(6) (2001), M. V. Fistul, A. E. Miroshnichenko, S. Flach, M. Schuster and A V. Ustinov, “Incommensurate dynamics of resonant breathers in Josephson junction ladders,” Phys. Rev. B 65, 174524-1(5) (2002),

P. Binder and A. V. Ustinov, “Exploration of a rich variety of breather modes in Josephson ladders,” Phys. Rev. E 66, 016603-1(9) (2002), E. Trias, Vortex motion and dynamical states in Josephson arrays, Ph.D. thesis, Massachusetts Institute of Technology (2000) and P. Binder, Nonlinear localized modes in Josephson ladders, Ph.D. thesis, Universitat Erlangen-Nurnberg (2001),

E. Trias, J. J. Mazo and T. P. Orlando, “Interactions between Josephson vortices and breathers,” Phys. Rev. B 65, 054517-1(10) (2002), A. Benabdallah, M. V. Fistul and S. Flach, “Breathers in a single plaquette of Josephson junctions: existence, stability and resonances,” Physica D 159, 202-214 (2001), M. V. Fistul, S. Flach and A. Benabdallah, “Magnetic field-induced control of breather dynamics in a single plaquette of Josephson junctions,” Phys. Rev. E 65, 0466161(4) (2002), F. Pignatelli and A. V. Ustinov, “Observation of breather like states in a single Josephson cell,” to be published,

R. S. Newrock, C. J. Lobb, U. Geigenmuller and M. Octavio, “The two-dimensional physics of Josephson-junction arrays,” Sol. State Phys. 54, 263-512 (2000), J. J. Mazo, “Discrete breathers in two-dimensional Josephson-junction arrays,” to be published, which are incorporated in their entirety as examples of prior art. It should be noted that the instant invention can be used as a nanomanipulator and assembler in a quantum computer component I/O system for forming and testing qubit circuits and operating them.

The prior art reference A. E. Miroshnichenko, M. Schuster, S. Flach, M. V. Fistul and A. V. Ustinov “Resonant plasmon scattering by discrete breathers in Josephson junction ladders” PHYSICAL REVIEW B 71, 174306 (2005) describes detection and manipulation methods for discrete breathers in Josephson junctions.

Modified phosphoramidite solid phase synthesis can be used as a means to establish site specific synthesis of oligonucleotide. Electrochemical oligonucleotide synthesis methods as in U.S. Pat. No. 6,280,595 photochemical oligonucleotide synthesis methods such as those in prior art reference U.S. Pat. No. 5,510,270 or “Maskless fabrication of light-directed oligonucleotide microarrays using a digital micromirror array” Sangeet Singh-Gasson, Roland D. Green, Yongjian Yue, Clark Nelson, Fred Blattner, Micheal R. Sussman, and Franco Cerrina, Nature Biotechnology. Vol 17, October 1999.

Integration of the instant invention superconductive coherent electron nanomanipulator MEMS device with biomolecular microfluidic, nanofluidic and nanomechanical structures is anticipated as a means of using the instant invention to enhance the operational characteristics of these device.

The equilibrium dissociation constant of enzymes and substrates or ligands and receptors limits the substrate solution concentration conditions that kinetically measurable reactions must be carried out at relatively high temperatures compared to superconducting transition temperatures of SQUID devices. Using the zero-mode waveguide system allows high reactant concentration conditions with good signal to noise detection of the pairs of enzyme and substrate or ligand and receptor during reactions. The method described in Levene (Science vol. 299, p 682, Jan. 31, 2003) is another prior art reference of note. The instant invention proposes integration of the spectroscopic methods of zero-mode waveguide excitation with combinatorial array synthesis and STM-SQUID-MEMS nanotweezer device as a powerful means of composing, assembling and detecting single molecule reactions or interactions. The operation of the instant invention at cryogenic temperatures requires that the biological buffer fluid of the nucleic acid be in a frozen state or freeze etched away for imaging or spectroscopy. The subsequent coherent electron spectroscopic scanning can be used to determine molecular structure.

The use of mesoscopic and single molecule spectroscopic methods on array elements in a combinatorial array is a powerful method of exploring the mechanics and dynamics of molecules, molecular interactions and quantum well structures. In preferred embodiments such techniques are utilized as a means of obtaining spectroscopic data for use with the instant inventions novel synthetic process. Such spectroscopic methods provide dynamic structural and functional information which is useful in evolving structures, characterizing and quantifying molecular and electronic properties as well as for providing analytical chemical methods in diagnostic processes. In the biochemical milieu the recent work by Levene (Science vol. 299, p 682, Jan. 31, 2003) details a high signal to noise ratio single molecule spectroscopy method that utilizes a zero-mode waveguide. The waveguide consists of an illuminated transparent substrate with a metal layer whose surface possesses cylindrical well structures with dimensions below 100 nm. The electromagnetic radiation impinging on the substrate produces confined optical modes within the well structure. Tethered macromolecules such as DNA polymerase enzyme are placed in the high field density region at the bottom of the well structure. The well is exposed to a solution of template duplex DNA and reactive monomers which contain some fluorescent labeled species. The DNA polymerase-DNA duplex complex is extended when reactive monomers diffuse into the well and enter the active site of the enzyme complex. The short duration which the diffusing fluorescence monomers reside in the well structure when they do not associate and react via the enzyme in the zero mode pore results in very low signals compared to molecules which enter the active region of the polymerase enzyme and form a complex with the duplex DNA. The advantage of the method is that the confined excitation zone allows for high monomer concentrations to be achieved in the enzyme reactions without high background fluorescence signals. The statistical correlation of the fluorescent emission bursts which result from molecules having long residence times in the well excitation zone allows for differentiation of single molecule processes in solution. The instant invention has operational modes which take place at cryogenic temperatures and thus may not be used for aqueous phase chemical enzymatic reactions at these cryogenic temperatures. It is anticipated that certain embodiments of the instant invention will make use of zero mode waveguide structures integrated with or in proximity to the multi tip coherent STM-MEMS interferometer tunneling device of the instant invention and will provide enhances optical detection of junction dynamics. Thermal cycling, freeze fracture methods and critical point drying of samples allows for cryogenic device operation in conjunction with the buffered enzyme reactions in zero mode waveguide methods of the above cited reference.

The instant invention can be integrated with the above high temperature device as an alternate low temperature mode of operation and as a means of checking data from the above device to remeasure the data obtained from the zero-mode waveguide device cited above.

Nanofluidic channels are another method of fabricating and carrying out chemical reactions and interactions at sites on a substrate where the device feature size and reaction volumes are of subdiffraction limited dimensions. Work by Foquet et al., Anal. Chem. 74, 1415 (2002) serves as a prior art reference to these methods. Such methods are amicable to combination with the BioMEMS methods of the instant invention. Use of microfluidic and nanofluidic channels to perform reactions and manipulations of biomolecules which are to be scanned by the instant device is a preferred embodiment of the instant invention. Thermal cycling of the device to allow reactions and fluidic flow as well as cryogenic SQUID operation is anticipated as an operating modality.

The use of surface plasmon resonance imaging SPRI may be used as a means of characterizing molecular array dynamics and reactions and is applicable to combinatorial arrays. An article by Lyon (Rev of Scientific Instruments vol 70, p 2076-81) serves as a prior art reference. This article describes the use of SPRI as a means of characterizing arrayed materials on a substrate. The methods described are easily adapted to the instant inventions synthesis and algorithmic methods by one skilled in the art. Additionally means such as fluorescence and scanning probe microscope detection may be integrated into a device which uses SPRI detection processes as a preferred embodiment.

In certain embodiments, the nucleic acid molecules to be sequenced is a single molecule of ssDNA or ssRNA. A variety of methods for selection and manipulation of single ssDNA or ssRNA molecules may be used, for example, hydrodynamic focusing, micro-manipulator coupling, optical trapping, or combination of these and similar methods. (See, e.g., Goodwin et al., 1996, Acc. Chem. Res. 29:607-619; U.S. Pat. Nos. 4,962,037; 5,405,747; 5,776,674; 6,136,543; 6,225,068.)

In certain embodiments, microfluidics or nanofluidics may be used to sort, isolate and deliver template nucleic acids, probe nucleic acids, primer nucleic acids, proteins, nanoparticles, molecular complexes and cells on the device. Hydrodynamics may be used to manipulate the movement of nucleic acids into a microchannel, microcapillary, or a micropore. In one embodiment, hydrodynamic forces may be used to move nucleic acid molecules across a comb structure to separate single nucleic acid molecules. After the nucleic acid molecules have been separated, hydrodynamic focusing may be used to position the molecules. A thermal or electric potential, pressure or vacuum can also be used to provide a motive force for manipulation of nucleic acids. In exemplary embodiments, manipulation of template nucleic acids for sequencing may involve the use of a channel block design incorporating microfabricated channels and an integrated gel material, as disclosed in U.S. Pat. Nos. 5,867,266 and 6,214,246. Electrokinetic sample manipulation techniques can be used with the present invention, preferably using MEMS/NEMS structures.

The flexible gap coherent electron interferometer of the instant invention has embodiments where a nanopore is present either through the flexible gap electrode structure, the nanoring tip or the sample substrate 127 or 188. The prior art reference U.S. Pat. No. 6,706,203 describes prior art methods and uses for nanopores.

Another relevant prior art citation for one of the particularly preferred embodiments of the instant invention is U.S. Pat. No. 6,218,086 which describes a thin film lithographic patterning technique which utilizes a SPM (scanning probe microscope tip) as a thermomechanical writing stylus. The method is applicable to data storage and mask formation with feature elements having nanometer scale dimensions. A unique aspect of this technique is that it rapidly physically modifies the substrate surface topography, is reversible and the substrates have a write/over-write life of over 100,000 cycles. In this method of pattern formation the SPM tip stylus is heated and impinges upon a polymer thin film coated substrate resulting in the localized deformation of the polymer film and the formation of recessed nano-pits resulting from local thermal effects on the polymer at the SPM tip apex. The thermomechanical SPM devices are fabricated in arrays where each device is composed of a v-shaped silicon cantilever which is 0.5 microns thick and 70 microns long. IBM has built arrays of such devices operating simultaneously with 1024 tips and is currently fabricating and prototyping 7 mm×7 mm arrays of 4096 (64×64) thermomechanical tips built as single MEMS packages. MEMS arrays with 1 million tips are currently feasible with state of the art fabrication methods. A single 200 mm silicon wafer can have 250 MEMS arrays on each wafer. Each tip scans an area of 100 microns by 100 microns and writes pits which are 10 to 50 nanometers in diameter. Data bit densities of 200 gigabits per square inch or 16 gigabits in a 7 mm×7 mm area of substrate have been achieved. Certain embodiments of the present invention use data storage on the sample substrate for scanned sample data and other data to be written on the sample substrate.

The U.S. Pat. No. 6,218,086 provides no description or claims to superconducting quantum interferometer device operation or photochemical polymer synthesis reactions being carried out on the thermomechanically patterned data storage substrate of the MEMS device. This patent does not describe the use, modification or formation of zero-mode waveguides with a coherent electron tunneling spectroscopy SPM tip array being used to access or modify the electromagnetic confinement zone of a zero-mode waveguide with sub-wavelength resolution. The integration of MEMS fabricated coherent electron tunneling spectroscopy SPM arrays and TIR total internal refraction fluorescence correlation spectroscopy (FCS) is not claimed or contemplated. This patent does not claim or contemplate the thermomechanical patterned substrate being used as a combinatorial synthesis substrate. The particular aspect of this invention useful in the instant invention is that the instant invention has preferred embodiments where the substrate is used as both a vehicle for supporting scanned material, combinatorial synthesis and as a data storage medium. The deposition of nucleotide molecules and nanoparticle assemblies on the sample substrate in conjunction with writing of data on the surface is an embodiment which is useful for synergistic application of both scanning data from samples and writhing data gained from the scanning process. The cited reference material has no means of providing the novel spectroscopic information generated from coherent electron tunneling which the instant invention provides. Connecting a superconducting substrate to one or more of the tips of the flexible gap junction and performing interferometry with it while the other tip is used for data storage on the opposing side of the substrate provides a high density dual purpose role for the flexible gap junction and substrate. Rapid switching between low voltage superconductor gap measurements with phase coherent electrons and higher voltage scanning tunneling spectroscopy or changing temperature of the SQUID above the superconducting transition temperature is a particularly valuable embodiment of the instant invention. Spectroscopy and data storage on the same substrate is possible.

The U.S. Pat. No. 5,439,829 describes a means of forming reversible linkages between a biological molecule and a solid phase support for use in Chelation Peptide Immobilized metal affinity chromatography (CP-IMAC) and biological assays. The chelation method describes the formation of reagents which are functionalized with a metal ion chelation moiety which serves as a means of linking functionalized biological molecule to a solid support. The patent describes and contemplates using the attached bifunctional molecules for biochemical assays and chromatographic separations.

This patent describes the functionalization of an individual support substrate with metal ion chelating moieties which have affinity for solution phase molecules functionalized with metal chelating groups. The attachment of the molecules is rendered kinetically stable via oxidation or reduction of the metal group which modifies the affinity constant of the chelation complex. The process describes a transfer of the chelator functionalized biological molecules onto and off of the support matrix.

The instant invention has embodiments where the metal affinity linkers of the general class as described in U.S. Pat. No. 5,439,829 are used in conjunction with the flexible coherent tunneling junction of the instant invention to allow for chemical functionalization of the tip and substrate sample materials.

Additional prior art chemical synthesis methods useful for the present invention can be found in U.S. Pat. Nos. (6,239,273), (5,510,270) and (6,291,183).

The U.S. Pat. No. 5,843,663 discloses methods for the attachment of nucleic acid polymers and analogs to surfaces using a chelation linker, metal ion and solid support moiety. This patent does not use the chelation linkage process to perform de novo synthesis or superconductive josephson junction scanning probe microscope spectroscopy as the instant invention does.

Additional prior art citations useful in the chemical linking via ion chelation reversible groups can be found in U.S. Pat. No. 6,919,333.

The U.S. Pat. No. 6,472,148 discloses compositions of matter in which a SAM and chelation linker functionality are integrated into a means for attaching biological molecules. The species contemplated takes the form of X—R-Ch in which:

“X, R, and Ch are each selected such that X represents a functional group that adheres to the surface, R represents a spacer moiety that promotes self-assembly of the mixed monolayer, and Ch represents a chelating agent that coordinates a metal ion”. The species X—R-Ch-M-BP where X, R, Ch, and M are as described above, and BP is a binding partner of a biological molecule, coordinated to the metal ion”.

The U.S. Pat. No. 6,472,148 also provides:

“a species having a formula X—R-Ch-M-BP-BMol, in which X represents a functional group that adheres to a surface, R represents self-assembled monolayer-promoting spacer moiety, Ch represents a chelating agent that coordinates a metal ion, M represents a metal ion coordinated by the chelating agent, BP represents a biological binding partner of a biological molecule, and BMol represents the biological molecule. The binding partner is coordinated to the metal ion”.

This patent does not provide a means of de novo synthesis or characterization of the chelation linkers species using a coherent electron interferometer scanning probe or superconductive josephson junction scanning probe microscope spectroscopy as the instant invention does.

The prior art are reference of Min and Verdine in Nucleic Acids Research, 1996, Vol. 24, No. 19 p 3806-3810 regards the use of IMAC methods on nucleic acid molecules which have a set of chelating groups synthesized into the oligonucleotide. The method allows for reversible surface linkage of nucleic acids. The chelation bonds can withstand harsh chemical conditions which can be used to denature duplex DNA and resolve duplex strands. The method also is compatible with Sanger dideoxy sequencing reactions.

This prior art reference does not provide a means of the chelation linkers species being used in a superconductive josephson junction or coherent electron source scanning probe microscope spectroscopy as the instant invention does.

Prior art chemical means useful in functionalizing the device 128 can be found in U.S. Pat. No. 6,472,184 Bandab, U.S. Pat. No. 6,927,029, U.S. Pat. No. 6,849,397, U.S. Pat. No. 6,677,163, U.S. Pat. No. 6,682,942.

Photolysis, electron beam, contact printing or electrochemical potential thresholds provide a means of selectively and spatially modifying attachment sites in an iterative assembly process using chelation attachment moieties on the second substrate surface of the instant invention. Additionally the selective modification and attachment of objects and compounds may be carried out on the flexible tip Josephson junction or coherent electron source apex tip structures. In particular soft lithography and nanoscale contact printing are preferably used with the present invention imaging, synthesis, manipulation and characterization means.

### OBJECTS AND ADVANTAGES

The device described in preferred embodiments of the invention can be used for scanning probe microscopy comprising coherent quantum interferometer scanning tunneling microscopy, inelastic electron scattering spectroscopy (IETS), plasmon spectroscopy, Raman resonance, mass spectroscopy and pulse probe optical spectroscopy of molecular samples and quantum structures. Additionally the device is configured to be a nanomanipulation device with two or more probe tips for measurement, spectroscopy and processing of nanoscale objects and systems. Generally the scanning probe methods of the invention provide a means of producing a local tunneling probe which possesses spatial and temporal coherence in conjunction with electromagnetic, optical, microwave and RF excitation of the junction. Some embodiments provide a novel means of coherent electron transport through a flexible, variable width tunneling gap junction with subangstrom feedback measurement and modulation of the gap spacing and position of the probe tips. This allows for the unique spectroscopic and imaging capabilities of the instant invention. Use of integrated single electron transistor and Cooper pair injection devices with the flexible gap junction allow for novel embodiments of the instant invention for spectroscopic and imaging operations using single electrons or quasiparticle electron Cooper pairs. Operation of the device in the Coulomb blockade mode is envisioned as a possible mode of operation in conjunction with SQUID interferometer capabilities. Additionally the scanner device is provided with a prototyping area near the active probe pair region which can be used for producing unique optical and electrical interconnections integrated with the flexible gap scanner. Genetic algorithm driven design is used to produce novel device and interconnection structures which interface with the coherent electron flexible gap scanner probes and samples.

Bond specific chemical characterization is possible using the scanning probe of the instant invention. Additionally devices embodied by the inventions disclosure can be used in conjunction with molecular biological techniques to provide nucleic acid sequencing and characterization methods. Embodiments of the instant invention may further have tunneling tip structures which are chemically modified to produce tunneling tip structures with chemically selective functional groups attached to a quantum interferometer. In particular, the use of nanotube structures with nucleic acid monomers and oligomers is envisioned as a means of scanning nucleic acid polymer libraries, arrays and genomes. Use of nucleic acid arrays which hybridize DNA or RNA samples in parallel can be used with the instant invention to perform characterization of RNA and genomic DNA materials for rapid sequencing applications. The nanomanipulator capabilities of the actuator scanner can also be used to measure, assemble, compose or modify materials and systems with resolution and specificity at the nanometer and potentially angstrom range. The device can also be operated as a meterology device for critical dimension measurement in the microchip manufacturing industry. The integration of mass spectroscopy and Raman spectroscopy means with the novel flexible gap nanotweezers embodiment of the invention allows for field and optical evaporation of samples, substrates and identification of individual atoms, functional groups, molecules and complexes in combination with nanotweezers manipulation capabilities. Additionally a plurality of the MEMS/NEMS devices fabricated on a chip can operate in conjunction provide novel nanomanipulator system capabilities for testing and developing top down and bottom up nanotechnology materials and systems. Further objects and advantages of the invention will become apparent from a consideration of the drawings and ensuing description.

### SUMMARY OF THE INVENTION

A device and method is described which provides a means of generating coherent electron tunneling imaging and spectroscopy using a normal conductor or superconductive Josephson junction scanning tunneling microscope integrated with an actuator driven flexible gap. Basically the main preferred embodiment of the novel device consists of one or more actuator modulated coherent electron tunneling gaps mounted on cantilevers of a MEMS or NEMS device. Formation of the device using existing microelectronic MEMS or NEMS fabrication processes is described. The multiple tip MEMS/NEMS device can be used as a nanotweezers or nanomanipulator as well as combined with standard SPM and near field and far field optical devices and methods. The use of the novel spectroscopic capabilities of the coherent electron tunneling process in conjunction with molecular biological methods provides a means of characterizing and possibly sequencing nucleic acid sequences. The instant invention provides and anticipates the following possible embodiments of the invention:

1) A Microelectromechanical/Nanoelectromechanical (MEMS/NEMS) device which produces coherent electron tunneling through a junction which may be used to scan a sample carrier substrate or opposing interferometer electrode.

2) Means for using the MEMS/NEMS tunneling junction to produce spectroscopic characterization of the sample substrate and materials deposited on the substrate or opposing interferometer electrode.

3) A means, using the spectroscopic data obtained from the MEMS/NEMS tunneling junction to gain molecular information about specific functional groups or residues in a molecular sample on the substrate or opposing interferometer electrode.

4) A means of using the instant inventions MEMS/NEMS tunneling junction and spectroscopic data to sequence nucleic acid oligomers and polymers

5) A means of using the instant inventions MEMS/NEMS tunneling junction to provide coherent electron spectroscopy via quantum interference circuit operation and provide spectroscopic data of atoms, nanostructures and molecules.

6) A means of using the instant inventions MEMS/NEMS flexible tunneling junction to provide coherent electron spectroscopy via quantum interference circuit operation and provide imaging and spectroscopic data of atoms, nanostructures and to sequence nucleic acid oligomers, polymers and genomes.

7) Operation of said coherent tunneling device with flexible tunneling junction gap in a mode where it acts as a bolometer or photon counter.

8) Operation of said coherent tunneling device with flexible tunneling junction gap in a mode where the flexible gap junction acts as a source of electromagnetic radiation due to Josephson voltage oscillations caused by a bias potential across the device junction.

9) Operation of said coherent tunneling device with flexible tunneling junction gap in a mode where said first surface flexible junction is used to scan samples as well as write and erase patterns of data on said second surface substrate.

10) A means of fabricating a phase coherent self-aligned probe tip pair device with a nanotube bridging the probe gap junction.

11) A means of fabricating a self-aligned probe tip pair device integrated with a SQUID device with a nanotube bridging the probe gap junction where the nanotube bridge is subsequently selectively modified so as to produce two self-aligned nanotube extensions forming a molecular tip pair bridging the flexible tunnel gap junction integrated with a quantum interferometer.

12) A means of fabricating multiple self-aligned probe tip pair devices with a SQUID device where a pair of nanotubes bridge the probe gap junctions where the nanotube bridges form a cross structure which is allows for both scanning contact and independent movement of the nanotubes. The nanotubes may subsequently be selectively modified so as to produce two self-aligned nanotube extensions between flexible gap structures forming a molecular tunneling probe pair bridging the flexible tunnel gap junction integrated with a electron quantum interferometer.

13) An embodiment where a pair of devices as described in 12 form a quad tip junction.

14) An embodiment as in 12 where a nanopore aperture device with one or more nucleic acid molecules are used to form a BioMEMS device.

15) An embodiment where microspheres/nanospheres functionalized with biomolecules are arranged with the flexible gap junction device and form a BioMEMS device where the microspheres/nanospheres are manipulated by the flexible gap junction comb drive actuator driven tips. The scanning probe of the instant invention is used to measure the biomolecules associated with the microspheres/nanospheres.

16) An embodiment where microspheres/nanospheres functionalized with nucleotide polymers are arranged with the flexible gap junction device and form a BioMEMS device where the microspheres/nanospheres are manipulated by the flexible gap junction comb drive actuators. The scanning probe of the instant invention is used to measure the nucleotide polymers associated with the microspheres/nanospheres. Optical scattering, fluorescence and electrochemical monitoring of the nucleotide polymer is also performed to characterize the polymer.

17) An embodiment where a prototyping area is connected to the flexible gap coherent electron tunneling junction and a genetic algorithm is used to generate and optimize diverse circuits associated with said flexible gap scanner. The genetic algorithm generated SPM tunneling circuits are tested with a known array of polynucleotide sequences and unknown sequences to determine the discrimination ability of the novel genetic algorithm generated tunneling microscope spectroscopy. Preferable embodiments use field programmable molecular electronic or mesoscopic circuit components connected to the novel flexible gap scanner junction for rapid testing and rewiring of novel evolving circuits.

18) An embodiment where an electron beam lithography, scanning electron microscope and focused ion beam milling device is integrated with the instant invention and provides a nanotechnology fabrication, nanomanipulation, SPM, nanotweezers, and coherent electron spectroscopy platform. Said instant invention comprises a means for nanomanipulation and scanning probe imaging of surfaces in the vacuum, liquid, or gas phase.

19) A MEMS/NEMS device which can be used to form a tunable pocket with chemical catalyst or enzymes attached to the programmable probes or the multiple tipped nanotweezers probes.

20) A MEMS/NEMS device which can be used to form a tunable molecular electronics fabrication and testing platform with chemical catalyst or enzymes attached to the programmable tips of the scanning probe microscope.

21) A MEMS/NEMS device scanning probe microscope and nanomanipulator which can be interfaced with a gas phase or vacuum phase molecular identification device means comprising a mass spectrometer for molecular identification of materials scanned by the scanning probe microscope and nanomanipulator.

22) The instant invention has embodiments where probe tip field ionization and mass spectroscopy is performed in conjunction with the coherent electron probe spectroscopy, microscopy and nanomanipulation. In addition this invention provide means for Raman spectroscopy of samples or surfaces being imaged and ionized. Thus optical vibrational and low energy coherent interferometry can be performed by the present device.

23) The instant invention has embodiments where one or more scanning probes or sample is functionalized with a Raman active nanoparticle tip and this tip is used to scan the sample surface the scanning maps the vibrational stated of chemical species on the sample. Before during or after Raman scanning of the surface, field ionization of species is carried out and analyzed by mass spectroscopy. This allows for atomic and molecular characterization of samples via vibrational and mass identification means. Laser optical excitation can be combined with this method for vibrational and electronic state pumping and probing in conjunction with scanning probe microscopy, Raman and mass spectroscopy.

24) The present invention has embodiments where the multiple tip MEMS/NEMS scanner and nanomanipulator is used to pickup atomic and nanoscale objects from a surface and inject them into a mass spectrometer.

25) The present invention has embodiments where the multiple tip MEMS/NEMS scanner and nanomanipulator is used to create high field conditions at a sample surface and field evaporate atoms, molecules and nanoparticles from the surface by application of pulses of energy to the tip structure of the device.

26) The present invention has embodiments where the multiple tip MEMS/NEMS scanner and nanomanipulator is used in conjunction with an extraction electrode to create high field conditions at a sample surface and field evaporate atoms, molecules and nanoparticles from the surface by application of pulses of energy to the extractor electrode structure of the device.

Thus the instant invention provides a general description of a scanning tunneling probe interferometer device. Using metals with long coherence lengths or small circuit path lengths non-superconductive circuits may be used to form the tunneling interferometer probe scanner. interferometer probe scanner. Deconvolution of scanner tip to tip displacement from sample atomic and molecular tunneling properties provides a means for mapping of samples. The components of the invention provide unique tunneling capabilities which may be used in many preferred embodiments to gather optical and electronic spectroscopic data from materials scanned by the tunneling junction. In particular the use of the spectroscopic tunneling properties of nucleotide, base, phosphate, peptide and organic functional groups associated with the sample carrier substrate results in unique imaging and mapping capabilities such as nucleic acid base sequencing. Nanosystem electronic and mechanical assemblies can be characterized and optimized using the spectroscopic information derived from the device embodiments. Additionally, by measuring the deflection of the tunneling tips or sample carrier substrate the molecular and atomic force fields associated with the sample substrate may be measured in conjunction with coherent electron tunneling mapping. Other physical properties of samples and systems can be measured by the invention.

The present invention can be understood by observation of the detailed description given below and from the accompanying drawings of the preferred embodiments. These should not be taken to limit the invention to the specific embodiments but are for explanation and understanding only.

### DESCRIPTION OF THE DRAWINGS

FIG. 1. Top View of the MEMS/NEMS device 128 quad flexible junction embodiment on 4 sheets of paper.

FIG. 2. An embodiment of the coherent scanning probe microscope and nanomanipulator with optical interferometry measurement means for a tip pair of device MEMS/NEMS 128.

FIG. 3. Low temperature Niobium superconductor SQUID device embodiment flexible gap interferometer circuit material with silicon SOI fabrication methods.

FIG. 4. Region 5 from FIG. 1 is the interaction area of tips 1,2,3 and 4 and sample substrate 127 showing tips 3 and 4 being used to measure tips 1 and 2 for deconvolution of subangstrom displacement during coherent electron interferometry, scanning probe microscopy and nanomanipulation.

FIG. 5. Region 5 from FIG. 1 is the interaction area of tips 1,2,3 and 4 and sample substrate 127 showing tips 3 and 4 being used to measure tips 1 and 2 for deconvolution of subangstrom displacement during coherent electron interferometry, scanning probe microscopy and nanomanipulation showing local Aux tips 122,123,124 and 125 located at the attachment points of cantilevers 54,55,56 and 57.

FIG. 6. A diagram of a two junction embodiment of the flexible gap junction SQUID using Josephson junctions.

FIG. 7. A diagram of a non-shunted SQUID device embodiment of the flexible gap junction Josephson junction interferometer device.

FIG. 8. A diagram of an INSQUID inductively coupled SQUID detector circuit used to monitor the flexible gap interferometer SQUID.

FIG. 9. Represents the spanned flexible gap device formed in region 5 of the quad tip MEMS/NEMS device.

FIG. 10. Prior Art Genetic algorithm for evolution of device hardware in prototyping area and nanomanipulation routines.

FIG. 11. Represents the spanned flexible gap device formed in region 5 of the quad tip MEMS/NEMS device with object 269 threaded through the center during scanning.

FIG. 12. Represents a spanned flexible gap device formed in region 5 of the quad tip MEMS/NEMS device with objects 170 and 170 forming two flexible spanning beams from tip cantilever 54 to 57 and from cantilevers 55 to 56 respectively.

FIG. 13. Represents and Quad tip and 1 dual tip multiple MEMS/NEMS nanomanipulator device formed in region 5.

FIG. 14. Represents a close view of the spanned flexible gap device formed in region 5 of the quad tip MEMS/NEMS device with object 269 threaded through the center during scanning.

FIG. 15. Represents and Quad tip and 2 dual tip multiple MEMS/NEMS nanomanipulator device formed in region 5.

FIG. 16. Represents an embodiment where sample materials 269 is attached to all four tips and all four of the flexible gap interferometers are wired together and Aux tips 122,123,124 and 125 are not fabricated.

FIG. 17. Represents an embodiment where sample materials 269 is attached to all four tips and all four of the flexible gap interferometers are wired together.

FIG. 18. Represents an embodiment where tips 1 and 3 are used to scan materials 269 attached to a nanobridge across tip 2 and 4.

FIG. 19. Close view of region 5 where tips sample substrate 188 is located at the position where tip 4 is located and is connected to the interferometer and sample substrate 127 is located where tip 2 is in the interferometer.

FIG. 20. Close view of region 5 where tips sample substrate 188 is located where tip 2 is normally located connected and is connected to the interferometer.

FIG. 21. Represents an embodiment where the flexible gap interferometer has Josephson junctions 162,163,164,165,166,167,168 and 169 at the tip interaction region 5.

FIG. 22. Close view of region 5 where tips scan sample substrate 127 with reference marks and data bits is used to scan 269.

FIG. 23. Close view of region 5 where tips scan sample substrate 188 with reference marks and data bits is used to scan 269.

FIG. 24. View of dual tip embodiment of the large area flexible gap interferometer region 5 where tip 1 is mechanically connected to the large area flexible gap top electrode and tip 2 is mechanically connected to the bottom electrode of the large area flexible gap junction.

FIG. 25. View of dual tip embodiment of the large area flexible gap interferometer region 5 where tip 1 is electrically connected to the large area flexible gap top electrode and tip 2 is electrically connected to the bottom electrode of the large area flexible gap junction.

FIG. 26. View of dual tip embodiment of the large area flexible gap interferometer region 5 where tip 1 is electrically connected to the large area flexible gap top electrode and tip 2 is electrically connected to the bottom electrode of the large area flexible gap junction. The large area flexible gap junction 271 has a top electrode 290 connected to tip 1 and a bottom electrode 291 connected to tip 2. One or both electrodes 290 and 291 can gave a nanopore through the junction 271 in this embodiment.

FIG. 27. Close view of large area flexible gap junction with nanopore through it without tips 1 and 2.

FIG. 28. Diagram of the quad tip interaction region 5 where large area flexible gap junctions are used as sensors.

FIG. 29. Fiber interferometer and SPM control diagram.

FIG. 30. Fixed gap scanning probe coherent electron interferometer microscope embodiment.

FIG. 31. Field ionization and Raman spectroscopy embodiment of the coherent electron junction scanning probe microscope and nanomanipulator

FIG. 32. This is an embodiment of a dual tip MEMS/NEMS scanner 128 operated with a SAP mass spectroscopy extraction electrode.

FIG. 33. Depicts an asymmetric aperture on the extraction electrode 348 and which is retracted from the tip interaction zone where tips 1 and 2 can touch.

FIG. 34. Depicts a dual tip Nanomanipulator SPM with one horizontal SAP extractor electrode embodiment the extraction electrode 348 in the preferable operating zone close to the tips 1 and 2 where ions can be extracted efficiently for mass spectroscopy.

FIG. 35. Depicts a quad tip Nanomanipulator SPM scanner with one horizontal SAP extractor electrode embodiment.

FIG. 36. Depicts a vertical SAP extractor electrode embodiment

FIG. 37. depicts a close up view of the vertical SAP extractor electrode embodiment of the quad tip electrode configuration.

FIG. 38. represents a close view of a quad tipped MEMS/NEMS device 128 tip interaction region 5 with a scanning atom probe extractor electrode 348 mounted vertically above the junction area.

FIG. 39. Depicts the retracted state position of an embodiment where the extractor electrode 356 has a scanning atom probe extractor electrode with scanning probe nanomanipulator 357.

FIG. 40. depicts the embodiment where the extractor electrode 356 has a scanning atom probe extractor electrode with scanning probe nanomanipulator attached for nanomanipulation, imaging and analysis of materials on substrate 128 or 188.

FIG. 41. Represents the software systems associated with a preferred embodiment of the invention.

### DRAWINGS

### LIST OF REFERENCE NUMERALS

1. The object represents the first flexible gap junction electrode of the coherent electron interferometer scanner probe.
2. The object represents the second flexible gap junction electrode of the coherent electron interferometer scanner probe.
3. The object represents the third flexible gap junction electrode of the coherent electron interferometer scanner probe.
4. The object represents the fourth flexible gap junction electrode of the coherent electron interferometer scanner probe.
5. The region represents the nanotube or high resolution lithographically defined quad tip structure interaction region of the coherent electron interferometer scanner probe scanner quad junction device 128.
6. The wire connecting the z axis capacitive actuator and sensor 114 for input and output.
7. The wire connecting the z axis capacitive actuator and sensor 116 for input and output.
8. The wire connecting the z axis capacitive actuator and sensor 117 for input and output.
9. The wire connecting the z axis capacitive actuator and sensor 121 for input and output.
10. The wire connecting the z axis capacitive actuator and sensor 120 for input and output.
11. The wire connecting the z axis capacitive actuator and sensor 118 for input and output.
12. The wire connecting the z axis capacitive actuator and sensor 119 for input and output.
13. The wire connecting the z axis capacitive actuator and sensor 115 for input and output.
14. Input and output multiplexer for prototyping area 74.
15. Input and output multiplexer for prototyping area 75.
16.Input and output multiplexer for prototyping area 77.
17. Input and output multiplexer for prototyping area 76.
18. The object represents the spring and coherent electron transport lines attaching the first flexible gap junction tip electrode of the coherent electron interferometer scanner probe to the Josephson junction.
19. The object represents the spring and coherent electron transport lines attaching the second flexible gap junction tip electrode of the coherent electron interferometer scanner probe to the Josephson junction.
20. Ring structure of the Josephson junction interferometer joining the first and second flexible gap junction tip electrodes of the coherent electron interferometer scanning probe.
21. Josephson Junction of the interferometer joining the first and second flexible gap junction tip electrodes of the coherent electron interferometer scanning probe.
22. First contact line of the flux excitation coil for the SQUID transformer of the first and second tips of the flexible gap junctions of the coherent electron interferometer scanning probe.
23. Second contact line of the flux excitation coil for the SQUID transformer of the first and second tips of the flexible gap junctions of the coherent electron interferometer scanning probe.
24. First contact line of the flux detector coil for the SQUID transformer of the first and second tips of the flexible gap junctions of the coherent electron interferometer scanning probe.
25. Second contact line of the flux detector coil for the SQUID transformer of the first and second tips of the flexible gap junctions of the coherent electron interferometer scanning probe.
26. The left/upper corner double spring suspended SOI structure with insulated conductive line for conduit attached to the cantilever of the first flexible gap junction tip of the coherent electron interferometer scanning probe.
27. The right/upper corner double spring suspended SOI structure with insulated conductive line for conduit attached to the cantilever of the first flexible gap junction tip of the coherent electron interferometer scanning probe.
28. The left/lower corner double spring suspended SOI structure with insulated conductive line for conduit attached to the cantilever of the first flexible gap junction tip of the coherent electron interferometer scanning probe.
29. The right/lower corner double spring suspended SOI structure with insulated conductive line for conduit attached to the cantilever of the first flexible gap junction tip of the coherent electron interferometer scanning probe.
30. The left/upper corner double spring suspended SOI structure with insulated conductive line for conduit attached to the cantilever of the second flexible gap junction tip of the coherent electron interferometer scanning probe.
31. The right/upper corner double spring suspended SOI structure with insulated conductive line for conduit attached to the cantilever of the second flexible gap junction tip of the coherent electron interferometer scanning probe.
32. The left/lower corner double spring suspended SOI structure with insulated conductive line for conduit attached to the cantilever of the second flexible gap junction tip of the coherent electron interferometer scanning probe.
33. The right/lower corner double spring suspended SOI structure with insulated conductive line for conduit attached to the cantilever of the second flexible gap junction tip of the coherent electron interferometer scanning probe.
34. The object represents the support spring and coherent electron transport line attaching the third flexible gap junction tip electrode of the coherent electron interferometer scanner probe to the Josephson junction.
35. The object represents the support spring and coherent electron transport line attaching the fourth flexible gap junction tip electrode of the coherent electron interferometer scanner probe to the Josephson junction.
36. Ring structure of the Josephson junction interferometer joining the first and second flexible gap junction tip electrodes of the coherent electron interferometer scanning probe.
37. Josephson junction of the interferometer joining the first and second flexible gap junction tip electrodes of the coherent electron interferometer scanning probe.
38. First contact line of the flux excitation coil for the SQUID transformer of the third and fourth tips of the flexible gap junctions of the coherent electron interferometer scanning probe.
39. Second contact line of the flux excitation coil for the SQUID transformer of the third and fourth tips of the flexible gap junctions of the coherent electron interferometer scanning probe.
40. First contact line of the flux detector coil for the SQUID transformer of the first and second flexible gap junctions of the coherent electron interferometer scanning probe.
41. Second contact line of the flux detector coil for the SQUID transformer of the first and second flexible gap junctions of the coherent electron interferometer scanning probe.
42. The comb drive capacitance structure driving the Y axis tunneling junction displacement sensor and actuator attached to the third flexible gap junction tip of the coherent electron interferometer scanning probe.
43. The comb drive capacitance structure driving the X axis tunneling junction displacement sensor and actuator attached to the third flexible gap junction tip of the coherent electron interferometer scanning probe.
44. The comb drive capacitance structure driving the Y axis tunneling junction displacement sensor and actuator attached to the third flexible gap junction tip of the coherent electron interferometer scanning probe.
45. The comb drive capacitance structure driving the X axis tunneling junction displacement sensor and actuator attached to the third flexible gap junction of the tip coherent electron interferometer scanning probe.
46. The left/upper corner double spring suspended SOI structure with insulated conductive line for conduit attached to the cantilever of the third flexible gap junction tip of the coherent electron interferometer scanning probe.
47. The right/upper corner double spring suspended SOI structure with insulated conductive line for conduit attached to the cantilever of the third flexible gap junction tip of the coherent electron interferometer scanning probe.
48. The left/lower corner double spring suspended SOI structure with insulated conductive line for conduit attached to the cantilever of the third flexible gap junction tip of the coherent electron interferometer scanning probe.
49. The right/lower corner double spring suspended SOI structure with insulated conductive line for conduit attached to the cantilever of the third flexible gap junction tip of the coherent electron interferometer scanning probe.
50. The left/upper corner double spring suspended SOI structure with insulated conductive line for conduit attached to the cantilever of the fourth flexible gap junction tip of the coherent electron interferometer scanning probe.
51. The right/upper corner double spring suspended SOI structure with insulated conductive line for conduit attached to the cantilever of the fourth flexible gap junction tip of the coherent electron interferometer scanning probe.
52. The left/lower corner double spring suspended SOI structure with insulated conductive line for conduit attached to the cantilever of the fourth flexible gap junction tip of the coherent electron interferometer scanning probe.
53. The right/lower corner double spring suspended SOI structure with insulated conductive line for conduit attached to the cantilever of the fourth flexible gap junction tip of the coherent electron interferometer scanning probe.
54. The cantilever actuator connector beam attaching the X and Y axis comb drive structure to the first flexible gap junction tip of the coherent electron interferometer scanning probe.
55. The cantilever actuator connector beam attaching the X and Y axis comb drive structure to the second flexible gap junction tip of the coherent electron interferometer scanning probe.
56. The cantilever actuator connector beam attaching the X and Y axis comb drive structure to the third flexible gap junction tip of the coherent electron interferometer scanning probe.
57. The cantilever actuator connector beam attaching the X and Y axis comb drive structure to the fourth flexible gap junction tip of the coherent electron interferometer scanning probe.
58. The first interferometer slit structure for sensing Z axis displacement attached to the first flexible gap tip.
59. The second interferometer slit structure for sensing Z axis displacement attached to the second flexible gap tip.
60. The second interferometer slit structure for sensing Z axis displacement attached to the third flexible gap tip.
61. The second interferometer slit structure for sensing Z axis displacement attached to the fourth flexible gap tip.
62. The first Y axis comb drive spring beam of the first comb drive actuator sensor.
63. The first X axis comb drive spring beam of the first comb drive actuator sensor.
64. The second Y axis comb drive spring beam of the first comb drive actuator sensor.
65. The second X axis comb drive spring beam of the first comb drive actuator sensor.
66. The first Y axis comb drive actuator and sensor structure attached to the second flexible gap tip.
67. The first X axis comb drive actuator and sensor structure attached to the second flexible gap tip.
68. The second Y axis comb drive actuator and sensor structure attached to the second flexible gap tip.
69. The second X axis comb drive actuator and sensor structure attached to the second flexible gap tip.
70. The first Y axis comb drive spring beam of the second comb drive actuator sensor.
71. The first X axis comb drive spring beam of the second comb drive actuator sensor.
72 The second Y axis comb drive spring beam of the second comb drive actuator sensor.
73. The second X axis comb drive spring beam of the second comb drive actuator sensor.
74. The object represents the first flexible gap junction tip electrode, microelectronic and nanoelectronic circuit prototyping area of the coherent electron interferometer scanner probe.
75. The object represents the second flexible gap junction tip electrode, microelectronic and nanoelectronic circuit prototyping area of the coherent electron interferometer scanner probe.
76. The object represents the third flexible gap junction tip electrode, microelectronic and nanoelectronic circuit prototyping area of the coherent electron interferometer scanner probe.
77. The object represents the fourth flexible gap junction tip electrode, microelectronic and nanoelectronic circuit prototyping area of the coherent electron interferometer scanner probe.
78. The first Y axis comb drive spring beam of the first comb drive actuator sensor.
79. The first X axis comb drive spring beam of the first comb drive actuator sensor.
80. The second Y axis comb drive spring beam of the first comb drive actuator sensor.
81. The second X axis comb drive spring beam of the first comb drive actuator sensor.
82. The first Y axis comb drive spring beam of the third comb drive actuator sensor.
83. The first X axis comb drive spring beam of the third comb drive actuator sensor.
84. The second Y axis comb drive spring beam of the third comb drive actuator sensor.
85. The second X axis comb drive spring beam of the third comb drive actuator sensor.
86. The first Y axis comb drive actuator and sensor structure attached to the fourth flexible gap tip.
87. The first X axis comb drive actuator and sensor structure attached to the fourth flexible gap tip.
88. The second Y axis comb drive actuator and sensor structure attached to the fourth flexible gap tip.
89. The second X axis comb drive actuator and sensor structure attached to the fourth flexible gap tip.
90. The first Y axis comb drive spring beam of the fourth comb drive actuator sensor.
91. The first X axis comb drive spring beam of the fourth comb drive actuator sensor.
92. The second Y axis comb drive spring beam of the fourth comb drive actuator sensor.
93. The second X axis comb drive spring beam of the fourth comb drive actuator sensor.
94. The cantilever actuator connector beam attaching the X and Y axis comb drive structure of the first flexible gap junction tip to the upper/left double spring structure of the coherent electron interferometer scanning probe.
95. The cantilever actuator connector beam attaching the X and Y axis comb drive structure of the first flexible gap junction tip to the upper/right double spring structure of the coherent electron interferometer scanning probe.
96. The cantilever actuator connector beam attaching the X and Y axis comb drive structure of the first flexible gap junction tip to the lower/left double spring structure of the coherent electron interferometer scanning probe.
97. The cantilever actuator connector beam attaching the X and Y axis comb drive structure of the first flexible gap junction tip to the lower/right double spring structure of the coherent electron interferometer scanning probe.
98. The cantilever actuator connector beam attaching the X and Y axis comb drive structure of the second flexible gap junction tip to the upper/left double spring structure of the coherent electron interferometer scanning probe.
99. The cantilever actuator connector beam attaching the X and Y axis comb drive structure of the second flexible gap junction tip to the upper/right double spring structure of the coherent electron interferometer scanning probe.
100. The cantilever actuator connector beam attaching the X and Y axis comb drive structure of the second flexible gap junction tip to the lower/left double spring structure of the coherent electron interferometer scanning probe.
101. The cantilever actuator connector beam attaching the X and Y axis comb drive structure of the second flexible gap junction tip to the lower/right double spring structure of the coherent electron interferometer scanning probe.
102. The cantilever actuator connector beam attaching the X and Y axis comb drive structure of the third flexible gap junction tip to the upper/left double spring structure of the coherent electron interferometer scanning probe.
103. The cantilever actuator connector beam attaching the X and Y axis comb drive structure of the third flexible gap junction tip to the upper/right double spring structure of the coherent electron interferometer scanning probe.
104. The cantilever actuator connector beam attaching the X and Y axis comb drive structure of the third flexible gap junction tip to the lower/left double spring structure of the coherent electron interferometer scanning probe.
105. The cantilever actuator connector beam attaching the X and Y axis comb drive structure of the third flexible gap junction tip to the lower/right double spring structure of the coherent electron interferometer scanning probe.
106. The cantilever actuator connector beam attaching the X and Y axis comb drive structure of the fourth flexible gap junction tip to the upper/left double spring structure of the coherent electron interferometer scanning probe.
107. The cantilever actuator connector beam attaching the X and Y axis comb drive structure of the fourth flexible gap junction tip to the upper/right double spring structure of the coherent electron interferometer scanning probe.
108. The cantilever actuator connector beam attaching the X and Y axis comb drive structure of the fourth flexible gap junction tip to the lower/left double spring structure of the coherent electron interferometer scanning probe.
109. The cantilever actuator connector beam attaching the X and Y axis comb drive structure of the fourth flexible gap junction tip to the lower/right double spring structure of the coherent electron interferometer scanning probe.
110. The object represents a support spring and electron transport line attaching the first flexible gap junction tip electrode cantilever to the substrate of the coherent electron interferometer scanner probe MEMS.
111. The object represents a support spring and electron transport line attaching the second flexible gap junction tip electrode cantilever to the substrate of the coherent electron interferometer scanner probe MEMS.
112. The object represents a support spring and electron transport line attaching the third flexible gap junction tip electrode cantilever to the substrate of the coherent electron interferometer scanner probe MEMS.
113. The object represents a support spring and electron transport line attaching the fourth flexible gap junction tip electrode cantilever to the substrate of the coherent electron interferometer scanner probe MEMS.
114. The first capacitive Z axis actuator plate on the cantilever attaching the first flexible gap tip electrode to the substrate.
115. The second capacitive Z axis actuator plate on the cantilever attaching the first flexible gap tip electrode to the substrate.
116. The first capacitive Z axis actuator plate on the cantilever attaching the second flexible gap tip electrode to the substrate.
117. The second capacitive Z axis actuator plate on the cantilever attaching the second flexible gap tip electrode to the substrate.
118. The first capacitive Z axis actuator plate on the cantilever attaching the third flexible gap tip electrode to the substrate.
119. The second capacitive Z axis actuator plate on the cantilever attaching the third flexible gap tip electrode to the substrate.
120.The first capacitive Z axis actuator plate on the cantilever attaching the fourth flexible gap tip electrode to the substrate.
121. The second capacitive Z axis actuator plate on the cantilever attaching the fourth flexible gap tip electrode to the substrate.
122. Aux probe tip 1 attached to cantilever 54.
123. Aux probe tip 2 attached to cantilever 55.
124. Aux probe tip 3 attached to cantilever 56.
125. Aux probe tip 4 attached to cantilever 57.
126. X,Y,Z actuator attached to sample substrate carrier.
127. Substrate sample XYZ stage and sample holder.
128. MEMS/NEMS coherent scanning probe microscope and nanomanipulator.
129. Laser for optical interferometer measurement of tip 1 displacement.
130. Optical beam splitter.

131. Photo detector.
132. Laser for optical interferometer measurement of tip 2 displacement.
133. Optical beam splitter.
134. Photo detector
135. Interferometer data acquisition and control circuit.
136. XYZ Sample substrate closed loop stage control with multiple degrees of freedom MEMS/NEMS actuator outputs and MEMS actuator measurement and control circuit with substrate bias control circuit.
137. MEMS coherent electron and normal electron tunneling measurement and control circuit.
138. Represents an orthogonal set of interferometer device parts comprising a laser, optical beam splitter and photo detector.
139. Computer with data acquisition, display and control hardware and software.
140. Sample substrate library and loading mechanism.
141. Sample and MEMS substrate library loading and chemical treatment control circuitry.
142. Sample substrate chemical treatment mechanism.
143. MEMS device SPM/Nanomanipulator chemical treatment mechanism.
144. Circuit prototyping area for scanner tips 1, and 2.
145. Circuit prototyping area for scanner tips 2, 4, 123 and 125.
146. Circuit prototyping area for scanner tips 3 and 4.
147. Circuit prototyping area for scanner tips 1,3, 122 and 124.
148. Coherent electron junction circuit area connecting flexible gap tip circuits on cantilevers 54 and 55.
149. Coherent electron junction circuit area connecting flexible gap tip circuits on cantilevers 55 and 56.
150. Coherent electron junction circuit area connecting flexible gap tip circuits on cantilevers 54 and 56.
151. Coherent electron junction circuit area connecting flexible gap tip circuits on cantilevers 55 and 57.
152. On chip magnetic flux generation coil 1.
153.On chip magnetic flux generation coil 2.
154. On chip magnetic flux generation coil 3.
155. On chip magnetic flux generation coil 4.
156. SQUID sensor with flexible scanner junction Fj and standard fixed junction Sj.
157. SQUID sensor readout circuit for flexible gap SQUID 156.
158. Interferometer gap spanning nanoscale conduit at region 5 spanning cantilevers 54 and 55.
159 Interferometer gap spanning nanoscale conduit at region 5 spanning cantilevers 55 and 57.
160 Interferometer gap spanning nanoscale conduit at region 5 spanning cantilevers 54 and 56.
161 Interferometer gap spanning nanoscale conduit at region 5 spanning cantilevers 56 and 57.
162. Micron to sub-micron scale coherent electron junction located at the apex of the flexible gap cantilever 54 proximal to tip 1.
163. Micron to sub-micron scale coherent electron junction located at the apex of the flexible gap cantilever 55 proximal to tip 2.
164. Micron to sub-micron scale coherent electron junction located at the apex of the flexible gap cantilever 56 proximal to tip 3.
165. Micron to sub-micron scale coherent electron junction located at the apex of the flexible gap cantilever 57 proximal to tip 4.
166. Micron to sub-micron scale coherent electron junction located at the apex of the flexible gap cantilever 54 proximal to tip 122.
167. Micron to sub-micron scale coherent electron junction located at the apex of the flexible gap cantilever 55 proximal to tip 123.
168. Micron to sub-micron scale coherent electron junction located at the apex of the flexible gap cantilever 56 proximal to tip 124.
169. Micron to sub-micron scale coherent electron junction located at the apex of the flexible gap cantilever 57 proximal to tip 125.
170. Diagonal flexible gap spanning nanostructure connecting cantilever 54 and 57.
171. Diagonal flexible gap spanning nanostructure connecting cantilever 55 and 56.
172. Ring structure of the Josephson junction interferometer joining the first and third flexible gap junction tip electrodes of the coherent electron interferometer scanning probe.
173. Josephson junction of the interferometer joining the first and third flexible gap junction tip electrodes of the coherent electron interferometer scanning probe.
174. First contact line of the flux excitation coil for the SQUID transformer of the first and third tips of the flexible gap junctions of the coherent electron interferometer scanning probe.
175. Second contact line of the flux excitation coil for the SQUID transformer of the first and third tips of the flexible gap junctions of the coherent electron interferometer scanning probe.
176. First contact line of the flux detector coil for the SQUID transformer of the first and third tips of the flexible gap junctions of the coherent electron interferometer scanning probe.
177. Second contact line of the flux detector coil for the SQUID transformer of the first and third tips of the flexible gap junctions of the coherent electron interferometer scanning probe.
178. Ring structure of the Josephson junction interferometer joining the second and fourth flexible gap junction tip electrodes of the coherent electron interferometer scanning probe.
179. Josephson junction of the interferometer joining the second and fourth flexible gap junction tip electrodes of the coherent electron interferometer scanning probe.
180. First contact line of the flux excitation coil for the SQUID transformer of the second and fourth tips of the flexible gap junctions of the coherent electron interferometer scanning probe.
181. Second contact line of the flux excitation coil for the SQUID transformer of the second and fourth tips of the flexible gap junctions of the coherent electron interferometer scanning probe.
182. First contact line of the flux detector coil for the SQUID transformer of the second and fourth tips of the flexible gap junctions of the coherent electron interferometer scanning probe.
183. Second contact line of the flux detector coil for the SQUID transformer of the second and fourth tips of the flexible gap junctions of the coherent electron interferometer scanning probe.
184. The flux return conduit on the flux transformer connecting the first and second tips of the flexible gap scanner junction.
185. The flux return conduit on the flux transformer connecting the second and fourth tips of the flexible gap scanner junction.
186. The flux return conduit on the flux transformer connecting the third and fourth tips of the flexible gap scanner junction.
187. The flux return conduit on the flux transformer connecting the first and third tips of the flexible gap scanner junction.
188. Additional sample substrate deposition area for scanned samples similar to area 127.
189. The left/upper corner double spring suspended SOI structure insulated conductive line attached to the cantilever of the first flexible gap junction tip of the coherent electron interferometer scanning probe.
190. The Y axis comb drive conduit of the first comb drive actuator sensor.
191. The Y axis comb drive conduit of the first comb drive actuator sensor.
192. The Y axis comb drive conduit of the first comb drive actuator sensor.
193. The right/upper corner double spring suspended SOI structure insulated conductive line attached to the cantilever of the first flexible gap junction tip of the coherent electron interferometer scanning probe.
194. The right/upper corner double spring suspended SOI structure insulated conductive line attached to the cantilever of the first flexible gap junction tip of the coherent electron interferometer scanning probe.
195. The X axis comb drive conduit of the first comb drive actuator sensor.
196. The X axis comb drive conduit of the first comb drive actuator sensor.
197. The X axis comb drive conduit of the first comb drive actuator sensor.
198. The right/lower corner double spring suspended SOI structure insulated conductive line attached to the cantilever of the first flexible gap junction tip of the coherent electron interferometer scanning probe.
199. The right/lower corner double spring suspended SOI structure insulated conductive line attached to the cantilever of the first flexible gap junction tip of the coherent electron interferometer scanning probe.
200. The Y axis comb drive conduit of the first comb drive actuator sensor.
201. The Y axis comb drive conduit of the first comb drive actuator sensor.
202. The Y axis comb drive conduit of the first comb drive actuator sensor.
203. The left/lower corner double spring suspended SOI structure insulated conductive line attached to the cantilever of the first flexible gap junction tip of the coherent electron interferometer scanning probe.
204. The right/lower corner double spring suspended SOI structure insulated conductive line attached to the cantilever of the first flexible gap junction tip of the coherent electron interferometer scanning probe.
205. The X axis comb drive conduit of the first comb drive actuator sensor.
206. The X axis comb drive conduit of the first comb drive actuator sensor.
207. The X axis comb drive conduit of the first comb drive actuator sensor.
208. The left/upper corner double spring suspended SOI structure insulated conductive line attached to the cantilever of the first flexible gap junction tip of the coherent electron interferometer scanning probe.
209. The left/upper corner double spring suspended SOI structure insulated conductive line attached to the cantilever of the second flexible gap junction tip of the coherent electron interferometer scanning probe.
210. The Y axis comb drive conduit of the first comb drive actuator sensor.
211. The Y axis comb drive conduit of the first comb drive actuator sensor.
212. The Y axis comb drive conduit of the first comb drive actuator sensor.
213. The right/upper corner double spring suspended SOI structure insulated conductive line attached to the cantilever of the second flexible gap junction tip of the coherent electron interferometer scanning probe.
214. The right/upper corner double spring suspended SOI structure insulated conductive line attached to the cantilever of the second flexible gap junction tip of the coherent electron interferometer scanning probe.
215. The X axis comb drive conduit of the first comb drive actuator sensor.
216. The X axis comb drive conduit of the first comb drive actuator sensor.
217. The X axis comb drive conduit of the first comb drive actuator sensor.
218. The right/lower corner double spring suspended SOI structure insulated conductive line attached to the cantilever of the second flexible gap junction tip of the coherent electron interferometer scanning probe.
219. The right/lower corner double spring suspended SOI structure insulated conductive line attached to the cantilever of the second flexible gap junction tip of the coherent electron interferometer scanning probe.
220. The Y axis comb drive conduit of the first comb drive actuator sensor.
221. The Y axis comb drive conduit of the first comb drive actuator sensor.
222. The Y axis comb drive conduit of the first comb drive actuator sensor.
223. The left/lower corner double spring suspended SOI structure insulated conductive line attached to the cantilever of the second flexible gap junction tip of the coherent electron interferometer scanning probe.
224. The right/lower corner double spring suspended SOI structure insulated conductive line attached to the cantilever of the second flexible gap junction tip of the coherent electron interferometer scanning probe.
225. The X axis comb drive conduit of the first comb drive actuator sensor.
226. The X axis comb drive conduit of the first comb drive actuator sensor.
227. The X axis comb drive conduit of the first comb drive actuator sensor.
228. The left/upper corner double spring suspended SOI structure insulated conductive line attached to the cantilever of the second flexible gap junction tip of the coherent electron interferometer scanning probe.
229. The left/upper corner double spring suspended SOI structure insulated conductive line attached to the cantilever of the third flexible gap junction tip of the coherent electron interferometer scanning probe.
230. The Y axis comb drive conduit of the first comb drive actuator sensor.
231. The Y axis comb drive conduit of the first comb drive actuator sensor.
232. The Y axis comb drive conduit of the first comb drive actuator sensor.
233. The right/upper corner double spring suspended SOI structure insulated conductive line attached to the cantilever of the third flexible gap junction tip of the coherent electron interferometer scanning probe.
234. The right/upper corner double spring suspended SOI structure insulated conductive line attached to the cantilever of the third flexible gap junction tip of the coherent electron interferometer scanning probe.
235. The X axis comb drive conduit of the first comb drive actuator sensor.
236. The X axis comb drive conduit of the first comb drive actuator sensor.
237. The X axis comb drive conduit of the first comb drive actuator sensor.
238. The right/lower corner double spring suspended SOI structure insulated conductive line attached to the cantilever of the third flexible gap junction tip of the coherent electron interferometer scanning probe.
239. The right/lower corner double spring suspended SOI structure insulated conductive line attached to the cantilever of the third flexible gap junction tip of the coherent electron interferometer scanning probe.
240. The Y axis comb drive conduit of the first comb drive actuator sensor.
241. The Y axis comb drive conduit of the first comb drive actuator sensor.
242. The Y axis comb drive conduit of the first comb drive actuator sensor.
243. The left/lower corner double spring suspended SOI structure insulated conductive line attached to the cantilever of the third flexible gap junction tip of the coherent electron interferometer scanning probe.
244. The right/lower corner double spring suspended SOI structure insulated conductive line attached to the cantilever of the third flexible gap junction tip of the coherent electron interferometer scanning probe.
245. The X axis comb drive conduit of the first comb drive actuator sensor.
246. The X axis comb drive conduit of the first comb drive actuator sensor.
247. The X axis comb drive conduit of the first comb drive actuator sensor.
248. The left/upper corner double spring suspended SOI structure insulated conductive line attached to the cantilever of the third flexible gap junction tip of the coherent electron interferometer scanning probe.
229. The left/upper corner double spring suspended SOI structure insulated conductive line attached to the cantilever of the third flexible gap junction tip of the coherent electron interferometer scanning probe.
230. The Y axis comb drive conduit of the first comb drive actuator sensor.
231. The Y axis comb drive conduit of the first comb drive actuator sensor.
232. The Y axis comb drive conduit of the first comb drive actuator sensor.
233. The right/upper corner double spring suspended SOI structure insulated conductive line attached to the cantilever of the third flexible gap junction tip of the coherent electron interferometer scanning probe.
234. The right/upper corner double spring suspended SOI structure insulated conductive line attached to the cantilever of the third flexible gap junction tip of the coherent electron interferometer scanning probe.
235. The X axis comb drive conduit of the first comb drive actuator sensor.
236. The X axis comb drive conduit of the first comb drive actuator sensor.
237. The X axis comb drive conduit of the first comb drive actuator sensor.
238. The right/lower corner double spring suspended SOI structure insulated conductive line attached to the cantilever of the third flexible gap junction tip of the coherent electron interferometer scanning probe.
239. The right/lower corner double spring suspended SOI structure insulated conductive line attached to the cantilever of the third flexible gap junction tip of the coherent electron interferometer scanning probe.
240. The Y axis comb drive conduit of the first comb drive actuator sensor.
241. The Y axis comb drive conduit of the first comb drive actuator sensor.
242. The Y axis comb drive conduit of the first comb drive actuator sensor.
243. The left/lower corner double spring suspended SOI structure insulated conductive line attached to the cantilever of the third flexible gap junction tip of the coherent electron interferometer scanning probe.
244. The right/lower corner double spring suspended SOI structure insulated conductive line attached to the cantilever of the third flexible gap junction tip of the coherent electron interferometer scanning probe.
245. The X axis comb drive conduit of the first comb drive actuator sensor.
246. The X axis comb drive conduit of the first comb drive actuator sensor.
247. The X axis comb drive conduit of the first comb drive actuator sensor.
248. The left/upper corner double spring suspended SOI structure insulated conductive line attached to the cantilever of the third flexible gap junction tip of the coherent electron interferometer scanning probe.
249. The left/upper corner double spring suspended SOI structure insulated conductive line attached to the cantilever of the fourth flexible gap junction tip of the coherent electron interferometer scanning probe.
250. The Y axis comb drive conduit of the first comb drive actuator sensor.
251. The Y axis comb drive conduit of the first comb drive actuator sensor.
252. The Y axis comb drive conduit of the first comb drive actuator sensor.
253. The right/upper corner double spring suspended SOI structure insulated conductive line attached to the cantilever of the fourth flexible gap junction tip of the coherent electron interferometer scanning probe.
254. The right/upper corner double spring suspended SOI structure insulated conductive line attached to the cantilever of the fourth flexible gap junction tip of the coherent electron interferometer scanning probe.
255. The X axis comb drive conduit of the first comb drive actuator sensor.
256. The X axis comb drive conduit of the first comb drive actuator sensor.
257. The X axis comb drive conduit of the first comb drive actuator sensor.
258. The right/lower corner double spring suspended SOI structure insulated conductive line attached to the cantilever of the fourth flexible gap junction tip of the coherent electron interferometer scanning probe.
259. The right/lower corner double spring suspended SOI structure insulated conductive line attached to the cantilever of the fourth flexible gap junction tip of the coherent electron interferometer scanning probe.
260. The Y axis comb drive conduit of the first comb drive actuator sensor.
261. The Y axis comb drive conduit of the first comb drive actuator sensor.
262. The Y axis comb drive conduit of the first comb drive actuator sensor.
263. The left/lower corner double spring suspended SOI structure insulated conductive line attached to the cantilever of the fourth flexible gap junction tip of the coherent electron interferometer scanning probe.
264. The right/lower corner double spring suspended SOI structure insulated conductive line attached to the cantilever of the fourth flexible gap junction tip of the coherent electron interferometer scanning probe.
265. The X axis comb drive conduit of the first comb drive actuator sensor.
266. The X axis comb drive conduit of the first comb drive actuator sensor.
267. The X axis comb drive conduit of the first comb drive actuator sensor.
268. The left/upper corner double spring suspended SOI structure insulated conductive line attached to the cantilever of the fourth flexible gap junction tip of the coherent electron interferometer scanning probe.
269. Sample object attached or proximal to sample substrate 127,128 or 188.
270. Tracking marker features on 127,128 or 188.
271. Large area flexible gap junction.
272. Second large area flexible gap junction.
273. SOI Handle wafer
274. SOI Oxide between handle wafer and SOI layer
275. SOI layer
276. Thermal Oxide layer on SOI layer
277. Aluminum Ohmic contact layer for Comb drive, Z axis actuator/sensor plates.
278. PSG or BSG glass filler insulator layer over Aluminum lines left after CMP.
279. Niobium ground plane metal
280. SiO2 insulation
281. Niobium-Aluminum Oxide-Niobium Trilayer for Josephson junction
282. SiO2 insulation
283. Resistor metal layer Mo
284. SiO2 insulator
285. Niobium layer
286. SiO2 insulator
287. Niobium layer
288. Resistor metal layer Ti/Pd/Au
289. SiO2 Passivation layer
290. Upper electrode of large area flexible gap junction 271
291. Lower electrode of large area flexible gap junction 271
292. Low-coherence super luminescent diode laser (SLD) source with fiber output for tip 1.
293. Optional photodiode.
294. Four channel fiber coupler which splits and routes source beam from SLD to the probe and returning beam from probe tip 1 to diode detectors.
295. Photodiode for interferometry detection of tip 1.
296. Low-coherence super luminescent diode laser (SLD) source with fiber output for tip 3.
297. Optional photodiode.
298. Four channel fiber coupler which splits and routes source beam from SLD to the probe and returning beam from probe tip 3 to diode detectors.
299. Photodiode for interferometry detection of tip 3.
300. Low-coherence super luminescent diode laser (SLD) source with fiber output for tip 2.
301. Optional photodiode.
302. Four channel fiber coupler which splits and routes source beam from SLD to the probe and returning beam from probe tip 2 to diode detectors.
303. Photodiode for interferometry detection of tip 2.
304. Low-coherence super luminescent diode laser (SLD) source with fiber output for tip 4.
305. Optional photodiode.
306. Four channel fiber coupler which splits and routes source beam from SLD to the probe and returning beam from probe tip 4 to diode detectors.
307: Photodiode for interferometry detection of tip 4.
308. Lens system for focusing energy beam on tips 1,2,3,4,122,123,124,125 and other parts of device 128 surface.
309. Energy beam from device 310 heading to device 128.
310. Means for producing an energy beam of electromagnetic energy, electrons or particles.
311. Multiplexer input output bus for multiplexer 14 and input/output lines 189 and 208 connected to prototype area 74.
312. Multiplexer input output bus for multiplexer 14 and input/output lines 193 and 194 connected to prototype area 74.
313. Multiplexer input output bus for multiplexer 14 and input/output lines 203 and 204 connected to prototype area 74.
314. Multiplexer connector bus for multiplexer 14 and input/output lines connecting multiplexer 14 to prototype area 74.
315. Multiplexer input output bus for multiplexer 15 and input/output lines 209 and 228 connected to prototype area 75.
316. Multiplexer input output bus for multiplexer 15 and input/output lines 213 and 214 connected to prototype area 75.
317. Multiplexer input output bus for multiplexer 15 and input/output lines 218 and 219 connected to prototype area 75.
318. Multiplexer connector bus for multiplexer 15 and input/output lines connecting multiplexer 15 to prototype area 75.
315. Multiplexer input output bus for multiplexer 16 and input/output lines 263 and 264 connected to prototype area 77.
316. Multiplexer input output bus for multiplexer 16 and input/output lines 258 and 259 connected to prototype area 77.
317. Multiplexer input output bus for multiplexer 16 and input/output lines 253 and 254 connected to prototype area 77.
318. Multiplexer connector bus for multiplexer 16 and input/output lines connecting multiplexer 16 to prototype area 77.
319. Multiplexer input output bus for multiplexer 17 and input/output lines 229 and 248 connected to prototype area 76.
320. Multiplexer input output bus for multiplexer 17 and input/output lines 243 and 244 connected to prototype area 76.
321. Multiplexer input output bus for multiplexer 17 and input/output lines 238 and 239 connected to prototype area 76.
322. Multiplexer connector bus for multiplexer 17 and input/output lines connecting multiplexer 17 to prototype area 76.
323. Data recording feature on sample substrate 127,128 or 188.
324. Reversible linker functional group
325. Contact attaching nanotube to tip 1.
326. Contact attaching nanotube to tip 2.
327. Contact attaching nanotube to tip 3.
328. Contact attaching nanotube to tip 4.
329. Nanoring 1 probe tip for threading polymers, nanotubes,nanorods, nanosystems, RNA or DNA.
330. Nanoring 2 probe tip for threading polymers, nanotubes, nanorods, nanosystems, RNA or DNA.
331. Mechanically or chemically opened and closed gap in flexible corral spanning gap structure.
332. Dual tip chip consisting of one half of a quad MEMS/NEMS device 128.
333. Second dual tip chip consisting of one half of a quad MEMS/NEMS device 128.
334. Nanoring 3 probe tip for threading polymers, nanotubes,nanorods, nanosystems, RNA or DNA.
335. Nanoring 4 probe tip for threading polymers, nanotubes, nanorods, nanosystems, RNA or DNA.
336. Connector to upper electrode of large area flexible gap junction 271.
337. Connector to lower electrode of large area flexible gap junction 271.
338. Nanopore in top electrode of large area flexible gap junction 271.
339. Nanopore in bottom electrode of large area flexible gap junction 271.
340. Upper electrode for large area flexible gap junction 272.
341. Lower electrode for large area flexible gap junction 272.
342. Connector to upper electrode of large area flexible gap junction 272.
343. Connector to lower electrode of large area flexible gap junction 272.
344. Polymer attached to object 269.
345. First lead conduit to a non-flexible quantum interferometer probe.
346. Second lead conduit to a non-flexible quantum interferometer probe.
347. Scanning probe tip structure of the non-flexible scanning interferometer probe.
348. Scanning Atom Probe (SAP) Extractor electrode.
349. Scanning Atom Probe spectroscopy electronics
350. Mass Spectrometer device
351. Pulsed ultra fast laser.
352. Raman Spectrometer.
353. Raman Spectrometer Electronics
354. Second Scanning Atom Probe (SAP) Extractor electrode.
355. Ultra thin support membrane for samples on pore of substrate 127 or 188.
356. Scanning atom probe extractor electrode with scanning probe nanomanipulator attached.
357. Scanning atom probe extractor electrode probe tip.
358. Scanning probe extractor electrode probe closed loop actuator drive and connector to probe tip 357 and extractor electrode with nanomanipulator 356.

### DETAILED DESCRIPTION

### Preferred Embodiments

The following description of a preferred embodiment of the invention is intended to give one possible depiction of the device fitting the claims of the instant invention and is given as one nonlimiting form of many possible devices possible using the novel claims of the instant invention. The quad actuator and tip configuration of the depicted embodiment of the invention can be altered in many ways as alternate embodiments of the invention.

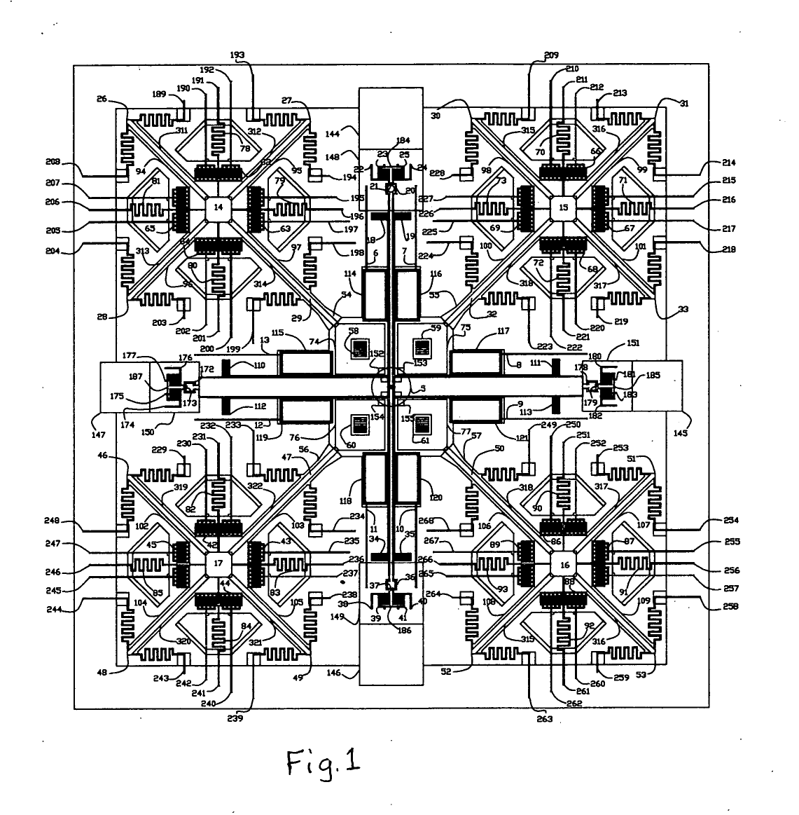

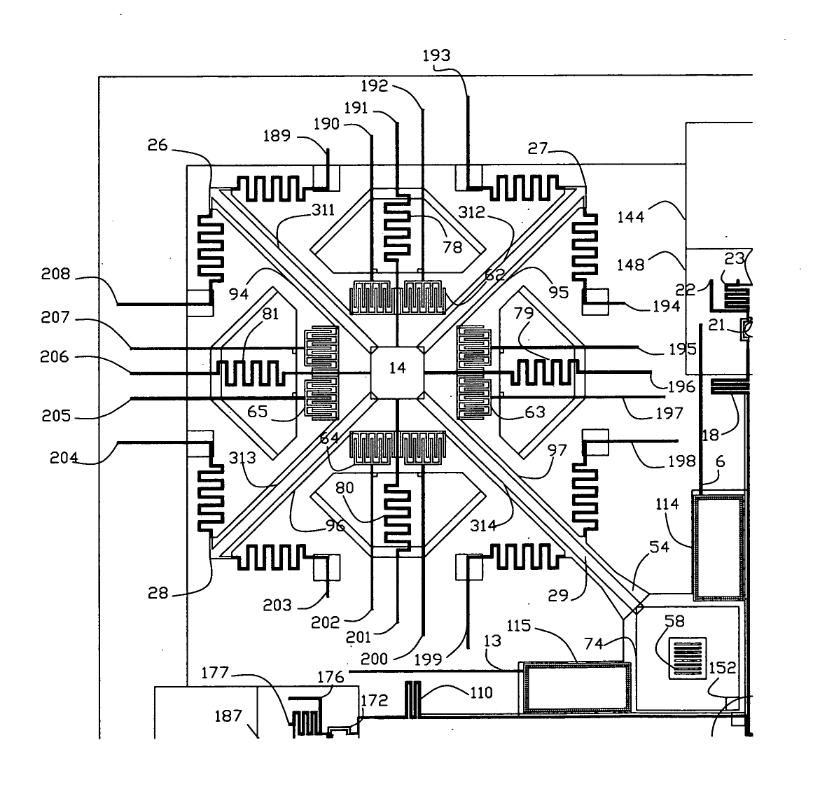

The four part FIG. 1 diagram depicts a quadrant compartmentalized symmetrical embodiment of the flexible gap coherent nanomanipulator and scanning probe microscope coherent electron interferometer. The mechanical spring and actuation MEMS/NEMS structures of the device are preferably suspended via SOI trench and backside etching and are intended to be symmetrical about the axis of the apex of the nanoscale probes 1,2,3 and 4 at the quad tip interaction junction region 5 where said tips 1,2,3 and 4 are in proximity. The apex of the cantilever structures 54,55,56 and 57 where tips 1,2,3 and 4 have apex regions in close proximity is at junction region 5.

The junction region 5 can have multiple additional coherent and standard scanning microscopy and spectroscopy probes for measurement and nanomanipulation. In addition nanomachines and additional actuators may be fabricated in preferred embodiments of the invention in proximity to junction region 5 of the SOI suspended structure or on the fixed substrate. The in FIG. 1, junction region auxiliary tip structures and tips 1,2,3 and 4 are connected to coherent electron junction areas 21,37, can be interfaced and operated with prototyping circuitry areas 74,75,76,77,144,145,146 and 147 as well as circuitry off the chip. In this embodiment tips 1 and 2 form a coherent junction via Josephson junction 21 and tips 3 and 4 form a coherent junction device via Josephson junction 37. Alternately any combination of tips 1,2,3 and 4 can be connected to form interferometric coherent electron circuits.

Preferably the tips 1,2,3 and 4 are independently movable in the X,Y and Z axis but may also have individual or pairs of fixed tips in the group. Alternately rotational and tilt motion is possible for these tip structures using alternate MEMS or NEMS structures. In the case where tips 1,2,3 and 4 are all connected to actuators for X,Y and Z axis motion depicted in FIG. 1-5 electrostatic comb drive actuators are used for motion and sensing of motion components.

In the case of the electrostatic actuator embodiment of the MEMS/NEMS device an insulating coating is deposited preferably by CVD or molecular beam epitaxy on the MEMS/NEMS device to inhibit electrical short circuiting of the device. As the subsequent possible MEMS/NEMS and-SQUID fabrication-sequence shows the comb drive actuators of the invention are trench etched into the SOI layer of the wafer substrate and have insulating SiO2 layers separating the SOI silicon layer from the M1 niobium and subsequent metal layers. A passivation layer of SiO2 is deposited over the MEMS/NEMS chip near the end of the fabrication sequence. Insulator coating of nanotube tips and spanning structures can be performed to limit conductivity to the apex of the nanotweezers SQUID scanner.

Coherent electron detection circuit 137 which interfaces with computer 139 can be used to generate and control magnetic flux and coherent electrons on MEMS/NEMS chip 128 on FIG. 1. The on chip magnetic flux generation coils 152,153,154 and 155 can be used to generate magnetic flux on the coherent electron interferometer chip. It should be noted that as the flexible gap junction cantilevers 54,55,56 and 57 are displaced the area enclosed by the loop of SQUID devices attached to probes 1,2,3,4, 122,123,124 and 125 will change. Mapping of the flux area change as a function of probes position within the scan volume space of the scanner can be used to compensate flux output when a sample is present in the scanner using coherent electron interferometer sampling and control circuit 137 and feedback and processing algorithms on computer 139. By referencing the scanner probes to tracking marks mapped on the sample substrate surface and or referencing any of the probes 1,2,3,4,122,123,124 and 125 to one another, deconvolution of the flux volume changes during scanning can be provided and surface and sample transmission coefficients can be determined.

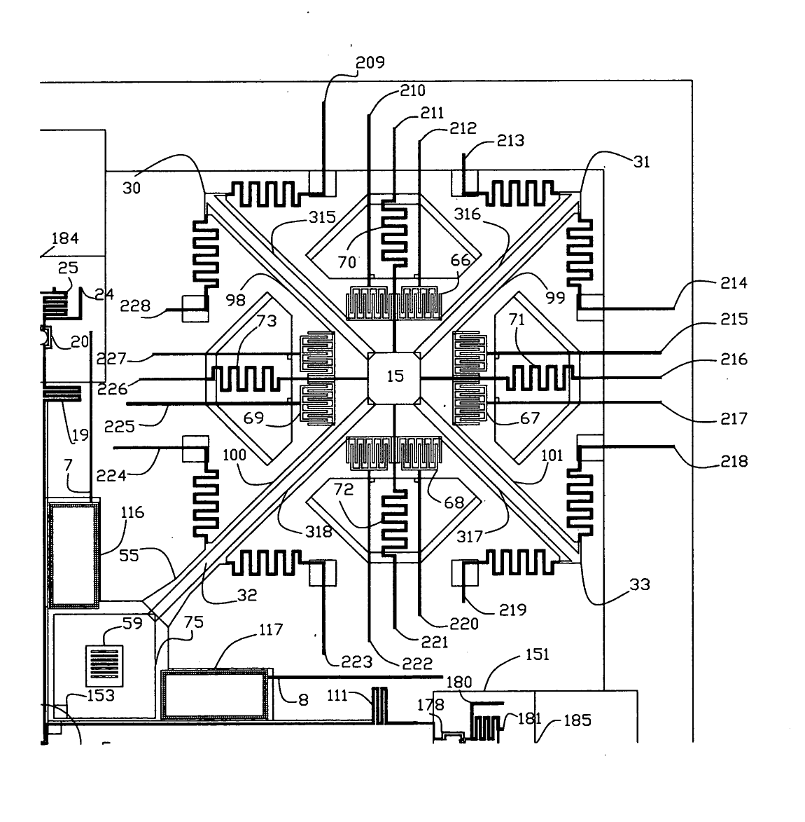

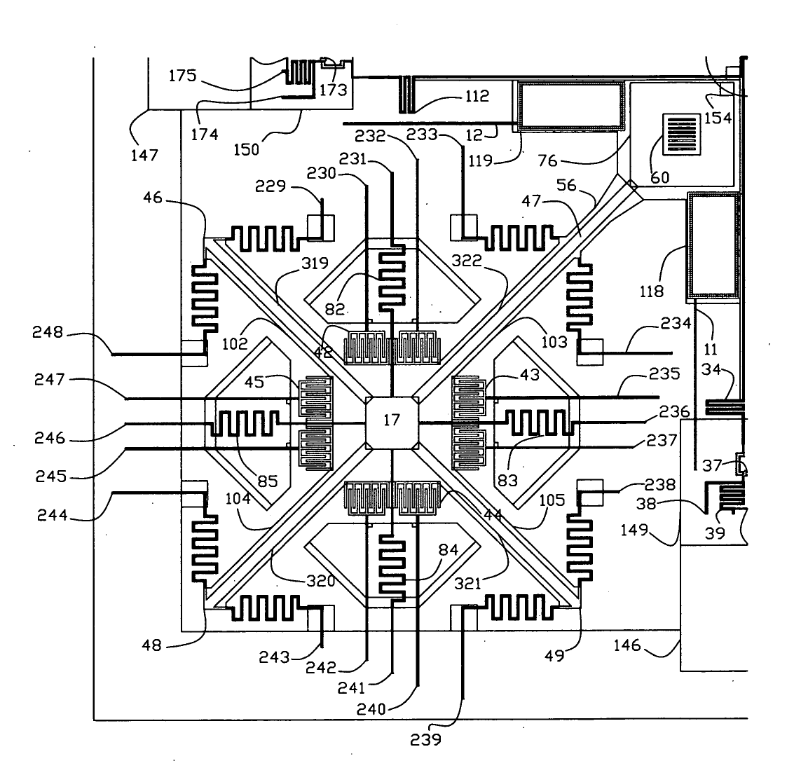

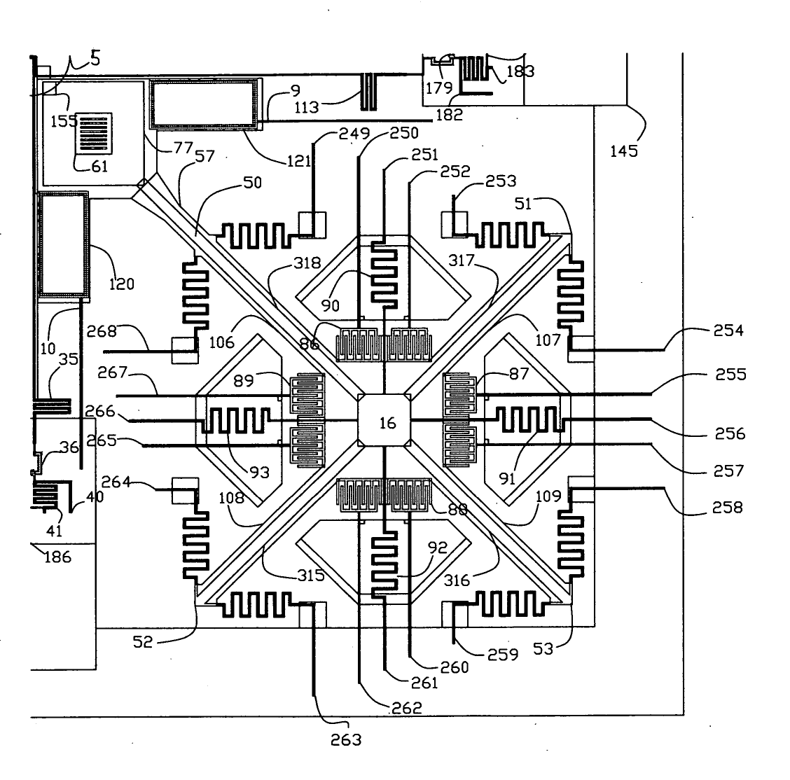

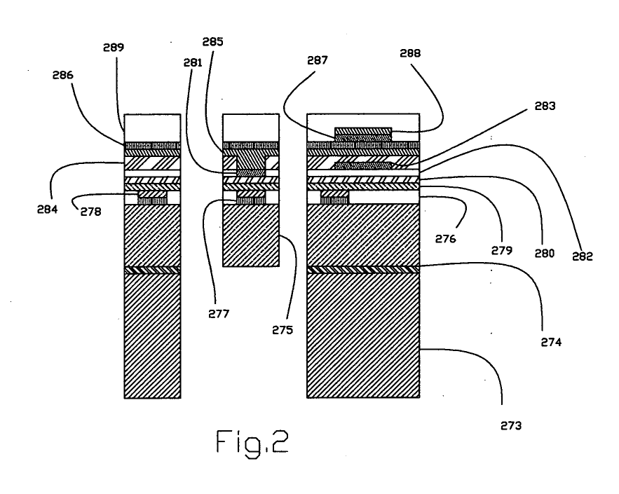

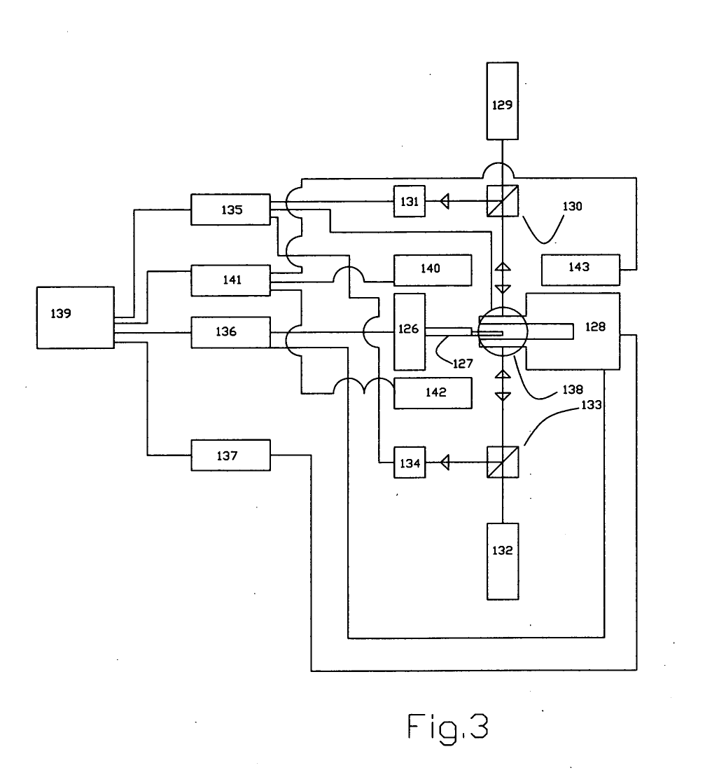

The center of the chip contains an opposing pair of scanner devices as depicted in FIG. 1. The scanner area centered between the two or four possible coherent electron transport tip pairs (1-2, 1-3, 3-4,2-4) is located between MEMS structures comprising capacitive plate actuators, suspension spring structures and flexible gap junction cantilever tip devices residing on the SOI layer 275 of FIG. 2. The main area of interest as far as the sample and tips of the scanner interaction region goes is depicted in the center of the device in FIG. 1. The elements of the device shown consists of a pair tips 1 and 2 mounted on actuated cantilevers 54 and 55 forming the first flexible gap junctions under computer 139 control (FIG. 3).

The opposing pair of tip structures 3 and 4 form an opposing pair of aligned flexible gap junction tips and are attached to cantilevers 55 and 56 respectively. The tip formed quad junction structure is depicted by interaction region 5. The said structures are electrically connected via superconductive lines lithographically defined on the top of the MEMS cantilever, spring support and capacitive actuator structure. The superconductive lines of the flexible gap junction which connect the opposing quad tip structures of the scanner quad junction 5 are connected to the SQUID interferometer Josephson junctions 21 and 37 by folded coherent electron conduit bearing spring structures 18, 19, 34,35. The SQUID interferometer Josephson junction and attached flexible gap junction tips can have flux current injected or induced in the circuit by 22, 23, 38 and 39 which are the first, second, third and fourth contact line of the flux excitation coils. The resultant flux or current induced in the two superconductive ring structures effectively circulates in the SQUID structure formed by the said structures. By inserting a sample carrier comprising a superconductive sample substrate, thin normal metal substrate or thin exfoliated mica membrane sample carrier substrate into the flexible gap junction between tips 1,2,3 and 4 using X,Y,Z actuator 126 and stage 127 a sample of material can be scanned by the circulating superconductive current in the said SQUID structures.

The gap distance between the tips 1,2,3 and 4 is monitored by the tunneling junction displacement tip pair sensors 122,123,124 and 125 for X and Y axis sensing. The relative Z axis displacement of the tips 1,2,3 and 4 are measured by optical interferometry via laser reflection off of the cantilever interferometer grating structures 58,59,60 and 61 or alternately by mapping the vertical displacement via tip pairs 122,123,124 and 125. The X and Y axis tunneling sensors will register tunneling variation as the Z axis of the cantilevers attached to tips 1,2,3 and 4 are flexed and actuated in the z axis.

By mapping the image of the X and Y axis current output of the tunneling sensors as a function of the Z axis displacement a Z axis displacement is deconvolved from the X and Y signal. Use of induced markers by intentionally modifying the reference electrode structures on tips 122,123,124 and 125 atomic scale reference marks can be made and mapped into displacement space of the sensors and used to calibrate and deconvolve the motion of tips 1,2,3 and 4. Preferably the electrode structures 122,123,124 and 125 are made by molecular beam epitaxy and have engineered layered structures with atomic scale patterning for intrinsic calibration via tunneling current variation.

Alternately the electrode structures can be sputter coated or evaporated onto the substrate. The thickness of the electrode structures tips 122,123,124 and 125 are to be greater than 50 nm so that a displacement of this amount or less can constitute the range of Z axis displacement which can be mapped and measured with the tunneling sensor. The biasing of tip pairs causes a current to flow between the tip structures. The tips 122,123,124 and 125 can also be attached via interferometer circuits as tips 1,2,3 and 4 are.

The Z axis displacement actuators are adjusted so that the tunneling sensor tips of 122,123,124 and 125 make contact in the middle of the Z axis of the reference electrode structures 122,123124 and 125 so that both positive and negative Z axis displacement can be mapped and measured. Preferably the tips 122,123,124 and 125 can have nanotubes deposited on them to make for high resolution and high aspect ration probes for displacement sensing for tips 1,2,3 and 5 while the primary tips 1,2,3 and 4 interact with samples on the substrate carrier 127.

The sample carrier 127 with the sample substrate sample can have the electrical potential voltage modulated or scanned by device 137.

The structures 114,115,116,117,118,119,120 and 121 are capacitive actuators and sensor plates formed by the erosion of the BOX oxide layer 274 separating the SOI handle wafer layer 273 form the SOI suspended layer 275 seen in FIG. 2. The biasing of the two sides of the Handle layer 273 and SOI layer 273 can cause z axis displacement tips 1,2,3 and 4 and the measurement of the capacitance of the gap can be used to sense the z axis displacement of 1,2,3 and 4. Alternately asymmetrical comb drives can be used to provide z axis motion. The SOI trench etch laterally isolates the four z axis actuator/sensor devices

The wire connecting the z axis capacitive actuator and sensor 114 for input and output is labeled 6. The wire connecting the z axis capacitive actuator and sensor 116 for input and output is labeled 7. The wire connecting the z axis capacitive actuator and sensor 117 for input and output is labeled 8. The wire connecting the z axis capacitive actuator and sensor 121 for input and output is labeled 9. The wire connecting the z axis capacitive actuator and sensor 120 for input and output is labeled 10. The wire connecting the z axis capacitive actuator and sensor 118 for input and output is labeled 11. The wire connecting the z axis capacitive actuator and sensor 119 for input and output is labeled 12. The wire connecting the z axis capacitive actuator and sensor 115 for input and output is labeled 13. All of these actuator and sensor wires are connected to the XYZ Sample substrate stage and MEMS actuator measurement and control circuit 136 and controlled by computer 139. Device 136 provides stage measurement control as well as measurement and control circuit with substrate bias control circuit for 127 and 188.

The prototyping areas 74,75,76 and 77 are connected to multiplexers 14,15,17 and 16 respectively. The input output multiplexer buses 314 connects prototyping area 74 with multiplexer 14. The input output multiplexer buses 318 connects prototyping area 75 with multiplexer 15. The input output multiplexer buses 318 connects prototyping area 77 with multiplexer 16. The input output multiplexer buses 322 connects prototyping area 76 with multiplexer 17. Input and output via multiplexers 14,15,16 and 17 is provided by input/output conduits deposited on SOI springs. The multiplexer can be analog, digital or a mixture of analog and digital input and output channels for each prototype circuit area and connected to each respective tip pair. It should be noted that in addition to I/O via the SOI spring structures the device can use optical I/O for the multiplexer devices 14,15,16 and 17. Optically isolated I/O for electronics is inherently less susceptible to electrical noise due to the fact that input and output leads and wires on and off of the chip and printed circuit board are not used for signal transmission as LED or laser diodes and photodetectors are used.

I/O for Multiplexer 14

Object 311 is the Multiplexer input output bus for multiplexer 14 and input/output lines 189 and 208 connected to prototype area 74.

Object 312 is the Multiplexer input output bus for multiplexer 14 and input/output lines 193 and 194 connected to prototype area 74.

Object 313 is the Multiplexer input output bus for multiplexer 14 and input/output lines 203 and 204 connected to prototype area 74.

Object 314 is the Multiplexer connector bus for multiplexer 14 and input/output lines connecting multiplexer 14 to prototype area 74.

Object 191 is the Multiplexer input output bus for multiplexer 14 and input/output connected to prototype area 74.

Object 196 is the Multiplexer input output bus for multiplexer 14 and input/output connected to prototype area 74.

Object 201 is the Multiplexer input output bus for multiplexer 14 and input/output connected to prototype area 74.

Object 206 is the Multiplexer connector bus for multiplexer 14 and input/output connected to prototype area 74.

I/O for Multiplexer 15

Object 315 is the Multiplexer input output bus for multiplexer 15 and input/output lines 209 and 228 connected to prototype area 75.

Object 316 is the Multiplexer input output bus for multiplexer 15 and input/output lines 213 and 214 connected to prototype area 75.

Object 317 is the Multiplexer input output bus for multiplexer 15 and input/output lines 218 and 219 connected to prototype area 75.

Object 318 is the Multiplexer connector bus for multiplexer 15 and input/output lines connecting multiplexer 15 to prototype area 75.

Object 211 is the Multiplexer input output bus for multiplexer 15 and input/output connected to prototype area 75.

Object 216 is the Multiplexer input output bus for multiplexer 15 and input/output connected to prototype area 75.

Object 221 is the Multiplexer input output bus for multiplexer 15 and input/output connected to prototype area 75.

Object 226 is the Multiplexer connector bus for multiplexer 15 and input/output connected to prototype area 75.

I/O for Multiplexer 16

Object 315 is the Multiplexer input output bus for multiplexer 16 and input/output lines 263 and 264 connected to prototype area 77.

Object 316 is the Multiplexer input output bus for multiplexer 16 and input/output lines 258 and 259 connected to prototype area 77.

Object 317 is the Multiplexer input output bus for multiplexer 16 and input/output lines 253 and 254 connected to prototype area 77.

Object 318 is the Multiplexer connector bus for multiplexer 16 and input/output lines connecting multiplexer 16 to prototype area 77.

Object 211 is the Multiplexer input output bus for multiplexer 16 and input/output connected to prototype area 77.

Object 216 is the Multiplexer input output bus for multiplexer 16 and input/output connected to prototype area 77.

Object 221 is the Multiplexer input output bus for multiplexer 16 and input/output connected to prototype area 77.

Object 226 is the Multiplexer connector bus for multiplexer 16 and input/output connected to prototype area 77.

I/O for Multiplexer 17

Object 319 is the Multiplexer input output bus for multiplexer 17 and input/output lines 229 and 248 connected to prototype area 76.

Object 320 is the Multiplexer input output bus for multiplexer 17 and input/output lines 243 and 244 connected to prototype area 76.

Object 321 is the Multiplexer input output bus for multiplexer 17 and input/output lines 238 and 239 connected to prototype area 76.

Object 322 is the Multiplexer connector bus for multiplexer 17 and input/output lines connecting multiplexer 17 to prototype area 76.

Object 231 is the Multiplexer input output bus for multiplexer 17 and input/output connected to prototype area 76.

Object 236 is the Multiplexer input output bus for multiplexer 17 and input/output connected to prototype area 76.

Object 241 is the Multiplexer input output bus for multiplexer 17 and input/output connected to prototype area 76.

Object 246 is the Multiplexer connector bus for multiplexer 17 and input/output connected to prototype area 76.

Object 14 is the Input and output multiplexer for prototyping area 74.

Object 15 is the Input and output multiplexer for prototyping area 75.

Object 16 is the Input and output multiplexer for prototyping area 77.

Object 17 is the Input and output multiplexer for prototyping area 76.

The device 128 has four magnetic flux generating loops at positions 152,153,154 and 155 on cantilevers 74,75,76 and 77 respectively. These magnetic flux generating loops 152,153,154 and 155 which are located in proximity to the flexible gap junctions tips 1,2,3 and 4 are connected to the multiplexer circuits 14,15,16 and 17 respectively. The input and output to the flux generating loops is made through the input and output lines and connector buses of each respective multiplexer as described above. The flux generating loops can be used to locally heat the respective tip and flexible gap junction by modulating the current through the loop. This can be use to unpin persistent flux in persistent current loop quantum interferometer circuits as well as perform variable temperature experiments with tips 1,2,3 and 4 including Fano resonance studies of materials and surfaces. Additionally the heating may be used to asymmetrically bias the tips and check physical properties of the materials in the nanomaniplator function of the device.

All of the above multiplexers are attached to MEMS/NEMS coherent electron measurement and the control circuit 137 and are controlled input and output from software on computer 139 or a combination of machine code on read only memory ROM, random access memory RAM and DSP circuits built in prototyping areas 74,75,76 and 77 of device 128. Preferably when Genetic Algorithms (GA) are used to design the circuits in prototyping areas of the device 128 computer control is used to implement fabrication and interconnection of components in areas 74,75,76 and 77 of device 128. Field programmable gate and mesoscopic quantum interferometer and qubit arrays can be built on prototyping areas 74,75,76 and 77 by (GA) and connected with tips 1,2,3 and 4 of the 128 to evolve novel circuits for testing and manipulation of quantum information systems and nanoparticle arrays. It should be noted that it is possible to stack input and output lines and run multiple lines in parallel over spring objects to span onto the SOI suspended structure and increase channel count if needed.

The circulating superconductive current in a SQUID circuit will be dependent upon the tunneling gap separation distance and electronic state of the material present in the junction region between tips 1,2,3 and 4. By measuring the displacement of the flexible gap cantilevers holding the tips 1,2,3 and 4 the tunneling current can be measured as a function of the distance separating the tunneling tips. By knowing the gap displacement the signal dependence of the SQUID current as a function of the sample scanning position can be deconvolved.

Measurement of the displacement is made by optical interferometry and tunneling. Alternately or in conjunction with tunneling displacement sensing, optical interferometry is used on one or more tunneling gap sensors to independently sense the X Y and Z displacement of the flexible gap junction cantilever attached to tips 1,2,3 and 4. This method can also be used to sense displacement of Aux tips 122,123,124 and 125. The tip structures of the scanner can interact asymmetrically where a normal metal tip interacts with a superconductive tip in one or more tips of the device 128.

Alternately electron microscopy or holography can be used to measure tip and sample geometry and displacement. Atom and molecular interferometry is also possible measuring means.

The use of a circulating superconductive current in the coherent electron circuit can be induced by applying a magnetic field to MEMS/NEMS device 128. This flux will induce a quantized current in the superconductive loop structures of device 128. In preferred embodiments of the invention high temperature superconductive ceramics comprising YBCO are used in forming some or all of the electron interference circuit elements of the MEMS/NEMS device 128.

One particularly useful embodiment is where the quad device is fabricated such that it is bisected in half and tips 1 and 2 or 3 and 4 or 1 and 3 and 2 and 4 share a substrate. Etching of SOI substrate and dicing of the die with quad chips with large 100 um to 200 um spacing between half's or quadrants of the symmetric MEMS device of FIG. 1 allows for formation of tip pairs which hang into free space. These tip pair devices can be operated alone or in conjunction with quad tip scanner 128 in FIG. 1 to provide orthogonal interaction with samples scanned by tips 1,2,3,4,122,123,124 and 125.

FIG. 2 depicts a preferred embodiment of the SOI MEMS/NEMS thin film fabrication layers.

The use of low temperature Niobium superconductor as the circuit material is one possible technology which is especially useful as it is compatible with Silicon IC methods. The SOI handle wafer 273 is preferably a 100 mm or larger diameter. The SOI oxide 274 acts as an insulator between handle wafer and SOI layer 275. The SOI layer 275 is preferably a P or N doped single crystal layer 1 um to 50 um thick for MEMS and 10 nm to 500 nm thick for NEMS. The thermal oxide layer 276 on SOI layer acts as an insulator and adhesive layer for later Niobium layer growth. The thermal oxide layer 276 is lithographically patterned and etched for SOI machine comb and spring formation. The thermal oxide layer 276 is again photo lithographically and etched patterned for Aluminum comb drive wire connection.

The Aluminum Ohmic contact layer 277 is photo lithographically processed and lift off patterning is used for electrical connections of the comb drives 62,63,64,65, 66,67,68,69,42,43,44,45,86,87,88,89 and z axis capacitor/sensors 114,115,116,117,118,119,120,121 and the connection lines to these capacitive devices. Potentially other circuits built on prototyping areas 74,75,76,77, 144,145,146 and 147 can make use of the layer 277. The thickness of the Aluminum layer 277 is chosen to be around 500 nm to allow for the next insulation layer to fill and isolate the recessed Aluminum layer 277. Alternately doped polysilicon can be used for interconnection of comb drives. The Phosphosilicate (PSG) or Borosilicate (BSG) or low temperature CVD oxide glass filler insulator layer 278 is deposited over Aluminum lines 277 and SOI layer 275 left before chemical mechanical polishing (CMP). This layer is deposited to allow for insulation of Aluminum lines 277 and to act as a planarization layer which is polished to allow for subsequent photolithography resist layers for further processing of SQUID and Prototype layers on the SOI thermal oxide layer. The CMP process is carried out till the top of the thermal oxide layer is reached and stopped to allow for a 500 nm layer of insulation glass 278 to remain. Later in processing the insulating fill layer 278 is etched in areas where the SOI structures such as comb drives, springs and cantilevers will be free above the back-side etch holes through the wafer.

Niobium ground plane metal 279 is deposited on the SOI thermal oxide layer 276 and trench fill areas over the whole wafer SOI top side layer and patterned and etched to leave the spaces between SOI comb drive, spring and cantilever and chip die structures free of Niobium ground plane film.

A layer of SiO2 insulation 280 is deposited over the Niobium ground plane layer and patterned and etched. A Niobium-Aluminum Oxide-Niobium Trilayer 281 is deposited on the SiO2 layer 280 for Josephson junction formation. Another SiO2 insulation layer 282 is deposited over the etched Trilayer 281. A resistor metal layer 283 of Molybdenum is deposited over the SiO2 layer 282 to form shunting resistors for the SQUID devices and prototype devices in regions 74,75,76,77, 144,145,146 and 147. A layer of SiO2 insulator 284 is deposited to form an isolation layer over the resistor layer 283. An interconnection wiring layer of Niobium 285 is deposited over the SiO2 layer 284 and is used for connecting the Trilayer junction areas formed using 281.

Another SiO2 insulator layer 286 is deposited over the Niobium interconnection layer 285. The Niobium layer 287 is deposited over the insulation 286. A resistor metal layer Ti/Pd/Au used for contacts and resistors is deposited on top of the Niobium layer 287 and oxide layer 286 and is labeled 288. Next a layer of SiO2 Passivation oxide is deposited and is labeled 289.

Alternately an additional Niobium and insulator layer can be deposited above layer 285 in the above stack of layers or under the final passivation layer to act as a coaxial shield for the circuit components. Via etching to penetrate the shield layer will be required.

Additionally the top passivation layer can be treated with SAM films or coatings to modify it's surface physical properties.

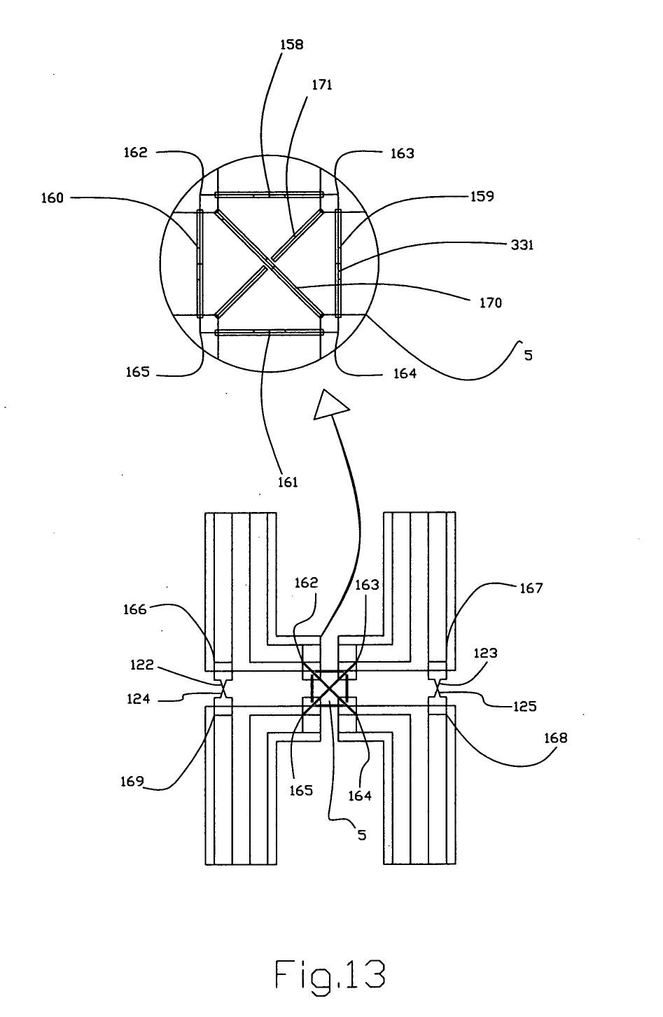

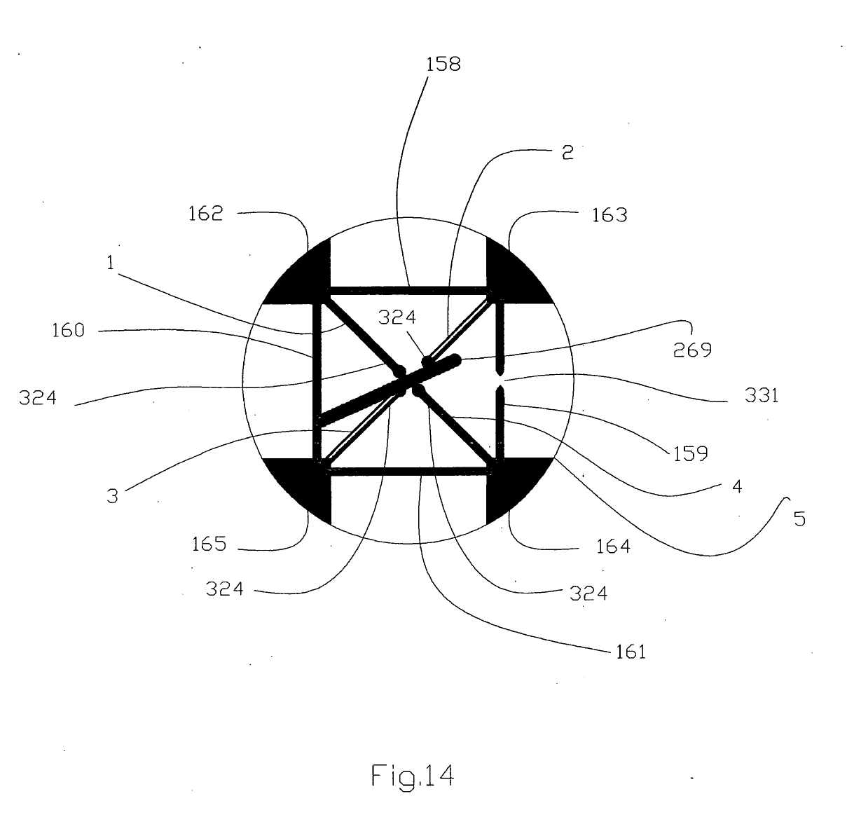

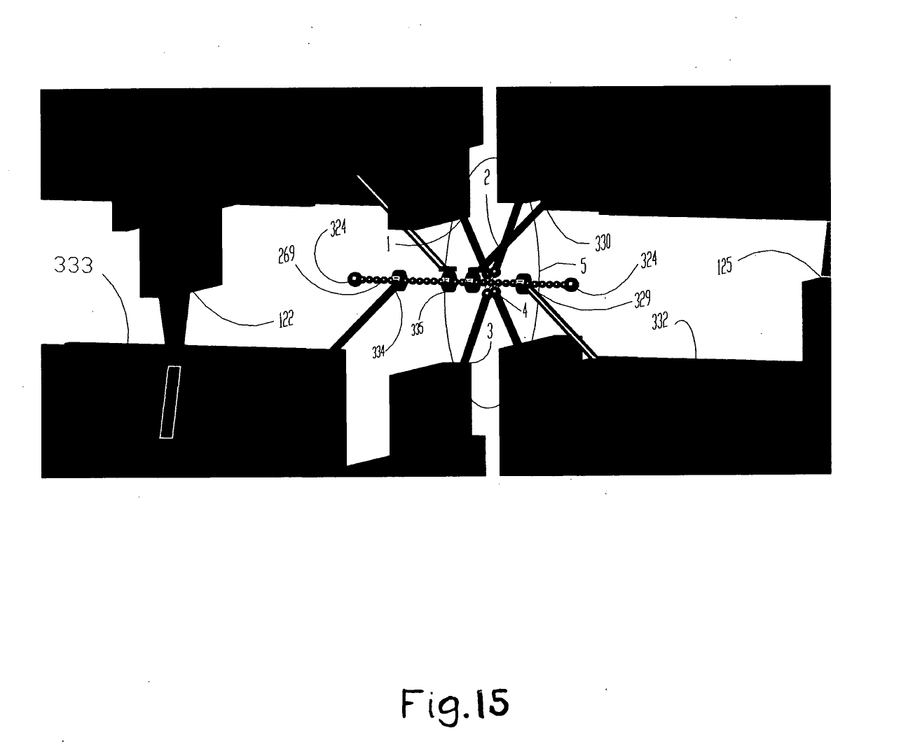

FIG. 3 depicts a schematic diagram of an embodiment of the coherent scanning probe microscope and nanomanipulator with optical interferometry measurement means for a tip pair of device MEMS/NEMS 128. The quad tip device of FIG. 1 will require a second set of cantilever interferometer means for the second tip pair 3 and 4. Multiple sets of the depicted interferometer part of the diagram can be run in parallel for multiple MEMS/MEMS devices like quad tip device 128 or the dual tip devices as for operating devices 332 and 333 of FIGS. 12 and 15.

The reference numeral 128 represents the MEMS/NEMS coherent electron interferometer nanomanipulator/probe microscope. The XYZ actuator stage 126 is preferably a closed loop piezo stage with the sample substrate attached for scanning by MEMS/NEMS device 128. The reference numeral 138 represents an orthogonal interferometer comprised of a laser, beam splitter and photodetector attached to interferometer control circuit 135 and computer 139. The lasers 129,132 and the laser in interferometer 138 reflect off of the MEMS/NEMS device 128 and produce interferometer signals detected by photodetectors 131, 134 and 138. The signal output from the photodetectors are sampled and digitized by device circuitry 135 and sent to computer 139 for processing and feedback control. The interferometers detect sub-Angstrom level motion in the device resulting from actuator signals or sample/probe interactions. Preferably in the case where multiple flexible gap junctions need to be detected by interferometers where close spacing of the moving surfaces on the MEMS/NEMS device is required a thin film coating on each of the tip cantilevers being detected by the interferometer is used in conjunction with multiple wavelength laser sources to differentiate each of the moving surfaces.

Tip 1,2 3 and 4 would have cantilevers with different interference coatings which reflect narrow bands of light into their respective interferometer. Each narrow band filter coated cantilever surface is then measured with a different wavelength from lasers 129, 132 and 138. The grating structures 58,59,60 and 61 in FIG. 1 can be fabricated with different width and pitch for each of the tips 1,2,3 and 4 for discrimination of the displacement. The optical components of the preferred embodiment are fiber optic integrated packages so as to provide simple alignment. Both static displacement and shifts in frequency and phase of the resonant MEMS cantilever structure and sample substrate carrier 127 can be detected using the interferometer. Reference to the articles D. Ruger, H. J. Mamin and P. Guethner, Applied Physics Letters 55, 2588 (1989), H. J. Mamin and D. Ruger Applied Physics Letters 79, 3358 (2001) and D. Pelekhov, J. Becker and J. G. Nunes, Rev. Sci. Instrum. 70, 114 (1999). These citations discribe cantilever detection methods useful in the instant invention. These citations do not provide coherent scanning probe microscopy, spectroscopy or nanomanipulation as the instant invention does.

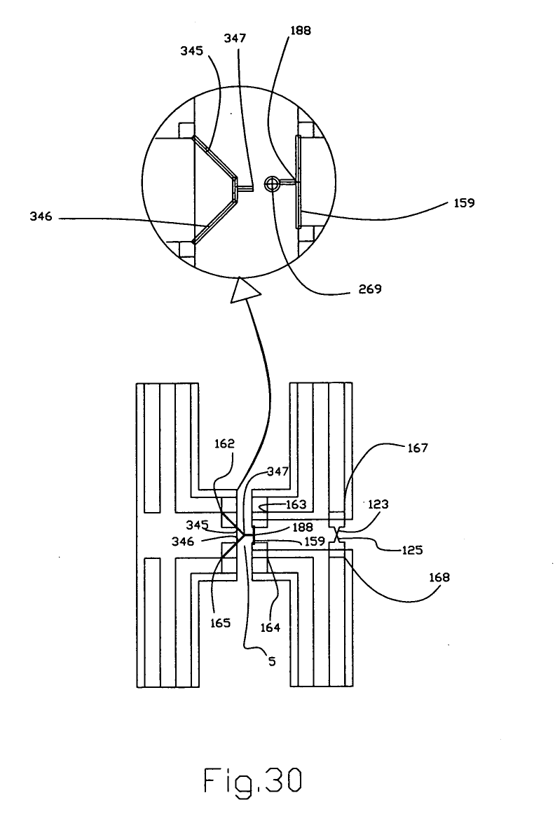

In preferred embodiments the interferometer uses a fiber optic device as seen in FIG. 30. In preferred embodiments the fiber optic detection arms of the interferometer and fiber coupler are fabricated on substrate 128 using integrated waveguides deposited in layers of the MEMS cantilevers 54,55,56 and 57 according to methods known in the electro optics art.

The sample stage positioning device 126 may be a MEMS/NEMS device or a large piezo stage. The XYZ stage 126 can be formed from the same substrate as 128. Preferably the XYZ stage 126 is integrated with a sample substrate loading and storage device 140, sample chemical treatment device 142 controlled by sample loading and chemical treatment circuit 141 under computer 139 control. The sample loading and storage device 140 allows for automated control of sample loading and management of large sample libraries scanned by MEMS/NEMS device 128. The loading and storage device 140 and MEMS/NEMS device SPM/Nanomanipulator chemical treatment mechanism 143 are integrated with control circuit 141 is interfaced with computer and software of device 139.

Preferably the MEMS/NEMS SPM chemical treatment device and sample substrate treatment mechanism 142 and 143 have a means for solvent, reagent, buffer and gas treatment of the instant device MEMS/NEMS 128 and sample substrate 127. Further the chemical treatment mechanism provides a means for cyclical application of chemical reagents, solvents and gases and includes critical point CO2 treatment of the device and sample substrate 127 and 188. In addition nucleotide and protein and bimolecular reagents and arrays can be handled, dispensed and interacted under control of computer 139. Additionally the MEMS/NEMS SPM chemical treatment device has electrical, and chemical means for providing electrophoresis in association with or on the MEMS/NEMS chip 128. Said electrophoresis process is controlled by software on computer 139.

Preferable embodiments of the MEMS/NEMS device 128 and substrate 127 have systems comprising microfluific channels, pores, valves and pumps for integrated delivery of reagents, samples and objects to the interaction region 5 of the device.

The MEMS/NEMS device 128 has tunneling detectors attached to cantilevers 54,55,56 and 57 holding tips 1,2,3,4, 122,123,124 and 125 in place. These tunneling displacement sensors can detect sub-Angstrom scale movement resulting from actuator induced motion from comb drives 62,63,64,65, 66,67,68,69,42,43,44,45,86,87,88 and 89 on the first, second, third and fourth tips of the flexible gap junction coherent electron interferometer quad device. The Aux tips 122,123,124 and 125 can be used to measure the position of tips 1,2,3 and 4 and provide a means for high resolution tunnel detector sensing.

The sample substrate carrier 127 can have the electric potential modulated or scanned by device coherent electron measurement and control circuit 137 to perform spectroscopic measurements during imaging under control of computer 139.

Alternately the tip to tip gaps between tips 1-2, 1-3,34,2-4, 122-124,123-125 can be illuminated with interferometers and the scattering components of the electromagnetic interactions can be measured. By inserting a sample between any of the tips 1,2,3,4, 122,123,124 and 125 and illuminating them with one or more interferometers optical mapping in conjunction with coherent electron interferometry and atomic force microscopy is performed. In preferred embodiments the interferometers have a phase modulation optoelectronic element in the reference or sample arm of the interferometer. The interferometers can be Fabry-Perot, Michelson interferometers or any other type of interferometers.

Additionally, conventional SPM control and data acquisition mechanisms, including software, can be modified to create new mechanisms or algorithms necessary to control tip movement or optimize the performance of the coherent electron SPM probe capable and nanomanipulator in the system of the present invention.

XYZ Stage and Sample Holder

SOI Springs

S1 26,27,28,29, 78,79,80,81

S2 30,31,32,33, 70,71,72,73

S3 46,47,48,49, 82,83,84,85

S4 50,51,52,53, 90,91,92,93

26,27,28,29,78,79,80,81,30,31,32,33,70,71,72,73,46,47,48,49,82,83,84,85,50,51,52,53,90,91,92 and 93

SOI Comb Drives

C1 62,63,64,65

C2 66,67,68,69

C3 42,43,44,45

C4 86,87,88, 89

62,63,64,65,66,67,68,69,42,43,44,45,86,87,88 and 89

Z axis capacitor/sensors

Cantilever 1-114,115

Cantilever 2-116,117

Cantilever 3-118,119

Cantilever 4-120,121

114,115,116,117,118,119,120 and 121

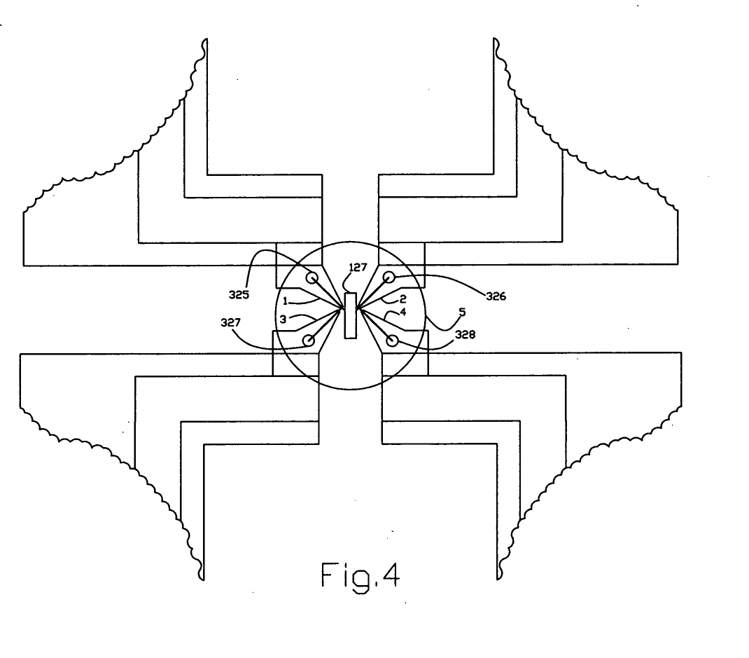

FIG. 4 represents a close view of region 5 where the tips 1,2,3 and 4 interact with one another and sample substrate 127. In a preferred embodiment the displacement of the flexible gap scanner junction interferometer is detected using the opposing tips in a pair of opposing the tips of a quadrant tip geometry. Preferably tips 1,2,3 and 4 have nanotube or nanorod materials deposited on them which are connected to the electron beam lithography or focused ion beam milled tip thin film defined tips using electron beam deposition contacts 325,326,327 and 328 in an electron microscope or are sandwiched between any of the metal layers in FIG. 2 during or after the Josephson junction Trilayer deposition layer 281. Probe functionalization using 324 insures good mechanical adhesion and electrical contact and reversible attachments to probes.

Preferred Operation of MEMS/NEMS Scanner (See FIGS. 1,4 and 5):

The computer 139 initiates a start sequence for digital to analog comb drive signals from circuit 136. A preferred tracking arrangement starts with retracting tips 1,2,3 and 4 from their equilibrium resting positions using comb drive actuators 62,63,64,65, 66,67,68,69,42,43,44,45,86,87,88,89 and z axis capacitors 114,115,116,117,118,119,120 and 121 of FIG. 1. Tip 3 is retracted more in the X direction from the junction equilibrium spot 5 so that tip 1 engages sample surface 127 first. Once a space wide enough for XYZ stage sample holder 127 is created the thin sample holder 127 with a sample is brought into contact with tip 1 by placing it between tips 1 and 2.

A tunneling, optical or atomic force measurement is made to determine when contact or close proximity (less than 2 nm) is made between tip 1 and sample substrate 127. Once contact or close proximity spacing is obtained between tip 1 and sample substrate 127 a closed loop feedback lock in algorithm is activated by computer 139 to keep a steady distance or force between tip 1 and substrate sample 127. Closed loop feedback is provided by computer 139 and circuit board 136 shown in in FIG. 3. Device 136 provides stage measurement control as well as measurement and control circuit with substrate bias control circuit. Alternate embodiments with circuit derived feedback are alternate embodiments of the invention.

At this point only tip 1 and sample substrate 127 are in contact. Next Aux tip 124 is brought into contact or close proximity (less than 2 nm) to tip 122 by comb drives 42,43,44,45 and z axis capacitors 118 and 119. A tunneling, optical or atomic force measurement is made to determine when and where contact is made. Once contact or close proximity spacing is obtained between tips 122 and 124 a closed loop feedback lock in algorithm is activated by computer 139 to keep a steady distance or force between tips 122 and 124.

Computer 139 activates a signal detection and generation algorithm in the coherent electron circuit 137 to generate coherent electron circuit activity via the flux excitation lines 22 and 23. The detection circuit also measures the flux detector coil on lines 24 and 25 for coherent electron circulation between tips 1 and 2 through the sample on substrate 127. Next comb drives 66,67,68,69 and z axis capacitors 116 and 117 move tip 2 into contact or proximity (less than 2 nm) to sample substrate 127. A tunneling, optical or atomic force measurement is made to determine when contact or close proximity (less than 2 nm) is made between tip 2 and sample substrate 127.

Once contact or close proximity spacing is obtained between tip 2 and sample substrate 127 a closed loop feedback lock in algorithm is activated by computer 139 to keep a steady distance or force between tip 2 and substrate sample 127. Closed loop feedback is provided by computer 139 and circuit board 136. Device 136 provides stage measurement control as well as measurement and control circuit with substrate bias control circuit.

The Aux tip 125 is moved into contact or close proximity (less than 2 nm) to tip 123 by comb drives 86,87,88,89 and z axis capacitors 120 and 121. A tunneling, optical or atomic force measurement is made to determine when and where contact is made. Once contact or close proximity spacing is obtained between tips 125 and 123 a closed loop feedback lock in algorithm is activated by computer 139 to keep a steady distance or force between tips 125 and 123.

The computer 139 next starts raster scanning the sample substrate 127 to obtain an image of the substrate surface and sample on the surface. The tip 1 is adjusted so as to maintain a fixed force or distance from sample substrate 127 and follows topographic features of substrate 127 and any sample material on the surface. Atomic and molecular features beneath the surface can effect the coherent electron tunneling process and cause image features during scanning. Because tips 1 and 2 are connected by a coherent interferometer tunneling circuit the gap distance between tips 1 and 2 has an associated phase and amplitude associated with it. The displacement of tips 1 and 2 is detected by tips 125 to 123 and 122 to 124 respectively. Thus as sample surface 127 and samples on this surface are moved between tips 1 and 2 a phase and amplitude change occurs in the output of the phase coherent detection circuit 137.

In preferred embodiments the sample substrate 127 has tracking marks of atomic to nanometer size placed at regular intervals for spatial scan compensation. Fixed location tracking marks are imaged then sample molecules are scanned in relation to these fixed marks. These tracking marks can be on either side of the thin sample substrate 127 and detected by either tips 1,2,3 or 4. Molecular beam epitaxy and nanoparticles can be used as scan tracking compensation marks as well as intrinsic crystal lattice features.

In preferred embodiments Aux 122, 123,124 and 125 tips are normal conductive materials and tips 1,2,3 and 4 have at least one pair of coherent electron conductive material in an interferometer circuit.

In preferred embodiments the sample substrate 127 has a surface comprising an array of aligned nanoparticles or nanotubes upon which sample molecules such as DNA, RNA, proteins, peptide, receptors, ligands, or nucleic acid synthesis reagents are attached for scanning or synthesis. Nanotubes comprised of single walled carbon nanotubes in particular are useful for attaching biomolecules for scanning in the instant invention. Nucleotide molecules can be placed in nanotubes and scanned by the coherent electron interferometer. Prior art methods for oriented nanotube deposition can be found in Zhi Chen, Wenchong Hu, Jun Guo, and Kozo Saito, J. Vac. Sci. Technol. B 22.2., March/April 2004 p 776-780 and is incorporated here as a reference in it's entirety.

The data from coherent electron detection circuit 137 monitoring coherent electron flux detected flowing between tips 1 and 2 is recorded as well as displacement data from comb drives 42,43,44,45,86,87,88,89 and z axis capacitors 114,115,116,117,118,119,120 and 121 are recorded as well as noise detected in vibration and actuation placement of tips 1 and 2 which is registered between AUX detector tips 122,123,124,125 and by interferometry depicted in FIG. 3 and 30. Alternately the nonlinearity and noise in actuation can be compensated by measuring tracking features like 270 periodically and determining relative position of the sample location being spectroscopically measured by measuring relative to these features. Intrinsic features such as lattice features can be used for position compensation.

Lateral dithering of the position of tips 1,2,3,4, 122,123,124 and 125 over sample sites to increase sampling of spectroscopic data can be performed by sending oscillation signals to comb drives 62,63,64,65, 66,67,68,69,42,43,44,45,86,87,88, 89 and z axis capacitors 114,115,116,117,118,119,120 and 121.

In preferred embodiments of operation the tips 1,2,3,4, 122,123,124 and 125 are vibrated and interact with the sample substrate 127 and or 188. Coherent electron detector circuitry 137 can preferably use lock-in detection at the vibrational frequency of the tips 1,2,3,4,122,123,124 and 125. These data sets of sample interactions between tips and sample can be used in conjunction with atomic force measurements AFM or any other form of scanning probe microscopy SPM.

In preferred embodiments the sample substrate 127 and or 188 are vibrated instead of the tips. Alternately the sample substrate 127 and or 188 and the tips 1,2,3,4, 122,123,124 and 125 are vibrated. Contact and non-contact AFM and electron interferometry can be performed in all modes.

An alternative mode is a case where tip 1 and 2 are being measured by tip 3 and 4 respectively and tips 122,123,124 and 125 are not fabricated. The equilibrium position of tips 3 and 4 are used as standards for position measurement of tips 1 and 2.

In a further preferred embodiment of the instant invention the coherent electron probe device is operated in a mode where tip 2 is used to monitor tip 1 displacement and surface interaction and tip 4 is used to monitor tip 3. Alternately tip 3 can monitor tip 1 and tip 4 can monitor tip 2.

In this mode of operation the tips being monitored can be used as a tunneling probe, atomic force probe or any other scanning probe microscope probe or spectroscopic scanner.

In preferred embodiments the circuitry of MEMS/NEMS coherent electron interferometer is composed of circuit elements comprising coaxially insulated superconductive material. The coaxial shielding protects the circuitry from stray fields from the actuator, sensor, noise and environment.

Resistively Shunted SQUID:

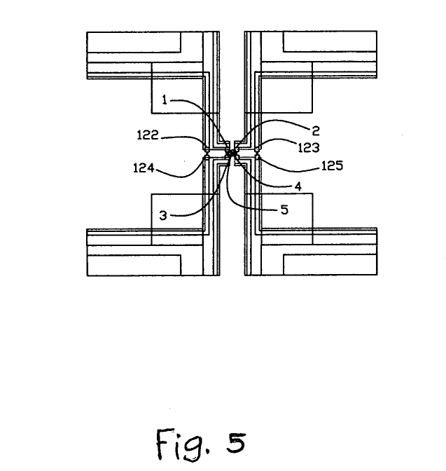

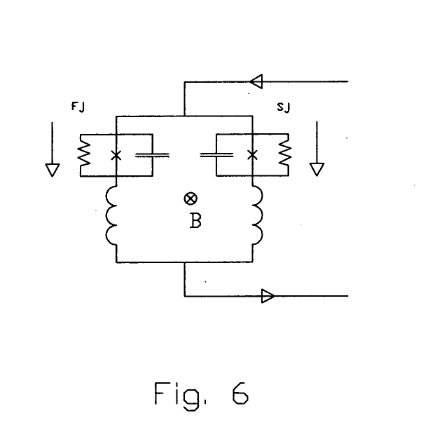

FIG. 6 depicts the circuit diagram of a resistively shunted SQUID circuit. In a preferred embodiment the instant invention flexible gap coherent electron interferometer is built using such a circuit. The circle with the x in it in the diagram represents a magnetic field directed into the plane of the image which can be used to induce a SQUID flux current in the circuit. The region Fj is the flexible gap probe junction where the two sides of the junction are formed by any of the tips 1,2,3,4, 122,123,124 and 125 and the sample substrate 127 or respective opposing tip.

One or more pairs of the tips 1,2,3,4, 122,123,124 and 125 can be fabricated in such a circuit to perform as scanning probes, nanomanipulators and act as Josephson junctions in circuits comprising the depicted circuit. Sj is a standard fixed junction gap Josephson junction. Such circuits can be wired in parallel or serial to form multi-junction feedback devices according to the invention. The shunting resistors can be removed and the device can be operated in the hysteretic or non-hysteretic regime in AC and DC mode. Alternately the second junction Sj can be removed to provide a single Fj junction loop for flux measurement and scanning. SQUID detection circuit 137 is used to control and monitor the circuit. Regions for prototyping at locations 74,75,76,77, 144,145,146 and 147 can be connected to the tip junctions for input, output, sensing and control.

Non-Shunted SQUID:

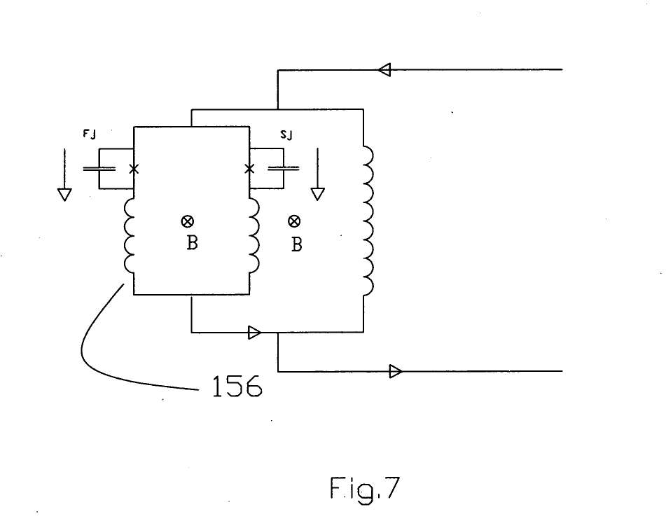

FIG. 7 depicts the circuit diagram of a non-resistively shunted SQUID circuit. In a preferred embodiment the instant invention flexible gap coherent electron interferometer is built using such a circuit. The circle with the x in it represents a magnetic field directed into the plane of the image which can be used to induce a SQUID flux current in the circuit. The region Fj is the flexible gap probe junction where the two sides of the junction are formed by any of the tips 1,2,3,4, 122,123,124 and 125 and the sample substrate 127 or respective opposing tip.

The tips 1,2,3,4, 122,123,124 and 125 can be fabricated in such a circuit to perform as scanning probes, nanomanipulators can act as Josephson junctions in circuits comprising the depicted circuit. Sj is a standard fixed junction gap Josephson junction. Such circuits can be wired in parallel or serial to form multi-junction feedback devices according to the invention. The shunting resistors can be added and the device can be operated in the hysteretic or non-hysteretic regime in AC and DC mode. Alternately the second junction Sj can be removed to provide a single Fj junction loop for flux measurement and scanning. SQUID detection circuit 137 is used to control and monitor the circuit. Regions for prototyping at locations 74,75,76,77, 144,145,146 and 147 can be connected to the tip junctions for input, output, sensing and control.

Flexible Junction Insquid:

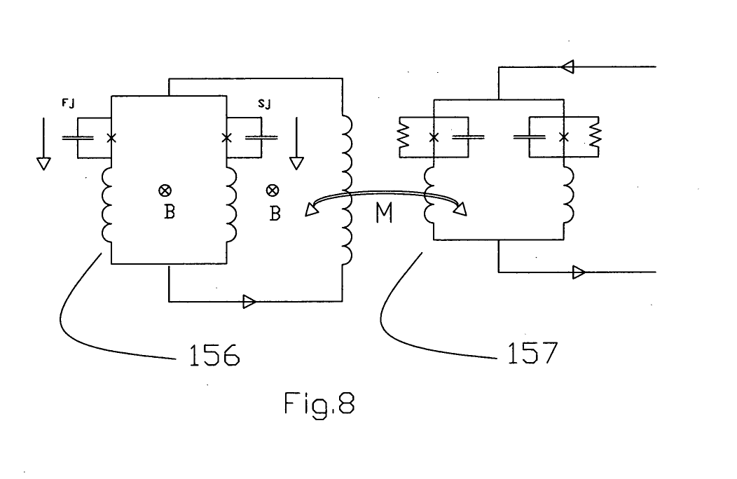

FIG. 8 depicts the circuit diagram of a non-resistively shunted flexible junction SQUID circuit detected by a resistively shunted SQUID circuit. In a preferred embodiment the instant invention flexible gap coherent electron interferometer is built using such a circuit. The circle with the x in it represents a magnetic field directed into the plane of the image which can be used to induce a SQUID flux current in the circuit. Circuit 156 is the flexible gap junction interferometer with superconductive inductive coupling coil. Circuit 157 is the output detector SQUID coupled to 156 via superconductive induction coil.

The region Fj is the flexible gap probe junction where the two sides of the junction are formed by any of the tips 1,2,3,4, 122,123,124 and 125 and the sample substrate 127 or respective opposing tip. The tips 1,2,3,4, 122,123,124 and 125 can be fabricated in such a circuit to perform as scanning probes, nanomanipulators and act as Josephson junctions in circuits comprising the depicted circuit. Sj is a standard fixed junction gap Josephson junction. Such circuits can be wired in parallel or serial to form multi-junction feedback devices according to the invention. The shunting resistors can be added and the device can be operated in the hysteretic or non-hysteretic regime in AC and DC mode. Alternately the second junction Sj can be removed to provide a single Fj junction loop for flux measurement and scanning. SQUID detection circuit 137 is used to control and monitor the circuit.

Coherent Electron Junctions at the Flexible Gap Junction Tips:

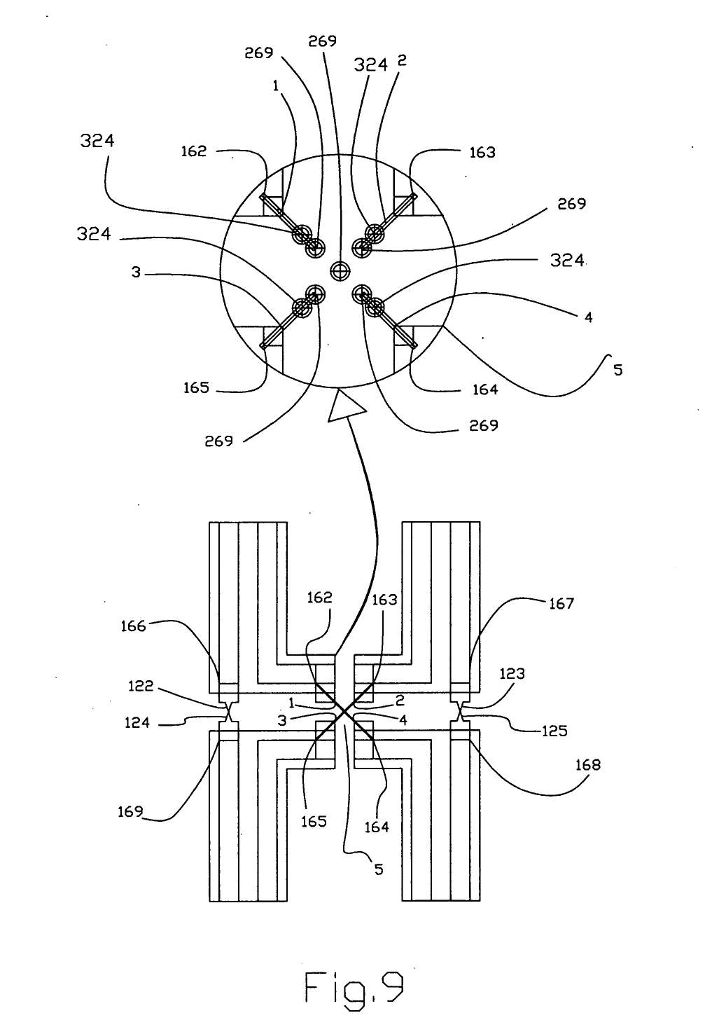

An alternate embodiment of the invention depicted in FIG. 9 has coherent electron junctions 162,163,164,165,166,167,168 and 169 located at tips 1,2,3,4, 122,123,124 and 125 at the apex of the cantilevers 54,55,56 and 57. These coherent electron junction devices are preferably Josephson junctions. Because the region 5 where tips 1,2,3,4, 122,123,124 and 125 converge and are much closer than prototyping regions 148,149,150 and 151 compact high frequency circuits can be fabricated by interconnecting the junctions at cantilever mounted tips 1,2,3,4,122,123,124 and 125. Preferably nanotubes are used to fabricate interconnections between coherent electron junction pads 162,163,164,165,166,167,168 and 169. The linker functional group 269 is preferably a reversible type compound 324 and each of the tips 1,2,3 and 4 can be functionalized with a different compounds.

Preferably the chemical linker group 269 is attached proximal to the apex region of each tip 1,2,3 and 4 so that a clean imaging atom or moiety at the very apex of the nanotube tip can be used for imaging without interference from the chemical agent 269. FIG. 9 also represents a diagram of a preferable circuit fabricated according to this preferred embodiment. The comb drive actuation mechanism of FIG. 1 can still be used to move and sense the compact interconnected junction configuration of FIG. 9. The circle in the upper region of the diagram is an enlarged top view of the flexible gap interaction region 5 of the MEMS/NEMS device 127. The junctions may be used as a SQUID loop in a DC or AC SQUID or attached to a quantum well device in connection with the tip structures 1,2,3 and 4. Alternately the tip area mounted local 162,163,164,165,166,167,168 and 169 junctions can be wired with nanoscale wires and used to form low-capacitance charge qubit superconducting junctions. Alternately one or more of the tips 1,2,3,4,122,123,124 and 125 can be fixed to the substrate and one or more of the remaining tips can be movable flexible gap tips for scanning. Regions for prototyping at locations 74,75,76,77, 144,145,146, 147,148,149,150 and 151 can be connected to the tip coherent electron junctions for input, output, sensing and control of scanned materials and tip interactions. The junctions at the apex of cantilevers 54,55,56 and 57 can be spanned using nanoscale nanotube or nanorod objects to form circuits. Functionalization of the tips or spanning nanotubes 158,158,160 and 161 can be used to create specific chemical groups and structures on the objects in contact with the coherent tip junctions.

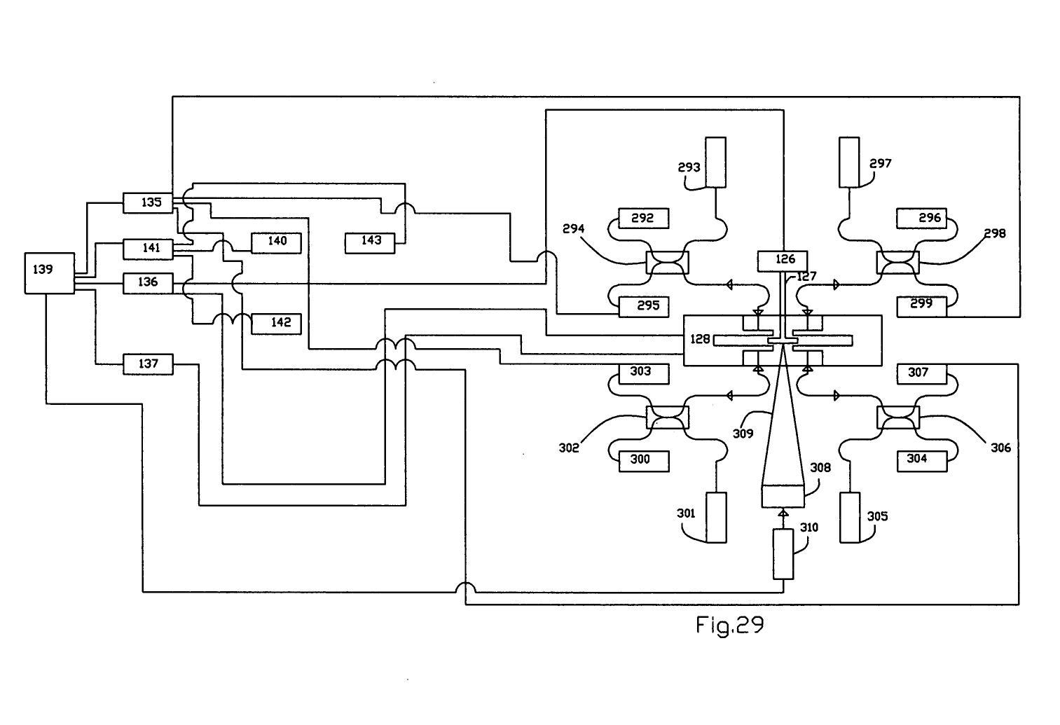

Due to the small size and spacing of the tip apex junctions high frequency and quantum limited performance far better than micron scale circuits results. A mixture of spanning gap nanotubes 158,159,160,161,170 and 171 mixed with tips 1,2,3 and 4 can are used in conjunction to form novel circuits and scanning structures preferably attached to junctions 21,37,173 and 179 as well as connected to prototyping areas 144,145,146,147, 148,149,150 and 151 These spanning circuits of the following description can be integrated with the coherent Josephson junctions at the tip interaction region 5. Though 8 junctions 162,163,164,165,166,167,168 and 169 located at tips 1,2,3,4, 122,123,124 and 125 at the apex of the cantilevers 54,55,56 and 57 are depicted a large array of the same type of junctions can be fabricated in the prototype areas 74,75,76,77 and at the tip region 5 for experimental interconnection topology tests using Genetic Algorithm (GA) evolvable hardware algorithms as depicted in FIG. 29.

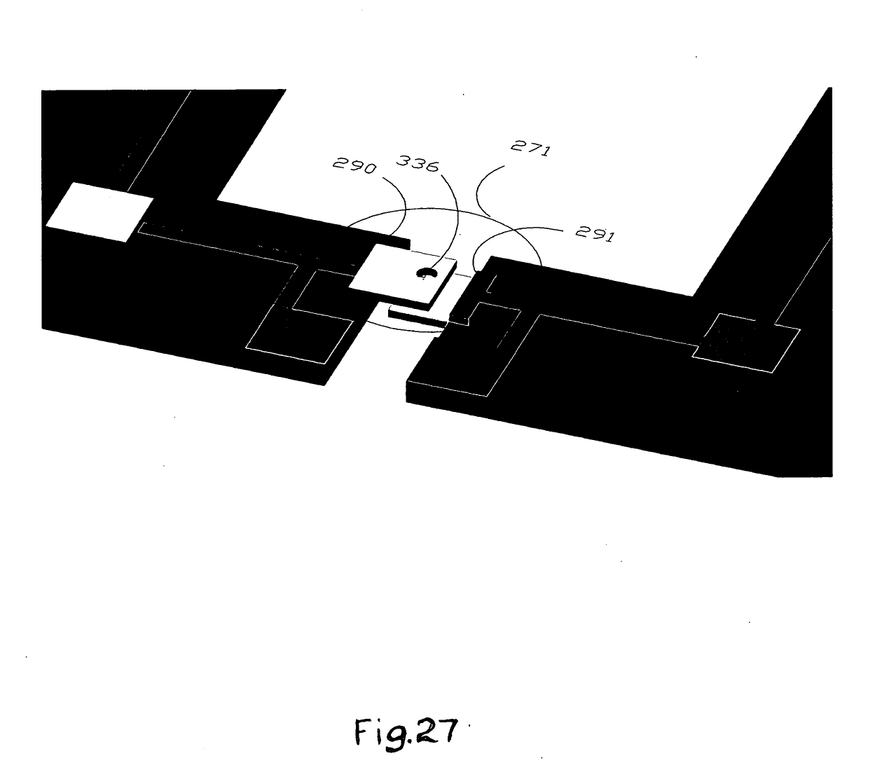

Discrete breather and quantum ratchet circuits can be formed using flexible gap tips 1,2,3,4,122,123,124 and 125 as Josephson junctions. Alternately if the tip resistance is too high for a particular Josephson circuit to be formed through direct use of the tips of the flexible gap tunneling tips the large area flexible gap junctions 271 and 272 depicted in FIG. 27 can be integrated into discrete breather circuits or quantum ratchet circuits in prototype areas 144,145,146,147, 148,149,150 and 151. The tip region local coherent electron tunneling junctions 162,163,164,165,166,167,168 and 169 can be connected to the tips 1,2,3,4,122,123,124 and 125

The large area flexible gap junctions 271 and 272 can be connected to the spanning junction objects directly, through tip region 5 local coherent electron tunneling junctions 162,163,164,165,166,167,168 and 169 or through prototyping areas 144,145,146,147, 148,149,150 and 151 in any combinatorial topological way.

Prior art reference related to the flexible gap embodiment of a discrete breather are. R. S. Newrock, C. J. Lobb, U. Geigenmuller and M. Octavio, “The two dimensional physics of Josephson-junction arrays,” Sol. State Phys. 54, 263-512 (2000), J. J. Mazo, “Discrete breathers in two-dimensional Josephson-junction arrays,” to be published, which are incorporated in their entirety as examples of prior art. It should be noted that the instant invention can be used as a nanomanipulator and assembler in a quantum computer component I/O system form testing qubit circuits and operating them.

The prior art reference A. E. Miroshnichenko, M. Schuster, S. Flach, M. V. Fistul and A. V. Ustinov “Resonant plasmon scattering by discrete breathers in Josephson junction ladders” PHYSICAL REVIEW B 71, 174306 (2005) describes detection and manipulation methods for discrete breathers in Josephson junctions. By forming a Josephson junction ladder in the prototyping areas 74,75,76,77, 144,145,146, 147,148,149,150 and 151 of FIG. 1 using art recognized means a novel flexible gap junction scanner with resonant behavior can be used in sample scanning, manipulation and quantum circuit testing. Coherent electron measurement and control circuit 137 and computer 139 process the signal data from these prototype areas.

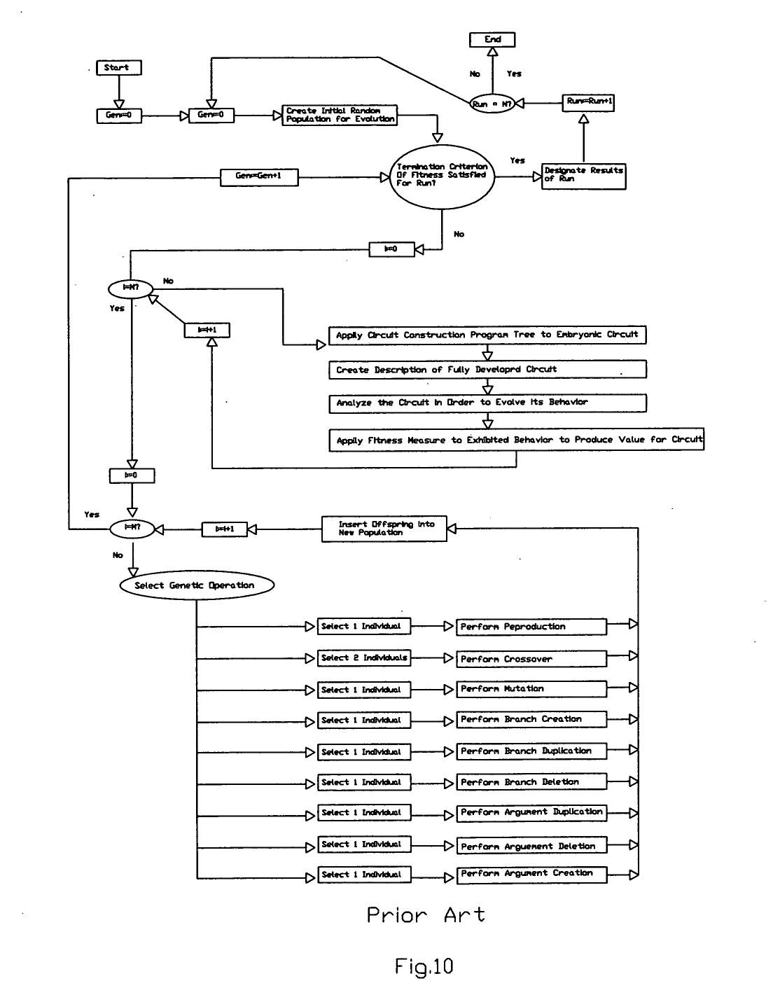

FIG. 10 Depicts the prior art flow chart for a genetic algorithm used for designing hardware device elements and interconnections in prototyping areas 74,75,76,77, 144,145,146, 147,148,149,150 and 151. In addition the genetic algorithm can be used to direct the tip fabrication, actuation geometry and dynamics of the nanomanipulator device of the present invention for assembly and testing of evolvable nanoscale circuits, machines and systems.

This diagram is a flow-chart for the overall process for a Genetic Algorithm used for designing a circuit, tip or alternately a MEMS/NEMS structure attached to or integral with the flexible gap coherent electron interferometer scanning probe microscope and nanomanipulator.

The prototyping areas 74,75,76,77, 144,145,146, 147,148,149,150 and 151 are preferably used for prototyping novel circuits designs generated by users or genetic algorithm which are attached to the coherent electron interferometer circuit flexible gap tips 1,2,3 and 4 as well as AUX tips 122,123,124 and 125. Preferably a set of routing switches in prototyping areas 74,75,76,77, 144,145,146, 147,148,149,150 and 151 can be switched by input from multiplexers 14,15,16 and 17. These switches in prototyping areas 74,75,76,77, 144,145,146, 147,148,149,150 and 151 alternately select routing of the flexible gap junction interferometer scanner and nanomanipulator coherent electron flux signals into the prototyping circuits in 74,75,76,77, 144,145,146, 147,148,149,150 and 151 or into the standard flexible junction output leads 22,23,24,25 route from tips land 2 while leads 38,39,40,41 route signal from tips 3 and 4 and leads 174,175,176,177 route signal from tips 1 and 3 and leads 180,181,182,183 route signal from tips 2 and 4 as can be seen in FIG. 1. Coherent electron measurement and control circuit 137 and computer 139 process the signal data from these prototype areas 74,75,76,77, 144,145,146, 147,148,149,150 and 151 and standard interferometer outputs 22,23,24,25,38,39,40,41,174,175,176,177, 180,181,182 and 183 to coordinate coherent electron interferometry, nanomanipulation and scanning probe microscopy according to software or hardware algorithms used for feedback control, analysis and visualization known in the art of scanning probe microscopy.

Genetic algorithms are computer programs which evolve structures in code which syntactically possess desired functional behavior. By iteratively generating random variation topologies and value tree structure representations searches are performed for functional software generated evolved devices. Simulating or fabricating the generated design variants and testing or simulating physical behavior, candidate topologies and component values for circuits and mechanisms can be generated which explore topological space for a designated program specific task. The novel coherent electron interferometer flexible gap junction device of the present invention can be autogenically optimized for user specific tasks by interfacing a genetic algorithm to a cyclical design, simulation, fabrication and testing process for fabrication or interconnection of components in the prototyping areas 74,75,76,77,144,145,146, 147 and probes 1,2,3,4,122,123,124, 125 and on sample substrate device 127 and 188. FIG. 10 represents an algorithm flow chart for implementation of a genetic algorithm for search and optimization of circuits and structures for prototype areas 74,75,76,77,144,145,146,147and probes 1,2,3,4,122,123,124 and 125 integrated with the coherent electron flexible gap scanner of the present invention.

The same type of algorithm can be used for generation of fabrication and process steps for nanomanipulation of objects by device 128 on surfaces 127 and 188. The genetic algorithm can be used for creation of manipulation, measurement and testing instructions of nanoscale devices and systems using the nanomanipulation capabilities of device 128. By creating combinatorial libraries of compounds and nanoparticles on sample substrates 127 and 188 and testing them with device 128 and using the iterative algorithm of FIG. 10 novel assemblies can be generated. Potentially even the MEMS and NEMS actuation, mechanical support and sensing structures of FIG. 1 can potentially be optimized by genetic algorithm also.

FIG. 10 illustrates one embodiment of the process of the present invention for automated design of electrical circuits and MEMS/NEMS structures.

The process of the present invention that is described for flexible gap coherent electron interferometer circuits and prototyping areas 74,75,76 and 77 can be applied to the automated design of other complex structures, such as mechanical structures of the comb drives and SOI spring structures. Potentially piezo structural actuator and sensors can be optimized by genetic algorithm also. Mechanical structures are not trees as circuits are, but, instead, are graphs. The lines of a graph that represents a mechanical structure are each labeled. The primary label on each line gives the name of a component (e.g., a specific numerical designation and type of element). The secondary label on each line gives the value of the component.

The design that results from the process of the present invention may be fed, directly or indirectly, into a machine or apparatus that implements or constructs the actual structure such as a photolithography, electron beam lithography, focused ion beam milling machine or field programmable gate array programming FPGA device or programming device for implementation of FPGA interconnection structures. The prototyping areas 74,75,76,77, 144,145,146, 147,148,149,150, 151 and tips 1,2,3,4,122,123,124 and 125 can in preferred embodiments have FPGA devices or a mixture of other circuit types or devices fabricated in them which can be interconnected by hardwiring, programmable interconnection, erasable programmable interconnection, irreversible burn in or a mixture of these. Such software and evolvable FPGA machines and their construction are well-known in the art. For example, electrical circuits may be made using well-known semiconductor processing techniques based on a design, and/or place and route tools. Preferably the devices fabricated in the prototyping areas possess one or more mesoscopic coherent quantum electrical or optical device. Programmable devices, such as FPGA, may be programmed using tools responsive to netlists and the like. Molecular electronic FPGA embodiments can be formed according to the prior art U.S. Pat. No. 6,215,327. Molecular electronics circuits can be formed by means comprising those above and from any prior art means including U.S. Pat. No. 6,430,511 and the like.

Constrained syntactic structure of the program trees in the population of potentially fit target designs for a specific task can be generated in simulation space in a powerful computer and an automated prototype fabrication process can be performed from the designs and tested cyclically. Alternately repeated reprogramming of a FPGA or programmable mesoscopic interconnection device can explore combinatorial evolvable solutions to a task or process for the present coherent electron flexible gap scanner.

One target specific function of particular importance to the present invention is the formation of nucleotide base discrimination circuits and nanostructures. Iterative genetic algorithm design, simulation and testing of mesoscale quantum circuits, quantum well structures, interferometer geometries, chemical functional groups or mechanical structures integrated with the flexible gap scanning interferometer and probe tips of the present invention can be targeted to evolve novel topologies, geometries and values of components which differentially respond to the different functional groups or labels of a RNA, DNA or protein molecule.

In the present invention, the prototype flexible gap coherent electron interferometer nanomanipulator and prototyping areas and 74,75,76,77, 144,145,146, 147,148,149,150, 151 and tips 1,2,3,4,122,123,124 and 125 are represented and processed by program trees which may contain any or all of the following five categories of functions:
(1) connection-creating functions that modify the topology of circuit or MEMS/NEMS mechanical structure from the embryonic circuit,
(2) component-creating functions that insert particular components into locations within the topology of the circuit or mechanical structure in lieu of wires (and other components) and whose arithmetic-performing sub trees specify the numerical value (sizing) for each component that has been inserted into the circuit or mechanical structure,
(3) automatically defined functions (subroutines) whose number and process are specified in advance by the user, and
(4) automatically defined functions whose number and arity are not specified in advance by the user, but, instead, come into existence dynamically during the run of genetic programming as a consequence of the architecture-altering operations.

FIG. 10 is a flow-chart for the overall process for a Genetic Algorithm used for designing a circuit, tip or alternately a-MEMS/NEMS structure attached to or integral with the flexible gap coherent electron interferometer scanning probe microscope and nanomanipulator.

Spanned Junctions:

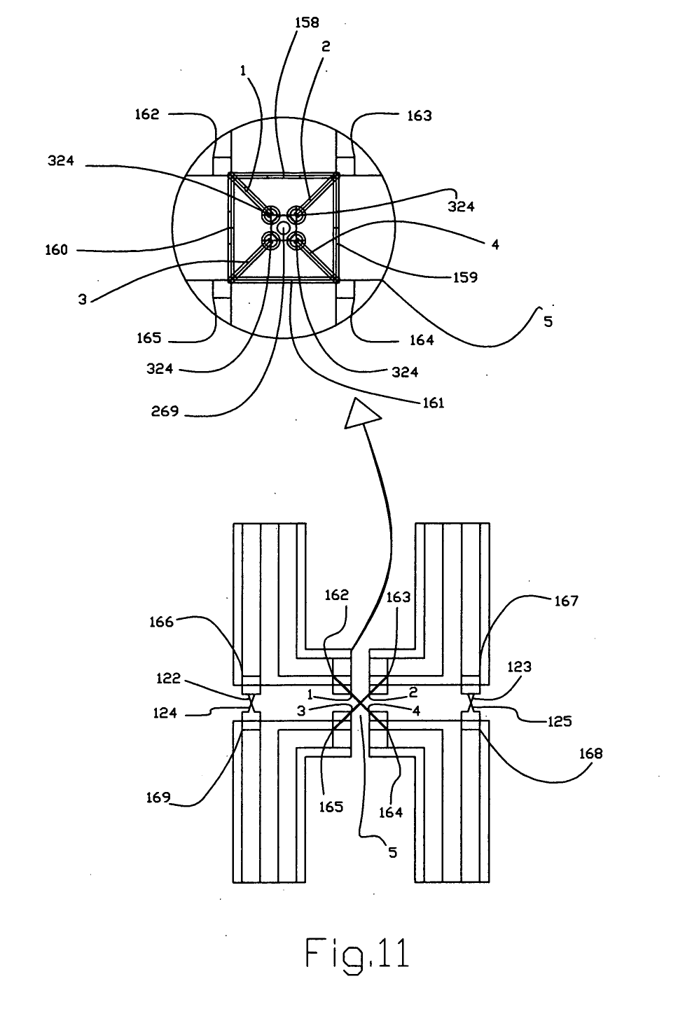

An alternate embodiment of the invention has one or more spanned coherent electron interferometer gaps at the junctions at tips 1,2,3 or 4. The gaps between tips 122,123,124 or 125 can also be spanned by nanotubes. FIGS. 11-16 depict various higher level integration uses for the flexible gap of these preferred embodiments of the invention. The spanning objects 158,159,160,161,170 and 171 are preferably nanotubes or nanorods. Alternately nanomachine functionalized objects can be used as spanning objects 158,159,160,161, 170 and 171. In the preferred embodiment of the spanning gap interferometer junctions one or more of the spanning objects is chemically functionalized to provide interaction with samples. The spanning objects may be of any shape but linear, rings, hooked, 8,C,G,R, B,T, X, Y, W, H,V and hairpin shapes are preferred shapes. Preferably one or more of the flexible gap tip to tip interfaces between tips 1-2, 1-3,34,24, 122-124,123-125 is not spanned by object such as 158,159,160,161. Tip gaps 122-124 and 123-125 can be used for tunneling displacement sensors for feedback on tip gaps 1-2, 1-3,3-4,2-4. By forming spanned gaps, circuits can be made between cantilevers 54,55,56 and 57 with short distance conduction pathways and high operating frequencies. In particular the use of a single pair of tip structures connected by spanning nanotubes attached to tip localized junctions 162,163,164,165,166,167,168 and 169 allows for a region 5 localized microscale to nanoscale SQUID with flexible scanning capabilities. Micron scale spanning beams can be used in the place of the nanoscale beams, tubes or rods of 158,159,160,161,170 and 171. Mixed scale geometry spanning structures of simple and complex geometry and function are also desirable.

FIG. 11-16 depict various interconnection geometries for use of flexible gap embodiments of the coherent electron interferometer scanner. These junction diagrams are enlarged views of region 5 of the FIG. 1 where the scanner tips 1,2,3 and 4 interact. Preferably objects 158,159,160 and 161 are molecular nanotubes such as carbon nanotubes or the like. The spanning objects are attached to the flexible cantilever structures 54,55,56 and 57. Preferably the spanning structures are used to build scanning interferometer structures, single electron transistors, quantum well and Bloch oscillation transistor devices according to prior art specifications. Attachment of objects to device 128 can be done in a spatially selective way by means comprising chemical functionalization, electron beam deposition, ion beam deposition. Chemical means for attachment can be fixed or reversible linkers.

FIG. 11 shows a quad spanned junction region 5 where a square corral structure is created by spanning nanoscale-objects 158,159,160 and 161 between cantilevers 54,55,56 and 57. These spanning structures can be a mixture of insulating, normal metal, semiconducting or superconducting. The tips 1,2,3 and 4 have a nanoscale space in the center of the corral which is preferably an equilibrium spacing of 25nm between respective opposing tip when the comb drive actuators 62,63,64,65, 66,67,68,69,42,43,44,45,86,87,88,89 and z axis capacitors 114,115,116,117,118,119,120 and 121 are not charged.

Suitable reactive functional groups useful for formation of the tip and substrate reversible linker group include, but are not to limited to, biotin, nitrolotriacetic acid, ferrocene, disulfide, N-hydroxysuccinimide, epoxy, ether, Schiff base compounds, activated hydroxyl, imidoester, bromoacetyl, iodoacetyl, activated carboxyl, amide, hydrazide, aziridine, trifluoromethyldiaziridine, pyridyldisulfide, N-acyl-imidazole,isocyanate, imidazolecarbamate, haloacetyl, fluorobenzene, arylazide, benzophenone, anhydride, diazoacetate, isothiocyanate and succinimidylcarbonate. The compounds terpyridine, iminodiacetic acid, bipyridine, triethylenetetraamine, biethylene triamine and molecular derivatives of these compounds or molecules capable of performing their chelation functions are preferred candidate linker compounds. Various art recognized coupling and cleaving reaction conditions for linkers which optimize the synthesis yield will be obvious to one knowledgeable in chemical synthesis. Prior art chemical means useful in functionalizing the device 128 can be found in U.S. Pat. No. 6,472,184 Bandab, U.S. Pat. No. 6,927,029, U.S. Pat. No. 6,849,397, U.S. Pat. No. 6,677,163, U.S. Pat. No. 6,682,942.

Suitable reactive functional groups useful for formation of the 324 reversible linker group include, but are not to limited to, biotin, nitrolotriacetic acid, ferrocene, disulfide, N-hydroxysuccinimide, epoxy, ether, Schiff base compounds, activated hydroxyl, imidoester, bromoacetyl, iodoacetyl, activated carboxyl, amide, hydrazide, aziridine, trifluoromethyldiaziridine, pyridyldisulfide, N-acyl-imidazole,isocyanate, imidazolecarbamate, haloacetyl, fluorobenzene, diene, dienophile, arylazide, benzophenone, anhydride, diazoacetate, isothiocyanate and succinimidylcarbonate, nitrilotriacetic acid, terpyridine, iminodiacetic acid, bipyridine, triethylenetetraamine, biethylene triamine and molecular derivatives of these compounds or molecules capable of performing their chelation functions are preferred.

Various art recognized coupling and cleaving reaction conditions for linker 324 formation which optimize the synthesis yield will be obvious to one knowledgeable in chemical synthesis. In particular reversible linker chemistries are particularly valuable in the present invention.

Linker 324 can function as a probe to interactions between it and sample material 269. If linker 324 has a nucleotide attached to it can be linked to tips 1,2,3,4,122,123,124 and 125 and used to map the material 269.

The functionalization of surfaces and attachment of moieties which one wishes to bind to the surface are facilitated by metal ion complexes. The bonding interaction between complexes is provided by organic molecules and or polypeptides which have chelation affinity to metal ions in specific oxidation states. A chelating agent functionalized surface and a labeled molecule which one wishes to attach to that surface can be made to bond in a kinetically labile state and then switched to a kinetically inert state by oxidizing the metal linking the surface and labeled molecule. The release of the labeled molecule is effected by reduction or oxidation of the metal ion in the complex.

Prior art citations useful in the chemical linking via ion chelation reversible groups can be found in U.S. Pat. Nos. 6,919,333 and 5,439,829.

The modulation of the bonding between chelation susceptible groups by changes in oxidation state of the transition metal in the object to surface linker complex provides a means of cyclically transferring objects like 269 between sample substrate surfaces and tips 1,2,3,4,122,123,124 and 125 in the instant invention. The instant invention provides nascent compounds of the formula:
[NObj-(spacer).sub.x-chelator].sub.n(M)

Where:

The “spacer” is a polymer or dendrimer composed of monomer units preferably polyacrylamide, polypeptide, polynucleotide, polysaccharide or other organic molecule monomers compatible with the chemical coupling methods.

The “chelator” is an organic chelating moiety or polypeptide,

The “M” is a transition metal ion which can form kinetically inert transition metal ion complexes and is in an oxidation state where its bonding is a kinetically inert state.

The “NObj” is a nascent object which may serve as a polymer initiator or be a nascent polymer, object, complex, or nanoassembly.

n=1 or greater

x=0 or 1

where each of the [NObj-(spacer).sub.x-chelator] units composed of the same materials or of different composition.

The reversible bonding linkers for chelation mechanisms may be composed of compounds of the following formula:
NObj-(spacer.sub.1.).sub.x-chelator.sub.1-(M)-chelator.sub. 2-(spacer.sub.2).sub.y].sub.n-Solid Support Substrate

The solid support substrate may be a solid material such as glass, silicon, metal or a multilayer composite structure. Self assembled monolayers are additionally preferred coatings on the solid support substrate which may serve as pattern forming layers.

where:

x=0 or 1

y=0 or 1

n=the number of units bound to the solid phase support.

The transition metal ions used to form chelation complexes in the instant invention include Ru(II), Ir(III), Fe(II), Ni(II), V(II), Cr(III), Mn(IV), Pd(IV), Os(H), Pt(IV), Co(III) or Rh(III). The most suitable ions being Cr(III), Co(III) or Ru(II). Of these preferred ions Co(III) and Ni(II) are the most preferred in the practice of the invention.

The structure of the chemical species composing the ion complex is selected from the group of agents comprising bidentate, tridentate, quadradentate, macrocyclic and tripod lingands. The compounds nitrilotriacetic acid, terpyridine, iminodiacetic acid, bipyridine, triethylenetetraamine, biethylene triamine and molecular derivatives of these compounds or molecules capable of performing their chelation functions are preferred.

FIG. 12 is an embodiment of the present invention where a quad tip MEMS/NEMS device 128 as in FIG. 1 is used in conjunction with a tip pair device 332 comprising 1/2 chip replica of a quad device 128 on a separate chip die substrate. By bisecting the quad device with diamond saw cutting lanes a two tip device with the cantilever tips as in tips 1 and 2 overhang free space and are brought into proximity to a quad tip device 128. The device 332 is mounted on a 6 axis of freedom stage as 126 attached to control circuit 136 under control of computer 139. Device 136 provides stage measurement control as well as measurement and control circuit with substrate bias control circuit.

In this view device 332 is orthogonal to the plane of device 128 seen in figure l. The tips of this particular tip pair device 332 are nanoring 1 probe tip for threading polymers, nanotubes, nanorods, nanosystems, RNA or DNA through 329 and nanoring 2 probe tip for threading polymers, nanotubes, nanorods, nanosystems, RNA or DNA through 330. The nanoring pore structure is preferably 1 to 50 nm in diameter and formed by means comprising electron beam lithography, biomolecule attachment to a nanotube or nanoscale self assembly.

Object 269 is preferably a DNA, RNA or protein molecule threaded through the nanopore tips 329 and 330. The ends or middle of object can be functionalized with chemical linker groups as in 324 and have molecules, nanosphere or microspheres attached to lock it in the threaded state as depicted. The tips 1,2,3 and 4 of device 128 are used to scan the molecule 269 being pulled past their interaction region 5. Any three of the tips say 1,2 and 3 can be used to form a three sided channel in which the molecule 269 is drawn through. The fourth tip 4 can be used to open and close the channel during scanning. Dynamic molecular interactions between tips 1,2,3 and 4 can be performed. Functionalization of any or all of the tips 1,2,3,4, 329 and 330 can be used to tune physical properties for sample device interaction modification. Preferably coherent electron interferometry is performed by tips 1,2,3 and 4.

Room temperature scanning tunneling spectroscopy, atomic force microscopy or any type of scanning probe microscopy can be performed and compared with the coherent spectroscopy obtained from the interferometer. Nanomanipulation of the sample 269 is possible in this configuration as well. Transient use of reversible linkers and functionalized materials is made possible by use of disparate reversible linker chemistries. Atomic scale assembly is also possible using the depicted topology. Genetic algorithm search and assembly methods using molecular simulation and assembly in the interaction region 5 is a preferred use for the interfaced computer 139, sample substrate library and loading mechanism 140, Sample and MEMS substrate library loading and chemical treatment control circuitry 141, Sample substrate chemical treatment mechanism 142 driven by results from the genetic algorithm in FIG. 10. Preferably one or more of tips 1,2,3,4, 329 and 330 are functionalized with ATC and G nucleotide containing monomers, dimers, oligomers, polymers or analogs of these compounds. Also amino acids and peptides can be attached.

The object 269 can be an polynucleotide, enzyme, enzyme complex or polynucleotide-enzyme complex. In addition, any type of label can be used both fluorescent labels and beacons can be attached to monitor interactions in region 5 between tips and substrate an well as intra structural interactions on the substrate. Preferably nanoparticles are used in the previous described faculty in particular embodiments using quantum dots are preferred. Preferably the device depicted in FIG. 12 can be placed in an electron microscope to further visualize materials in region 5. Preferably the deposition is from gas or liquid phase material substances delivered by software control from computer 139, sample substrate library and loading mechanism 140, Sample and MEMS substrate library loading and chemical treatment control circuitry 141. Solid phase transfer or absorbate reactions of material via probe tips 1,2,3,4 329 and 330 is possible using this topology.

FIG. 13 depicts a quad tip junction of the flexible gap junction MEMS/NEMS device where tips 1,2,3 and 4 are interconnected via flexible nanotubes spanning cables 158,159,160 and 161. The interconnection tubes and probe tips 1,2,3 and 4 are interconnected by diagonal spanning nanostructures 170 and 171 which connect junctions 162,163,164 and 165 to form a micron to nanoscale mesoscopic interferometer in region 5 of the flexible gap junction device 128. The region 5 where tips 1,2,3 and 4 overlap is preferably driven by capacitive comb drives 62,63,64,65, 66,67,68,69,42,43,44,45,86,87,88,89 and z axis capacitors 114,115,116,117,118,119,120 and 121 to form a nanopore. The nanopore is chemically functionalized with atomic or molecular materials. Scanning of DNA and RNA and protein interactions can be studied and mapped using the devices of these figures.

The tip 1,2,3 and 4 formed pore in the center of region 5 and spanning structures 158,159,160 and 161 can be functionalized by chemical reactions with STM electrochemical means or optical means. Dithering and vibrating the tips of the nanopore can be used to modulate the size of the nanopore. These diagonal spanning wires are preferably made from superconductive, normal metals or semiconductors. By application of flexure forces by capacitive comb drives 62,63,64,65, 66,67,68,69,42,43,44,45,86,87,88,89 and z axis capacitors 114,115,116,117,118,119,120 and 121 a space between spanning structures 170 and 171 can be opened and closed. The structures 170 and 171 as well as structures 158,159,160 and 161 are chemically functionalized as the above structures in the descriptions above state. In addition the structure 159 has a gap in it which can be chemically or mechanically opened and closed to.

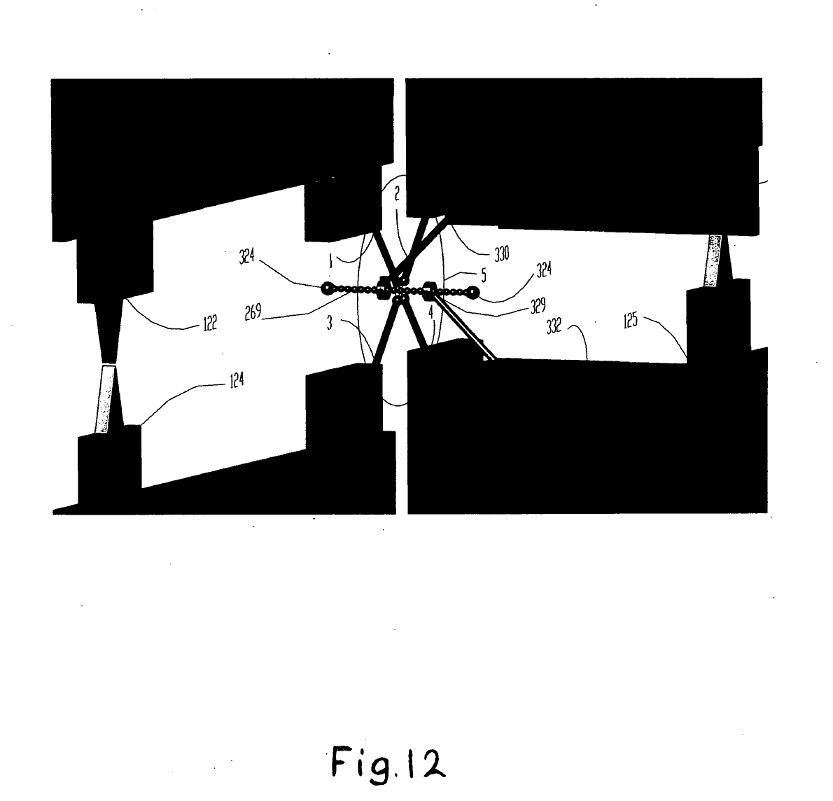

FIG. 14 depicts a preferred embodiment of operation where three of the tips out of 1,2,3 and 4 are contacted or brought into close nanoscale proximity and the one of the four is retracted to form a three sided channel in the region 5. This channel can be used for scanning polymer molecules and forming a tunable nanopocket. Additional MEMS/NEMS devices 128 can be used to probe samples and move samples through the three sided nanopocket region 5 as a means for scanning and mapping molecules and nanosystems. Preferably RNA and DNA are pulled through the nanopocket device. The corral structure formed by spanning structures 158,159,160 and 161 is in place in this embodiment and has a bisecting gap in spanning nanoscale object 158 is a means for mechanically or chemically opening and closing gap in flexible corral spanning gap structure 331. The corral structure can also be formed by polymers or self assembled molecules that span the cantilevers 54,55,56 and 57 where one or more of the spanning structures is a superconductor or coherent electron conduit for the interferometer structures attached to tips 1,2,3 and 4.

FIG. 15 is an embodiment of the present invention where a quad tip MEMS/NEMS device 128 as in FIG. 1 is used in conjunction with a tip pair device 332 comprising 1/2 chip replica of a quad device 128 on a separate chip die substrate as in FIG. 12 with the addition of a second 1/2 chip replica of a quad device 128 on a separate chip die substrate orthogonal to chip 128 surface in FIG. 1.

The device 332 and 333 are mounted on separate 6 axis of freedom stage as 126 attached to control circuit 136 under control of computer 139. In this view device 332 and 333 is orthogonal to the plane of device 128 as seen in FIG. 1. The tips MEMS/NEMS device 332 are dual separate 1/2 quad chip tip pair nanoring 1 probe tip labeled 329 for threading object 269 (polymers, nanotubes, nanorods, nanosystems, RNA or DNA) and nanoring 2 probe tip labeled 330 for threading polymers, nanotubes, nanorods, nanosystems, RNA or DNA through region 5.

The tips of the second 1/2 quad dual pair 333 are nanoring probe tip 3 labeled 334 for threading polymers, nanotubes, nanorods, nanosystems, RNA or DNA and nanoring 4 probe tip labeled 335 for threading polymers, nanotubes, nanorods, nanosystems, RNA or DNA through interaction region 5. The nanoring pore structure is preferably 1 to 50 nm in diameter and formed by means comprising electron beam lithography, biomolecule attachment (modified clamp ring from DNA replication complex, porin, topoisomerase or other proteins) or a nanotube or nanoscale self assembly.

Object 269 is preferably nanomaterial, DNA, RNA or protein molecule threaded through the nanopore tips 329, 330, 334 and 335. The ends or middle of object 269 can be functionalized with chemical linker groups as in 324 and have molecules, nanosphere or microspheres attached to lock it in the threaded state as depicted. The tips 1,2,3 and 4 of device 128 are used to scan the molecule 269 being pulled past their interaction region 5. Any three of the tips say 1,2 and 3 can be used to form a three sided channel in which the molecule 269 is drawn through. The fourth tip 4 can be used to open and close the channel during scanning. Dynamic molecular interactions between tips 1,2,3 and 4 can be performed. Functionalization of any or all of the tips 1,2,3,4, 329,330,334 and 335 can be for synthesis and used to tune physical properties for sample device interaction modification. Preferably coherent electron interferometry is performed by tips 1,2,3 and 4 as described above. Room temperature scanning tunneling spectroscopy, atomic force microscopy or any type of scanning probe microscopy can be performed and compared with the coherent spectroscopy obtained from the interferometer. Nanomanipulation of the sample 269 is possible in this configuration as well.

In particular objects threading the nanoring tips can be rotated by coordinated force application using tips 1,2,3 and 4. Nanoring structures 329, 330, 334 and 335 can act as bushings for rotational motion of object 269 during scanning or fabrication processes. In preferred embodiments of nanomanipulation object 269 is a ring structure with a reversible clasp used to form a open or closed ring threading 329, 330, 334 and 335. Application of pinching tweezer forces with tips 1,2,3 and 4 and coordinated Z axis motion (with respect to tips 1,2,3 and 4 in FIG. 1) the ring embodiment of object 269 can be continuously circulated in either forward or reverse direction through nanorings 329, 330, 334 and 335.

Transient use of reversible linkers and functionalized materials is made possible by use of disparate reversible linker chemistries. Atomic scale assembly is also possible using the depicted topology. Artificial intelligence algorithm search and assembly methods using molecular simulation and assembly in the interaction region 5 is a preferred use for the interfaced computer 139, sample substrate library and loading mechanism 140, Sample and MEMS substrate library loading and chemical treatment control circuitry 141, Sample substrate chemical treatment mechanism 142 driven by results from the genetic algorithm in FIG. 10 or any other artificial intelligence means.

Preferably one or more of tips 1,2,3,4, 329 and 330 are functionalized with ATC and G nucleotide containing monomers, dimers, oligomers, polymers or analogs of these compounds. Also amino acids and peptides can be attached. The object 269 can be an polynucleotide, enzyme, enzyme complex or polynucleotide-enzyme complex. In addition any type of label can be used but fluorescent labels and beacons can be attached to monitor interactions in region 5. Preferably nanoparticles are used in the previous faculty in particular quantum dots. Preferably the device depicted in FIG. 12 can be placed in an electron microscope to further visualize materials in region 5. The object 269 can be a nanotube or nanorod used as an assembly substrate where tips 1,2,3,4, 329,330,334 and 335 are used for atomic or molecular deposition of material.

Preferably the deposition is from gas or liquid phase material substances delivered by software control from computer 139, sample substrate library and loading mechanism 140, Sample and MEMS substrate library loading and chemical treatment control circuitry 141. Electron beam deposition, laser irradiation, electrochemical modification and focused ion beam milling can be used to deposit, crosslink, mill and process object 269. In preferred uses for the above embodiment the interaction region 5 is used as a means to manipulate systems comprising replication forks of nucleotide polymers and genes of DNA, Holiday junctions in recombination, characterize Ribosome's, RNA processing and nanosystems. Polymerase chain reaction, Ligase chain reaction and other enzyme based nucleotide and peptide synthesis systems can be arranged on tips 1,2,3,4, 329,330,334 and 335 and the nanopores formed by the computer 139 driven interaction of these functionalized tips.

Preferably tips 1,2,3,4, 329,330,334 and 335 have enzymes, templates and possibly even monomer substrates attached to them. Enzyme reaction rates can be studied achieved by attaching biomolecule enzymes to tips 1,2,3,4, 329,330,334 and 335 and dispensing enzyme substrates using devices 128, 333 and 333 with the processing means as in FIG. 3 where computer 139, sample substrate library and loading mechanism 140, Sample and MEMS substrate library loading and chemical treatment control circuitry 141 systems carry out software mediated synthesis treatments and measurement steps.

Tips 1,2,3,4, 329,330,334 and 335 can have catalytic nanoparticles at the apex so that specific chemical reactions can be driven to completion during the above synthesis and nanomanipulation processes. The nanopocket formed by the interaction of tips 1,2,3,4, 329,330,334 and 335 can be a dual purpose nanoscale chemical factory and scanning probe microscopy station. Combinatorial arrays of chemicals and SELEX and SELEX like chemical reactions can be used in conjunction with the embodiments of FIGS. 3,15, 31 and 41.

The tip mounted Josephson junctions 162,163,164,165,166,167,168 and 169 can be wired together in preferred embodiments by spanning objects 158,159,160 and 161 to form high frequency coherent electron circuits on the flexible gap scanner MEMS/NENM device 128.

FIG. 16 depicts an alternate circuit wiring for the region 5 where the conduction lines to Probes 1 and 3 are wired together via flexible spring structure conduit 110, junction structure 172, coherent electron junction 173, spring connected together via each flexible spring conduit 112.

Probes 3 and 4 are wired together via flexible spring structure conduit 34, junction structure 36, coherent electron junction 37, spring connected together via each flexible spring conduit 35.

Probes 4 and 2 are wired together via flexible spring structure conduit 113, junction structure 178, coherent electron junction 179, spring connected together via each flexible spring conduit 111.

Probes 1 and 2 are wired together via flexible spring structure conduit 19, junction structure 20, coherent electron junction 21, spring connected together via each flexible spring conduit 18.

The tip connections are routed in the embodiment of the FIG. 16 to connect to coherent junctions of flexible gap junction tips 1,2,3 and 4 which occurs via flexible spring conductor structures 18,19,34,35,110,111,112 and 113 to interferometer junctions 21,37, 173 and 179 respectively. This arrangement can be used to cause feedback interactions between the between tip junctions 1-2, 1-3, 2-4, 3-4 and coherent electron junctions 21,37, 173 and 179 as samples are scanned. Modulation of tip 1,2,3 and 4 by application of flexure forces by capacitive comb drives 62,63,64,65, 66,67,68,69,42,43,44,45,86,87,88,89 and z axis capacitors 114,115,116,117,118,119,120 and 121 can be driven by computer 139 in closed loop feedback to generate tuning of said flexible junctions as a sample 269 is scanned by tips 1,2,3 and 4. An alternate embodiment is to wire the interferometers as above but to include tips 122,123,124 and 125 for tunneling feedback interaction on separate channels from the interference signals generated by junctions 21,37, 173 and 179 respectively. Multiple channels of optical interferometry are used for tracking tip displacement according to FIG. 29.

Flexible Gap Tip Scanning Sample on the Same Surface Substrate as Scanner:

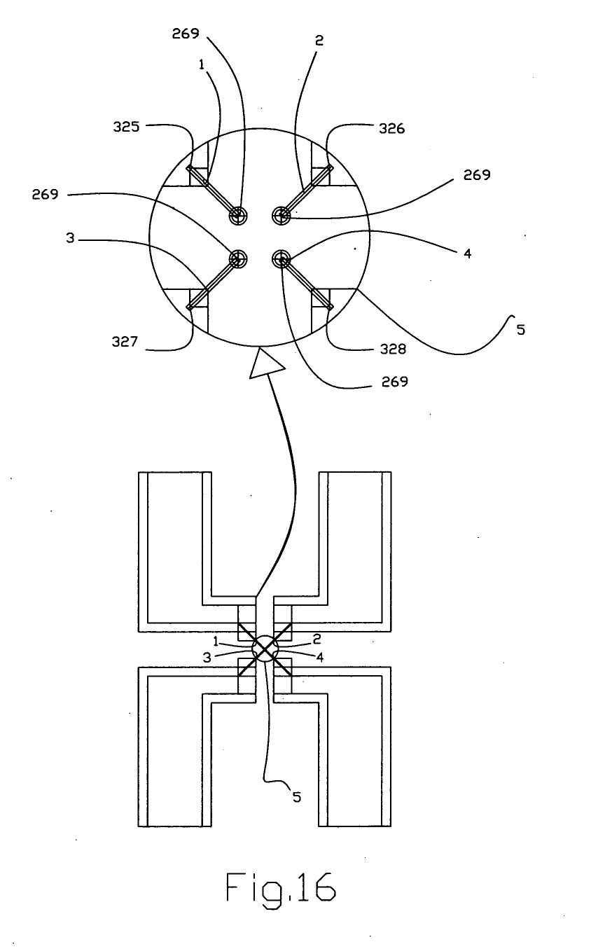

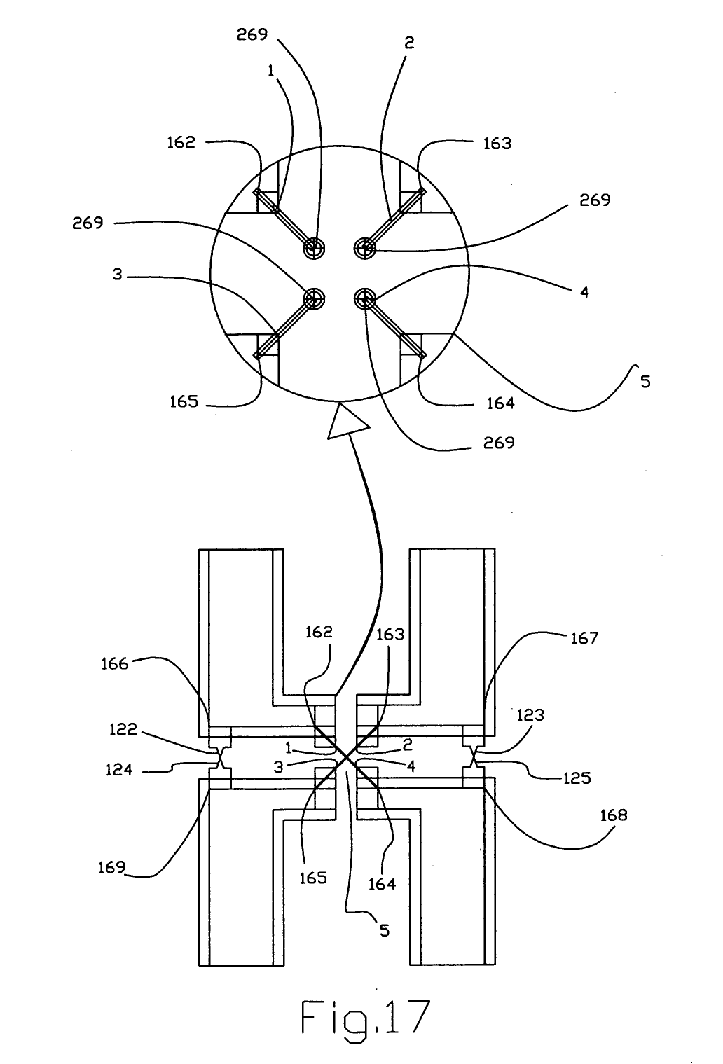

FIG. 17

claim 102 describes an embodiment of the MEMS/NEMS device of the instant invention where a sample substrate area 127 to be scanned is attached to a surface on the same substrate as the scanner tip. FIG. 17 shows an embodiment of a quad tip device where the sample substrate area 127 scanned by tip 1 is located on the same substrate as the MEMS/NEMS device as the tip 1. In this embodiment sample substrate area 188 is placed where tip 2 would be or is tip 2 with a sample 269 attached and is an integral part of the interferometer in area 148 being connected to coherent electron junction 21 via conduits 18 and 19 seen in FIG. 1. When the sample is placed on the opposing electrode of the quantum interferometer the device references the electrode and sample states during scanning. Preferably the surface of 127 is coated with a material such as gold which can be functionalized with linker molecules and biomolecules such as proteins, DNA and RNA can be attached to surface 127 and scanned. Thin layers of normal conductors on superconductors have a proximity superconductive current which can be used for interferometer SQUID operation. Gold also inhibits oxidation of Niobium if it is used as the SQUID superconductor top layer coating material. Carbon nanotubes, YBCO high temperature superconductor or long coherence normal metal mesoscopic interferometers made from metal such as Aluminum or Silver can be coated with linker chemistry metals such as gold to form the flexible gap scanner interferometer. Data recording feature 323 on sample substrate 188 can be used to store information on the substrate.

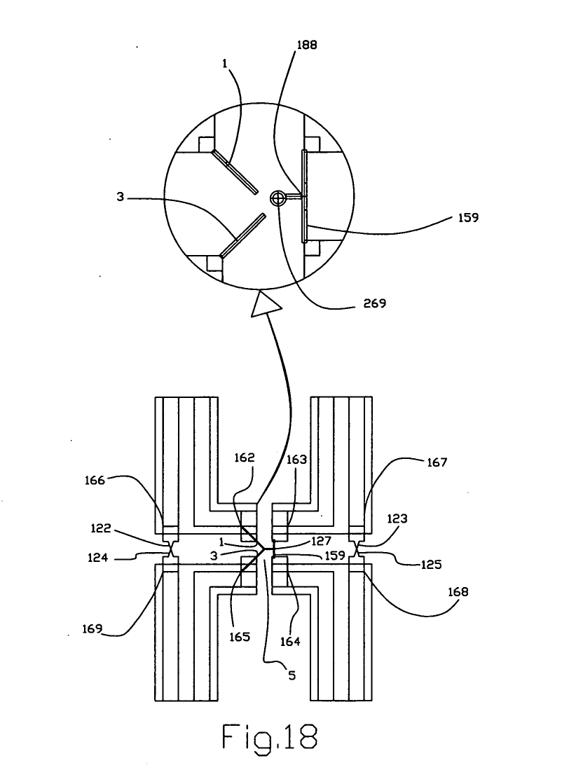

FIG. 18 depicts a further embodiment where scanned object 269 is attached to a spanning nanostructure 159 which spans cantilever 55 and 57 and interconnects coherent electron junctions 20 and 37. The sample substrate 188 is attached to spanning structure 159. The scanned object 269 is attached to 188 and is scanned by tips 1 and 3. Tips 1 and 3 can either be operated independently as separate SPM for imaging and nanomanipulation or they can be wired together as an interferometers as follows.

Tips 1 and 3 are wired together via flexible spring structure conduit 110, junction structure 172, coherent electron junction 173 and via flexible spring conduit 112.

Tip 3 and 4 are wired together via flexible spring structure conduit 34, junction structure 36, coherent electron junction 37, and via spring conduit 35.

Tip 4 and 2 are wired together via flexible spring structure conduit 113, junction structure 178, coherent electron junction 179,and via flexible spring conduit 111.

Tip 1 and 2 together are wired together via flexible spring structure conduit 19, junction structure 20, coherent electron junction 21,and via flexible spring conduit 18.

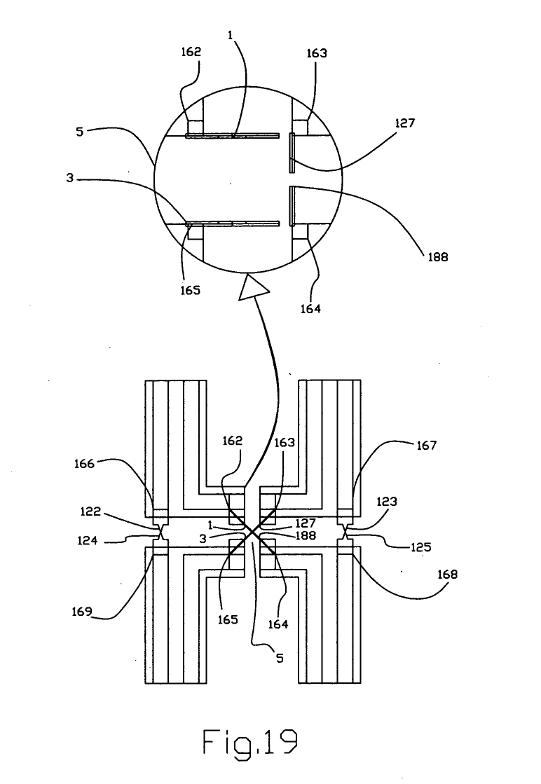

FIG. 19 represents an embodiment where the flexible gap interferometer has Josephson junctions 162,163,164,165,166,167,168 and 169 at the tip interaction region 5 and the sample substrate 127 and a second sample substrate deposition or fabrication area 188 are located on one of the flexible gap cantilever tips 1,2,3 or 4. Alternately the sample substrate may be any or all of the tips 1,2,3 or 4 or coherent electron junctions 162,163,164,165,166,167,168 and 169 as material sample 269 can be attached to any of these locations and scanned. Transfer of materials such as 269 deposited on either circuit electrode sample area allows for interaction and sorting of materials on these surfaces. Alternate tip geometries will be obvious to one skilled in the art.

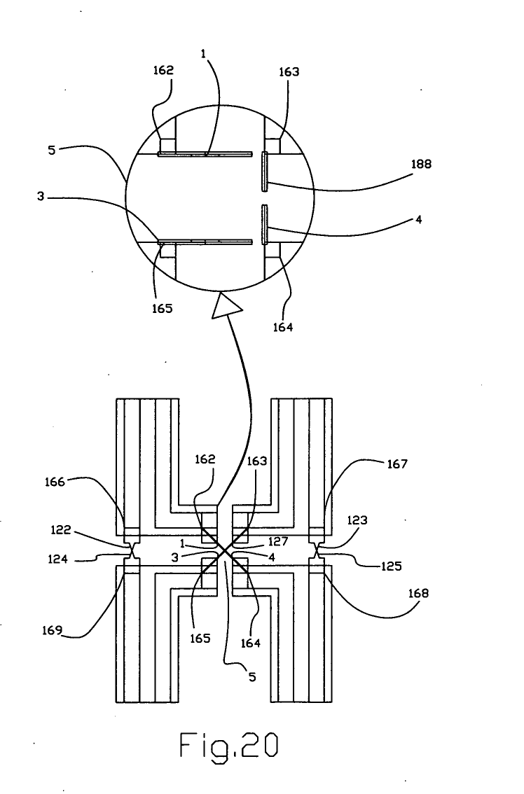

FIG. 20 represents an embodiment where the flexible gap interferometer has Josephson junctions 162,163,164,165,166,167,168 and 169 at the tip interaction region 5 and the sample substrate 188 is located on one of the flexible gap cantilever tips 1,2,3 or 4. Alternately the sample substrate 127 or 188 which has sample material 269 attached may be any or all of the tips 1,2,3 or 4 or junctions 162,163,164,165,166,167,168 and 169 during operation of a particular device or in specific embodiments.

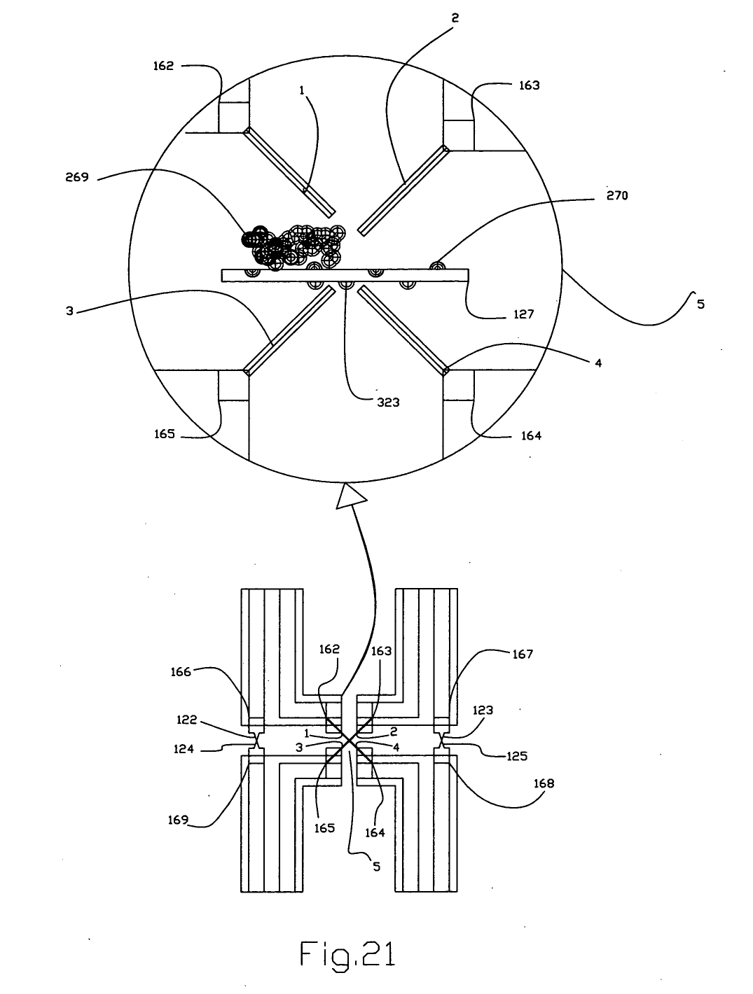

FIG. 21 represents an embodiment where a sample substrate 127 has marker features 270 on the surface to which sample object 269 is attached to or is in proximity with. These marker features are preferably nanoparticles deposited or nucleated on an atomically flat surface. Alternately a scanning probe microscope such as a STM can be used to mark a surface 127 to produce tracking marks. Alternately a crystal with a nanoscopic repeated pattern which can be used as a tracking structure 270 when samples such as 269 are attached to 127. The marker features can be on one or both sides of surface 127. Alternately the marker features 270 comprising a supperlattice structures deposited by molecular beam epitaxy or similar means. The FIG. 21 also features data recording mark 323. This data mark can be formed by any art recognized means but is preferably erasable and of nanometer scale. Preferably the mark 323 is produced by tips 3 or 4. Multiple data marks can be used to write information on the sample substrate 127 or 188. The surface of 127 or 188 can have multilayer films deposited so as to provide optimal chemical and electronic properties for data storage. Though data mark 323 is shown as a bump it can be a dimple or a modification in the local chemical or physical properties of surface 127 or 188. In addition it can be on any surface of 127, 188 or on a proximal surface to these.

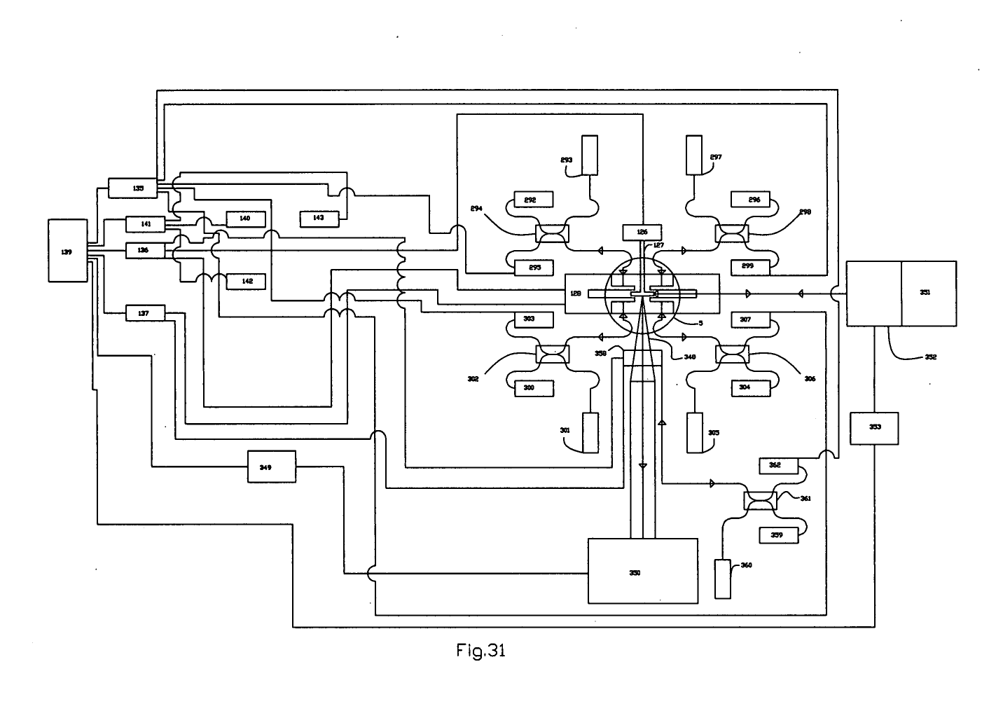

FIG. 22 represents an embodiment of the present invention as in FIG. 21 but where the sample substrate 127 is connected to a single mode optical fiber. The optical fiber is preferably attached any of the following detection means comprising, an interferometer as in FIG. 29, a Raman spectrometer as in FIG. 31 or a fluorescence spectrometer. Commercial near field scanning optical microscopy (NSOM with Raman capabilities can be attached to the present invention object 128 with the SAP embodiment in FIG. 31 where preferably a device comprising a device such as a Nanonics MultiView system with the Renishaw RM Series Raman Microscope for high-resolution Raman spectroscopy. Prior art feedback and optical sample interaction means known in the art can be used to control and manipulate materials on optically interfaced embodiment of sample 127.

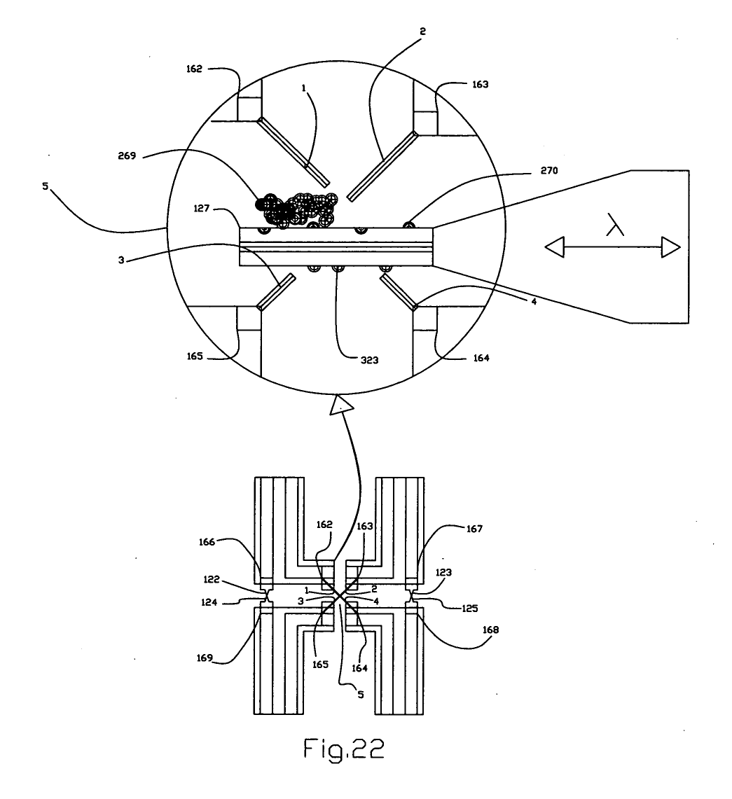

FIG. 23 represents an embodiment where a sample substrate 188 has marker features 270 on the surface to which sample object 269 is attached to or in proximity with. These marker features are preferably nanoparticles deposited or nucleated on an atomically flat surface. Alternately a scanning probe microscope such as a STM can be used to mark a surface 188 to produce tracking marks. Alternately a crystal with a nanoscopic repeated pattern which can be used as a tracking structure 270 when samples such as 269 are attached to 188. The marker features can be on one or both sides of surface 188. Alternately the marker features 270 are supperlattice structures deposited by molecular beam epitaxy or similar means or nanoparticles with universal or site specific linker groups.

In a preferred embodiment sample material objects such as 269 can be passed from surface region 127 to 188 or inversely from 188 to 127. Preferably combinatorial chemical synthesis of proteins and nucleotide polymer arrays can be used with the instant invention and form materials on sample substrates 127 and 188. Arrays can be synthesized by art recognized means cited below.

In a preferred embodiment the protective group on the nucleotide monomer units of the polymer synthesis carried out on the sample substrate are nucleotide carbonate protection groups as in U.S. Pat. No. 6,222,030. The advantage to using carbonate protecting groups is that the deprotection step and oxidation of the phosphate group occurs in a single chemical reaction.

In preferred embodiments photochemically or electrochemically generated nucleotide polymers such as DNA and RNA are synthesized by generated reagents of compounds such as in U.S. Pat. No. (6,426,184). In alternately preferred embodiments the nucleotide synthesis is carried out by an electrochemically generated species of compound as in U.S. Pat. No. (6,280,595) or modified phosphoramidite solid phase synthesis can be used as a means to establish site specific synthesis of oligonucleotide. Alternately U.S. Pat. Nos. (6,239,273), (5,510,270) and (6,291,183) are prior art references useful in the fabrication of polymers on locations of a substrate and are incorporated here by reference in there entirety. Peptides and other polymeric materials may complement or substitute for nucleic acid polymers on MEMS/NEMS device 128 or sample substrate 127.

Electrochemical oligonucleotide synthesis methods as in U.S. Pat. No. 6,280,595, photochemical oligonucleotide synthesis methods such as those in prior art reference U.S. Pat. No. 5,510,270 or “Maskless fabrication of light-directed oligonucleotide microarrays using a digital micromirror array” Sangeet Singh-Gasson, Roland D. Green, Yongjian Yue, Clark Nelson, Fred Blattner, Micheal R. Sussman, and Franco Cerrina, Nature Biotechnology. Vol 17, October 1999 are prior art references useful in the fabrication of polymers on locations of a substrate and are incorporated here by reference in there entirety. Preferably SNOM optical lithography and electrochemical STM lithography of peptides and nucleotide molecules is used for high resolution patterning of biomolecules on MEMS/NEMS device 128.

By gating the electrochemical activation of the MEMS electrodes which are to have DNA or RNA polynucleotides spanning the flexible gap junctions of the MEMS device single template molecules can be synthesized or deposited across the flexible gap junctions of the device. These DNA or RNA functionalized flexible gap junctions can be used for various methods and devices.

In Preferred embodiments the single spanning DNA or polymer molecules are used as templates to sputter deposit materials for nanoscale tips or rods spanning the flexible gap junctions. Alternate synthesis methods can be found in the prior art for site specific chemical synthesis and used in the instant invention. Alternate molecules such as PNA and other types of polymers can be synthesized on the surfaces of 127 and 188. Preferably molecular biological arrays and samples from organisms are attached or associated with sample substrate 127 and or 188. The sample and MEMS substrate library loading and chemical treatment control circuitry 141, Sample substrate chemical treatment mechanism 142 and MEMS device SPM/Nanomanipulator chemical treatment mechanism 143 are controlled by computer 139 to generate combinatorial chemical reactions in parallel. These can be used to probe, qualitative and quantitative interaction in chemical and nanoscale systems.

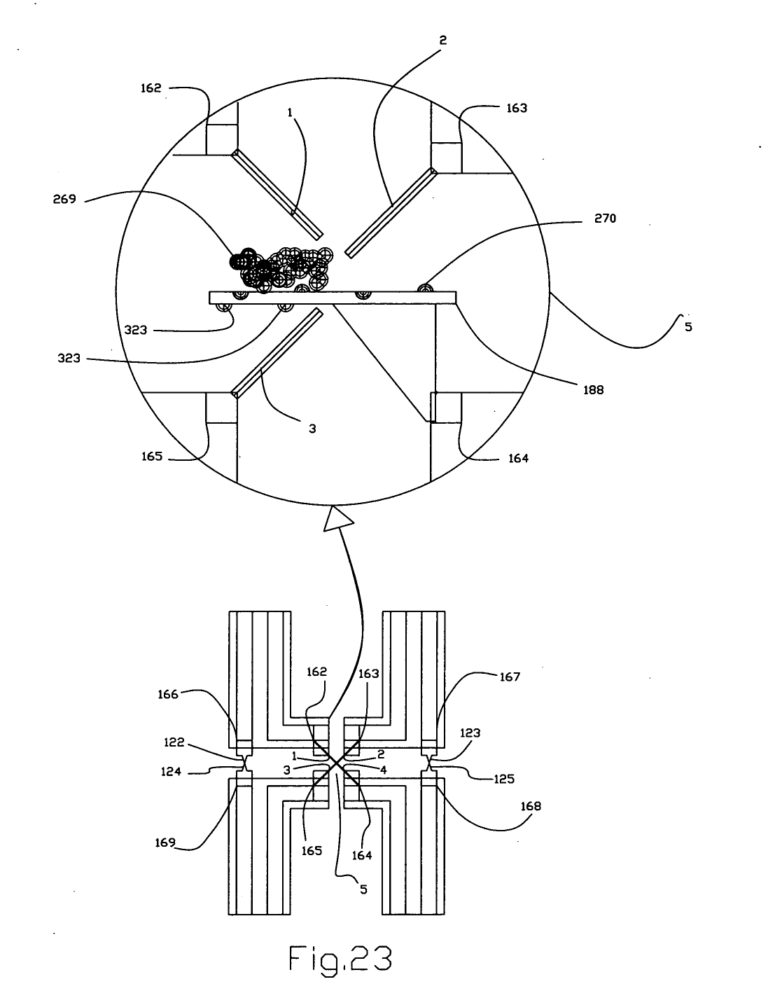

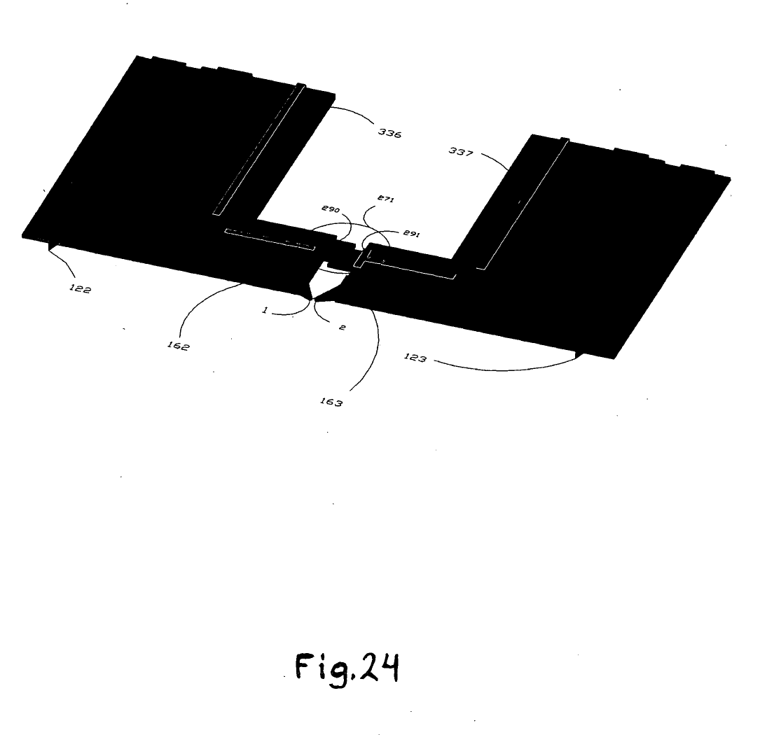

FIG. 24 depicts a close up view of region 5 of an embodiment of the flexible gap junction where the flexible junction cantilever 54 and 55 with the tips 1 and 2 have a large area flexible Josephson junction 272 with upper electrode 290 and lower electrode 291 which act as variable gap flexible tunneling junction interferometer. The tips 122 and 123 are also formed on the large area flexible gap version of this device. The tips 1 and 2 and the large area junction electrodes 290 and 291 are not electrically connected in this embodiment. Samples can be either scanned through the space between the electrodes 290 and 291 or between the tips 1 and 2. This view is of the tip apex region and can be used in a pair or in any number or tips and flexible gap circuits. Simultaneous electron interferometry can be performed using tips 1 and 2 as well as the large area junction 272. The large area junction can be used to detect relative Z axis motion of tips 1 and 2 by monitoring the tunneling current. Vectoring of the cantilevers 54 and 55 in the Z axis can be used to periodically bring the tips 1 and 2 to a set distance then they can be vectored to a specific distance or position for imaging or nanomanipulation. Preferably the large area junctions can be formed first then the nanotube tips 1 and 2 deposited and preferably modified by lithography or electron beam deposition to meet as tweezers at a specific large area flexible gap junction electrode gap distance. Preferably the symmetric quad tip geometry as in the figure is 1 used. Pure tip 1 to tip 2 gap separation motion can be performed and the area of overlap of large area junction 290 and 291 will change in relation to the motion of the tip gap separation. Correlation of the tip 122 to tip 124 and tip 123 to tip 125 can be used as a motion index for multiple axis motion using the large area flexible gap junctions

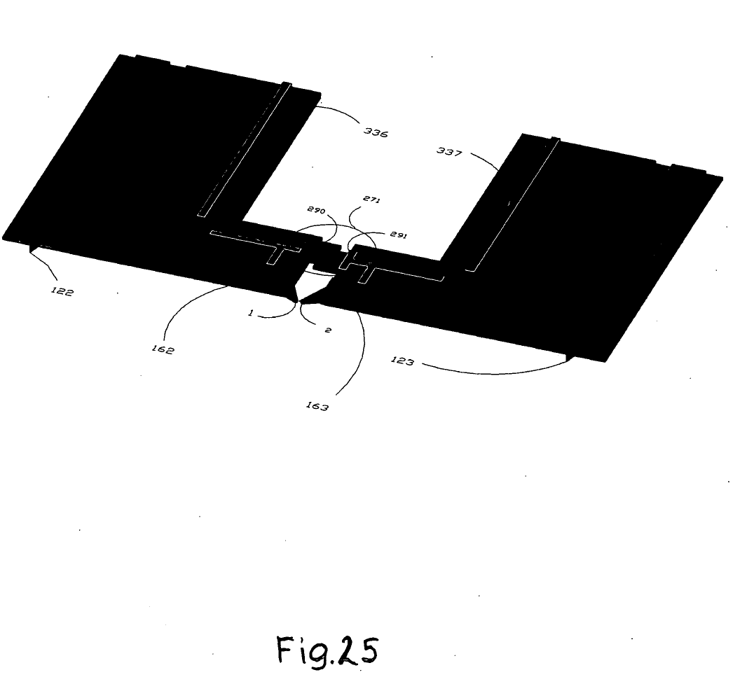

FIG. 25 depicts an embodiment where at least one of the flexible gap junction junctions of device 128 has a larger area than the tip to tip area of the tips extending off of the flexible gap junctions. Said tips are either electrically connected with the large area flexible gap tunneling surface 271 or are insulated from the large area flexible gap junction 271. The large area flexible gap junction 271 connected to local flexible gap junctions 162,163,164,165,166,167,168 and 169. The large area flexible gap junction preferably has an area greater than 1 nmˆ2 and less than 100 umˆ2. Alternately the tips 1,2 and 3 and 4 connected to a flexible gap large area junction such as 271 can be directly attached and not be attached through Josephson junctions 162,163,164,165.

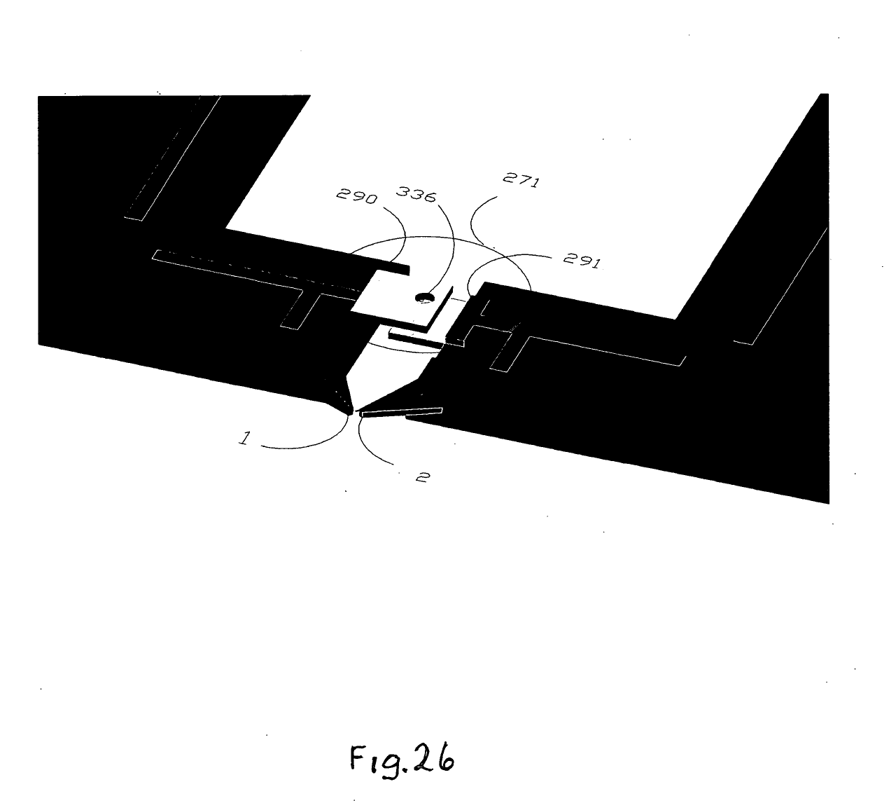

FIG. 26

The above large area structures can have nanopores 336 and 337 etched through then to monitor alignment optically or using electron beam imaging and to thread polymers and nanoscale structures through the pore structure. In preferred embodiments the nanopore on the flexible gap structure is interfaced with a optical waveguide channel of a fiber optic interferometer. The waveguide structure measures flexible gap junction interaction.

FIG. 27

The above large area structures can have nanopores 336 and 337 etched through then to monitor alignment optically or using electron beam imaging and to thread polymers and nanoscale structures through the pore structure. FIG. 27 depicts the large area flexible gap junction without tips attached. In preferred embodiments the nanopore on the flexible gap structure is interfaced with a optical waveguide channel of a fiber optic interferometer. The waveguide structure measures flexible gap junction interactions with materials threaded through the nanopore.

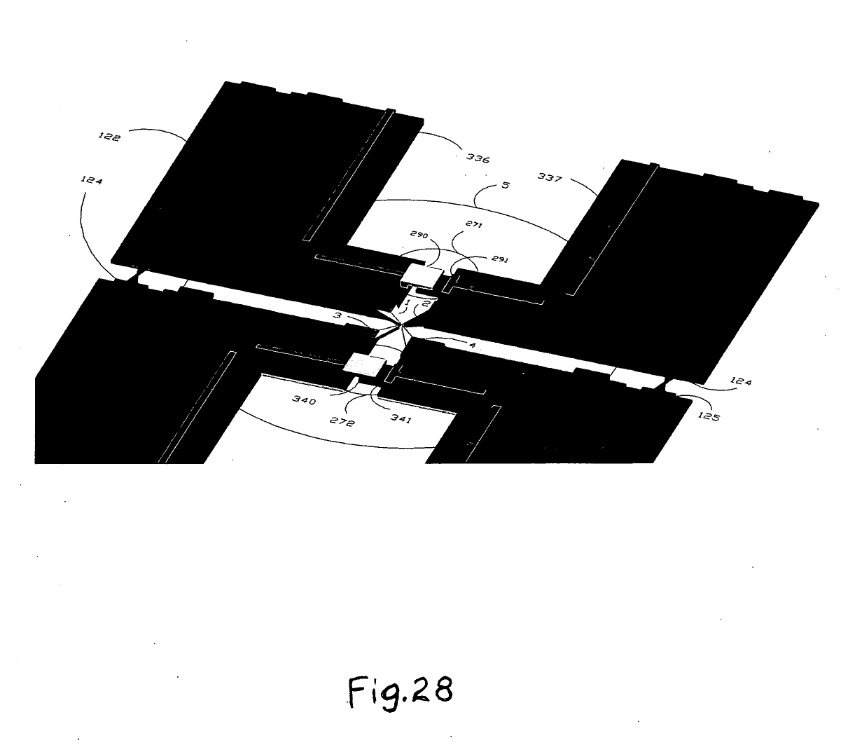

FIG. 28.

Depicts a dual large area flexible gap interferometer scanning probe microscope and nanomanipulator device according the above descriptions. Tips 1 and 3 are connected to coherent electron junction 173 and tips 2 and 4 are connected to coherent electron junction 179. Large area flexible gap junction 272 is connected to coherent electron junction 21 while large area flexible gap junction 273 is connected to coherent electron junction 37.

Ring shaped nanostructures such as those found in “Electrical Transport in Rings of Single-Wall Nanotubes: One-Dimensional Localization”

H. R. Shea, R. Martel, and Ph. Avouris, VOLUME 84, NUMBER 19 PHYSICAL REVIEW LETTERS 8 MAY 2000 can be deposited on the MEMS/NEMS device 123 in the prototyping areas 144,145,146,147, 148,149,150 and 151. In particular connection of nanotube ring structures to the scanner tips in the tip interaction region 5 where tips 1,2,3 and 4 are located. The tip mounted Josephson junctions 162,163,164,165,166,167,168 and 169 can be wired together with ring shaped nanotubes.

FIG. 29 depicts a fiber optic interferometer tip movement measurement embodiment for detection of the flexible gap junction X axis gap tip to tip and tip to sample separation interactions of region 5 tips 1,2,3 and 4. This embodiment of the fiber interferometer interfaces with the sensing and control electronics depicted in FIG. 3 to perform scanning probe microscopy and electron and optical interferometery.

Additional sets of interferometers can be used to monitor the axis of motion. The displacement and force detection scheme for the four tips 1,2,3 and 4 in region 5 of the MEMS/NEMS device 128 in FIG. 30 uses an all fiber low coherence optical interferometer. Four identical channels are depicted for the four tips. In each interferometer a super luminescent laser diode source is coupled to a single mode fiber to illuminate a Michelson interferometer created using a 50/50% fiber coupler. The coupler has a port which is called the control fiber has a polished fiber end which is positioned near the vertical sidewall of one of the tip interaction region 5 of the device 128. The control fiber has a transmittance of 96% and 4% of the light in the fiber is reflected off of the glass-air interface of the polished end and returns back into the coupler. The 96% of the light which exits the fiber reflects off of the SOI sidewall of the tip scanner 128 and some of the beam returns back into the coupler forming a Fabry-Perot interferometer of low finesse. Much of the light reflected back into the fiber and is detected with the detector diode in the other arm of the interferometer. The optional diode detector is used to monitor the intensity fluctuations of the super luminescent diode laser. By monitoring the intensity of the interference fringes the tip vibration amplitude and displacement can be measured. The super luminescent diode has low coherence and eliminates spurious interference signal coming from reflections in the coupler resulting in a very high signal to noise ratio. Lock-in amplification excitation of the interferometer and lock-in detection of the optical output signal allows for amplitude vibration measurements of 200 fm/Hzˆ(½).

Object 292 is a low-coherence super luminescent diode laser (SLD) source with fiber output for tip 1. object 293 is an Optional photodiode attached to the four channel fiber coupler 294 which splits and routes source beam from SLD to the probe and returning beam from probe tip 1 to diode detectors. The interference signal is detected by 295 the photodiode for interferometry detection of tip 1.

Object 296 is a low-coherence super luminescent diode laser (SLD) source with fiber output for tip 3. object 297 is an Optional photodiode attached to the four channel fiber coupler 298 which splits and routes source beam from SLD to the probe and returning beam from probe tip 3 to diode detectors. The interference signal is detected by 299 the photodiode for interferometry detection of tip 3.

Object 300 is a low-coherence super luminescent diode laser (SLD) source with fiber output for tip 2. object 301 is an Optional photodiode attached to the four channel fiber coupler 302 which splits and routes source beam from SLD to the probe and returning beam from probe tip 2 to diode detectors. The interference signal is detected by 303 the photodiode for interferometry detection of tip 2.

Object 304 is a low-coherence super luminescent diode laser (SLD) source with fiber output for tip 4. object 305 is an Optional photodiode attached to the four channel fiber coupler 306 which splits and routes source beam from SLD to the probe and returning beam from probe tip 4 to diode detectors. The interference signal is detected by 307 the photodiode for interferometry detection of tip 4.

The output from these interferometers is detected by interferometer data acquisition and control circuit 135 and processed by computer 139.

In the non-contact mode the tip and cantilever being monitored is vibrated alternately the sample is vibrated. Before the tip approaches the sample or opposing tip the cantilever or tip is excited to one of it's resonant frequencies.

As the tip comes into proximity to the opposing tip or sample the vibration amplitude of vibration detected by the interferometer photodiode output drops sharply as the tip to tip or sample distance drops to the nanometer scale. A set point can be assigned to the oscillation that corresponds to a specific force between the tip and sample or opposing tip. The lock-in detector output of the interferometer measuring the tip vibration is used in a feedback loop to maintain the oscillation at the set point during the sample scanning process. The output of the feedback loop controlling the tip to tip or tip to sample axis motion is used to drive the actuator or actuators generating that axis of motion. This feedback output signal is plotted as a function of sample substrate position to map the atomic force plot of the sample or opposing tip.

By locking the tip to tip or tip to sample distance in and recording the output of the quantum interferometer of the flexible gap junction a coherent electron signal map of the sample or opposing tip can be generated.

In the contact mode the tip to tip or tip to sample distance is zero and the interferometer fiber with the control fiber with polished end is placed at a distance from the sidewall of the cantilever which produces an interferometer signal maxima or minima. As the sample is scanned the tip interacts with surface topography and the cantilever bends proportional to topographic features traversed and interaction forces. The interferometer detects the cantilever deflection and produces a force and or topographic output signal. As the sample substrate 127 or 188 is scanned a proportional integration or phased locked loop can be implemented to keep either the deflection or force between the tip and sample constant by modulating the cantilever actuator. The above fiber optic interferometers and connected to the interferometer detection circuit 135 and interface with the computer 139 as described in above for FIG. 3. It should be noted that an optical lever detection method used in the art of atomic force microscopy can be used for motion detection with interferometry or as an alternative detection means.

Preferably an energy beam source such as an electron beam, ion beam or other device is used to interact with probes of region 5 and sample substrates 127 and 188. Mounting the MEMS/NEMS device 128 and associated systems in a commercial or custom, dual beam electron beam and ion beam system is depicted in rudimentary form by the following objects in FIG. 29.

308. Lens system for focusing energy beam on tips 1,2,3,4,122,123,124,125 and other parts of device 128 surface.

309. Energy beam from device 310 heading to device 128.

310. Means for producing an energy beam of electromagnetic energy, electrons or particles.

FIG. 30 represents an embodiment of the invention where a fixed gap interferometer circuit is attached to a scanning probe tip 347. The lead conduits 345 and 346 attached to tip 347 interconnect with coherent electron junction 173 as seen in FIG. 1. The difference between this embodiment and that seen in FIG. 1 is that the SOI cantilevers 54 and 56 are fused and the space between structures spring and conduit structures 110 and 112 is filled. The scanning probe tip 347 can be operated in a tunneling mode by measuring the current phase and amplitude modulation of the SQUID signal from junction 173. The interaction of tip 347 with sample 269 and substrate 127 or 188 can be measured by biasing sample substrate 127 or 188 and measuring the gating field effect on the phase and amplitude of the coherent electron interferometer circuit.

Alternately the force interactions between tip 347 and sample 269 and substrate 188 can be measured by the effect of flexure of the tip 347 and lead structures 345 and 346 on the phase and amplitude of the coherent electron circuit. Leads 345,346 and tip 347 can be attached to prototyping structures in areas 74,75,76,77, 144,145,146, 147,148,149,150, and 151 for user defined and genetic algorithm derived novel circuits. Tip 347 can be a conductor, insulator semiconductor or a superconductor for SPM applications. The tip 347 can be functionalized with nanoparticle and molecules for specialized tip sample interaction probing.

FIG. 31 represents the Scanning Atom probe (SAP) field ionization scanner microscopy and spectroscopy analysis embodiment of the present scanning probe microscope device. The present coherent electron junction scanner and nanomanipulator can be used as a field evaporation and field ionization probe to generate topographic, spectroscopic and ion mass and charge analysis data from samples on substrate 127 and 188. Illumination of tip-sample and tip-tip junctions with electromagnetic radiation before during or after field evaporation is a useful means for enhancing the characterization method for photon assisted field evaporation. Photoelectrons from the probe tips 1,2,3,4, sample 269 or sample substrate 127 or 188 can be generated by illumination and used to ionize sample material 269. Alternately these photoelectrons can be analyzed directly by the device. In addition to the standard interferometers of FIG. 29 the embodiment of FIG. 31 has an additional interferometer channel and tunneling detector channels for the extractor electrode probe tip 357 used with the nanomanipulator 128 tips 1,2,3 and 4 Thus in addition to the 4 interferometer channels for flexible gap distance monitoring and tip to tip tunneling distance measurement described above there is:

Object 359 is a low-coherence super luminescent diode laser (SLD) source with fiber output for extractor electrode 356 and extractor electrode probe tip 357. object 360 is an Optional photodiode attached to the four channel fiber coupler 361 which splits and routes source beam from SLD to the probe and returning beam from extractor electrode 356 and extractor electrode probe tip 357 to diode detectors. The interference signal is detected by 362 the photodiode for interferometry detection of extractor electrode 356 and extractor electrode probe tip 357. The photodiode output from this and all of the other interferometers is detected by interferometer data acquisition and control circuit 135 and processed by computer 139.

The SLD 359 can preferably be replaced by a tunable laser for near field scanning optical microscopy (NSOM), aperatureless interferometer microscopy or pulsed laser assisted evaporation for scanning atom probe SAP such as the laser 351. Preferably a gated ultra fast pulsed Ti-Sapphire laser, excimer or tunable dye laser is used for excitation of the extractor electrode 356, sample substrate 127, 188 or tips, 1,2,3,4, 357 and interaction region 5. In preferred embodiments extractor electrode 356 is formed with a single mode optical fiber attached for easy alignment and connection of optical I/O.

In other embodiments extractor electrode tip 357 is attached to a flexible cantilever extending off of extractor electrode 356 and the interferometer SLD 359 is used to measure deflection as in an atomic force microscope. The cantilever is coated with a conductor for tunneling, field evaporation and nanomanipulation.

356. Scanning atom probe extractor electrode with scanning probe nanomanipulator attached.

357. Scanning atom probe extractor electrode probe tip.

358. Scanning probe extractor electrode probe closed loop actuator drive and connector to probe tip 357 and extractor electrode with nanomanipulator 356.

Scanning atom probe extractor electrode with scanning probe nanomanipulator attached 356 has an embodiment where the Scanning atom probe extractor electrode probe tip 357 is used as a nanomanipulator and SPM tip in conjunction with tips 1,2,3 and 4. The extractor probe tip is preferably attached to a closed loop actuator for sub-nanometer resolution actuation in concert with tips 1,2,3 and 4. Scanning probe extractor electrode probe closed loop actuator drive 358 provides motion control and a connector to probe tip 357 and extractor electrode with nanomanipulator 356. The nanoprobe attached to the extractor electrode is measured and integrated with the actuation and control circuits connected to the XYZ Sample substrate stage and MEMS actuator measurement and control circuit 136 and controlled by computer 139 as seen in FIG. 31. The tunneling current sensor 137 is also attached to the nanoprobe of extractor electrode tip 357 via closed loop extractor electrode actuator drive 358. This tunneling sensing allows for concerted coordination of tip 357 with tips 1,2,3 and 4 by computer 139.

Multiple wavelength pulse laser excitation of the multiple tip by Pulsed ultrafast laser 351 is a preferred embodiment of the present invention which can be used in conjunction with SAP analysis apparatus 348,349 and 350. Preferably mass spectrometer 350 is a reflection type device but any type can be used depending upon desired resolution. The SAP causes of ionized sample or substrate material 127,188 or 269 that is generated by pumping radiation and electrical pulses. The tip-tip between tips 1,2,3 and 4 of previous figures of the multiple tip nanomanipulator can be used to pickup and ionize material 269 from surface 127 and 188 in a further development of the preferred embodiment. Conventional masking and milling steps used in prior art SAP extractor electrode fabrication U.S. Pat. No. 6,797,952 and MEMS/NEMS fabrication prior art cited above can be used to form multiple field evaporation tip structures on a sample substrate 127 or 188. but the advantage of the present invention is that the sample substrate 127 or 188 can be flat and the means comprising multiple tip, dual tip or quad tip MEMS/NEMS device 128.

The Scanning Atom Prone extractor electrode can be one of the tips 1,2,3 or 4. Alternately multiple extractor electrodes can be fabricated and used on the device 128 MEMS/NEMS SOI substrate by means comprising focused ion beam milling. The extractor electrode 348 can be fabricated or used as a sample substrate 127 or 188 alternately. Alternately the nanoring probe tips depicted in FIG. 15 with nanoring probe tips 329,330,334 and 335 can be used as extractor electrodes for field evaporation to inject ions into the mass spectroscopy analyzer 350. Preferably the field ionization process is assisted by optical excitation of any of the sample 269, substrates 127 or 188 or the tips 1,2,3,4,329,330,334 or 335. Preferably two or more of the tips are functionalized with materials with different work functions for photoelectron excitation and a selective wavelength specific pulse is used to select individual electrodes for excitation. Alternately quantum dot or plasmon resonance particles can be used to selectively excite tips of the MEMS/NEMS device 128 in conjunction with pulse excitation of the field evaporation extraction electrode 348. Introduction of helium gas into the chamber can be used for field ion microscopy in conjunction with field emission microscopy using electrons field emitted from the tip structures 1,2,3,4 and 357.

Preferably the extractor 348 is fabricated by micromachining and is independent from the MEMS/NEMS device 128. The extractor electrode is preferably attached to a multiple axis translation stage with nanometer resolution with 2 or more extraction positions with respect to device 128. The extractor electrode can further have a optical waveguide integrated or associated with it for optical excitation of the extractor aperture region for detection or excitation. This is used to excite material structures in region 5 and alternately excite species of ions being injected into mass analysis device 350 for optical fragmentation or excitation.

348. Scanning Atom Probe (SAP) Extractor electrode.

349. Scanning Atom Probe spectroscopy electronics

350. Mass Spectrometer device

351. Pulsed ultrafast laser.

352. Raman Spectrometer.

353. Raman Spectrometer Electronics

Transfer from sample substrate 127 or 188 to tips 1,2,3 and 4 then ionization is an alternate embodiment where atomic and molecular differentiation of surface species and tomography can be carried out using the present coherent electron interferometer device invention. Details of the methods useful for this can be found in prior art reference U.S. Pat. No. 5,621,211.

The instant invention with one, two or more tips can be used to ionize atoms, molecules and complexes on insulating or conductive substrates as the tip pairs probe flexible gap can be alternately polarized during the pulsed injection of sample material the into the mass spectroscopy device. Preferably two or more tips are brought into proximity or contact with sample 269 and an energy pulse is used to excite tip interaction region 5. Preferably means comprising electrical, optical, acoustic, thermal, electromagnetic or particle beams are used to excite the region to be ionized and analyzed by the scanning atom probe device comprising 348,349,350 and 351. Alternately the tips 1,2,3 and 4 or just tips 1 and 2 can be used without the extractor electrode 348 to ionize material for SAP mass detection. Tip pairs can have an AC or pulsed DC current applied across them when in scanning tunneling microscopy or scanning probe microscopy mode and selectively field evaporate sample material into the SAP device 348,349,350 and 351. Scanning atom probe extractor electrode with scanning probe nanomanipulator attached 356 has an embodiment where the Scanning atom probe extractor electrode probe tip 357 is used as a nanomanipulator and SPM tip in conjunction with tips 1,2,3 and 4. The extractor probe tip is preferably attached to a closed loop actuator for sub-nanometer resolution actuation in concert with tips 1,2,3 and 4. Scanning probe extractor electrode probe closed loop actuator drive 358 provides motion control and a connector to probe tip 357 and extractor electrode with nanomanipulator 356.

The sample substrate 127 or 188 can have surface enhanced Raman spectroscopy (SERS) films, nanoparticles or mesoscale patterned structures on it for detection of vibrational states of sample material 269. Alternately the tips 1,2,3 and 4 can have SERS nanoparticles, films or mesoscale patterns on them for Raman vibrational detection of sample 269. Conventional far field Raman, near field scanning optical microscopy (NSOM) or scanning probe Raman spectroscopy can be performed using the instant invention devices 351,352 and 353. Integration of waveguide and nanoscale illumination and detection on the device 128 is possible. Preferably scanning probe tips and sample substrate 127 or 188 have SERS particles or films attached and a set of spectra are obtained before, during and after operation of the coherent electron interferometer probe or SAP mass spec probing. The field evaporation of material by SAP and surface modification by SPM and the multiprobe of the nanomanipulator can be used to modify or tune the SERS particles on tips 1,2,3 or 4.

Commercial near field scanning optical microscopy (NSOM with Raman capabilities can be attached to the present invention object 128 with the SAP embodiment in FIG. 31 where preferably a device comprising a device such as a Nanonics MultiView system with the Renishaw RM Series Raman Microscope for high-resolution Raman spectroscopy.

Alternately the tuning or the SERS particles can be done by the said means but the operation is performed on the substrate SERS particles associated with 127 and 128. Alternately SERS particles on both tips and the substrate can be modified and analyzed in conjunction with one another. Prior art SERS-SPM methods in U.S. Pat. Nos. (6,850,323) and (6,002,471) as well as Raman spectroscopy and methods in Shuming Nie and Steven R. Emory, Probing Single Molecules and Single Nanoparticles by Surface-Enhanced Raman Scattering, Feb. 21, 1997, Science vol. 275, Katrin Kneipp, Yang Wang, Harold Kneipp, Lev T. Perelman, Irving Itzkan, Ramachandra R. Dasari, and Michael S. Feld, Single Molecule Detection Using Surface-Enhanced Raman Scattering (SERS), Mar. 3, 1997, The American Physical Society, Physical Review Letters vol. 78 No. 9, F. Zenhausem, Y. Martin, H. K. Wickramasinghe, Scanning Interferometric Apertureless Microscopy: Optical Imaging at 10 Angstrom Resolution, Aug. 25, 1995, Science vol. 269, Ayaras et al, Surface enhancement in near-filed Raman spectroscopy, Appl. Physics Letters, June 2000, v. 76, pp 3911-3913 are prior art references incorporated by reference in their entirety.

Field evaporation and ion mass spectra of SERS particles used to modify and can be used to topologically and compositionally tune and elucidate SERS and chemical functional groups associated with SERS particles in situ. Field evaporation of spatially selected regions on a SERS particle or system can be used to strip atoms or nanoparticles off one at a time and the SERS spectra can be checked for vibrational frequency, amplitude and enhancement changes as the SERS system is modified. Chemical catalysts can be analyzed in the same way using the present invention. Coupling of the device in FIG. 31 with the combinatorial synthesis capabilities of the means of FIG. 3, 29 are used for rapid characterization of chemical systems at the single atom and molecule level. Field emission microscopy and field ion microscopy are preferred embodiments of the present invention using nanotweezers and extractor electrodes described in the figures of the present invention in conjunction with mass spectroscopy and Raman spectroscopy.

The SERS and SAP devices coupled with the MEMS/NEMS device 128 in FIG. 31 can be used to pick material off of the surface of sample substrate 127 or 188 and perform SERS spectra of the material 269. Any one or more of the tips in FIGS. 1,4,5,9,11,12,13,14,15,16,17,18,19,20,21,22,23,24,2526,28 or 30 can be functionalized with SERS active particles and used to perform SERS. When two or more probes are aligned and used to scan a particle or operate on it SERS spectra can be obtained. In addition tips 1,2,3 and 4 can be used to pick up objects alone or in conjunction with other nanomanipulator objects associated with MEMS/NEMS system 128. After picking up an abject 269 from substrates 127 or 188 the tips and object 269 can be scanned by SERS spectra from devices 351,352 and 353. After scanning the object 269 can be chemically reacted in the pickup tweezers, placed on substrate 127,188 or another substrate or injected into the SAP mass spectroscope device comprising 348,349,350 and 351. Assembly and SERS spectroscopy cycles integrated with synthesis steps can be used to monitor fabrication of complex systems on the sample substrates.

Alternately disassembly can be performed using SERS and SAP mass spectroscopy of sample object 269 or systems. The SAP mass spectroscopy device and more particularly the extraction electrode 348 can be oriented in any direction or axis with respect to the quad tip device tips 1,2,3 and 4 of interaction region 5 or in the case of the dual junction device tips 1 and 2. Preferably the extraction electrode 348 is either parallel to the tip axis or perpendicular to it. It should be noted that the scanning probe microscope scanner 128 can perform any desired form of SPM, in preferred embodiments the SPM performs STM with inelastic electron scattering spectroscopy IETS using devices 128 and a correlation is made of the Raman spectroscopy is used for analysis on computer 139. In addition correlation of IETS scanning tunneling microscopy and Raman spectroscopy with the SAP mass spectroscopy is made.

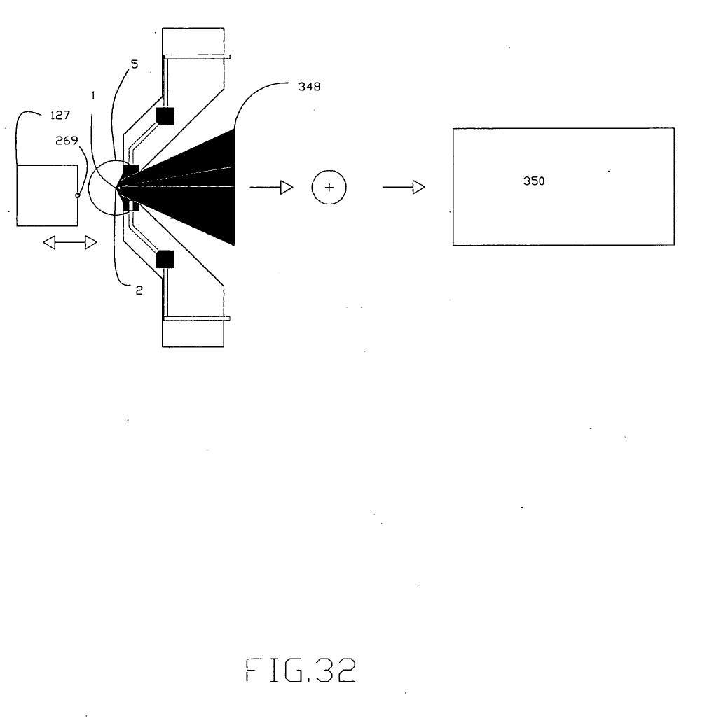

FIG. 32. This is an embodiment of a dual tip MEMS/NEMS scanner 128 operated with a SAP mass spectroscopy extraction electrode 348 situated at the interaction region 5 of the tips 1 and 2 of device 128. The substrate 127 or 188 is used to scan sample 269 into the mass spectroscopy device 350.

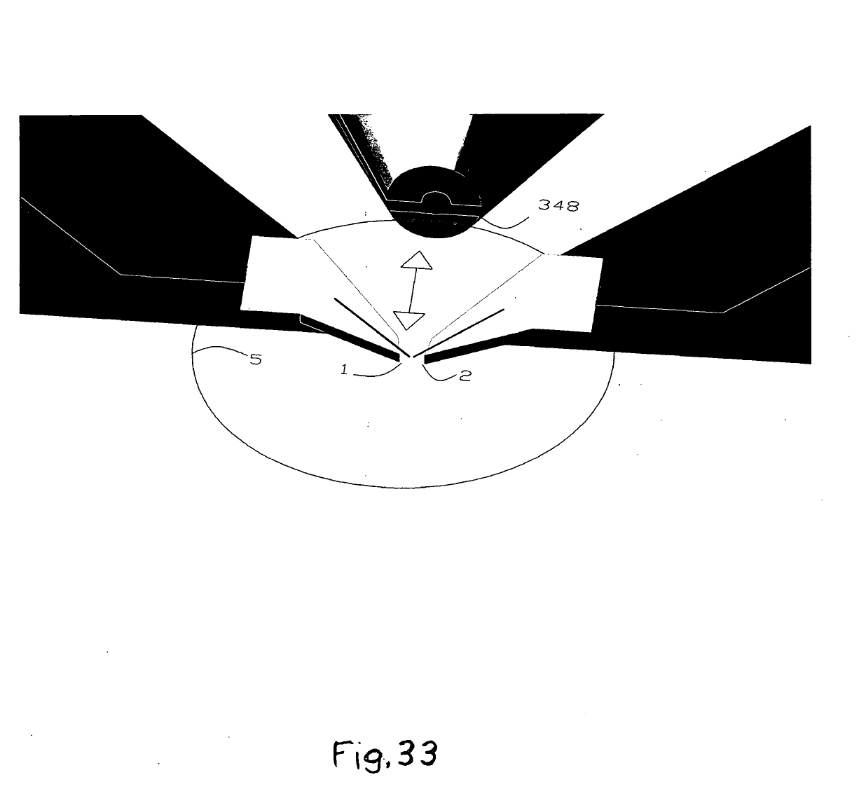

FIG. 33 depicts an asymmetric aperture on the extraction electrode 348 and which is retracted from the tip interaction zone where tips 1 and 2 can touch. This view is to show the slotted embodiment of the extractor electrode. Symmetrical aperture and slotted and non-slotted geometries are possible alternatives to this embodiment. The sample substrate 127 can be moved in the XYZ axis and is retracted in this view. Sample substrate 188 can be used as well as 127.

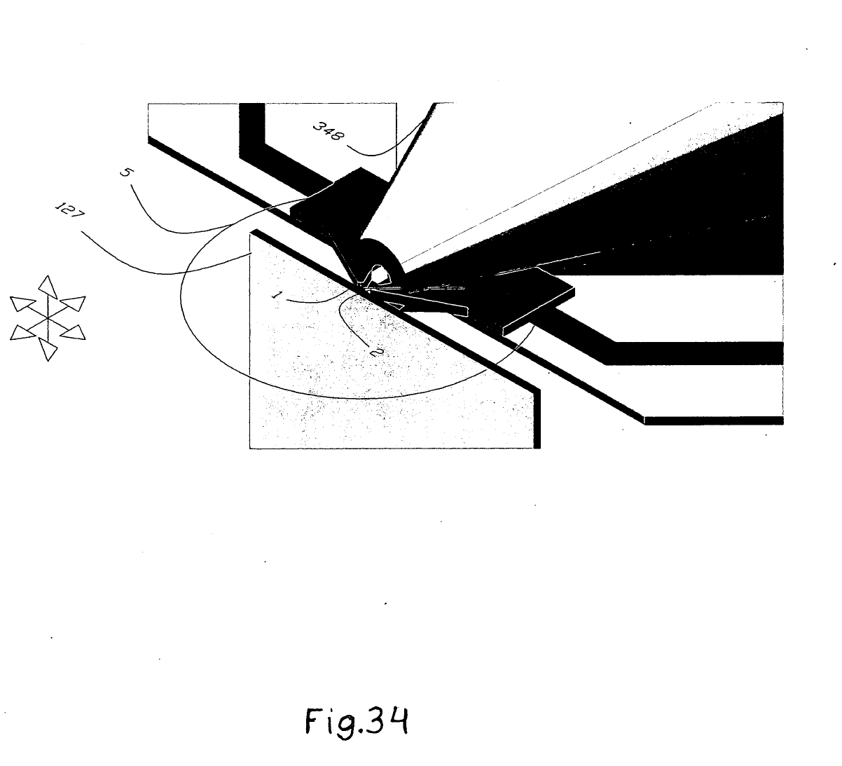

FIG. 34 depicts the extraction electrode 348 in the preferable operating zone close to the tips 1 and 2 where ions can be extracted efficiently.

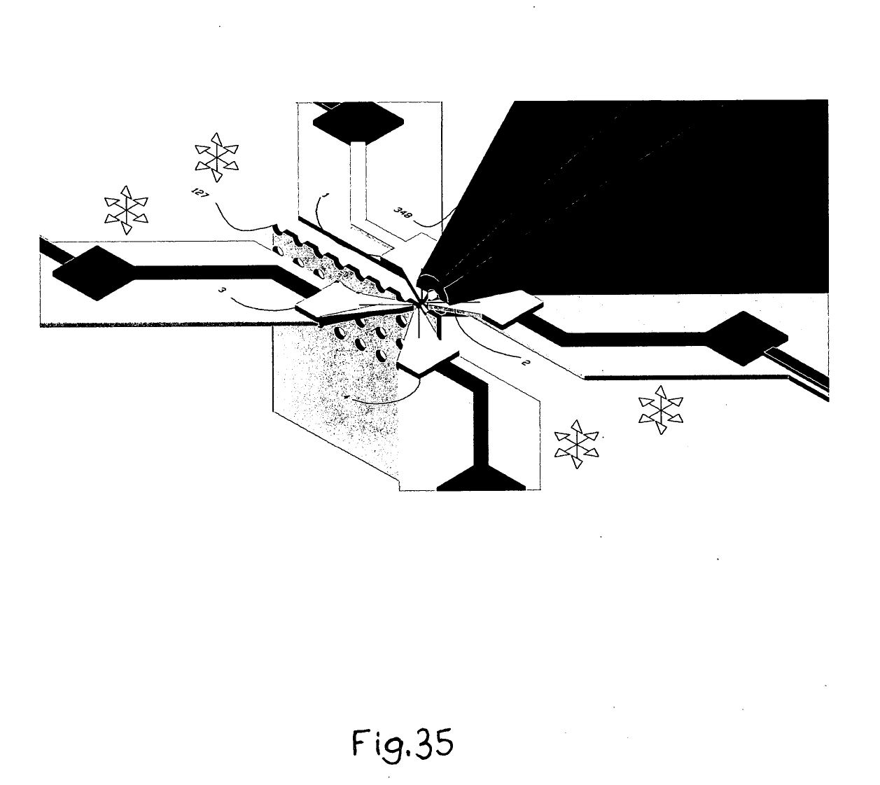

FIG. 35 depicts the extraction electrode 348 in the preferable operating zone close to the Quad tip embodiment where tips 1,2,3 and 4 can be used for nanomanipulation, imaging and ions can be extracted efficiently into extraction electrode 348 and used for mass spectroscopy device 350 for identification of materials. The embodiment can also use the tips 1,2,3 and 4 for Raman spectroscopy by using the tips for SERS probe scanning of surface 127.

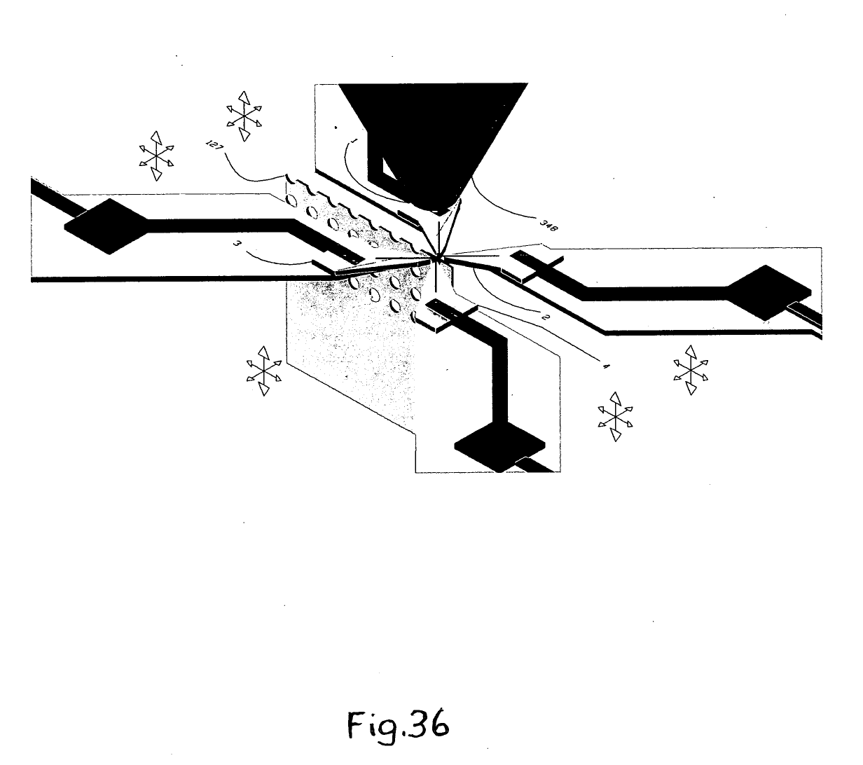

FIG. 36 depicts a vertical SAP extractor electrode embodiment of the quad tip electrode configuration.

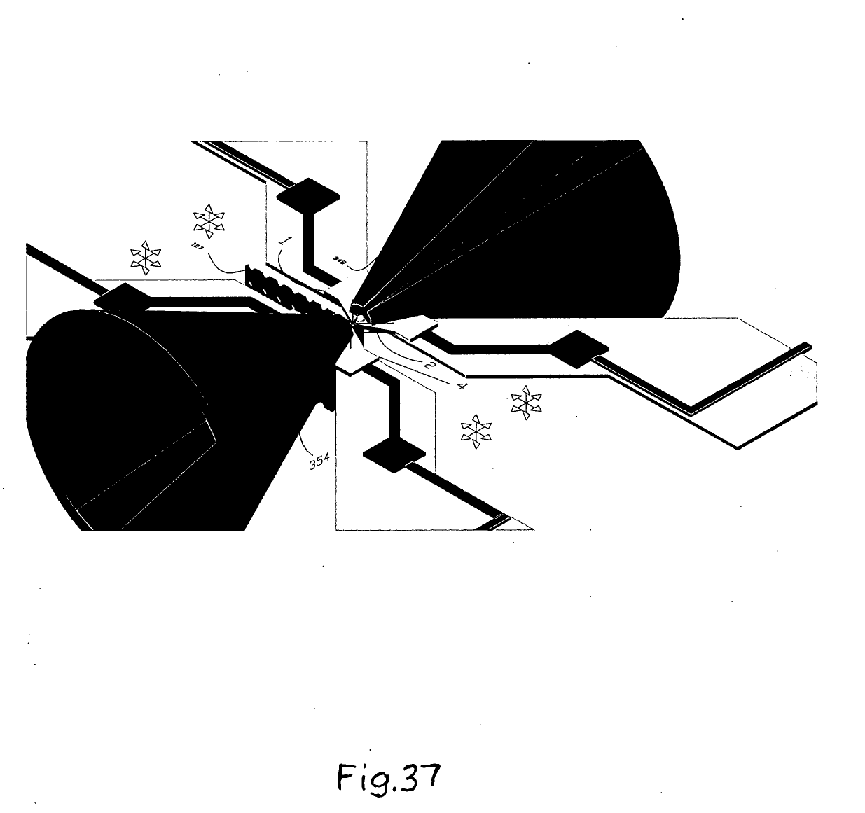

FIG. 37 depicts a close up view of the vertical SAP extractor electrode embodiment of the quad tip electrode configuration. Where the sample substrate 127 or 188 has an ultra thin membrane 353 covering a pore on the surface of sample substrate 127 or 188. The thin layer is preferably exfoliated mica as use for transmission electron microscopy and is thin enough to tunnel electrons through, consisting of one to several monolayers. The tips 3 and 4 can be used to tunnel electrons and apply high electric fields to materials on the opposite side of the membrane 353 allowing ionization of material on the opposite side to be injected into the extractor electrode. The ultra thin membrane alternately can be formed of or coated with a thin conductive layer on one or both sides. FIG. 37 depicts a dual SAP extractor electrode embodiment where multiple extractor electrodes 348 and 354 are operated in sequence or simultaneously. Injection of material from field evaporation tips 1,2,3 and 4 occurs into either of the dual extraction electrodes depending upon biasing pulse. Two mass spectroscopy devices 350 are used to measure the emitted atoms and molecules leaving the surface of the sample substrate 127. One alternate arrangement is for the dual extractor electrodes to be at right angles to each other.

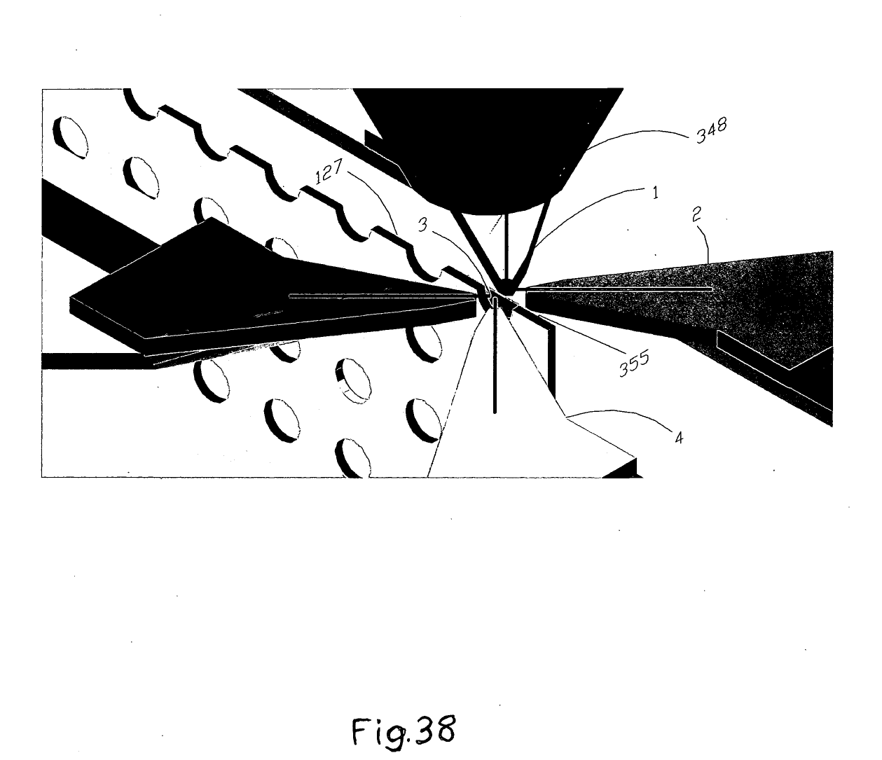

FIG. 38 represents a close view of a quad tipped MEMS/NEMS device 128 tip interaction region 5 with a scanning atom probe extractor electrode 348 mounted vertically above the junction area. In this embodiment the sample substrate 127 has pores in it and has some of the pores covered with a membrane structure 355 which is used to support sample materials.

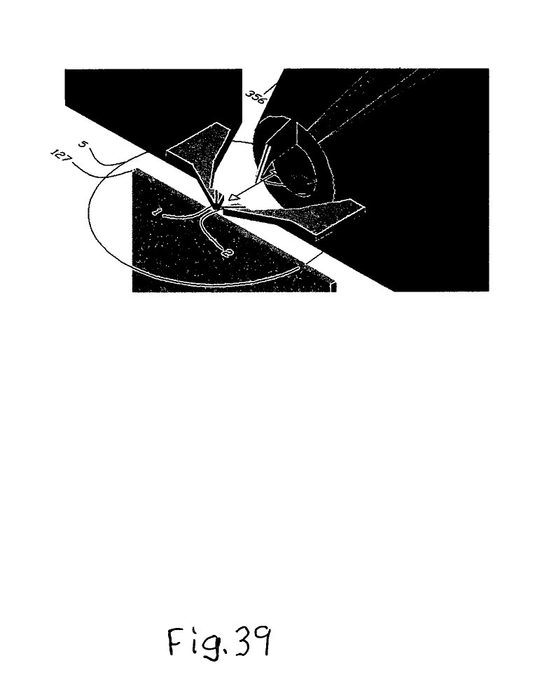

FIG. 39 depicts the retracted state position of an embodiment where the extractor electrode 356 has a scanning atom probe extractor electrode with scanning probe nanomanipulator 357 attached for nanomanipulation, imaging and analysis of materials on substrate 128 or 188. As with the extractor electrode in FIG. 31 the extractor electrode 356 can be fabricated by focused ion beam milling and electron beam deposition on the MEMS/NEMS substrate of 128 or it can be preferably fabricated on a separate electrode and attached to a three axis stage. Preferably a nanotube or nanorod is attached to the scanning atom probe extractor electrode 356 by means described above. The extractor electrode can be fabricated from a micropipette tip known in the biochemical prior art for patch clamping and commercially available.

A micropipette coated with metal and further processed according to prior art U.S. Pat. Nos. 6,797,952 and 6,875,981 can be used to form a nanoprobe tip on the extractor electrode. The present invention uses the nanoprobe at the extractor in concert with at least one or more nanoprobes on the MEMS/NEMS substrate 128 to form a nanotweezers. Obviously it is possible to fabricate multiple probe tips 357 and actuators on the SAP extractor electrode and further preferred embodiments can be comprised of this, preferably arranged in a symmetrical way around the aperture of the extractor electrode 356. The multiple axis actuator attached to the extractor electrode 356 can is preferably operated in a closed loop feedback manner with the computer 139 under software control in concert with the MEMS/NEMS device 128. In the case of use of a micropipette extractor electrode it is further possible to use a single mode optical fiber attachment to the hollow glass fiber to provide optical interface with the extractor electrode. In this case a optical device such as a in FIG. 22 comprising an optical instrument attached to the optical fiber. The nanomanipulator 357 then has both nanomanipulation, imaging and mass spectroscopic capabilities.

The optical fiber is preferably attached any of the following detection means comprising, an interferometer as in FIG. 29, a Raman spectrometer as in FIG. 31 or a fluorescence spectrometer. Commercial near field scanning optical microscopy (NSOM with Raman capabilities can be attached to the present invention object 128 with the SAP embodiment in FIG. 31 where preferably a device comprising a device such as a Nanonics MultiView system with the Renishaw RM Series Raman Microscope for high-resolution Raman spectroscopy. Prior art feedback and optical sample interaction means known in the art can be used to control and manipulate materials on substrate 127 or 188. The above mentioned nanotube functionalized extractor electrode can have the scanning probe attached via a cantilever structure which is used in an optical lever or interferometer arrangement for atomic force microscopy.

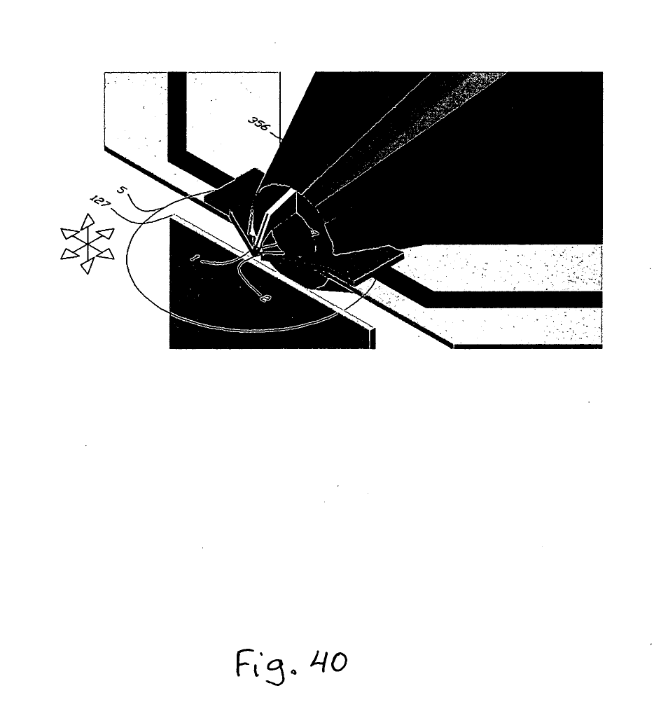

FIG. 40 depicts the embodiment where the extractor electrode 356 has a scanning atom probe extractor electrode with scanning probe nanomanipulator attached for nanomanipulation, imaging and analysis of materials on substrate 128 or 188. The extractor electrode nanoprobe is in operational position for interaction with samples on substrate 127 and tips 1 and 2.

Scanning atom probe extractor electrode with scanning probe nanomanipulator attached 356 has an embodiment where the Scanning atom probe extractor electrode probe tip 357 is used as a nanomanipulator and SPM tip in conjunction with tips 1,2,3 and 4. The extractor probe tip is preferably attached to a closed loop actuator for sub-nanometer resolution actuation in concert with tips 1,2,3 and 4. Scanning probe extractor electrode probe closed loop actuator drive 358 provides motion control and a connector to probe tip 357 and extractor electrode with nanomanipulator 356. The nanoprobe attached to the extractor electrode is measured and integrated with the actuation and control circuits connected to the XYZ Sample substrate stage and MEMS actuator measurement and control circuit 136 and controlled by computer 139 as seen in FIG. 31. The tunneling current sensor 137 is also attached to the nanoprobe of extractor electrode tip 357 via closed loop extractor electrode actuator drive 358. This tunneling sensing allows for concerted coordination of tip 357 with tips 1,2,3 and 4 by computer 139.

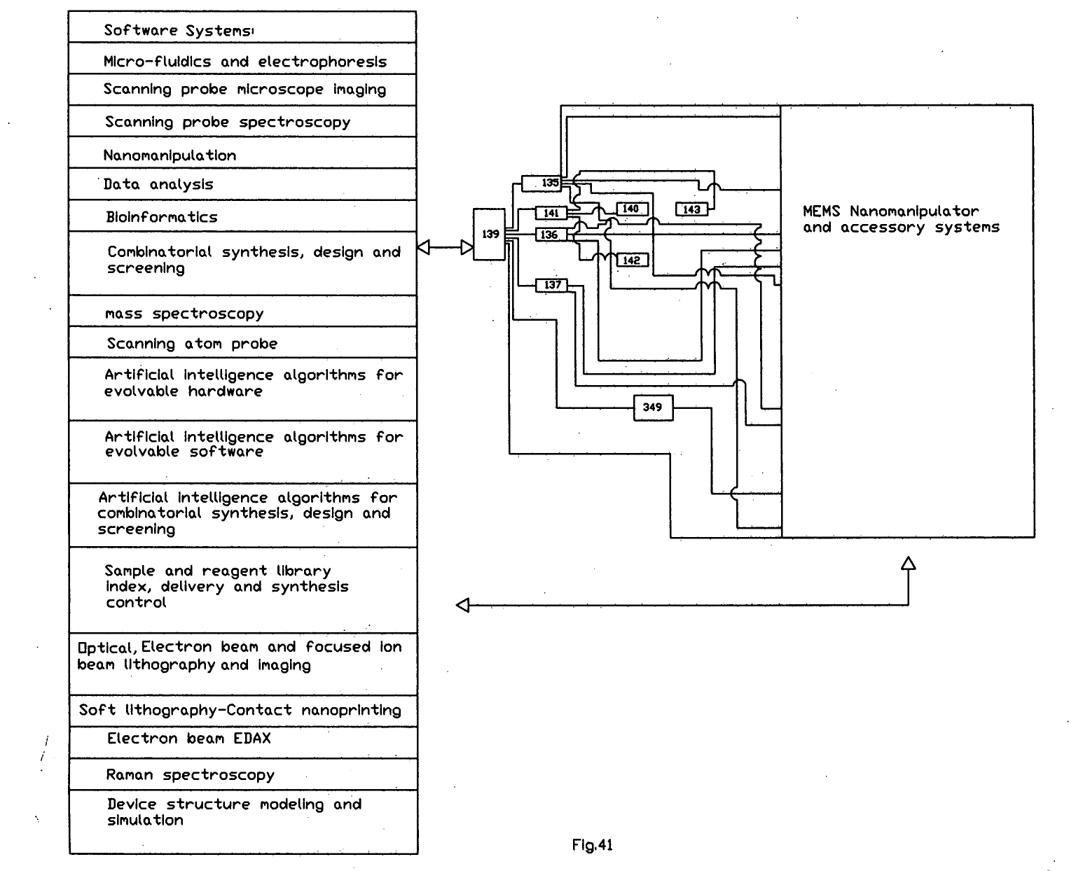

FIG. 41 represents the software systems associated with a preferred embodiment of the invention. The preferred embodiment places at least one scanning atom probe version of the device 128 from FIG. 31 in a dual beam scanning electron microscope and focused ion beam lithography device as available from FEI inc (Nova 600 Nanolab or Strata 400 SEM-STEM-FIB) or Carl Zeiss SMT AG (1560XB crossbeam or Ultra 55 FESEM). The following commercially available software or custom written software can be implemented on a general purpose computer 139:
Micro-fluidics and electrophoresis
Raman Spectroscopy
Scanning probe imaging
Scanning probe spectroscopy
Nanomanipulation
Data analysis
Combinatorial Synthesis, design and screening
Bioinformatics
Mass spectroscopy
Scanning atom probe
Electron beam and focused ion beam lithography and imaging
Electron EDAX spectroscopy
Device structure modeling and simulation
Soft-lithography, nanoscale contact printing and assembly

Custom written code for the following process can be performed by computer programmers knowledgeable in the art:
Sample and reagent library, index, delivery and synthesis control
Artificial intelligence algorithm for evolvable hardware
Artificial intelligence algorithm for combinatorial synthesis, design and screening
Artificial intelligence algorithm for evolvable software

Preferably the artificial intelligence algorithms are run on a cluster supercomputer with teraflop or better performance for rapid simulation and search of device space according to the prior art.

Additionally, conventional SPM control and data acquisition mechanisms, including software, can be modified to create new mechanisms or algorithms necessary to control tip movement or optimize the performance of the SPM probe, nanomanipulator and accessory means and processes in the system of the present invention.

Simultaneous Operation of Multiple Squids Connected by Flexible Gap Cantilevers:

Any number of flexible gap coherent electron scanner devices can be interconnected and operated in ways where signals from one or more of the junction devices interacts with one or more other junctions. The quad tip and cantilever geometry of the preferred embodiment of the invention affords a particularly useful feature in that by having four or more flexible gap SQUID junctions on the device unique measurement and coupling of the junctions is possible. In a preferred embodiment the coherent electron junction and circuit areas 148 and 144 connected to cantilevers 54 and 55 and tips 1 and 2 are modulated by comb drives 62,63,64,65,66,67,68,69 and z axis capacitors 114,115,116 and 117.

The displacement of the cantilevers 54 and 55 causes a modification of the area of the SQUID formed by junction 21, conduits 18 and 19 and tips 1 and 2 which causes less magnetic flux to be enclosed by the SQUID circuit. The fact that elements of the Josephson junction 173 via loop 172 and further SQUID circuits 147 and 150 share a flexible gap region and scanning junction at 21 via the junction formed by probes 122 and 124 means that the two SQUID devices are physically coupled and can be used to compensate for flux area modulation. By performing measurements of the flux through the two SQUID devices and monitoring the relative change as a function of displacement a deconvolution of the flux correlation function is performed. This is used just one of many possible means of flux compensation between pairs of junctions and SQUID devices formed by probes 1,2,3 and 4 on MEMS/NEMS device 127. The symmetrical pairs of SQUID junction flexible gap devices attached to fixed junctions 21,37,173 and 179 can be connected in the above way and have a correlation function compare their respective responses to displacement and sample scanning output to form data sets for spectroscopy and imaging.

Alternately all four SQUID devices in on MEMS/NEMS device 128 can be connected in serial or parallel and used to scan substrate 127,188 or objects in the tip interaction region 5 by modulating comb drives 62,63,64,65, 66,67,68,69,42,43,44,45,86,87,88,89 and z axis capacitors 114,115,116,117,118,119,120 and 121. The discrete breather and quantum ratchet embodiment of the flexible gap coherent electron device of the present are examples of multiple junction devices of the present invention where flexible gap scanner in FIG. 1 is used to scan material. Multiple flexible gap junctions can be wired in parallel or in series to form hybrid circuits using the flexible gap coherent electron design. The large area flexible gap junctions 271 and 272 can be connected with the probe junctions 1,2,3,4,122,123,124 and 125 which can be wired in series or parallel.

Nano-Bimorph:

In a preferred embodiment the probes 1,2,3,4, 122,123,124 and 125 are nanobimorph actuators formed of components comprising single walled or multi-walled carbon nanotubes, BCN (Boron, Carbon and Nitrogen) nanotubes, BN (Boron and Nitrogen) nanotubes or other materials. Multiple tip nanotweezers means are integrated with the coherent electron flexible gap junction of the instant invention and provide combined nanomanipulation, spectroscopy and imaging.

Operating the flexible gap SQUID detector scanner in the superconducting threshold to voltage switching state is a method used in a preferred embodiment. When the current passing through the tunneling junctions of a Josephson junction SQUID exceeds the critical current the device switches to a normal current carrier mode and a voltage appears across the SQUID. The current at which a voltage develops across the SQUID with the flexible gap sample scanner in it is a characteristic measure of the quantum state of the sample scanner SQUID. The process of transition to a voltage state across the SQUID is a stochastic one and repeated transitions through the transition are made to find the average and map the flux state of the SQUID. Modulation of the tip sample gap in the axis orthogonal to the sample surface as the threshold current required to end superconductivity is stochastically measured is a method preferred for sample measurement.

The above device can be used as a scanning bolometer or single photon counting photodiode device. Embodiments are possible where one or more photon counting diodes or photomultiplier tubes is integrated with the operating of the flexible gap device. Microsphere and nanosphere objects can be used in conjunction with tips 1,2,3 and 4 as well as multiple MEMS/NEMS devices to provide a means for manipulation of the sphere devices. Clusters of microspheres and nanospheres can also manipulated and used as biomolecule handles. Bloch oscillation transistors and Aharonov-Bhom interferometer devices can be built using the flexible gap junction or the flexible gap junction scanner device can be used in conjunction with these devices.

### IETS Embodiment

The tips of the MEMS/NEMS coherent electron interferometer scanner of the instant invention are operated as inelastic electron scattering spectroscopy devices in a preferred embodiment of the invention. Scanning one or more of the tips 1,2,3,4, 122,123,124 and 125 over a molecular or nanoscale object on sample substrate 127 or 188 and measuring the vibrational excitation generated inelastic electronic current can be used to identify molecular and plasmon vibrational states of molecules and nanosystems. In IETS a differential tunneling voltage and current measurement spectra is taken for each scan pixel as the sample is scanned by the tips 1,2,3 and 4. Combining interferometry imaging with the IETS spectra is a powerful technique for sample characterization.

The prior art reference article “A variable-temperature scanning tunneling microscope capable of single-molecule vibrational spectroscopy”, B. C. Stipe, M. A. Rezaei, and W. Ho, REVIEW OF SCIENTIFIC INSTRUMENTS VOLUME 70, NUMBER 1 JANUARY 1999 is incorporated here by reference in its entirety. The online prior art research proposal “Single Molecule DNA Sequencing with Inelastic Tunneling Spectroscopy STM” by Jian-Xin Zhu, K. O. Rasmussen, S. A. Trugman, A. R. Bishop, and A. V. Balatsky describes using inelastic electron scattering from a STM tip to differentiate and sequence nucleotide monomers of a DNA molecule. The use of inelastic tunneling spectroscopy according to the prior art does not provide coherent electron spectroscopy or provide a means of deconvolving topographic sample data from coherent electron spectroscopy data during DNA scanning as the instant invention does.

The polynucleotide being sampled can be pulled through the tip junction or the flexible gap junction tip can be scanned over the polynucleotide molecules.

The spanned junction device embodiments depicted by the figures above can be used as scanning structures for polynucleotide molecules in conjunction with inelastic scanning tunneling spectroscopy.

Using the flexible gap junction spanned by nanoscale spanning objects attached to the interferometer polynucleotide polymers can be drawn over one or more nanotubes spanning an interferometer circuit of device 128. The spanning objects 158,159,160,161,170 and 171 are preferably functionalized with molecules such as nucleotide and nucleotide analogs which interact with each of the nucleotide bases of the polynucleotide being drawn over the flexible gap junction spanning objects 158,159,160,161,170 and 171. Monomers, dimers, trimers oligomers and polymers may be attached to the spanning objects 158,159,160,161,170 and 171 and interact with the polymer being scanned in a site specific nucleotide base or label specific way.

The sample stage positioning device 126 may be a MEMS/NEMS device or a large piezo stage. The XYZ stage 126 can be formed from the same substrate as 128. Preferably the XYZ stage 126 is integrated with a sample substrate loading and storage device 140, sample chemical treatment device 142 controlled by sample loading and chemical treatment circuit 141 under computer 139 control. The sample loading and storage device 140 allows for automated control of sample loading and management of large sample libraries scanned by MEMS/NEMS device 128. The loading and storage device 140 and MEMS/NEMS device SPM(Nanomanipulator chemical treatment mechanism 143 are integrated with control circuit 141 is interfaced with computer and software of device 139.

Preferably the MEMS/NEMS SPM chemical treatment device 143 has a means for solvent, reagent, buffer and gas treatment of the instant device MEMS/NEMS 128. Further the chemical treatment mechanism provides a means for cyclical application of chemical reagents, solvents and gases and includes critical point CO2 treatment of the device and sample substrate 127 and 188. In addition nucleotide and protein and biomolecule reagents and arrays can be handled, dispensed and interacted under control of computer 139. Additionally the MEMS/NEMS SPM chemical treatment device has electrical, and chemical means for providing electrophoresis in association with or on the MEMS/NEMS chip 128. Said electrophoresis process is controlled by software on computer 139. Preferable embodiments of the MEMS/NEMS device 128 has systems comprising microfluific channels, electrophoresis channels, pores, valves and pumps for integrated delivery of reagents, samples and objects to the interaction region 5 of the device. Fluoresences labeling and optical detection means known in the art can be used in conjunction with the nanomanipulator scanning probe MEMS/NEMS device to coordinate detection, analysis and manipulation processes. In particular high sensitivity photo detectors or CCD optical systems and pattern recognition software can be used to detect materials on or in device 128 or sample substrate 127.

In an alternate embodiment the SQUID circuit is used to sense the amplitude and or phase modulation of the flexible gap junctions of tips 1,2,3,4, 122,123,124 and 125 as a nucleotide polymer is moved through the junction region 5. The polymer may be moved mechanically or by electrophoresis. The operation of electrophoresis must be performed at temperatures where nucleotides and buffer are mobile while coherent electron interferometers generally operate at cryogenic temperatures. Transient thermal cycling of the junction region using means comprising a laser or resistive heating element can transiently heat the junction area so that electrophoresis movement of nucleic acid polymers past the scanner junction.

A phase shifter is any structure that shifts the phase of the superconducting order parameter .PSI. by .alpha. pi. in transition through the structure, where .alpha. is a constant such that —1.ltoreq . . . alpha . . . ltoreq.1. The phase shift in the superconducting loop causes time-reversal symmetry breakdown in the mesoscopic quantum system and thus causes a double degeneracy of the ground state without requiring an external magnetic flux or other influence. In some embodiments, the terminals attached to flexible gap junction interferometer tips 1,2,3,4,122,123,124 and 125 in devices of a multi-terminal junction can be physically asymmetric. This asymmetry affects the properties of a coherent electron scanner according to the present invention by controlling the phase shift of the order parameter .PSI. in transition through a multi-terminal junction.

Sample generated phase shifts can be measured by modulating the phase angle using a phase shifter to cancel sample generated phase shift in an embodiment of the present invention.

A coherent electron interferometer flexible gap scanner according to the present invention may be constructed out of any superconducting material or long electron coherence material such as Aluminum or Silver. Embodiments of coherent interferometers having any desired number of terminals and phase shifters can also be constructed in accordance with desired applications for the scanner. Embodiments of coherent electron interferometer structures include, for example, s-wave superconductor/two dimensional electron gas/s-wave superconductor, referred to as S-2DEG-S junctions, s-wave superconductor/normal metal/d-wave superconductor/normal metal/s-wave superconductor, referred to as S-N-D-N-S junctions, superconductor/ferromagnetic/superconductor, referred to as S-F-S junctions, or multi-crystal d-wave superconductors patterned on an insulating substrate. The equilibrium ground state of the coherent electron scanner nanomanipulator quantum system can be, in the absence of external magnetic fields, twice degenerate, with one of the energy levels corresponding to a magnetic flux threading the loop in one sense (corresponding to an equilibrium supercurrent flow, for example, in the clockwise direction around the superconducting loop), and the other energy level corresponding to a magnetic flux threading the loop in the opposite sense (corresponding to an equilibrium supercurrent flow, for example, in the counterclockwise direction around the superconducting loop).

Some embodiments of coherent electron interferometer nanomanipulator according to the present invention include an s-wave (for example, niobium, aluminum, lead, mercury, or tin) superconducting structure that includes an asymmetric four-terminal junction with all terminals connected by constriction junctions. Use of spanned gap junctions using structures 158,159,160,161, 170 and 171 allows for mixing spanned junction objects with flexible gap open junctions such as tips 1,2,3 and 4 to provide constriction junctions.

Two of the terminals of a four terminal flexible gap device can be joined to form a superconducting loop and the other two terminals can be coupled to a source of transport current. The superconducting loop includes at least one phase shifter, which may consist of a S-N-D-N-S (for example, niobium/gold/YBa.sub.2CU.sub.3O.sub.7-x/gold/nobi-um) junction. If the incoming current is parallel to the a (or b) crystallographic direction of the d-wave material, and the outgoing current is parallel to the b (or a) crystallographic direction of the d-wave material, this S-N-D-N-S junction can give a phase shift of .pi. Choosing the incoming and outgoing currents to be at any arbitrary angle to each other in the a-b plane in this embodiment allows a more general phase shift.

A phase modulator can be used to compensate for flexure induce phase modulation of the flexible gap junction scanner 128.

Preferably the tips 1,2,3,4,122,123,124 and 125 can be chemically functionalized so as to attach molecules to the nanotube or metal tip structures. In addition the nucleotide polymer can be attached to one or more tips of a MEMS/NEMS device of the instant invention as previously described and scanned by the tips of a second replica of the MEMS/NEMS device.

Though the diagrams provided in the instant patent depict the flexible gap junction having an axis of orientation with the tunneling junction fabricated parallel to the device substrate it will be obvious to those skilled in the art of MEMS and NEMS design that the device can be fabricated in other orientations with respect to the tip structure and device substrate. Orthogonal and tilted orientations are obvious alternate orientations.

The actuator elements 62,63,64,65, 66,67,68,69,42,43,44,45,86,87,88,89 and z axis capacitors 114,115,116,117,118,119,120 and 121 may be operated in a linear mode or a vibrational mode where any of the aforementioned actuator elements is driven by an input signal and oscillated at a resonant mode or non-resonant mode. Multiple displacement detection modes may be used to detect interaction of the flexible gap top electrode with the sample substrate surface and flexible gap bottom electrode with the sample substrate surface. Preferably means comprising capacitive sensing, optical interferometry and tunneling detection are used to detect motion of the flexible gap junction or junctions. The periodic interaction of the surfaces is then detected using differential tunneling signals from the top electrode-sample substrate and bottom electrode-sample substrate shown in FIG. 4.

In addition, because the instant invention has embodiments where the flexible gap junction and associated circuits are superconducting materials a zero bias superconducting current induced by a magnetic flux is used in preferred embodiments to measure the transmission of current through the sample substrate. In the case of zero bias operation the two tips at the flexible gap apex are at the same potential during scanning. When spectroscopic information is measured for a particular X and Y position on the sample substrate the flexible gap junction is paused at that location and a momentary sampling of the site location is performed. If the flexible gap junction is being operated in the oscillation mode the duration of the pause in scanning may be one to several cycles typically but may be of long duration if the time evolution of the spectroscopic signal is being studied. External stimulus may be provided by chemical, physical or electromagnetic forces which modify the time evolution of the spectroscopic signal. Pump and probe optical methods may additionally be used to sample short duration events.

Pump probe optical methods used in conjunction with STM are described in U.S. Pat. No. 4,918,309. This patent describes use of optical excitation of electrical potentials between the STM tip and sample surface by optical gate excitation of charge carriers which are detected by the tunneling junction of a STM. By timing pumping pulses of a laser it is possible to measure very short duration events occurring at the tunneling junction using this method. The citation in the prior art does not provide means for coherent electron quantum interference or resultant spectroscopy provided by the instant invention. By combining the use of optical excitation by optical pulses of femtosecond to picosecond duration with the coherent measurement circuitry of the instant invention novel spectroscopic information and data manipulation methods are possible.

Alternate modes of actuator operation are possible. The actuator elements may be operated in a mixed mode where one of either the top electrode-sample substrate or bottom electrode-sample substrate is mechanically resonated and the other linearly actuated. A further possible mode of operation is where one of either the top electrode-sample substrate or bottom electrode-sample substrate is actuated and the other is held static. Additionally the sample substrate can be oscillated alone or in conjunction with the flexible gap junction tips. The actuators of the instant invention are preferably piezoelectric elements in a further preferred embodiment. Artificial intelligence probe excitation searches can be performed to find novel probe mechanical, electrical, electromagnetic and acoustic excitation modalities.

Microscopic or nanometer scale microtomb sectioning of materials can be used to form samples particularly from biological materials. The instant invention can be incorporated into a freeze fracture electron microscope device to provide imaging of biological materials using the coherent electron interferometer capabilities of the instant invention. Biological cells, proteins, and nucleotide molecules can be imaged in fractures frozen buffer at cryogenic temperatures for coherent quantum interferometer operation or at high temperatures using the scanning probe of the instant invention.

In addition in preferred embodiments the flexible gap junction scanner device has nanotubes deposited or grown which span the gap or gaps formed by the cantilever structures 54,55,56 and 57 preferably at tips 1,2,3,4,122,123,124 and 125. The nanotube elements are preferably vibrated at high frequency by means of electromagnetic irradiation or mechanical actuator. Because the resonant vibrational mode frequencies of micron to sub-micron length nanotubes is tens to thousands of times higher than the mechanical resonant frequency of the micron scale MEMS comb and spring structures of the scanner the high frequency excitation of the nanotube structures is not expected to destabilize the rest of the MEMS actuator device. Excitation time pulse measurement gated correlation of sample signal detection excitation or lock-in detection of the nanotube structures is a preferred detection method.

In another preferred embodiment the MEMS coherent electron flexible gap scanner has signals measured and generated using superconducting circuits. These circuits can be on a substrate comprising the first said substrate of claim 1 in device 128 or any other surface. In preferred embodiments the superconducting circuits are located in the prototyping areas comprising 114, 115, 116, 117, 118, 119, 120, 121, 148,149,150 and or 151. In further preferred embodiments the superconductive sensing, control and processing circuits of 137 in FIG. 3 are located on a flip-chip in contact with or in proximity to the flexible gap scanner substrate. Alternately the sampling and control circuits can be off chip and connected to the scanner substrate. Alternate embodiments have the superconductive sample and control circuits located on the sample substrate. The scanned sample and superconductive circuitry may be located on the scanner substrate in still further preferred embodiments. Use of mixed semiconductor and superconductor circuits may be used in any of the above embodiments.

In a preferred embodiment the quad tip MEMS/NEMS device of FIG. 1 is fabricated so as to allow sectioning of the device in half so as to produce an overhanging two tip junction device which can be used to scan a surface in the plane orthogonal to the tip and chip fabrication plane of the MEMS/NEMS device.

Superconductive circuit fabrication methods developed for radar applications in the following citations can be used to fabricate the instant inventions novel flexible gap junction and sampling and control circuits for the MEMS/NEMS device 128. The citations J. X. Przybysz and D. L. Miller, IEEE Trans. on Appl. Supercond., vol. 5, pp. 2248-2251, June 1995, S. V. Rylov, L. A. Bunz, D. V. Gaidarenko, M. A. Fisher, R. P. Robertazzi and O. A. Mukhanov, “High resolution ADC system” IEEE Trans. on Appl. Supercond., vol. 7. pp. 2649-2652, June 1997, J. H. Kang, D. L. Miller, J. X. Przybysz and M. A. Janocko. IEEE Trans. Magn., vol. 27, pp. 3117-3120, March 1991, D. L. Meier, J. X. Przybysz and J. H. Kang. IEEE Trans. Magn., vol. 27, pp. 3121-3122, March 1991 and C. Lin, S. V. Polonsky, D. F. Schneider, V. K. Sememov, P. N. Shevchenko and K. K. Likharev, Extended Abstracts of 4th ISEC, pp. 304-306, September 1995 discribe prior art circuit designs and fabrication methods for superconducting A to D sampling circuits. Preferred embodiments use analog to digital conversion and software or hardware feedback of flexible Josephson junctions attached to tips 1,2,3 and 4.

Magnetoresistence measurement can be used with any of the embodiments of the invention but in embodiments where there are spanning nanostructures it is particularly useful.

Freeze Fracture Methods:

In further embodiments the instant invention nanomanipulator and scanning probe microscope is used with commercially produced freeze fracture equipment for biological sample processing. Low temperature cryogenic biological samples can be generated in a freeze fracture device and the SPM and nanomanipulator of the instant invention cam be used in conjunction with an electron microscope to characterize and manipulate samples in the frozen sample. Cryogenic devices, etching and coating methods known in the art can be employed in conjunction with the device of the instant invention. Novel nanomanipulation methods for cell samples can be produced by the freeze fracture means combined with the coherent electron flexible gap scanner and nanomanipulator.

In some preferred embodiments the flexible gap junction is immersed in a liquid and frozen. Periodically the junction area is heated by a means comprising a laser or heating coil element and the flexible gap junction is moved and allowed to freeze again. The spectroscopic scanning of a sample is carried out in cycles of freezing and thawing. This method is particularly useful for biological samples. Laser heating can be used to thaw areas before, during or after scanning using the present invention with frozen material.

Quantum tapping mode is an operational mode of the device where one or both of the flexible gap tip structures is oscillated and periodically makes contact or near contact with the sample substrate or opposing tip. Additionally the sample substrate can be oscillated alone or in conjunction with the flexible gap junction tips. In this mode the time variant signal generated by the proximal approach of the tips and substrate structures results in tunneling overlap of electronic states of the tip structures and sample. The periodic orbital overlap signals are measured and mapped spatially as the sample is scanned by the flexible gap tunneling junction. Lock-in detection of the periodic signal detected with the actuators driving the oscillations of the variable gap and sample are used to enhance measurement of weak signals. During quantum tapping the tip and sample also have an atomic force interaction which is measured as well as the tunneling exchange. Any other transient SPM force or field interaction mode can be measured in conjunction with coherent tunneling modulation of the flexible gap during sample and scanner interaction.

The process of electron tunneling is exponentially dependent upon the junction gap distance which separates the conductive tips. To detect sample electron transmission and measure the sample electron spectroscopy spatially as the sample is scanned between the tips of the flexible gap junction the movement of the relative motion of the tips with respect to each other must be known. By placing tunneling tip displacement structures on the flexible gap apex the x, y and z components of the flexible gap junction apex can be measured during scanning.

In addition methods comprising capacitive and optical interferometer measurements can be used to measure the flexible gap junction apex motion to sub-angstrom levels of resolution. Commercially sold interferometer vibrometers by THOT inc have picometer resolution and can be used to measure the vibrating cantilevers 54,55,56 and 57 of the device 128 in dynamic oscillating modes of operation. Other high precision methods for motion sensing will suffice to perform flexible gap junction displacement measurement. With rapid sampling of the motion components of the apex structures active feedback can be implemented by driving the actuator signals to maintain set sample to tip distance values or constant current values as is done in standard scanning probe microscopy (SPM) such as scanning tunneling microscopy (STM)and atomic force microscopy (AFM). Deconvolution of the spatial displacement of the flexible gap tip pair and the tunneling coefficient as the sample is scanned can also be performed by computer 139 or a dedicated DSP. Artificial intelligence algorithms can optimize the deconvolution algorithm for probe-probe, sample-sample and sample-probe interactions.

A digital signal processor and D/A and A/D converter devices can perform the task of actuation, signal control and measurement of signals rapidly and with software control as is done in standard SPM using a general purpose computer with data acquisition means. Using circuit fabrication technology used for D/A, A/D and Josephson junction RFSQ logic gates it is possible to fabricate signal measurement and actuator control process circuits using superconductive circuit elements. HYPRES inc. at (hypres.com) provides standard circuit fabrication foundry services for such circuit elements which can be used in conjunction with art recognized surface micromachine or bulk micromachine MEMS fabrication methods to fabricate the instant invention flexible gap junction device. These integrated superconductive measurement and processing circuits can be fabricated on the same substrate as MEMS/NEMS device 128, on flip-chip substrate hybrid circuits on wafer to wafer complexes or on separate chips and boards. Close proximity of the flexible gap scanner and measurement and processing circuitry increases signal transit time but creates noise and thermal issues.

The prior art work at IPHT Jena on low temperature superconductor circuits in Supercond. Sci. Technol. 12 (1999) 806-808, by Stolz, Fritzsch and Meyer describes formation of a Niobium based SQUID Josephson junction sensor using Nb/AlOx/Nb junction. The citation device differs form the present invention in that it does not provide a means of providing scanning probe microscopy and only acts as a magnetometer. Using the described SQUID circuit fabrication sequence with the MEMS fabrication methods cited here the instant invention can be fabricated. The IPHT process is a commercially available process and can be integrated with a MEMS fabrication process to provide a hybrid SQUID-MEMS device as described in the instant invention.

Correlation of this signal with electromagnetic excitation of the flexible gap junction or multiple junctions of the scanner provides high frequency spectroscopic probing of the tip or tips, sample gap junction states and thus sample electronic states during scanning. Tunneling junctions are known to be efficient electromagnetic mixing devices and the instant invention provides novel spectroscopic methods utilizing these properties of the flexible junction device. Microwave, millimeter wave and other frequencies of electromagnetic radiation may be used to excite the flexible gap junction.

A particularly preferred embodiment of the device uses a set of Josephson junction flexible junctions fabricated so as to integrate two or more flexible gap junctions so as to compensate for relative motion of the sample substrate scanner. FIG. 4 depicts an embodiment of the type of circuit integrating multiple flexible gap junction devices so as to provide intrinsic relative position detection in situ at the junction apex.

In conjunction with the periodic actuator driving signal and electronic modulation of the junction the instant invention provides preferred embodiments where the flexible gap junction is structurally optimized and operated in a mode where the flexible gap junction structure acts as an atomic force microscope. By designing and forming the device with a highly flexible cantilevers and springs (FIG. 1) connecting the gap junction to the actuator, atomic force interactions can be measured by the device. By varying the operating temperature the device may be operated in normal conducting and superconducting states and the compliance and lateral friction coefficient of the sample and tip gap can be measured in conjunction with electronic spectroscopy. Various spring constant flexible gap junction devices can be fabricated on the same chip die substrate and provide different atomic force microscope modes with different force constants in addition to coherent electron spectroscopy.

The flexible gap junction cantilevers can also be moved, or its motion detected, by a piezoelectric film alone or in conjunction with capacitive actuation. Capacitive detection of motion of the flexible gap junction can be detected by applying a high frequency potential across the capacitive elements of the capacitive elements of the circuit and detection of the change in the electrostatic charge across the plates as the motion of the plates produces changes in charge. Alternately single electron transistor circuits may be used to count the charge on the plates dynamically to determine the change in position as charge is modified as the gap between the plates changes.

Use of the instant invention to measure molecular association and dissociation processes through force curve measurement in conjunction with coherent electron spectroscopy is possible using the instant invention. Correlation of force applied during dissociation in conjunction with coherent electron transmission through the flexible gap junction is a particularly useful embodiment for molecular biology, biochemistry and nanotechnology.

An alternate method of operation of the variable gap junction is possible where a point contact is made between the bottom electrode of the sample substrate and the bottom tip of the flexible gap junction. This point contact junction is used to maintain a fixed reference by performing actuator feedback with current and voltage measurement of the point contact. The potential applied between the second surface sample substrate and the bottom tip of the flexible gap junction can be used to perform feedback with the actuator drive modulating the bottom tip to sample substrate contact force. This fixed reference established by modulation of the point contact on the bottom side of the sample electrode allows for the measurement of the sample deposited upon the top face of the sample substrate. The top tip electrode of the flexible gap junction is spatially modulated so as to make tunneling measurements of the sample.

Fabrication Methods:

The use of hybrid superconductive circuits using CMOS gates and Josephson junctions is a preferred embodiment of the instant invention. Superconductive materials other than Niobium are possible and preferable in the case of YBCO and other high temperature superconductive material embodiments. Mixed high temperature and low temperature superconductive junctions can be used on the same substrate 128 MEMS/NEMS device. Silicon substrate device fabrication of YBCO SQUID device can be performed on YSZ coated MEMS devices according to methods known in the prior art.

The formation of the superconductive layers required for the quantum interferometer can be formed using standard trilayer Nb/AlOx/Nb integrated process such as the commercial Hypres process for superconductive quantum interferometer (SQUID) fabrication. The Nb/AlOx/Nb trilayer process is temperature sensitive and thus low temperature etching of mechanical actuator and spring assemblies will be required. Alternately the Nb/AlOx/Nb trilayer can be deposited and etched after the substrate is micromachined.

A preferred embodiment uses GaAs or another group III-V semiconductor as the substrate. The advantage of using GaAs or other group III-V semiconductors is that they may be used to form low temperature operable HEMT transistors and amplifiers as well as other analog circuits which may be integrated with the flexible gap junction scanner. The group III-V semiconductors may be used to integrate laser diodes and photodetectors into the MEMS structure forming a microelectro-optical-mechanical systems (MOEMS). Integration of laser diodes and photodetectors into prototyping areas and area 5 of the novel flexible gap coherent electron superconductive circuit of the instant invention is preferred. Piezo actuators may also be used with or as an alternate to electrostatic actuation.

MESFET, PHEMT and HBT transistor technologies are high speed signal processing electronics useful for interfacing with SQUID devices or the instant invention. At cryogenic temperatures when operating the instant invention in the SQUID mode the power dissipation of the tunneling lock-in and sensing electronics can limit use in sorption pumped helium-3 or dilution refrigerators. Northrop Grumman has developed a family of GaAs MMIC products focused on power generation. New fabrication advances will reduce the gate length of the PHEMT process to 0.1 μm to extend frequency coverage to W-band. Similarly, critical dimensions in the HBT process will be reduced to extend the applicability of this process to 35 GHz. The process will also be migrated to the GaAs/InGaP materials system for improved reliability. Back end deposition MEMS fabrication and Nb/AlOx/Nb trilayer steps performed on these commercially processed wafers offers a standard route to fabrication of the actuators and MEMS spring structures instant invention. Flip chip integration of MEMS structures and III-v semiconductor and Josephson junction chip structures is also a means of producing the systems of the instant invention device. Integration of superconductive metallization and oxide layers onto the surface of a MEMS micromachined group III-V HEMT or PHEMT circuit allows for dc to high microwave frequency signal generation, sampling and processing at cryogenic temperatures a feature which is currently not possible using silicon substrate based circuits.

A possible fabrication process for the MEMS device of the instant invention is as follows:

A n-type double side polished silicon SOI wafer with a 10 micron single crystal silicon layer separated from a 400 micron substrate wafer by a 1 micron SiO2 layer is used as the starting material. A sub-micron SiO2 layer is present on the bottom of the 400 micron substrate.
1) A borosilicate (BSG) or phosphosilicate glass (PSG) is deposited on the top of the 10 micron SOI layer and heated to 1050 C for 1 hr in an Argon atmosphere to dope the top of the 10 micron SOI layer.
2) The BSG or PSG is stripped from the 10 micron SOI layer using a wet etchant.
3) A 1 micron thermal oxide is grown on the 10 micron SOI layer front side.
4) A lithographic photoresist is spin coated onto the 10 micron front side SOI surface.
5) The resist is patterned with the Ohmic Aluminum comb drive lines and contact pads UV mask and developed.
6) The thermal oxide is etched through to pattern Ohmic Aluminum comb drive recessed contacts.
7) 300 nm Al is deposited on the etched trenches and holes for comb drive metal through the thermal oxide.
8) The resist is removed and the Al is liftoff patterned.
9) A lithographic photoresist is spin coated onto the 10 micron front side SOI surface.
10) The resist is patterned with the SOI patterning UV mask and developed.
11) The 10 micron front side SOI surface is etched with a DRIE Bosch etchant down to the 1 micron SiO2 layer.
12) The photoresist is stripped from the surface.
13) The trenches etched in the 10 micron SOI silicon layer are filled with a deposition of SiO2.
14) The 10 micron SOI surface is chemical mechanical polished (CMP) to planarize the SiO2 trench fill and expose the patterned SOI surface.
15) The front side 10 micron SOI surface is coated with a protective layer.
16) The bottom of the 400 micron substrate handle wafer under the 10 micron SOI layer is spin coated with a photoresist layer.
17) The photoresist is exposed to a substrate Handle Wafer Trench mask UV pattern and developed.
18) The 400 micron substrate is RUE etched through to the bottom oxide layer.
19) The 400 micron substrate is DRIE etched through to the 400 micron silicon substrate and stopping at the 1 micron SiO2 layer between the 400 micron substrate and 10 micron SOI layer.
20) The photoresist is stripped.
21) The 1 micron SiO2 layer between the 400 micron substrate and 10 micron SOI layer is etched with an etchant.
22) The front side 10 micron SOI surface has the protective layer removed with a dry etch process.
23) 100 nm Niobium M1 deposition (1000 Å)
24) 100 nm Niobium level M1 Photo
25) 100 nm Niobium level M1 Etch
26) 100 nm Niobium level M1 Resist Strip
27) SiO2 Deposition (1500 Å)
28) SiO2 Photolithography
29) SiO2 Etch
30) SiO2 Resist Strip
31) 125 nm Nb/AlOx/NbTrilayer Deposition
32) 125 nm Nb/AlOx/NbTrilayer electron beam lithography
33) 125 nm Nb/AlOx/NbTrilayer Etch
34) 125 nm Nb/AlOx/NbTrilayer Resist Strip
35) Photolithography (Josephson Junction Definition)
36) Josephson Junction Definition Etch
37) Josephson Junction Definition Resist Strip
38) SiO2 Deposition (1000 Å)
39) 100 nm Mo R2 Deposition
40) 100 nm Mo R2 Photolithography
41) 100 nm Mo R2 Etch
42) 100 nm Mo Resist Strip
43) SiO2 Deposition (1000 Å)
44) Contact hole Photolithography
45) Contact hole Etch through Oxides and via connects M2 and R2 and M2 and M1.
46) Contact hole Resist Strip
47) 300 nm Niobium level M2 Deposition (3000 Å)
48) 300 nm Niobium level M2 Photo
49) 300 nm Niobium level M2 Etch
50) 300 nm Niobium level M2 Resist Strip
51) Passivation SiO2 Deposition (5000 Å)
52) Passivation Oxide Photolithography
53) Passivation Oxide Etch
54) Passivation Resist Strip

55) 600 nm Niobium Deposition
56) 600 nm Niobium Photolithography
57) 600 nm Niobium Etch
58) 600 nm Niobium Resist Strip
59) Resistor layer 350 nm Ti/Pd/Au Deposition
60) Resistor layer 350 nm Ti/Pd/Au electron beam lithography
61) Resistor layer 350 nm Ti/Pd/Au Etch
62) Resistor layer 350 nm Ti/Pd/Au Resist Strip
63) Passivation SiO2 Deposition (5000 Å)
64) A Passivation and trench fill photolithographic photoresist is spin coated onto the 10 micron front side SOI surface.
65) The resist is exposed to a pattern with the SOI trench and pad patterning UV mask to define areas for etching of the contact pads, SIO layer SiO2 fill in step 8 which was used for planarization after exposure the resist is developed.
66) Passivation oxide contact pad and trench fill wet etch.
67) Post fabrication processing of MEMS/NEMS device using combinatorial synthesis and nanotube deposition.

Nanotube Deposition and Functionalization Methods:

The prior art reference by “Electrical cutting and nicking of carbon nanotubes using an atomic force microscope” Ji-Yong Park, Yuval Yaish, Markus Brink, Sami Rosenblatt, and Paul L. McEuena), APPLIED PHYSICS LETTERS VOLUME 80, NUMBER 23 10 JUN. 2002, describes nanotube cutting and nicking using an atomic force microscope and STM. The nanotubes processed are spanning lithographically defined structures useful to the region 5 tip interaction zone of the present invention depicted in the above figures. Micromanipulator deposited nanotubes can be fused to a surface using electron beam deposition and cut or nicked with nanometer precision using the above cited reference methods.

The nanotubes of the probe and other parts where nanotubes are used can have nicked nanotubes for formation of quantum structures in the probes. Nicked nanotubes can in theory also be used as circuit elements.

The prior art reference by Changwook Kim, Kwanyong Seo, Bongsoo Kim, Noejung Park, Yong Soo Choi, Kyung Ah Park and Young Hee Lee in Physical Review B 68, 115403 (2003) describes nanotube functionalization of nanotube STM or field emission tips. The chemical groups may subsequently be used to attach DNA oligo and nucleoside monomers.

The prior art reference by Chris Dwyer, Martin Guthold, Micheal Flavo, Sean Washburn, Richard Superfine and Dorothy Erie in Nanotechnology 13, (2002) p. 601-604 describes chemical steps for DNA functionalization of single-walled carbon nanotubes.

Xidex U.S. Pat. No. 6,146,227 describes a method of fabricating nanotubes on MEMS devices with controlled deposition of nanoparticle catalysts in channel and pore structures of a MEMS. The channel and pore structures provide a template limiting the direction of growth of the nanoparticle catalyzed nanotube. This patent does not discribe or provide any means of performing electron interferometry with the nanotube structures synthesized.

Prior art on fabrication of suspended nanotube circuits can be found by H. D. Dai in the publication Small 2005,1 No. 1 p 138-141 and is incorporated in it's entirety as prior art.

A nanowire template method of fabrication of superconductive nanotube structures particularly applicable to the fabrication of the instant invention tips is described in “Quantum interference device made by DNA templating of superconductive nanowires” David S. Hopkins, David Pekker, Paul M. Goldbart, Alexey Bezryadin in Science 17 June 2005 vol 308 p 1762-1765.

By fabricating two or more individual DNA oligonucleotides on each of the pair or quad flexible gap electrode tips of the instant invention MEMS device a template for superconducting nanotube deposition can be fabricated as in the above reference. By using solid phase DNA synthesis using linker functionalized phosphoramidite synthesis methods, aligned nanowire tunneling probes can be fabricated spanning the MEMS scanner device of the instant invention. By exposing the flexible gap superconducting junction device of the instant invention with the site specific short oligonucleotide molecules on it's flexible gap junction areas to a low concentration of a complementary polynucleotide long enough to span the distance between the flexible gap tip pairs of the MEMS device, DNA molecules spanning the gap of the MEMS can be deposited. By exposing the oligonicleotide functionalized MEMS device to the spanning polynucleotide molecule at concentrations in the 1.0 micromole to 100 micromole range and gating the exposure time allowed for hybridization single molecules spanning the junction can be achieved. A commercially produced automated DNA synthesizer which programmable solution delivery systems can be used to deposit the DNA.

Modified phosphoramidite solid phase synthesis can be used as a means to establish site specific synthesis of oligonucleotides. Electrochemical oligonucleotide synthesis methods as in U.S. Pat. No. 6,280,595, photochemical oligonucleotide synthesis methods such as those in prior art reference U.S. Pat. No. 5,510,270 or “Maskless fabrication of light-directed oligonucleotide microarrays using a digital micromirror array” Sangeet Singh-Gasson, Roland D. Green, Yongjian Yue, Clark Nelson, Fred Blattner, Micheal R. Sussman, and Franco Cerrina, Nature Biotechnology. Vol 17, October 1999. By gating the electrochemical activation of the MEMS electrodes which are to have DNA polynucleotides spanning the flexible gap junctions of the MEMS device single template molecules can be deposited across the flexible gap junction. These DNA functionalized flexible gap junctions can be used for various methods and devices. Preferably the single spanning molecules are used as templates to sputter deposit materials for nanoscale tips or rods spanning the flexible gap junctions.

Vibration of the flexible gap junctions before, during and after deposition of DNA polynucleotide molecules or nanotubes across the flexible gap junction is used to monitor and modulate the junction. After the nanowires which span the flexible gap tunneling junctions are fabricated they can be cut in a spatially selective manner using various means comprising FIB milling, electron beam lithography, scanning tunneling microscope damage.

The connection of reactively terminated nucleic acid molecules or in situ synthesis of nucleic acid molecules on the flexible gap junction tips and or sample substrate is used in the present invention to allow for tunneling spectroscopy for molecular biological analysis and experimentation. The synthesized nucleic acid molecules are preferably used for hybridization with samples possibly containing complementary base sequence structures. Biological organism extracted samples of nucleic acid molecules or synthetic combinatorial populations may be used with the sample substrate and the instant scanning tunneling spectroscopy device. Attachment chemistries used may be from the extensive prior art means available for attachment and in situ nucleic acid polymer synthesis. Alternately polypeptides or proteins may be used to form arrays attached to the sample substrate scanned by the instant scanning tunneling spectroscopy device. Reversible attachment moieties may further be used to provide additional processing of the sample substrate array chemistry.

Suitable reactive functional groups useful for formation of the 324 reversible linker group include, but are not to limited to, biotin, nitrolotriacetic acid, ferrocene, disulfide, N-hydroxysuccinimide, epoxy, ether, Schiff base compounds, activated hydroxyl, imidoester, bromoacetyl, iodoacetyl, activated carboxyl, amide, hydrazide, aziridine, trifluoromethyldiaziridine, pyridyldisulfide, N-acyl-imidazole,isocyanate, imidazolecarbamate, haloacetyl, fluorobenzene, diene, dienophile, arylazide, benzophenone, anhydride, diazoacetate, isothiocyanate and succinimidylcarbonate. Various art recognized coupling and cleaving reaction conditions for linker 324 formation which optimize the synthesis yield will be obvious to one knowledgable in chemical synthesis.

In preferred embodiments the sample object 269 is attached to the sample substrate by a cleavable linker which can be a photolabile compound or an electrochemically labile compound which may be selectively cleaved using electrochemical reduction or oxidation reactions.

In preferred embodiments the sample object 269 is cleaved by a photochemically generated species of compound such as in Gao U.S. Pat. No. (6,426,184). In preferred embodiments the sample object 269 is cleaved by an electrochemically generated species of compound as in U.S. Pat. No. (6,280,595) Multiple disparate linker cleavage compounds allows for independent attachment and release of connections and objects from tips 1,2,3,4,122,123,124 and 125.

Suitable reactive functional groups useful for formation of the tip and substrate reversible linker group include, but are not to limited to, biotin, nitrolotriacetic acid, ferrocene, disulfide, N-hydroxysuccinimide, epoxy, ether, Schiff base compounds, activated hydroxyl, imidoester, bromoacetyl, iodoacetyl, activated carboxyl, amide, hydrazide, aziridine, trifluoromethyldiaziridine, pyridyldisulfide, N-acyl-imidazole,isocyanate, imidazolecarbamate, haloacetyl, fluorobenzene, arylazide, benzophenone, anhydride, diazoacetate, isothiocyanate and succinimidylcarbonate. The compounds terpyridine, iminodiacetic acid, bipyridine, triethylenetetraamine, biethylene triamine and molecular derivatives of these compounds or molecules capable of performing their chelation functions are preferred candidate linker compounds. Various art recognized coupling and cleaving reaction conditions for linkers which optimize the synthesis yield will be obvious to one knowledgable in chemical synthesis. Prior art chemical means useful in functionalizing the device 128 can be found in U.S. Pat. No. 6,472,184 Bandab.

The functionalization of surfaces and attachment of moieties which one wishes to bind to the surface are facilitated by metal ion complexes. The bonding interaction between complexes is provided by organic molecules and or polypeptides which have chelation affinity to metal ions in specific oxidation states. A chelating agent functionalized surface and a labeled molecule which one wishes to attach to that surface can be made to bond in a kinetically labile state and then switched to a kinetically inert state by oxidizing the metal linking the surface and labeled molecule. The release of the labeled molecule is effected by reduction or oxidation of the metal ion in the complex. The modulation of the bonding between chelation susceptible groups by changes in oxidation state of the transition metal in the object to surface linker complex provides a means of cyclically transferring objects like 269 between sample substrate surfaces and tips 1,2,3,4,122,123,124 and 125 in the instant invention.

The transition metal ions used to form chelation complexes in the instant invention include Ru(II), Ir(III), Fe(II), Ni(II), V(II), Cr(III), Mn(IV), Pd(IV), Os(II), Pt(IV), Co(III) or Rh(III). The most suitable ions being Cr(III), Co(III) or Ru(II). Of these preferred ions Co(III) and Ni(II) are the most preferred in the practice of the invention.

The structure of the chemical species composing the ion complex is selected from the group of agents comprising bidentate, tridentate, quadradentate, macrocyclic and tripod lingands. The compounds nitrilotriacetic acid, terpyridine, iminodiacetic acid, bipyridine, triethylenetetraamine, biethylene triamine and molecular derivatives of these compounds or molecules capable of performing their chelation functions are preferred.

The chelation attachment process for SPM-MEMS scanner tip and nanopore functionalization synthesis may be used with aqueous enzyme catalyzed polymer synthesis processes using methods described in Hiatt U.S. Pat. Nos. 5,763,594 and 6,232,465 or the like.

It should be noted by those skilled in the art that synthesis of DNA and RNA arrays and probe and nanopore functionalization is possible using the probes 1,2,3,4,122,123,124 and 125 on substrate 127, 188 or another substrate. Assembly of molecular biological and nanosystems components on substrates 127 and 188 are possible using the present invention SPM, optical and electrochemical means under computer 139 control.

Alternately chelation attachment processes may be used in enzymatic or traditional organic solid phase synthesis of combinatorial polymer arrays such as peptide and nucleotide polymers. Many other polymer classes may be synthesized in conjunction with the instant invention synthesis methods.

Alternate reaction conditions appropriate for these functional groups would be known to those of ordinary skill in the art or organic synthesis.

Chelation systems have been developed in prior art methods which are compatible with phosphoramidite synthesis and enzyme based phosphodiester synthesis (Hurley, D. J. and Tor, Y. (1998) J. AM. Chem. Soc., 120, 2194-2195), (Manchanda, R., Dunham, S. U. and Lippard, S. J. (1996) J. Am. Chem. Soc., 118, 5144-5145), (Schliepe, J., Berghoff, U., Lippert, B. and Cech, D. (1996) Angew. Chem. Int. Ed. Engl., 35, 646-648), (Magda, D., Crofts, S., Lin, A., Miles, D., Wright, M. and Sessler,. J. L. (1997) J. Am. Chem. Soc., 119, 2293-2294)

Additionally formation of 6-histaminylpurine oligonucleotide polymers which are suitable for chelation attachment may be formed by the following methods:
1) MacMillan A. M. and Verdine, G. L. (1990) J. Org. Chem., 55, 5931-5933.
2) MacMillan A. M. and Verdine, G. L. (1991) Tetrahedron, 47, 2603-2616.
3) Ferentz A. E. and Verdine, G. L. (1994) In Eckstein, F. and Lilley, D. M. J. (ed.), Nucleic Acids and Molecular Biology. Springer-Verlag, Berlin, Vol. 8, pp. 14-40.
4) Ferentz, A. E. and Verdine, G. L. (1992) Nucleosides Nucleotides, 11, 1749-1763.
5) Ferentz A. E. and Verdine, G. L. (1991) J. Am. Chem. Soc., 113, 4000-4002.
6) Ferentz, A. E., Keating, T. A. and Verdine, G. L. (1993) J. Am. Chem. Soc., 115, 9006-9014.
7) Min, C. and Verdine, G. L. (1996) Nucleic Acids Research, Vol. 24, No. 19

Polymers such as polypeptides, proteins, aptamer nucleic acids and derivatives thereof may function as chelation groups as well and synthesized or placed on substrate 127 or 188. In particular molecules containing chelation peptide moieties or derivatives are particularly preferred in the instant invention for attachment of molecules to the sample substrate. Such chelation groups may also serve as synthesis site initiators. It is well known that peptides of the following formula have high affinity for transition metal ions.
(His).subx.−(A).sub.y−(His).sub.z

where A is one or more amino acid monomers,

x=1 to 10,

y=0 to 4,

z=1 to 10,

Additionally repeated units of the same or similar polypeptide sequence as above possess chelation activity.

The oxidation state of the metal ion may be modified electrochemically, optically or by chemical oxidizing agent to “lock” the chelation complex in place once the chelation complex has formed. A long linker attaching the metal ion chelator to the NObj nascent object may be composed of a wide variety of molecules such as polyacrylates, polypeptides, polyethers, polynucleotides or any other polymer.

Scavenger agents in contact with the synthesis substrates are used in preferred embodiments to reduce unwanted oxidation of sensitive nascent object moieties when using electrochemical or optical oxidation methods for modulation of the synthesis of object 269 or chemical functional groups or the like.

The release of chelation peptide or chelation molecule containing NObj via Co (III)transition metal-substrate complex is achieved via reduction of the metal ion by adding 0.1M beta-mercaptoethanol and boiling for 5 minutes. Localized probe heating or excitation can limit thermal effects on other regions of the device 128 and substrate 127. Use of photolabile or electrochemically generated redox agents is particularly useful in the instant invention. A large variety of suitable reduction agent compounds will be obvious to one skilled in the art.

Moreover, arbitrary combinations of the above-described elements and so forth, as well as expressions thereof changed between a method, an apparatus, a recording medium, software, a computer program, hardware, etc. are encompassed by the scope of the present invention.

Conclusion, Ramifications, and Scope of Invention:

The reader will see that the flexible gap scanning interferometer microscope and nanomanipulator of the present invention provides means for spectroscopy, imaging and manipulation of nanomaterials. The description of the present invention contains many specificities, these should not be construed as limitations on the scope of the invention but rather as exemplifications of preferred embodiments thereof Many variations of the flexible gap scanner device are possible. For example various methods and processing steps during and after isolation of genomic nucleic acid polymers from biological samples may be used in embodiments to obtain and measure and modify nucleic acid molecules for and with the SPM-MEMS scanner. Hybridization of nucleic acids and study of the structure and function of genes is possible using the present invention. Polymerase chain reaction PCR and other nucleotide amplification methods and bio-molecular array synthesis and replication methods can be performed in combination with the instant invention.

The present invention can have possible embodiments where one or more of the probes 1,2,3,4, 122,123,124 and 125 are used as a micromachining stylus tool and is preferably made of diamond or a similar hard material which can be used to cut or scratch materials. At least 1 tip is used as coherent electron interferometer devices in conjunction with the micromachine stylus tips. The coherent electron interferometry operation means is used before, during or after mechanical modification of a sample. Energy filtered scanning tunneling microscopy can be performed with the instant invention using semiconductor tips or probes in the present device. The present invention can be used as an ultra fast nanoelectronics, molecular electronics or quantum qubit logic tester or I/O device in preferred embodiments. It can perform as a prototype development and testing platform.

Transmission or scanning transmission electron microscopy can be used to image and perform electron holography of the tips, spanning nanostructures and samples of the device 128 or sample substrates 127 or 188. The SQUID needs to be shielded when operated in a variable magnetic field or compensated for flux alterations. A mu metal and a superconductive shielding layer of London thickness or greater can be used to encapsulate the device 128 and as an ultra thin beam window.

Alternately the SQUID and electron microscope imaging can be done in sequence where the SQUID is not operated when the scanning signals are being sent to the coils of the electron microscope. This is true of the scanning electron microscope and focused ion beam mill being used with the device 128 also.

Field ion microscopy and field emission microscopy can be performed on or with one or more probes of the present invention.

Near field microwave and scanning probe Schottky diode methods can be performed with the flexible gap probe of the present invention as can any other scanning probe microscope technique be performed with appropriate hardware and software modifications.

Transmission ion and scanning ion microscopy and spectroscopy can be used to image and characterize the present invention device structures and sample. Electron microscopes and field emission microscopy of tips and spanning structures can be performed in addition to electron holography of the tips, spanning nanostructures and samples of the device 128 or sample substrates 127 or 188.

Cellular automata can be fabricated on the probe, prototyping areas of the present invention or they can be fabricated on the sample substrate area and scanned and manipulated by the present invention. In particular quantum-dot cellular automata are of particular interest for the above use or implementation of the coherent electron scanner device.

Synchrotron radiation can be used to image and perform diffraction, spectroscopy and holography of the tips, spanning nanostructures and samples of the device 128 or sample substrates 127 or 188.

Preferably an embodiment of the invention uses nucleotide base molecules or functional groups attached to nanotube tip or spanning probes capable of interacting selectively with each of the bases in a nucleotide polymer as it is drawn through the junction of the flexible gap interferometer device. Alternately the nucleotide polymer can be drawn over a spanning nanotube attached to a coherent electron interferometer MEMS/NEMS device 128.

In a further embodiments of the instant invention the flexible gap coherent electron junction properties of the device are used as a means for a microstrip SQUID amplifier. Alternately the present device described above can have one or more microstrip SQUID amplifiers interact with the flexible gap junction and sample.

The flexible gap junction can be operated or fabricated in a one dimensional mode where the probe junction gap is actuated in one dimension and a sample is spectroscopically measured as the junction is modulated. The atomic forces and molecular forces of materials in the junction can be measured as in force distance atomic force microscopy is done on biological ligands, receptors, antibody-antigen and enzyme-substrate complexes.

The present invention can be operated so as to perform the operations and means for a self assembly search engine for nanosystems or bioinformatics and proteomics search engine.

In a further possible embodiments of the instant invention the coherent electron properties of the device are used to perform Aharonov-Bohm interferometry with the multiple tips of the instant invention a nanomanipulator and scanner are fabricated with Aharonov-Bhom interferometer capabilities. The superconducting and normal metal tips on the same MEMS/NEMS device 128 can be used to perform Aharonov-Bohm interferometry in conjunction with Josephson junction SQUID interferometry.

In an Aharonov-Bohm interferometer a pair of electrodes separated by a phase coherent medium is measured. When a small object such as a nanoparticle quantum dot is placed in the space between the electrodes there are two possible paths for the electrons in the interferometer to take. One is direct tunneling between the two leads and is temperature independent, the other is through the quantum dot and is called Kondo effect tunneling. There is an associated temperature called the Kondo temperature where a tunneling conductance transition occurs. Because the flow of electrons through a nanoparticle quantum dot is inhibited by Coulomb charge interaction of electrons (Coulomb Blockade) at temperatures above the Kondo temperatures little Fano interference occurs above the Kondo temperature. Below the Kondo temperature tunneling by Kondo resonance occurs through the nanoparticle quantum dot and a Fano interference signal results from the interaction of the Kondo resonance and direct tunneling path in the phase coherent electron device. Base pairing of DNA and RNA associated with the tunneling tip in conjunction with Kondo resonance spectroscopy can be used to determine structural features of single and double stranded molecules and complexes scanned by the present invention.

Correlation of spectroscopic scan data for DNA and RNA sequences with mass spectroscopy by the scanning atom probe means provides the present invention unique capabilities to sequence DNA and RNA as well as other molecular systems.

The atom probe extractor electrode can have multiple electrically connected or insulated probe structures attached and in addition electrostatic atom, molecule and ion effecting electrodes of any shape can be attached to the device on substrate 127,128,188 or the extractor electrodes 348 or 354. Spanning objects as in 158,159,160 and 161 can be used to span the aperture of the extractor electrodes 348 and 354.

Arrays of Josephson junctions and SQUID circuits are preferably formed in prototyping areas 144,145,146,147, 148,149,150 and 151 and attached to the flexible gap junction 1,2,3,4,122,123,124 and 125.

Transition edge superconductor detector methods and devices can be combined with the flexible gap coherent electron scanner of the present invention to provide enhanced detection capabilities.

The present invention has possible embodiments where the flexible gap junctions described above can be used to scan substrates 127 and 188 where said substrates have surface enhanced Raman spectroscopy particles or structures on it. The surface of 127 or 188 can have nanoshell particles composed of dielectric cores and metallic coating used for enhancing signals of the SERS detection process. Hollow nanoshells can be used also. These can be loaded with reagents, bimolecules, chemicals or catalysts.

The present invention has possible embodiments where the flexible gap junctions described above can be used in conjunction with or in an arrangement comprising a matched load detector Josephson junction device.

The present invention has further possible embodiments where the flexible gap junctions described above can be used in conjunction with or in an arrangement comprising a discrete breather Josephson junction device.

The present invention has further possible embodiments where the flexible gap junctions described above can be used in conjunction with or in an arrangement comprising an anisotropic ladder Josephson junction device.

The present invention has further possible embodiments where the flexible gap junctions described above can be used in conjunction with or in an arrangement comprising a quantum mechanical qubit information device.

The present invention has further possible embodiments where the flexible gap junctions described above can be used in conjunction with or in an arrangement comprising a quantum ratchet Josephson junction device and said ratchet is modulated by electromagnetic excitation of the sample.

The present invention has further possible embodiments where the flexible gap junctions described above can be used in conjunction with or in an arrangement comprising a quantum ratchet Josephson junction device where said quantum ratchet is modulated by electromagnetic excitation of the sample and one or more nanoparticle labels or molecular electronic structures in proximity to the flexible gap junction is scanned.

The present invention has further possible embodiments where the flexible gap junctions described above can be used in conjunction with or in an arrangement comprising a quantum ratchet Josephson junction device where said quantum ratchet is excited by electromagnetic excitation and one or more of the RNA or DNA molecule, nanoparticle label or molecular electronic structures in proximity to the flexible gap junction is scanned.

Sub-Flux Quantum Generator with an Integrated Flexible Gap Scanner:

The instant invention has preferred embodiments where one or more switchable stable sub-flux quantum generators are integrated with one or more flexible gap scanner junctions attached to tips 1,2,3 or 4. In one embodiment of the invention, an N-turn ring is used to trap fluxon or sub-fluxon amounts of magnetic flux in a circuit in communication with a signal which traverses the flexible gap junction region 5 where the tips 1,2,3 and 4 interact. Each turn of the N-turn ring includes a switch. By modulating the switches in the N-turn ring, the amount of magnetic flux in the N-turn ring and flexible gap junctions can be used to control the amount of magnetic flux trapped within the flexible gap junction associated ring with sub-fluxon precision. The trapped flux can be used to measure the physical properties if the material on sample substrate 127 and/or 188 scanned by the flexible cap junction tips 1,2,3 and 4. The switchable N-turn ring provides a reliable external magnetic flux that can be used to bias a persistent current qubit so that the two stable states of the qubit are degenerate.

The scanner tip junctions 1-2, 3-4 or the large area flexible gap Josephson junction 271 can be connected with or used as junctions in a sub-flux quantum generator.

The scanner tip junctions 1-2, 3-4 or the large area flexible gap Josephson junction 271 can be used as high frequency break junctions for connecting, disconnecting and routing superconductor lines and signals.

One possible embodiment of the present invention provides a sub-flux quantum generator. The sub-flux quantum generator attached to the flexible gap junction comprises an N-turn ring that includes N connected turns, where N is an integer greater than or equal to two. Further, each turn in the N-turn ring has a width that exceeds the London penetration depth λ_{L} of the superconducting material used to make each turn in the N-turn ring. The sub-flux quantum generator attached to the flexible gap junction further comprises a switching device that introduces a reversible localized break in the superconductivity of at least one turn in the N-turn ring. The sub-flux quantum generator also includes a magnetism device that generates a magnetic field within the N-turn ring.

In some possible embodiments, the switching device in sub-flux quantum connected to the flexible gap scanner is a flux generator with a cryotron that encompasses a portion of one or more of the turns in the N-turn ring connected to the flexible gap scanner circuit. In some embodiments, the switching device in the sub-flux quantum generator is a Josephson junction that is capable of toggling between a superconducting zero voltage state and a non-superconducting voltage state. In some embodiments, this Josephson junction attached to the flexible gap junction includes a set of critical current leads that are used to drive a critical current through the Josephson junction to toggle the Josephson junction between the superconducting zero voltage state and the non-superconducting voltage state.

In some possible embodiments, the sub-flux quantum ring attached to the flexible gap junction generator includes a set of leads that is attached to the N-turn ring. The magnetism device is in electrical communication with the set of leads in order to drive a current through the N-turn ring. In some embodiments of the present invention, the superconducting material used to make a turn in the N-turn ring is a type I superconductor such as niobium or aluminum. In some embodiments of the present invention, the superconducting material used to make a turn in the N-turn ring is a type II superconductor. The scanner tip junctions 1-2, 3-4 or the large area flexible gap Josephson junction 271 can be connected with cryotron switches. The scanner tip junctions 1-2, 3-4 or the large area flexible gap Josephson junction 271 can be in conjunction with cryotron switches to perform high frequency operations for connecting, disconnecting and routing superconductor lines and signals.

Variable temperature scanning is a preferred embodiment of the invention where one or more tip of the interferometer or sample is raised or lowered to a different temperature from the other components of the interferometer tip probe circuit. Differential thermal tunneling effects can be probed by having asymmetry in the temperature of the tunneling pathway through the sample in the interferometer.

Asymmetric superconductor, normal metal and semiconductor tip arrangements are possible and can be fabricated by the above described means.

Dielectric Oscillation Detection of Tip Gaps:

An alternate embodiment of the invention can use any of the probe tips 1,2,3,4, 122,123,124 and 125 to perform dielectric oscillation detection mapping of materials in the flexible gap junctions of the interferometer scanner. This dielectric measurement scan of the sample can be compared with standard scanning tunneling, atomic force microscopy and scanning SQUID interferometry data set of the sample. In a preferred embodiment the sample is DNA or RNA and simultaneous or sequential scanning dielectric microscopy and standard scanning tunneling and scanning SQUID interferometry of the sample are performed. Inelastic electron tunneling spectroscopy can be performed in conjunction with the dielectric oscillation scanning as well as SERS Raman spectroscopy using the present invention.

In a further embodiments the scanning flexible phase coherent electron junction has one or more nanoparticles associated with it. Preferably the nanoparticle is at the apex of a tip or spanning probe structure such as object 158 and forms a conduction channel of the Aharonov-Bohm interferometer. The phase coherence of the instant invention and the flexible gap allow for scanning of samples in the device and observation of Kondo effect spectroscopy of the device and sample when scanning samples. Preferably the samples are nanoscale systems or nucleotide or protein polymers. The measurement of thermopower transmission across the junction of the instant invention allows for molecular and nanoscale characterization of samples, arrays and surfaces. The thermopower measurement of an Aharanov-Bohm interferometer measures the transmission probability weighted by the electronic excitation energy with respect to the Fermi energy. This measurement is very sensitive to the particle-hole asymmetry in the transmission probability. The nanoparticle in the Aharonov-Bohm interferometer cause a splitting of the conduction tunneling channels across the electrodes of the interferometer due to the direct tunneling channel and resonant channel. Scanning a RNA or DNA molecule through the channel can be performed to characterize the sequence and structure of the molecules and associated chemicals and their interactions.

Asymmetrical Fano interference can be measured by measuring differential conductance measurement in preferred embodiments of the invention.

By using a gate voltage associated with the Aharonov-Bohm interferometer control of the tunneling coherence is possible. Thus in a preferred embodiment there is one or more gate electrode structures associated with the coherent electron scanning probe circuit which can modify the phase or amplitude of the flexible gap junctions of the device.

The present invention can be used as a four point probe or a multiple point probe to test mesoscopic and molecular electronic devices as well as molecular mechanical devices.

The above device can preferably be used to perform lithography and fabrication of nanometer scale structures in combination with nanomanipulation and mass spectroscopy.

Genetic algorithm evolution of gate mediated coherent electron circuits in the prototyping areas 74,75,76,77,144, 145, 146,147, 148,149,150 and 151 and attached to the flexible gap junction 1,2,3,4,122,123,124 and 125 is an application of the instant invention where the unique software and scanning probe microscopy and nanomanipulation of atoms and molecules in a feedback process can generate autogenic structures with novel properties. Design and tuning of these structures by genetic algorithm and fabrication in the prototyping areas 74,75,76 and 77 are performed iteratively with testing of known and unknown sequences of RNA or DNA.

Evolvable hardware can be built and tested by the present invention on substrates such as 127 and 188. In addition evolvable software can be used with the present invention to evolve novel software code for various system automated tasks associated with the device systems and operational methods.

Inelastic electron scattering can be performed by in preferred embodiments of the invention by varying the potential across the tip probe over a position of a sample in the interferometer. Isotopic or chemical functional labeling of biomolecules or other samples can be used in conjunction to selectively identify groups in complex samples such as nanosystems, nucleic acid polymers, polypeptides and proteins.

The instant invention has a further embodiment where the electron interferometer scanner is used in a vacuum chamber with means for electron microscope and focused ion beam milling capabilities. The device of the instant invention is used in conjunction with these fabrication and characterization tools to perform nanoscale fabrication and characterization of materials and systems. The interferometer circuit and nanotweezer nanomanipulator tips of the device in such an embodiment has a switch attached to the coherent electron conduit lines of the flexible gap beam structures for connecting and disconnecting voltage and current sensitive components from the tip structures exposed to irradiation by electron beams and ion beams. Shunting and switching using switching means in prototype areas 5, 74,75,76 and 77 of the scanner probe tips 1,2,3 and 4 from quantum interferometer or mesoscopic structures of the Josephson junctions 21, 37 or the prototyping areas 74,75,76 and 77 can be used to change the electrical behavior and interconnection topology of the tips and interferometers. The electron beam, ion beam or optical beam can be used to modify prototyped structures and interconnections.

Use of chemically functionalized nanoparticles to measure nucleotide polymer molecules scanned by the Aharonov-Bohm embodiment of the invention is a preferred embodiment of the invention. The functionalization of the nanoparticles in the junction with nucleotide base selective functional groups such as complementary bases allows for selective measurement of the nucleotide base sequence effects on the electron phase coherent tunneling and thermopower measurement of the Aharonov-Bohm interferometer. The sample object 269 can be an oligonucleotide attached to the surface of the second surface substrate using thiol modified nucleobases.

Chemical and isotope, coherent electron vibrational scanning spectroscopy for DNA measurement using base labeling of ring, exocyclic carbon, nitrogen and deuterium single, double or more labels is a further preferred embodiment of the invention. Use of Sulfur and phosphate labels is also a possible contrasting medium for vibrochemical tunneling spectroscopic sequencing. In conjunction with the mass spectroscopic means of the present invention these means allow for spectroscopic and compositional mass analysis of materials in samples and on the substrate. It is preferred that arrays of materials with duplicate copies of material scanned are present so that after mass spectroscopy a copy of the analyzed and preferably sequenced material is still present on the substrate or a replica substrate array.

In a further preferred embodiment of the instant invention the SERS nanoparticle probes or regions of the probes of the flexible gap junction or junctions are functionalized with alternate functional A-C, G-A, T-A, T-C, G-T, G-C monomers or dimers at the nanotube apertures of tips 1,2,3 and 4 or spanning structures 168,159,160,161,170 or 171. DNA base pairing switches the tunneling conductance or resonant states of the flexible gap junction during incremental scanning of the DNA or RNA by tips 1,2,3 and 4 as well as spanning nanoscale structures 158,159,160,161,170 and 171 of device 128. Detection of coherent electron tunneling variations as a function of incremental movement of the DNA or RNA object 269 is used to sequence or characterize the polymer. Alternately the scanner can be moved incrementally. Simultaneous Raman spectroscopy of the polymer is recorded during incremental movement through the scanner.

The use of nano imprint lithography in conjunction with the present invention is a method anticipated as a useful patterning and systems development combination with the present invention, particularly with the genetic algorithm and combinatorial synthesis capabilities coupled with the nanomanipulator of the present invention.

It is possible to use modified proteins comprising DNA polymerases, nucleases, single strand binding protein or topoisomerase in conjunction with the flexible gap coherent electron probe of the instant invention. Modification of natural or synthetic proteins or enzymes to produce tunneling channels through or around the protein sample complex and probe tip interferometer is a preferred embodiment. Nanoparticle modular probe replacement materials can be put on the device or a substrate to extend use of the device. Preferably the modular probe replacement material is composed of nanoparticles with oriented base pair functional groups~but may comprise any organic or inorganic materials. Preferably libraries of nucleotide processing enzymes, regulatory proteins, oncogenes, phages, viruses and nucleotide arrays are used as modular tip replacement particles.

The above embodiments, methods and means can be used to form bimolecules, aggregates and transfection systems. Introduction of genes, genomes and hybrid systems of molecular-protein-nucleotide and nanoparticle materials into living cells or organisms can be used in conjunction with the present invention to provide novel molecular biological capabilities. Eukaryotic and prokaryotic cell libraries can be used in conjunction with these embodiments of the device to perform methods comprising bioinformatics, proteomics and genomics. Transgenic organisms and stem cells can be created, analyzed and manipulated as known in the art and in new ways using the present invention. Associated software can interface with the software diagrammed in FIG. 41.

The invention can be used with data networking devices, structures and algorithms to provide automated synthesis, search and distributed computing and fabrication of nanoscale systems and biological systems using the nanomanipulator, scanning probe microscope and associated systems and algorithms of the present invention. Consortia of users possessing a multitude of device systems of the present invention can integrate fabrication, synthesis, sequencing, mutation, array screening, evolution and measurement processes on new and existing libraries of scanned data and samples to implement distributed problem solving and time sharing activities.

SELEX and SELEX-like combinatorial search methods can be implemented using the combinatorial synthesis apparatus integrated with the present invention scanner device for wide combinatorial space searches to find novel target molecules and structures. Molecular arrays and libraries can be scanned by the present invention for characterization and feedback processing.

In preferred embodiments the MEMS device of the instant invention is operated in an array configuration where multiple scanners on a wafer or individual chips are oriented and actuated in concert with multiple sample substrates.

One or more cantilever of the flexible gap junction may have means for varying the spring constant of the cantilever and acting as a resonant frequency modulator or clamp for fixing the position of one or more of the tips 1,2,3 or 4 for micromachining using a diamond probe tip. Scanning the coherent electron interferometer tip across the machined surfaces allows for characterization of the modification done by the diamond tip.

Various differential thermal junction effects can be used to modify and scan materials using the device.

In a further embodiments the quad device of the above figures is fabricated with a SOI handle wafer and SOI layer trench notch in the side so that two or more MEMS/NEMS chips can be interlocked and provide an orthogonal eight cantilever MEMS/NEMS hybrid scanner and nanomanipulator. Flip chip stacking and integration of multiple flexible gap containing MEMS/NEMS chips or wafers can be arranged. Quantum well structures can be connected to the flexible gap junction to provide electronic and optical measurement and modulation.

The present invention can be shielded and placed in a vacuum chamber used for environmental scanning electron microscopy (ESEM) with focused ion beam milling (FIB) and electron holography with nanomanipulator probes. ESEM can operate in low vacuum and deposit metals and insulators on the fly for prototyping.
Fast machining and prototyping on the nanoscale
High-resolution characterization and analysis in 3 dimensions
Integrated digital patterning engine allows optimized patterning conditions for each application, the production of complex shapes and 3D milling
High-precision, site-specific TEM sample preparation and cross sectioning

Dual Beam (FIB/SEM) instrument with ESEM support the lab requirements of the nanotechnology, material science and life science application. Its a precision stage, versatile specimen chamber and dual beam (FIB/ESEM) with EDAX and gas delivery chemistry allow researchers to analyze, characterize, machine and prototype nanosystems and Microsystems on the atomic, molecular and nanoscale. Software control enables researchers to combine the scanning probe microscope of the present invention with imaging and milling and deposition of a dual beam instrument. These dual beam (SEM/FIB)instruments are commercially available from FEI inc in the USA and SII nanotechnology of Japan. The present MEMS/NEMS system can be integrated with these existing instruments as enhancement nanomanipulator and scanning probe devices. Integration of a commercially available scanning atom probe (SAP) such as the IMAGO inc LEAP microscope or Oxford Instruments Laser 3-Dimensional Atom Probe (L-3DAP) with the present invention MEMS/NEMS instrument will allow researchers be able to visualize the atomic structure of semiconductor devices and general manipulation of structures at the molecular and atomic level with mass spectroscopic identification. MEMS and NEMS embodiments of the devices for means comprising combinatorial synthesis, laser, electron beam, ion beam and mass spectroscopy devices can be used to miniaturize the present invention.

The prior art reference by “Electrical cutting and nicking of carbon nanotubes using an atomic force microscope” Ji-Yong Park, Yuval Yaish, Markus Brink, Sami Rosenblatt, and Paul L. McEuena), APPLIED PHYSICS LETTERS VOLUME 80, NUMBER 23 10 JUN. 2002, describes nanotube cutting and nicking using an atomic force microscope and STM. The nanotubes processed are spanning lithographically defined structures applicable to the region 5 tip interaction zone of the present invention depicted in the above figures.

Nanobimorph actuators and sensors can be integrated into the probes and coherent electron interferometer or SQUID flexible gap circuit.

In preferred embodiments of the invention grain boundary Josephson junctions may be used as well as flip chip hybrid MEMS/NEMS devices for fabrication of the instant invention. Mapping of the sample and substrate conductive states by coherent SQUID current provides a means of obtaining novel spectroscopic data about molecules, materials and assemblies. Excitation of the sample and or junction tip states provides a means of obtaining additional sample information as the sample substrate is scanned.

The same artificial intelligence or genetic algorithm methods used to control formation of prototype circuits in prototyping areas of MEMS/NEMS device of the present invention can be used for novel processing of genetic material comprising sequencing, copying, assembling, editing, mutating, packaging, functionalizing and decorating using the bimolecular scanner structure embodiments of the invention. The artificial intelligence or genetic algorithms can be used in combination with the present invention to build and screen combinatorial chemical libraries and integrated molecular systems. Many possible embodiments and applications comprehensible to those knowledgeable in the arts will be obvious.

What is claimed is:

1. An integrated quantum interference circuit and electromechanical device structure comprising:
a first surface;
said first surface possesses one or more quantum interferometer devices comprising;
(a) one or more flexible gap coherent electron junctions formed by at least one probe structure, having at least one region with submicron scale radius of curvature or thickness;
one or more second surfaces referred to as the scanned sample substrate;
one or more transducer means for scanning said sample substrate;
one or more actuators which can spatially drive flexure or displacement of said one or more flexible gap coherent electron junctions;
one or more detection devices used to measure the displacement of the flexible gap coherent electron probe junction or junctions;
one or more flexible gap junction probe signal detectors,
One or more controller devices that control above said one or more flexible coherent electron junctions, said one or more flexible gap actuators and transducer means for scanning said sample and detects flexible gap junction probe detector signals and flexible gap displacement sensor output signals.

2. Device as in claim 1 where said second surface comprising a sample carrier substrate and sample material, possesses samples comprising molecules, atoms, biomolecules, electronic circuits, nanosystems or composite structures which are scanned by said quantum interferometer device of first said surface,
said second surface is scanned by said first surface device by transducer means with sub-nanometer resolution and is translated so as to allow at least one flexible gap junction probe structure of the first said surface to come within proximal energy interaction distance or contact said second surface structure, said flexible gap junction of said quantum interferometer device on first said surface is spatially modulated by one or more said actuators during translation of said second scanned sample substrate.

3. Device as in claim 1 where the quantum interferometer device of first said surface is connected to a single electron transistor device which allows for injection of single electrons into a flexible gap coherent junction or Josephson junction.

4. A micron to submicron dimensioned superconducting integrated quantum interference circuit and microelectromechanical system structure comprising:
a first surface;
said first surface possesses a multilayer thin film comprising the following;
(a) 100 nm Niobium superconductor layer
(b) 150 nm SiO2 insulation layer
(c) 130 nm Josephson junction Niobium Trilayer base electrode
(d) 0.5 to 10 nm Josephson junction AlOx Trilayer insulating layer
(e) 130 nm Josephson junction Niobium Trilayer top electrode
(f) 100 nm SiO2 insulation layer
(g) 50 nm Molybdenum resistor layer
(h) 100 nm SiO2 insulation layer
(i) 300 nm Niobium superconductor layer
(j) 500 nm SiO2 insulation layer
k) 500 nm Niobium superconductor layer
(l) 350 nm Ti/Pd/Au resistor and contact pad layer
(m) 1 to 10 nm non-oxidizing metal probe junction layer used to prevent Niobium Oxide layer from forming over the probe apex area of flexible junction gap;
(n) a 100 to 300 mm diameter silicon wafer substrate
The first surface Niobium superconductor base layer or top layer is patterned preferably using lithography and or focused ion beam milling so as to form opposing probe structures, each probe structure having a region With a nominal radius of curvature of 1 to 50 nm, said probe pair has a variable gap junction separation distance modulated by a sub-angstrom resolution actuator.

5. A micron to submicron scale superconducting integrated quantum interference circuit and electromechanical system structure comprising:
a first surface;
said first surface comprising a multilayer thin film composition as in claim 1 where said flexible gap coherent electron junctions are formed by at least one superconducting base layer, insulator layer and superconducting junction layer top layer forming a Superconducting Quantum Interferometer Device, said variable gap junction separation distance is driven by one or more actuators and allows for modulation of the gap junction separation distance;
a second surface referred to as the scanned sample substrate, which is scanned by said interferometer.

6. A micron to submicron scale superconducting integrated quantum interference circuit and electromechanical system structure comprising:
a first surface;
said first surface possesses a multilayer thin film composition as in claim 2 where said flexible gap coherent electron junctions are formed by at least one superconducting trilayer base layer, AlOx layer and superconducting trilayer top layer, to form a multi-junction SQUID (Superconducting Quantum Interferometer Device), said variable gap junction separation distance is driven by one or more actuators and allows for modulation of the gap junction separation distance, said modulation of variable gap junction and resultant tunneling current is used to perform both spectroscopic and spatial mapping of sample materials.

7. Device as in claim 1 where at least one flexible gap Josephson junction possesses at least one nanotube which bridges at least one said pair of probes forming the flexible junction gap, said nanotube is in electrical contact with at least one superconducting quantum interferometer device of first said surface.

8. Device as in claim 7 where said nanotube bridging said flexible gap junction is modified so as to form a self aligned bisected nanotube pair with a variable gap separating the nanotube pair.

9. Device as in claim 8 where said bisected nanotube pair are chemically modified so as to generate chemical functional groups attached to said nanotube pair.

10. Device as in claim 9 where said chemical functional groups attached to said chemically modified nanotube pair are nucleic acid monomers.

11. Device as in claim 10 where said chemical functional groups attached to said chemically modified nanotube pair are nucleic acid polymers.

12. Device as in claim 11 where said chemical functional groups attached to said chemically modified nanotube pair are nanomachines.

13. A micron to submicron superconducting integrated quantum interference circuit and electromechanical system structure comprising:
a first surface;
said first surface possesses a multilayer thin film superconducting quantum interferometer device comprising the following;
a. at least one standard fixed tunneling gap Josephson junctions;
b. one or more flexible open gap Josephson junctions formed by multiple probe structures each of which have a nanometer scale radius of curvature at their apex;
c. an actuator which can drive the flexible gap Josephson junction;
d. at least one flexible open gap tunneling junction formed by multiple probe structures each of which have a nanometer scale radius of curvature at their apex, said second open gap junction has one of the probe structures forming the junction attached to a stationary position of the first surface substrate, the second probe structure of the multiple probe forming the flexible gap is attached to the cantilever of the first flexible open gap Josephson junction;
e. a detection device used to measure the displacement of the flexible open gap tunneling junction;
a second surface,
said second surface comprising at least one superconducting material layer which is used to attach or fabricate molecules or atomic structures which are scanned by superconducting quantum interferometer device of first said surface, said second surface attached to a transducer and is translated so as to allow the flexible gap junction probe structures of the first said surface to contact said second structure.

14. The second substrate surface structure of claim 1, further including means for applying a potential between at least one pair of flexible open gap coherent electron junction probes and said second substrate surface, and circuit means for measuring and modulating the changes in said potential connected to at least one of said probes.

15. A device as described in claim 13 where said flexible junction displacements are measured using a normal conductor tunneling junction which uses non-Cooper pair electrons as current source.

16. A device as described in claim 1 where a Coulomb blockade device is used to inject electrons into one or more of the coherent electron junctions.

17. A device as described in claim 1 where one or more nanoparticles or nanoshells is placed in contact or proximity to said flexible gap junction, energizing said nanoparticle or nanoparticles results in excitation of electron or spin states of said nanoparticle or nanoparticles, said energizing and excitation interacts with said flexible gap junction and is used to measure or modify the physical states comprising optical, acoustic, spin, chemical and electronic states of said flexible gap and sample material.

18. A device as described in claim 17 where said illuminated nanoparticle or nanoparticles are used to detect said flexible gap junctions energy state.

19. A device as described in claim 1 where said sample substrate has an area of surface with said scanned material sample attached and a surface area which is used to record information comprising general data and or data resulting from the scanning process of said scanning junction gap interactions with said sample material.

20. A device as described in claim 19 where said scanned sample material attached to said sample substrate is composed of polynucleic acid molecules such as RNA, DNA or analogs of such compounds.

21. A device as described in claim 19 where said scanned sample material attached to said sample substrate is composed of polyamino acid proteins, peptides or analogs of such compounds.

22. A device as described in claim 1 where said first surface circuit has at least one gap junction which possesses a Superconductor-Insulator-Normal conductor configuration.

23. A device as described in claim 1 where said first surface circuit has at least one gap junction which possesses a Superconductor-Insulator-Normal-Insulator-Superconductor configuration.

24. A device as described in claim 1 where said first surface circuit has at least one gap junction which possesses a Superconductor-Normal-Superconductor configuration.

25. A device as described in claim 1 where the flexible gap variable junction is the only tunneling junction in the quantum interference device, said flexible gap variable junction is part of a broken ring structure which supports coherent electron transport around said ring structure, said broken ring of the flexible gap junction is operated in a normal conductive state with phase coherence.

26. A device as described in claim 25 where the flexible gap variable junction is the only tunneling junction in the quantum interference device, said flexible gap variable junction is part of a broken ring structure which supports coherent electron transport around said ring, said ring has a magnetic component or particle at one or more points along said ring which has the flexible gap variable junction.

27. A device as described in claim 1 where said flexible gap junction possesses one or more inductive pickup loops which are used to detect and or generate flux in said flexible gap junction forming a circuit, said flux is used to probe the sample which is scanned in the flexible junction gap.

28. A device as described in claim 1 where said second substrate surface with sample has one or more structures with one or more nanometer scale electrode structures on said surface, said nanometer scale electrode structures are used to perform differential conductance and interferometric measurements of electron transport between said nanometer scale electrodes and the electrode pair of said flexible gap variable junction probes.

29. The device of claim 1 wherein the instant invention is operated in a mode where the flexible gap Josephson junction circuit is exposed to a magnetic field whose flux lines are enclosed by one or more superconducting rings, in said quantum interference device, the magnetic flux induces a supercurrent in the ring structure which exactly opposes the applied flux, the induced supercurrent persists as long as the magnetic field is applied, if the device is cooled below the superconducting transition temperature in the presence of the magnetic field the persistent current will remain in the absence of the field, the ring structure will have a current fixed in a quantum state indefinitely, the circulating supercurrent will remain and maintain the flux at its initial value.

30. A method as claimed in claim 29, including the steps of:
subjecting said applied magnetic field to variation and spatially varying said flexible tunnel junction gap and said electrical potential between said second surface substrate sample and said first surface tunnel probe or probes, and determining a change in electron transport across said sample as a function of said magnetic field variation with said bias potential, thereby mapping said second surface sample states.

31. Device as in claim 1 where said device comprises a coherent electron tunneling device with flexible junction gap operated in a mode where said first surface flexible junction is used for processes comprising means of spectroscopic scanning, writing and erasing patterns on said second surface substrate, said second surface substrate has at least one surface placed in contact or proximity to at least one probe of the flexible junction gap, said second substrate surface is brought into proximity, tunneling distance or contact with said tips to facilitate scanning measurement and writing processes.

32. Device as in claim 1 where said device comprises a coherent electron capable tunneling device with flexible tunneling junction gap where first or second surface interacts with one or more electrophoresis channels or electrophoresis separation products.

33. Device as in claim 17 where said device comprises a phase coherent capable tunneling device with flexible tunneling junction gap operated in a mode where at least one said first surface flexible junctions is illuminated by a means for generating electromagnetic oscillations.

34. Device as in claim 17 where said device comprises a phase coherent capable tunneling device with flexible tunneling junction gap operated in a mode where at least one said second substrate sample surface is illuminated by a means for generating electromagnetic oscillations and one or more gate structures is associated with said flexible gap junctions where said gate can change the potential of said flexible gap probe or nanoparticle.

35. Device as in claim 17 where said device comprises a phase coherent capable tunneling device with flexible tunneling junction gap operated in a mode where said first surface flexible junction has a structure which acts as a waveguide for generated electromagnetic oscillations, said scanning probe has one or more field effect gate structures connected to the electron interferometer.

36. Device as in claim 35 where said device comprises a phase coherent capable tunneling device with flexible tunneling junction gap operated in a mode where said first surface flexible junction has an integrated structure which acts as a waveguide for generated electromagnetic oscillations.

37. A device made by interfacing two or more devices as in claim 1 where one of the said devices with a flexible gap junction is used as a sample substrate carrier and one or more devices of claim are used as a scanning quantum interferometer which senses the sample associated with the flexible gap junction of said first quantum interferometer device or devices.

38. A device as described in claim 1 where said tip structures of the flexible gap junction are fabricated so as to produce an electron current which is spin polarized and the resultant electrons traversing the flexible gap junction can be used for electron spin sensitive measurements of samples scanned by said gap junction.

40. Device as described in claim 38 where said device is switched from superconducting quantum interferometer Cooper pair tunneling through said flexible gap junction to a state where normal carriers are conducted through the spin polarized tunneling junction.

41. Device as described in claim 1 where said device is switched from superconducting quantum interferometer Cooper pair tunneling through said flexible gap junction to a state where normal single electron carriers are conducted through at least one tunneling junction.

42. A device as in claim 1 which uses molecules comprising any nucleotide specific base, backbone linker, sugar, amino acid and associated functional group vibration states as labels which cause the scanned sample to have a map of resonance assisted electronic tunneling and dissonance states generated, said scanning provides a means of using polynucleotide, polypeptide and scanning probe microscope junction complexes as a means of identifying nucleotide bases and conformational states, said interferometric phase coherent conductive state of the device measuring the junction is used for molecular structure and molecular interaction measurement in samples comprising nucleotides and proteins.

43. Use of device as in claim 1 with a computer interface signal processor which effects feedback control of said flexible gap junction and provides the ability to deconvolve and correlate the signals comprising those generated by spatial movement of the scanner tip structures, sample substrate, sample material and circuit noise.

44. Device as in claim 1 where said MEMS device structure has one or more thermotunneling cooling devices used to cool said device and material in the tunneling junction portion of the device

45. Device as in claim 1 where a combinatorial chemical synthesis device means is used in conjunction with or is provided by the said flexible gap junction device.

46. Device as in claim 1 where a replicable object or array of objects is used in conjunction with said flexible gap junction device.

47. Device as in claim 1 where said flexible gap junctions are used as a scanning probe microscope where said tip structures of the flexible gap are used to sense and generate interactions comprising atomic forces, electromagnetic fields, near field optical interactions, particle spin forces, magnetic field forces with high spatial resolution.

48. Device as in claim 1 where said flexible gap junctions have a means for localized heating so as to produce continuous or periodic thermal effects at the junction probe or between the probe and sample substrate.

49. Device as in claim 1 where said flexible gap junctions can be operated as a dip-pen writing system where said coherent electron interferometer circuit can scan lithographically deposited patterns and surfaces before, during or after deposition of lithographic material.

50. Device as in claim 1 where said flexible gap junctions can be used in conjunction with or in an arrangement comprising a quantum ratchet Josephson junction device.

51. Device as in claim 1 where said flexible gap junctions can be used in conjunction with or in an arrangement comprising a matched load detector Josephson junction device.

52. Device as in claim 1 where said flexible gap junction can be used in conjunction with or in an arrangement comprising a discrete breather Josephson junction device.

53. Device as in claim 1 where said flexible gap junction can be used in conjunction with or in an arrangement comprising an anisotropic ladder Josephson junction device.

54. Device as in claim 1 where said flexible gap junction can be used in conjunction with or in an arrangement comprising a quantum mechanical qubit information device.

55. Device as in claim 1 where said flexible gap junction can be used in conjunction with or in an arrangement comprising a quantum ratchet Josephson junction device and said ratchet is modulated by electromagnetic excitation of the sample.

56. Device as in claim 1 where said flexible gap junction can be used in conjunction with or in an arrangement comprising a quantum ratchet Josephson junction device and said ratchet is modulated by electromagnetic excitation of the sample and one or more nanoparticle labels or molecular electronic structures in proximity to the flexible gap junction.

57. Device as in claim 1 where one or more nanoparticles are located in proximity with said flexible gap junction and said nanoparticles comprise a superconducting material.

58. Device as in claim 1 where one or more nanoparticles or nanoshells are located in proximity with said flexible gap junction and said nanoparticles or nanoshells comprise a superconducting material where said nanoparticles couple to form a circuit integrated with or in proximity with said sample being scanned.

59. Device as in claim 1 where one or more nanoparticles or molecular electronics devices are located in proximity with said flexible gap junction and said system couples energetically with said flexible gap junction device of claim 1.

60. Device as in claim 1 where said MEMS device structure has one or more thermotunneling cooling device used to cool said coherent electron material on the junction substrate portion of the device and said circuit uses coherent electron material in conjunction with said thermotunneling cooling structure to provide integrated cooling and sensor device structures.

61. Device as in claim 1 where an optical interferometer device is coupled to the flexible gap junction of the quantum interferometer scanner, said optical interferometer detects scattered and fluorescence photons in the gap junction sample interface region and maps the distribution of optical excitation as a function of spatial location on the sample, electron interferometry is performed using the flexible gap junction on said mapping process sample area.

62. A method of sequencing DNA or RNA using the instant invention where isotopic labeled nucleotide monomers are labeled with isotopic variants of carbon, nitrogen, oxygen, phosphate or sulfur and are incorporated into nucleotide polymers where said molecules are scanned by the device of the instant invention and dielectric oscillation detection of probe gap sample complex is performed using the MEMS/NEMS scanner of the instant invention.

63. A method of sequencing DNA or RNA using the instant invention where isotopic labeled nucleotide monomers are labeled with isotopic variants of carbon, nitrogen, oxygen, phosphate or sulfur and are incorporated into nucleotide polymers where said molecules are scanned by the device of the instant invention and electromagnetic and electron spectroscopy is performed using the flexible gap junction scanner source of the instant invention.

64. Device as in claim 1 where one or more Josephson junctions of the flexible gap junction scanner is located at or proximal to the probe of the flexible gap junction of the cantilever where the probe or probes are located.

65. Device as in claim 64 where the Josephson junctions located at or in proximity to the probe of the flexible gap junction of the cantilever where said Josephson junctions at said probe are connected electrically to form a conducting circuit.

66. Device as in claim 1 where said junction or junctions of the scanner posses one or more layers comprising a Superconductor-Normal-Superconductor (SNS)junction.

67. Device as in claim 1 where said junction or junctions of the scanner posses one or more layers comprising a Superconductor-Normal-Superconductor (SNS) junction where said normal conductor of the SNS junction can be biased so as to modify the current flowing through the SNS junction or junctions and provides a means of creating a pi SQUID.

68. Device as in claim 1 where said junction or junctions are comprised of one or more normal-insulator-superconductor NIS) multilayer or superconductor-normal-insulator-normal-superconductor (S-N-I-N-S) junction.

69. Device as in claim 1 where said junction or junctions are comprised of one or more normal-insulator-superconductor-normal-insulator-superconductor (N-I-S-N-I-S) multilayer.

70. Device as in claim 1 where one or more nanotubes located at or proximal to said flexible gap junction of the interferometer circuit is caused to vibrate by means of electromagnetic irradiation or a mechanical actuator.

71. A device as in claim 1 where one or more areas for prototyping microelectronic, optoelectronic, molecular electronic, mesoscopic nanometer scale circuits, fluidic systems and molecular mechanical devices is connected to the flexible gap MEMS scanner chip or sample substrate, said device with means of claim 1 plus a set of signal input and output means, prototyping space with prototyping area comprised of one or more prototype devices, device interconnections, switches and connections is provided on said substrates.

72. A device as in claim 71 where said prototyping area connected to said MEMS scanner flexible gap comprises a field programmable gate array and mesoscopic circuit area.

73. A device as in claim 1 where said flexible gap junction device is operated as a hot electron bolometer or photon detector.

74. A device as in claim 1 where said first surface has a device comprising a plasmon wave generator integrated with it.

75. A device as in claim 1 where said second surface has a device comprising a plasmon wave detector integrated with it.

76. A device as in claim 1 where said first surface has a device comprising one or more nanopores integrated with it.

77. A device as in claim 1 where said second surface has a device comprising one or more nanopores integrated with it.

78. A device as in claim 1 where a third surface which has one or more nanopores is brought into contact or proximity to said device of claim 1.

79. A device as in claim 1 where said flexible gap coherent electron cantilever device has one or more probe tips connected to said device which are orthogonal or parallel to the axis of said flexible gap junction tips.

80. A device as in claim 1 where said second surface is used as a substrate for nucleotide polymers and has one or more electrodes used to orient said polynucleotide molecules before, during or after scanning.

81. A device as in claim 1 where one or more microelectromechanical, nanoelectromechanical or biochemical motor is integrated with said flexible gap junction scanner or substrate device.

82. A device as in claim 1 where one or more said coherent electron interferometer circuit has one or more flexible gap tunneling junction has with one or more standard scanning probe microscope tips in proximity or connected to said flexible gap tunneling junction or junctions.

83. A device as in claim 71 where said MEMS device and prototyping device area with said flexible gap coherent electron interferometer tunneling junction scanner is designed by one or more artificial intelligence algorithms.

84. A device as in claim 1 where said MEMS device and prototyping circuit connected to said flexible gap coherent electron interferometer tunneling junction scanner with nanomanipulator tips is used to build and test nanoscale component objects and assembly systems designed by one or more artificial intelligence algorithms.

85. Device as in claim 83 where said prototyping area designed by one or more artificial intelligence algorithms is optimized to distinguish specific molecules or functional groups.

86. Device as in claim 85 where said MEMS device and prototyping area designed by artificial intelligence algorithm are optimized to distinguish specific nucleotide molecules and provide a means for sequencing nucleotide polymers.

87. Device as in claim 1 where said device is used to perform nanolithography.

88. Device as in claim 1 where said device is used to perform Aharonov-Bhom interferometry and scanning tunneling spectroscopy of samples in the flexible gap junction, said flexible gap junction tips on surface 1 or substrate sample on surface 2 can be selectively set to different temperatures during, before and after scanning of sample.

89. A device as in claim 1 where said device coherent electron interferometer with flexible gap tips produces Kondo effect Fano interference spectroscopy at or in proximity to one or more of said probes.

90. A device as in claim 1 where said device has one or more gate electrode structures connected with said coherent electron interferometer circuits used for signal component phase modulation and or matching in one or more arms of the interferometer.

91. A device as in claim 1 where said coherent electron flexible gap junction probes have one or more nanotube bimorph actuators used for actuation and sensing at or in proximity to said the flexible gap junction probes.

92. A device as in claim 1 where said flexible gap junction is a mechanically controlled break junction.

93. Device as in claim 16 where at least one Josephson junction is used to inject electrons into said Coulomb blockade device.

94. Device as in claim 1 where one or more of said device flexible gap probes is a Coulomb blockade device.

95. Device as in claim 1 where said scanned sample is located on first said surface in connection or proximity to said flexible gap probes.

96. Device composed of a plurality of devices as in claims 1 where one or more said devices are operated in conjunction with one another and perform processes comprising spectroscopic scanning, imaging and nanomanipulation.

97. Device composed of a plurality of devices as in claims 95 where one or more said devices are operated in conjunction with one another and perform processes comprising spectroscopic scanning, imaging and nanomanipulation.

98. Device composed of a plurality of devices as in claims 95 where one or more said devices are operated in conjunction with one another and perform processes comprising spectroscopic scanning, imaging and nanomanipulation and said plurality of devices are located on separate substrates.

99. Device as in claim 1 where said scanned sample is located on first said surface in connection or proximity to said flexible gap probe and said flexible gap coherent electron interferometer junction device has one or more nanoscale beams structures or nanotubes spanning one or more nanoscale electrode gaps, said spanning structure is used to send and receive energy associated with sample scanning process.

100. A device as in claim 1 where said flexible gap cantilevers on surface one with one or more said probe tips has one or more micro spheres, nanoshells or nanoparticles functionalized with objects comprising molecular objects, biomolecules, nanoparticles, nanoscale assemblies or catalysts where the microspheres or nanospheres are manipulated by the flexible gap junction actuators at one or more probe interaction regions.

101. A device as in claim 100 where there are nanoscale objects such as nanotubes spanning across said interferometer flexible gap junctions.

102. Device as in claim 1 where said device has one or more scanner probes attached to a flexible cantilever with actuator modulated displacement, said scanner probe interacts with one or more samples on a proximal area on same fabrication substrate as said scanner.

103. Device as in claim 5 where said junction or junctions of the scanner are made of layers comprising a Superconductor-Ferromagnetic-Superconductor (SNS)junction.

104. Device as in claim 5 where said junction or junctions of the scanner are made of layers comprising a Superconductor-Normal-D-wave-Normal-Superconductor (S-N-D-N-S)junction.

105. Device as in claim 5 where said junction or junctions of the scanner are made of layers comprising a Superconductor-two dimensional electron gas-Superconductor (S-2DEG-S)junction.

106. Device as in claim 5 where said first or second surface has a quantum well structure where said quantum well is energetically coupled to at least one said flexible gap coherent electron junction interferometer scanner.

107. A micron to submicron scale integrated quantum interference circuit and micro electro mechanical system (MEMS) to nano electro mechanical system(NEMS) scale device structure comprising:
a first surface;
said first surface possesses a multilayer thin film quantum interferometer device comprising:
(a) one or more junctions formed by at least one probe structure, having a micron to nanometer scale radius of curvature;
(b) one or more scanning probes attached to said coherent electron junction or junctions;
(c) one or more tunneling current signal detectors;
a second surface referred to as the scanned sample substrate,
said second surface comprising a sample carrier substrate and sample material, said carrier substrate is used to attach molecules or atomic structures which are scanned by said quantum interferometer device of first said surface, said second surface is scanned by said first surface device by transducer means with sub-angstrom resolution and is translated so as to allow the flexible tunneling gap junction tip structures of the first said surface to come within electron tunneling distance or contact said second structure, said tunneling junction of said quantum interferometer device on first said surface is sampled during translation of said second scanned sample substrate.

108. A device as in claim 1 which has one or more probe tips which are used as a means for generating field evaporation or ionization species from said sample substrate material, said generated species is measured by a mass differentiating means effectively generating a scanning atom probe (SAP) with coherent electron interferometry capabilities.

109. A device as in claim 107 which has one or more probe tips which are used in conjunction with an extractor electrode means for generating field evaporation or ionization species from said sample substrate material, said generated species is measured by a mass differentiating means effectively generating a scanning atom probe (SAP) with coherent electron interferometry capabilities.

110. A device as in claim 108 where at least one probe tip is illuminated by an electromagnetic means before, during or after field evaporation of sample material.

111. A device as in claim 109 where at least one probe tip or extractor electrode is illuminated by an electromagnetic means before, during or after field evaporation of sample material.

112. A device as in claim 110 which has one or more probe tips which are used as a means for generating field evaporation or ionization species from said sample substrate material, said generated species is measured by a mass differentiating means effectively generating a scanning atom probe (SAP) with coherent electron interferometry capabilities wherein said coherent electron interferometer has one or more nanomanipulator probes.

113. A device as in claim 118 which has one or more probe tips which are used as a means for generating field evaporation or ionization species from said sample substrate material, said generated species is measured by a mass differentiating means effectively generating a scanning atom probe (SAP) with coherent electron interferometry capabilities wherein said coherent electron interferometer has one or more nanomanipulator probes.

114. A device as in claim 112 which has one or more probe tips which are used as a means for generating field evaporation or ionization species from said sample substrate material, said generated species is measured by a mass differentiating means effectively generating a scanning atom probe (SAP) with coherent electron interferometry capabilities wherein said device has coherent electron interferometer has one or more nanomanipulator probe and Raman spectroscopy capabilities.

115. A device as in claim 113 which has one or more probe tips which are used as a means for generating field evaporation or ionization species from said sample substrate material, said generated species is measured by a mass differentiating means effectively generating a scanning atom probe (SAP) with coherent electron interferometry capabilities wherein said coherent electron interferometer device has one or more nanomanipulator probe and Raman spectroscopy capabilities.

116. A device as in claim 1 which has one or more probe tips which are used as a means for generating field evaporation or ionization species from said sample material wherein said ionized material is transferred from the sample substrate to at least one scanning probe tip before injection into a mass spectroscopy device, said generated species is measured by a mass differentiating means effectively generating a scanning atom probe (SAP) with coherent electron interferometry capabilities.

117. A device as in claim 107 which has one or more probe tips and a means for generating field evaporation or ionization species from said sample material wherein said ionized material is transferred from the sample substrate to at least one scanning probe tip before injection into a mass spectroscopy device, said generated species is measured by a mass differentiating means effectively generating a scanning atom probe (SAP) with coherent electron interferometry capabilities.

118. A device as in claim 112 which has one or more probe tips which are used as a means for generating field evaporation or ionization species from said sample material wherein said ionized material is transferred from the sample substrate to at least one scanning probe tip before injection into a mass spectroscopy device, said generated species is measured by a mass differentiating means effectively generating a scanning atom probe (SAP) with coherent electron interferometry capabilities wherein said coherent electron interferometer device has one or more nanomanipulator probes and Raman spectroscopy capabilities.

119. A device as in claim 113 which has one or more probe tips which are used as a means for generating field evaporation or ionization species from said sample material wherein said ionized material is transferred from the sample substrate to at least one scanning probe tip before injection into a mass spectroscopy device, said generated species is measured by a mass differentiating means effectively generating a scanning atom probe (SAP) with coherent electron interferometry capabilities wherein said coherent electron interferometer device has one or more nanomanipulator probes and Raman spectroscopy capabilities.

120. A device as in claim 110 which has one or more probe tips excited by an energy pulse sequence which are used as a means for generating field evaporation or ionization species from said sample substrate material, said generated species is measured by a mass differentiating means effectively generating a scanning atom probe (SAP) with coherent electron interferometry capabilities wherein said coherent electron interferometer has one or more nanomanipulator probes.

121. A device as in claim 111 which has one or more probe tips excited by an energy pulse sequence which are used as a means for generating field evaporation or ionization species from said sample substrate material, said generated species is measured by a mass differentiating means effectively generating a scanning atom probe (SAP) with coherent electron interferometry capabilities wherein said coherent electron interferometer has one or more nanomanipulator probes.

122. A device as in claim 112 which has one or more probe tips excited by an energy pulse sequence which are used as a means for generating field evaporation or ionization species from said sample substrate material, said generated species is measured by a mass differentiating means effectively generating a scanning atom probe (SAP) with coherent electron interferometry capabilities wherein said device has coherent electron interferometer has one or more nanomanipulator probe and Raman spectroscopy capabilities.

123. A device as in claim 113 which has one or more probe tips excited by an energy pulse sequence which are used as a means for generating field evaporation or ionization species from said sample substrate material, said generated species is measured by a mass differentiating means effectively generating a scanning atom probe (SAP) with coherent electron interferometry capabilities wherein said coherent electron interferometer device has one or more nanomanipulator probe and Raman spectroscopy capabilities.

124. A device as in claim 1 which has one or more probe tips excited by an energy pulse sequence which are used as a means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP) with coherent electron interferometry capabilities.

125. A device as in claim 107 which has one or more probe tips excited by an energy pulse sequence which are used in conjunction with an extractor electrode means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP) with coherent electron interferometry capabilities.

126. A device as in claim 112 which has one or more probe tips excited by an energy pulse sequence which are used as a means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP) with coherent electron interferometry capabilities wherein said coherent electron interferometer device has one or more nanomanipulator probes and Raman spectroscopy capabilities.

127. A device as in claim 113 which has one or more probe tips excited by an energy pulse sequence which are used as a means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP) with coherent electron interferometry capabilities wherein said coherent electron interferometer device has one or more nanomanipulator probes and Raman spectroscopy capabilities.

135. A device as in claim 110 which has one or more probe tips excited by an energy pulse sequence which are used as a means for generating field evaporation or ionization species from said sample substrate material, said generated species is measured by a mass differentiating means effectively generating a scanning atom probe (SAP) wherein said scanning probe microscope has one or more nanomanipulator probes.

136. A device as in claim 111 which has one or more probe tips excited by an energy pulse sequence which are used as a means for generating field evaporation or ionization species from said sample substrate material, said generated species is measured by a mass differentiating means effectively generating a scanning atom probe (SAP) wherein said scanning probe microscope has one or more nanomanipulator probes.

137. A device as in claim 112 which has one or more probe tips excited by an energy pulse sequence which are used as a means for generating field evaporation or ionization species from said sample substrate material, said generated species is measured by a mass differentiating means effectively generating a scanning atom probe (SAP) wherein said scanning probe microscope device has one or more nanomanipulator probes and Raman spectroscopy capabilities.

138. A device as in claim 113 which has one or more probe tips excited by an energy pulse sequence which are used as a means for generating field evaporation or ionization species from said sample substrate material, said generated species is measured by a mass differentiating means effectively generating a scanning atom probe (SAP) wherein said scanning probe microscope device has one or more nanomanipulator probes and Raman spectroscopy capabilities.

139. A device as in claim 1 which has one or more probe tips excited by an energy pulse sequence which are used as a means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP).

140. A device as in claim 107 which has one or more probe tips excited by an energy pulse sequence which are used as a means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP).

141. A device as in claim 112 which has one or more probe tips excited by an energy pulse sequence which are used as a means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP) wherein said scanning probe has one or more nanomanipulator probes and Raman spectroscopy capabilities.

142. A device as in claim 113 which has one or more probe tips excited by an energy pulse sequence which are used as a means for generating field evaporation or ionization species from said sample material wherein said ionized material is transferred from the sample substrate to at least one scanning probe tip before injection into mass spectroscopy device, said generated species is measured by a mass differentiating means effectively generating a scanning atom probe (SAP) wherein said scanning probe has one or more nanomanipulator probes and Raman spectroscopy capabilities.

143. A device as in claim 1 which has one or more probe tips, the sample on said surface is excited by an energy pulse sequence which is used as a means for generating field evaporation or ionization species from said substrate sample material wherein said ionized material is injected into mass spectroscopy device, said generated ion species is measured by a mass differentiating means.

144. A device as in claim 1 which has one or more probe tips, the sample on said surface is excited by an energy pulse sequence which is used as a means for generating field evaporation or ionization species from said substrate sample material wherein said ionized material is injected into mass spectroscopy device, said generated ion species is measured by a mass differentiating means, wherein said scanning probe has one or more nanomanipulator probes and Raman spectroscopy capabilities.

145. A method using the device described in prior claims used for detecting materials where a first material is deposited on a substrate; said substrate and first material are subsequently 145. A method using the device described in prior claims used for detecting materials where a first material is deposited on a substrate; said substrate and first material are subsequently exposed to a second material which interacts with the first said material forming a product or complex; scanning the substrate with one or more probe to identify the resulting product or complex; transferring the product or complex from the substrate; measuring the product or complex.

146. Method according to claim 145 where said product or complex removed from the substrate surface is subjected to ionization and injection into a mass spectrometer from the one or more probes.

147. Method according to claim 145 where Raman scattering spectra is measured for the product or complex, before during or after removal from said substrate and subsequently the product or complex material is injected into a mass spectrometer from the one or more probes.

148. Method according to claim 147 where the product or complex is attached to one of the probes and is transferred to a second tip of the probes; where said transfer process is accompanied by a binding interrogation, chemical change or catalysis.

149. Method whereby material transferred from one probe tip to another in claim 148 is subjected to Raman spectroscopy.

150. Method whereby material transferred from one nanomanipulator tip to another in claim 148 is subjected to Raman spectroscopy and injected into a mass spectroscopy device.

151. Method according to claim 145 where a nanomanipulator posses one or more Raman scattering means comprising nanoparticles, nano-antennas, nanotubes, nanorods, nanoshells or complexes; said nanomanipulator probes are used to extract sample product or complex material from said sample surface; the measured product or complex is subjected to Raman spectroscopy before, during or after removal from said substrate surface and subsequently the product or complex material is injected into a mass spectrometer from the nanomanipulator.

152. Method according to claim 145 where nanomanipulator posses one or more Raman scattering means comprising nanoparticles, nano-antennas, nanorods, nanotubes, nanoshells or complexes; said nanomanipulator tips are used to extract sample product or complex material from said sample surface; the measured product or complex is subjected to Raman spectroscopy before, during or after removal from said substrate surface and subsequently the product or complex material is placed onto or into a surface.

153. Method according to claim 145 where said nanomanipulator posses one or more Raman scattering means comprising nanoparticles, nano-antennas, nanotubes, nanorods, nanoshells or complexes; said nanomanipulator tips are used to extract sample product or complex material from said sample surface; the measured product or complex is subjected to Raman spectroscopy before, during or after removal from said substrate surface and subsequently the product or complex material is subsequently placed in contact with at least one disparate sample material on a sample surface which may interact with the said nanomanipulator held sample material, said interaction between first product or complex sample material and second sample material is measured.

154. Method according to claim 145 where said nanomanipulator posses one or more Raman scattering means comprising nanoparticles, nano-antennas, nanotubes, nanorods, nanoshells or complexes; said nanomanipulator tips are used to extract sample product or complex material from said sample surface; the measured product or complex is subjected to Raman spectroscopy before, during or after removal from said substrate surface and subsequently the product or complex material is replicated.

155. Method according to claim 151 where said first product or complex sample material held by said nanomanipulator is attached to a circuit prototyping area with circuits generated by one or more artificial intelligence algorithm.

156. Method according to claim 151 where said first product or complex sample material held by said nanomanipulator is generated by a one or more artificial intelligence algorithm for directed combinatorial synthesis or assembly.

157. Method according to claim 151 where said subsequent products or complex sample materials interacted with the first product or sample material held by said nanomanipulator is generated by one or more artificial intelligence algorithm for combinatorial synthesis or assembly.

158. Method as in claim 151 where disparate Raman particles are attached to said probe and said probe is modulated by means comprising mechanical, electrical, phonon vibrational, chemical or optical modulation.

159. Method as in claim 151 where fluorescence energy transfer functionalities are attached to one or more probes or samples of said nanomanipulator or sample substrate means of said device and energy transfer between the probes, first product or complex sample material, scanning probe nanomanipulator device or subsequent product sample materials is measured.

160. Device as in claim 1 where the said probe device possess at least one scanning tunneling charge transfer microscope probe means.
